(19) United States
(12) Patent Application Publication
(10) Pub. No.: US 2026/0245226 A1
(43) Pub. Date: Aug. 20, 2026

(54) APPARATUS, SYSTEM, INTERFACE AND METHOD FOR DETERMINING INFORMATION CONCERNING DISTANT OBJECTS

(71) Applicant: PRIMARY ARMS, L.L.C., Houston, TX (US)

(72) Inventors: Robert E Sheets, Jr., Houston, TX (US); Ian Boehm, Houston, TX (US)

(21) Appl. No.: 19/541,252

(22) Filed: Feb. 16, 2026

Related U.S. Application Data
(60) Provisional application No. 63/759,521, filed on Feb. 17, 2025.

(51) Int. Cl. G06T 7/50; G06V 10/32; G06V 10/74; G06V 10/764; G06V 10/82; H04L 9/40

(52) U.S. Cl. CPC G06T 7/50; G06V 10/32; G06V 10/761; G06V 10/764; G06V 10/82; H04L 63/107; G06T 2207/20084; G06V 2201/07

(57) ABSTRACT

Apparatuses, systems, interfaces and methods for determining information concerning distant objects including distant objects in captured images.

### CROSS-REFERENCE TO RELATED APPLICATIONS

This application claims benefit of U.S. Provisional Patent Application No. 63/759,521, filed on Feb. 17, 2025, the content of which is hereby incorporated by reference in its entirety.

### BACKGROUND OF THE DISCLOSURE

### 1. Field of the Disclosure

This disclosure relates generally to determining the size and distance of distant objects.

### 2. Background Art

Determining a distance to a distant object and/or determining a dimension of a distant object is undertaken in activities including, but not limited to, hunting, golfing, surveying, security, military, and law enforcement. Conventional determination of distance and/or dimension is accomplished using devices often referred to as rangefinders, which employ stadiametric ranging and/or light beam technology such as laser rangefinders and infrared rangefinders. Stadiametric ranging can be time intensive and/or require mathematical calculations. Laser rangefinders use visible lasers and infrared rangefinders use infrared light that is detectable via technology such as night vision technology and thermal imaging, which may be critical in military and law enforcement combative situations.

While solutions to this problem may exist such as using stadiametric range finding typically done by having a stadia or set of stadia that is based off predetermined dimension(s) and compare it to the target to determine the distance away, there is still a need in the art for apparatuses, systems, and interfaces and methods for implementing them using one or more image capturing devices to capture one or images of one or more targets and determining distances to the one or more targets using image processing.

### SUMMARY OF THE DISCLOSURE

The present disclosure provides one or more solutions to the above-described shortcomings.

The present disclosure provides apparatuses, systems, interfaces and methods for determining information concerning distant objects including distant objects in captured images.

### BRIEF DESCRIPTION OF THE SEVERAL VIEWS OF THE DRAWINGS

FIG. 1A depicts an embodiment of an electronic device or system of this disclosure.

FIG. 1B depicts an embodiment of an electronic device or system of this disclosure.

FIG. 2A depicts an embodiment of an electronic device or system of this disclosure.

FIG. 2B depicts an embodiment of an electronic device or system of this disclosure.

FIG. 3A depicts an embodiment of an electronic device or system of this disclosure.

FIG. 3B depicts an embodiment of an electronic device or system of this disclosure.

FIG. 3C depicts an embodiment of an electronic device or system of this disclosure.

FIG. 4 is a conceptual flow chart of an embodiment of the apparatus, system, interface, or methods of this disclosure.

FIG. 5 is a conceptual flow chart of another embodiment of the apparatus, system, interface, or methods of this disclosure.

FIG. 6 is a conceptual flow chart of another embodiment of the apparatus, system, interface, or methods of this disclosure.

FIG. 7 is a conceptual flow chart of another embodiment of the apparatus, system, interface, or methods of this disclosure.

FIG. 8 is a conceptual flow chart of another embodiment of the apparatus, system, interface, or methods of this disclosure.

FIG. 9 is a conceptual flow chart of another embodiment of the apparatus, system, interface, or methods of this disclosure.

FIG. 10 is a conceptual flow chart of another embodiment of the apparatus, system, interface, or methods of this disclosure.

FIG. 11 is a conceptual flow chart of another embodiment of the apparatus, system, interface, or methods of this disclosure.

FIG. 12 is a conceptual flow chart of another embodiment of the apparatus, system, interface, or methods of this disclosure.

FIG. 13 is a conceptual flow chart of another embodiment of the apparatus, system, interface, or methods of this disclosure.

FIG. 14 is a conceptual flow chart of another embodiment of the apparatus, system, interface, or methods of this disclosure.

FIG. 15 is a conceptual flow chart of another embodiment of the apparatus, system, interface, or methods of this disclosure.

FIG. 16 is a conceptual flow chart of another embodiment of the apparatus, system, interface, or methods of this disclosure.

FIG. 17 is a conceptual flow chart of another embodiment of the apparatus, system, interface, or methods of this disclosure.

FIG. 18 is an exemplary captured image including two persons and an automobile.

FIG. 19 is an exemplary captured image including an enemy combatant.

FIG. 20 is an illustration of a tractor trailer traveling down a paved road and an airborne helicopter employing an apparatus, system, interface, or methods of this disclosure.

FIG. 21 is an exemplary captured image including two persons located out in front of a building.

### DEFINITIONS USED IN THE DISCLOSURE

Terms and phrases used in this document, and variations thereof, unless otherwise expressly stated, should be construed as open-ended as opposed to limiting. As examples of the foregoing: the term “including” should be read as meaning “including, without limitation” or the like, the term “example” is used to provide exemplary instances of the item in discussion, not an exhaustive or limiting list thereof, the terms “a” or “an” should be read as meaning “at least one,” “one or more,” or the like. The use of the term “assembly” does not imply that the components or functionality described or claimed as part of an assembly are all necessarily configured in a common package.

The term “at least one”, “one or more”, and “one or a plurality” mean one thing or more than one thing with no limit on the exact number; these three terms may be used interchangeably within this disclosure. For example, at least one device means one or more devices or one device and a plurality of devices.

The term “about” means that a value of a given quantity is within ±20% of the stated value. In other embodiments, the value is within ±15% of the stated value. In other embodiments, the value is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value.

The term “substantially” or “essentially” means that a value of a given quantity is within ±10% of the stated value. In other embodiments, the value is within ±7.5% of the stated value. In other embodiments, the value is within ±5% of the stated value. In other embodiments, the value is within ±2.5% of the stated value. In other embodiments, the value is within ±1% of the stated value. In other embodiments, the value is within ±0.5% of the stated value. In other embodiments, the value is within ±0.1% of the stated value.

The term “and/or” includes any and all combinations of one or more of the associated listed items.

The terms “first,” “second,” “third,” and the like, herein do not denote any order, quantity, or importance, but rather are used to distinguish one element from another.

The terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances, the modified term may sometimes not be appropriate, capable, or suitable. For example, in some circumstances, an event or capacity can be expected, while in other circumstances, the event or capacity cannot occur. This distinction is captured by the terms “may” and “may be.”

Spatially relative terms, such as “inner,” “outer,” “beneath,” “below,” “lower,” “above,” “upper,” “top,” “bottom,” and the like, may be used herein. These spatially relative terms can be used for ease of description to describe one element's or feature's relationship to another element(s) or feature(s) as illustrated in the figures. The spatially relative terms may also be intended to encompass different orientations of an apparatus or device in use, or operation, in addition to the orientation depicted in the figures. For example, if the apparatus or device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptions used herein interpreted accordingly.

The term “simultaneous” or “simultaneously” means that an action occurs either at the same time or within a small period of time. Thus, a sequence of events is considered to be simultaneous if they occur concurrently or at the same time or occur in rapid succession over a short period of time, where the short period of time ranges from about 1 nanosecond to 5 second. In other embodiments, the period ranges from about 1 nanosecond to 1 second. In other embodiments, the period ranges from about 1 nanosecond to 0.5 seconds. In other embodiments, the period ranges from about 1 nanosecond to 0.1 seconds. In other embodiments, the period ranges from about 1 nanosecond to 1 millisecond. In other embodiments, the period ranges from about 1 nanosecond to 1 microsecond. It should be recognized that any value of time between any stated range is also covered.

Real-time may refer to being approximately within the perceptual limits of human cognition including up to or about 2 seconds. Near real-time may refer to any interaction of a sufficiently short time to enable two individuals to engage in a dialogue via such user interface, and will generally be less than 10 seconds but greater than 2 seconds.

The term “kinetic”, “motion” or “movement” are often used interchangeably and mean motion or movement that is capable of being detected by a motion sensor or motion sensing component within an active zone of the sensor such as a sensing area or volume of a motion sensor or motion sensing component. “Kinetic” also includes “kinematic” elements, as included in the study of dynamics or dynamic motion. Thus, if the sensor is a forward viewing sensor and is capable of sensing motion within a forward extending conical active zone, then movement of anything within that active zone that meets certain threshold detection criteria, will result in a motion sensor output, where the output may include at least direction, velocity, and/or acceleration. Of course, the sensors does not need to have threshold detection criteria, but may simply generate output anytime motion of any nature is detected. The processing units can then determine whether the motion is an actionable motion or movement and a non-actionable motion or movement.

The term “physical sensor” means any sensor capable of sensing any physical property such as temperature, pressure, humidity, weight, geometrical properties, meteorological properties, astronomical properties, atmospheric properties, light properties, color properties, chemical properties, or any other physical measurable property.

The term “motion sensor” or “motion sensing component” means any sensor or component capable of sensing motion of any kind by anything within an active zone-area or volume, regardless of whether the sensor's or component's primary function is motion sensing.

The term “biometric sensor” or “biometric sensing component” means any sensor or component capable of acquiring biometric data.

The term “bio-kinetic sensor” or “bio-kinetic sensing component” means any sensor or component capable of simultaneously or sequentially acquiring biometric data and kinetic data (i.e., sensed motion of any kind) by anything moving within an active zone of a motion sensor, sensors, array, and/or arrays—area or volume, regardless of whether the primary function of the sensor or component is motion sensing.

The term “real items” or “real world items” means any real world object such as humans, animals, plants, devices, articles, robots, unmanned aerial vehicles (UAVs) such as drones, environments, physical devices, mechanical devices, electro-mechanical devices, magnetic devices, electro-magnetic devices, electrical devices, electronic devices or any other real world device, etc. that are capable of being controlled or observed by a monitoring subsystem and collected and analyzed by a processing subsystem.

The term “virtual item” means any computer generated (GC) items or any feature, element, portion, or part thereof capable of being controlled by a processing unit. Virtual items include items that have no real world presence, but are still controllable by a processing unit, or may include virtual representations of real world items. These items include elements within a software system, product or program such as icons, list elements, menu elements, generated graphic objects, 2D and 3D graphic images or objects, generated real world objects such as generated people, generated animals, generated devices, generated plants, generated landscapes and landscape objects, generate seascapes and seascape objects, generated skyscapes or skyscape objects, or any other generated real world or imaginary objects. Haptic, audible, and other attributes may be associated with these virtual objects in order to make them more like “real world” objects.

The term “a mixture” or “mixtures” mean the items, data or anything else is mixed together, not segregated, but more or less collected randomly-uniform or homogeneous.

The term “combinations” mean the objects, data or anything else segregated into groups, packets, bundles, etc.,—non-uniform or inhomogeneous.

The term “object data” or “item data” means data associated with an object or an item. The data includes, without limitation, object or item type, object or item classification, object or item similarity data, object or item textual data, object or item size data, and object or item distance data including object or item sizes at different downrange distances. The object or item type relates to the physical nature of the object or item. For example, if the object or item type is a fluid containing object or item, then the object or item may be a glass bottle, a plastic bottle, a flask, a cup, a can, a fluid storage bag, a tumbler, a tank, or any other fluid containing object or item. The object or item classification relates to a classification system of distinguishing object or item types. For example, the object or item types will be divided into very similar types. Thus, for the fluid containing object or item type, the classification may including soda bottles, soda cans, beer bottles, beer cans, mugs, ceramic cups, wooden cups, coffee tumblers, water tumblers, etc. The classification system allows for the determination of object or item similarity data. For example, if box type objects or items may be considered similar regardless of the object or item type. For example, if the box object is an ammunition box, then a similar box would be any box having a similar size and shape regardless of type. The object or item textual data include, without limitation, a textual description includes, without limitation, a full description of the object or item in searchable text including size (3 dimensional measurement), shape (geometrical), lettering if present, material, texture, logos if present, and any other aspect, feature, characteristic, or property. The object or item size data include, without limitation, 2D, 3D or 4D values (length, width, height and changes over time), orientation transformation values, fixed distance values, e.g., size at specification downrange distances, similarity type data including objects or items having a similarity value or index of at least 99%, at least 95%, at least 90%, at least 85%, at least 80%, at least 75%, at least 70%, at least 65%, at least 60%, at least 55%, or lower similarity values. The object or item distance data including object or item sizes at different downrange distances.

The term “sensor data” mean data derived from at least one sensor including user data, motion data, environment data, temporal data, contextual data, or other data derived from any kind of sensor or environment, in real-time of historically, or mixtures and combinations thereof.

The term “user data” mean user attributes, attributes of entities under the control of the user, attributes of members under the control of the user, information or contextual information associated with the user, or mixtures and combinations thereof.

The term “motion data” mean data evidencing one or a plurality of motion attributes.

The term “motion attributes” mean attributes associated with the motion data including motion direction (linear, curvilinear, circular, elliptical, etc.), motion velocity (linear, angular, etc.), motion acceleration (linear, angular, etc.), motion signature-manner of motion (motion characteristics associated with the user, users, objects, areas, zones, or combinations of thereof), motion as a product of distance traveled over time, dynamic motion attributes such as motion in a given situation, motion learned by the system based on user interaction with the system, motion characteristics based on the dynamics of the environment, changes in any of these attributes, and mixtures or combinations thereof.

The term “environment data” mean data associated with the user's surrounding or environment such as location (GPS, etc.), type of location (home, office, store, highway, road, etc.), extent of the location, context, frequency of use or reference, any data associated with any environment, and mixtures or combinations thereof.

The term “temporal data” mean data associated with time, time of day, day of month, month of year, any other temporal data, and mixtures or combinations thereof.

The term “contextual data” mean data associated with user activities, environment activities, environmental states, frequency of use or association, orientation of objects, devices or users, association with other devices and systems, temporal activities, and mixtures or combinations thereof.

The term “biometric data” means any data that relates to specific characteristics, features, aspects, attributes etc. of a primary entity, a secondary entity under the control of a primary entity, or a real world object under the control of a primary or secondary entity. For entities, the data include, without limitation, fingerprints, palm prints, foot prints, toe prints, retinal patterns, internal and/or external organ shapes, features, colorings, shadings, textures, attributes, etc., skeletal shapes, features, colorings, shadings, textures, attributes, etc., internal and/or external placements, ratio of organ dimensions, hair color, distribution, texture, etc., whole body shapes, features, colorings, shadings, textures, attributes, neural or chemical signatures, emf fields, etc., any other attribute, feature, etc. or mixtures and combinations thereof. For real world objects, the data include, without limitation, shape, texture, color, shade, composition, any other feature or attribute or mixtures and combinations thereof. For people, biometric data include fingerprints, hand size and shape, finger sizes and shapes, iris features, iris data stored in iris recognition databases, facial features, facial data stored in facial recognition databases, height, weight, skin color, ethnicity, and any other biometric data associated with an individual.

The term “entity” means a human or an animal.

The term “game” in a hunting sense, may refer to any animal that is hunted for sport, recreation or for the animal's products.

The term “primary entity” means any living organism with independent volition, which in the present application is a human, but other animals may meet the independent volition test, or organic entities under the control of a living organism with independent volition. Living organisms with independent volition include human for this disclosure, while all other living organisms useful in this disclosure are living organisms that are controllable by a living organism with independent volition.

The term “secondary entity” means any living organism or non-living (robots) device that is capable of being controlled by a primary entity including, without limitation, mammals, robots, robotic hands, arms, etc. that respond to instruction by primary entities.

The term “entity object” means a human or a part of a human (fingers, hands, toes, feet, arms, legs, eyes, head, body, etc.), an animal or a port of an animal (fingers, hands, toes, feet, arms, legs, eyes, head, body, etc.), or a real world object under the control of a human or an animal, or robotics under the control of a system, computer or software system or systems, or autonomously controlled (including with artificial intelligence), and include such articles as pointers, sticks, mobile devices, or any other real world object or virtual object representing a real entity object that can be directly or indirectly controlled by a human or animal or robot or robotic system.

The term “user” means an entity in a generic sense.

Herein, a person or persons operating an electronic device of this disclosure may be referred to as a “user” or “users” of the electronic device.

The term “real world item” means any real world item that is under the control of a primary or secondary entity including, without limitation, robots, pointers, light pointers, laser pointers, canes, crutches, bats, batons, etc. or mixtures and combinations thereof.

The terms “user features”, “entity features”, and “member features” means features including: overall user, entity, make up, or member shape, texture, proportions, information, state, layer, size, surface, zone, area, any other overall feature, and mixtures or combinations thereof; specific user, entity, or member part shape, texture, proportions, any other part feature, and mixtures or combinations thereof; and particular user, entity, or member dynamic shape, texture, proportions, any other part feature, and mixtures or combinations thereof; and mixtures or combinations thereof.

The term a “short time frame” means a time duration between less than or equal to 1 ns and less than 1 μs.

The term a “medium time frame” means a time duration between less than or equal to 1 μs and less than 1 ms.

The term a “long time frame” means a time duration between less than or equal to about 1 ms and less than or equal to 1 s.

The term a “very long time frame” means a time duration greater than 1 s, but less than or equal to 1 minute.

The term “mobile device” means any smart device that may be carried by a user and is capable of interacting with wireless communication network such as a WI-FI® network, a cellular network, a satellite network, or any other type of wireless network.

The term “data mining” means is a useful techniques that help artificial intelligence (AI) routines, and other software mining tools extract valuable information from huge sets of data. Data mining is also sometimes called Knowledge Discovery in Database (KDD). The knowledge discovery process includes data cleaning, data integration, data selection, data transformation, data mining, pattern evaluation, and knowledge presentation.

The term “data analytics” means using information from data mining to evaluate data, find patterns, and generate statistics.

The term “data integration” means the discipline of data mining comprises the practices, architectural techniques and tools for achieving the consistent access and delivery of data across the spectrum of data subject areas and data structure types in the enterprise to meet the data consumption requirements of all applications.

The term “environment data” means data associated with the user's surrounding or environment such as location (GPS, etc.), type of location (home, office, store, highway, road, etc.), extent of the location, context, frequency of use or reference, attributes, characteristics, and/or mixtures or combinations thereof.

The term “temporal data” means data associated with duration of motion/movement, events, actions, interactions, etc., time of day, day of month, month of year, any other temporal data, and/or mixtures or combinations thereof.

The term “temporal relationships and/or associations” or “temporal relationship and/or associated data” means associations and data representing temporal associations between entities (people, imaginary sentient beings, animals, imaginary animals, etc.), things (real, imaginary, items, objects, etc.), places (real or imaginary lands, seas, lakes, rivers, stream, etc., villages, towns, cities, counties, states, countries, etc.) and characteristics, features, properties, attributes, etc. associated therewith, CG/CC constructs thereof, or any mixture or combination thereof.

The term “historical data” means data associated with past events and characteristics of the user, the objects, the environment and the context gathered or collected by the systems over time, or any combinations of these.

The term “historical relationships and/or associations” or “historical relationship and/or associated data” means data associated with historical events and characteristics of the user, the objects, the environment and the history or historical data gathered or collected by the systems over time, or any combinations of these.

The term “contextual data” means data associated with user activities, environment activities, environmental states, frequency of use or association, orientation of objects, devices or users, association with other devices and systems, temporal activities, any other content or contextual data, and/or mixtures or combinations thereof.

The term “contextual relationships and/or associations” or “contextual relationship and/or associated data” means data associated with the context and characteristics of the user, the objects, the environment and the context gathered or collected by the systems over time, or any combinations of these.

The term “predictive data” means any data from any source that permits that apparatuses, systems, interfaces, and/or implementing methods to use data to modify, alter, change, augment, update, enhance, reformat, restructure, and/or redesign object identification, target identification, information and data used to identify objects and targets and information and data for determining identified objects and target distances for users in general or specific classes of users.

The term “predictive relationships and/or associations” or “predictive relationship and/or associated data” means data associated with the predictive or perceived relationships and/or associations and characteristics of the user, the objects, the environment and the predictions gathered or collected by the systems over time, or any combinations of these.

The term “spaced apart” means for example that objects displayed in a window of a display device are separated one from another in a manner that improves an ability for the systems, apparatuses, and/or interfaces to discriminate between objects based on movement sensed by motion sensors associated with the systems, apparatuses, and/or interfaces.

The term “maximally spaced apart” means that objects displayed in a window of a display device are separated one from another in a manner that maximizes a separation between the objects to improve an ability for the systems, apparatuses, and/or interfaces to discriminate between objects based on motion/movement sensed by motion sensors associated with the systems, apparatuses, and/or interfaces.

The term “s” means one or more seconds. The term “ms” means one or more milliseconds (10⁻³ seconds). The terms “μs” means one or more micro seconds (10⁶ seconds). The term “ns” means nanosecond (10⁻⁹ seconds). The term “ps” means pico second (10⁻¹² seconds). The term “fs” means femto second (10⁻¹⁵ seconds). The term “as” means femto second (10⁻¹⁸ seconds).

The term “hold” means to remain stationary at a display location for a finite duration generally between about 1 ms to about 2 s.

The term “brief hold” means to remain stationary at a display location for a finite duration generally between about 1 μs to about 1 s.

The term “microhold” or “micro duration hold” means to remain stationary at a display location for a finite duration generally ranging between about 1 femtosecond (fs) to about 500 milliseconds (ms). In certain embodiments, the microhold generally ranges between about 1 picosecond (ps) to about 500 ms. In certain embodiments, the microhold is between about 1 ns to about 500 ms. In certain embodiments, the microhold is between about 1 μs to about 500 ms. In certain embodiments, the microhold is between about 1 ms to about 500 ms. In certain embodiments, the microhold is between about 100 microseconds (μs) to about 500 ms. In certain embodiments, the microhold is between about 10 ms to about 500 ms. In certain embodiments, the microhold is between about 10 ms to about 250 ms. In certain embodiments, the microhold is between about 10 ms to about 100 ms.

The term “interactive” as used in conjunction with the apparatuses and systems of this disclosure and interfaces and methods implementing same means the ability to measure user confidence, intent, intensity, and/or relationships between the user and the content, information, and/or data associated with the work being analyzed as other independent attributes associated with the work being analyzed by the apparatuses and systems of this disclosure of interfaces and method implementing same.

The term “integration” as used herein means the ability to take any pre-generated content and to add the content within the interactive environment being generated or after generation. Also, some content may be interactive and other content (seen or unseen, generated or existing) may be influenced by user interaction. Additionally, input data from cameras, lenses, or other optical devices and the input data may be combined with displayed attributes viewable within the generated interactive environments. For instance, viewing a target or any other real object that the system recognizes optically or via ML, computer vision, etc., may cause the digital content to be modified or created to provide more relevant information to the user.

The term “portability” as used herein in conjunction with the apparatuses and systems of this disclosure and interfaces and methods implementing same means that assets/content/programs/systems/rules/and any other aspect of one system may be transferred to another system, or any part of one system may be transferred to any part of another system.

The terms “significant real-world items, imaginary items, computer-generated (CG) items and forms” or “essential real-world items, imaginary items, computer-generated (CG) items and forms” mean items or forms necessary for the interactive environment to make sense to the user, to adequately represent the work or environment, and/or to reduce the complexity of the animation.

The terms “significant data, information, content, context, features, characteristics, and/or attributes associated with each of the identified items and forms” or “essential data, information, content, context, features, characteristics, and/or attributes associated with each of the identified items and forms” mean data necessary for the interactive environment to make sense to the user, to adequately represent the work or environment, and/or to reduce the complexity of the animation.

The terms “insignificant real-world items, imaginary items, computer-generated (CG) items and forms” or “non-essential real-world items, imaginary items, computer-generated (CG) items and forms” mean items or forms are not necessary for the interactive environment to make sense to the user, to adequately represent the work or environment, and/or to reduce the complexity of the animation.

The terms “insignificant data, information, content, context, features, characteristics, and/or attributes associated with each of the identified items and forms” or “non-essential data, information, content, context, features, characteristics, and/or attributes associated with each of the identified items and forms” mean data not necessary for removing insignificant objects or elements from the image to improve object and target identification and ranging.

The term “couple,” “couples” or “coupled” is intended to mean either an indirect or direct connection. Thus, if a first device couples to a second device, that connection may be through a direct connection or through an indirect connection via other devices and connections.

Controller, control module, module, control, control unit, processor and similar terms mean any one or various combinations of one or more of Application Specific Integrated Circuit(s) (ASIC), electronic circuit(s), central processing unit(s) (preferably microprocessor(s)) and associated memory and storage (read only, programmable read only, random access, hard drive, etc.) executing one or more software or firmware programs or routines, combinational logic circuit(s), input/output circuit(s) and devices, appropriate signal conditioning and buffer circuitry, and other components to provide the described functionality, including data storage and data analysis. Software, firmware, programs, instructions, routines, code, algorithms and similar terms mean any controller-executable instruction sets including calibrations and look-up tables. The term “model” refers to a processor-based or processor-executable code that simulates a physical existence or a physical process.

Herein, the term “optical instrument” refers to a device comprising one or more lens elements.

Herein, an “image capturing device” is a device that can capture a still image and/or capture an image from a continuous sequence of images or frames. Non-limiting examples of image capturing devices are provided U.S. Pat. No. 11,223,826 B2, titled “Image Processing Device, Imaging Device, Image Processing Method, and Image Processing Program,” issued on Jan. 11, 2022; U.S. Pat. No. 9,369,631 B2, titled “Digital Photographing Apparatus Having First and Second Recording Modes and Method for Controlling the Same,” issued on Jun. 14, 2016; United States Publication Number US 2025/0024133 A1, titled “User Interface for Camera Effects,” published on Jan. 16, 2025; and U.S. Pat. No. 10,542,204 B2, titled “Methods and Apparatuses for Capturing Multiple Digital Image Frames,” issued on Jan. 21, 2020, each of which is herein incorporated by reference in its entirety.

For purpose of this disclosure regarding military and/or law enforcement activities, the term “munitions” refers to any type of weapon, ammunition and equipment used for military and/or law enforcement purposes and the term “ordnance” refers to weapons such as heavy artillery, cannons, and their ammunition as well as equipment used to fire the ammunition.

The term “firearm” may include, but is not limited to a pistol, a semiautomatic firearm, e.g., a semiautomatic rifle, a bolt action firearm, e.g., a bolt action rifle, a shotgun, a revolver, a shoulder fired bazooka, a shoulder fired rocket launcher, an air rifle, and a paintball gun. As understood by the skilled artisan, a particular firearm may be provided in different barrel lengths. Non-limiting examples of pistols are provided in U.S. Pat. No. 4,539,889, titled “Automatic Pistol with Counteracting Spring Control Mechanism,” issued on Sep. 10, 1985; and United States Patent Number U.S. D918,328 S, titled “Handgun,” issued on May 4, 2021, each of which is herein incorporated by reference in its entirety. Non-limiting examples of semiautomatic rifles are provided in U.S. Pat. No. 9,777,975 B2, titled “Semiautomatic Firearm,” issued on Oct. 3, 2017; and U.S. Pat. No. 7,775,150 B2, titled “Law Enforcement Carbine with One Piece Receiver,” issued on Aug. 17, 2010, each of which is herein incorporated by reference in its entirety. Non-limiting examples of a bolt action firearm are provided in U.S. Pat. No. 8,925,234 B1, titled “Bolt Action Rifle with Safety Latching Mechanism,” issued on Jan. 6, 2015; and U.S. Pat. No. 8,397,416 B2, titled “Multi-Caliber Bolt-Action Rifle and Components,” issued on Mar. 19, 2013; each of which is herein incorporated by reference in its entirety.

For purposes of distance determination, the term “range” refers to a distance between a point of observation and an object such as a distance between an image capturing device and an object captured in an image made by the image capturing device.

Herein, the term “OEM” refers to Original Equipment Manufacturer; the term “OEM product” means a product or component made by an OEM for use in final product of another; the term “USB” refers to Universal Serial Bus; the term “GPS” refers to Global Positioning System; the term “PCB” refers to printed circuit board; the term “RAM” refers to Random Access Memory; the term “SRAM” refers to Static RAM; the term “DRAM” refers to Dynamic RAM; the term “ROM” refers to Read-Only Memory; the term “EEPROM” refers to Electrically Erasable Programmable Read-Only Memory; the term “PROM” refers to Programmable Read-Only Memory; the term “MRAM” refers to Magnetoresistive RAM); the term “CCD” refers to Charge-Coupled Device; and the term “CMOS” refers to Complimentary Metal-Oxide Semiconductor.

The phrase “field of view” (“FOV”) refers to the visible or observable area through one or more optical elements, one or more optical mediums or one or more lenses (hereafter “lens”) of an image capturing device or system of this disclosure in a single frame. As understood by the skilled artisan the FOV may be determined by a focal length of a lens and the size of an image sensor of the image capturing device or system. Herein, a wider FOV means that more of a particular scene is captured and a narrower FOV means that a smaller area of the scene is captured.

Herein, “machine learning” may be defined as an algorithm that enhances the performance of a certain task through a steady experience with the certain task. Machine learning may include, but is not limited to evolutionary algorithms, deep learning, neural networks, Markov chains, and combinations thereof.

Herein, “GenAI” refers to Generative Artificial Intelligence.

In regard to an optical medium, the term “mark” is used herein to define one or more indicia disposed on the optical medium. Marks of this disclosure may comprise one or more indicia of one or more shapes or configurations including, but not necessarily limited to dots, straight lines, closed circles, open circles, closed rings, open rings, triangles, stars, chevrons, bullseyes, diamonds, X-shape marks, “T” shape marks, curved lines, crosses, letters, numbers, arc shapes, solid shapes and silhouette shapes including irregular shapes, and combinations thereof. Herein, the term “dot” need not necessarily be provided in a circular or substantially circular form.

The term “MOA” refers to Minutes of Angle, an angular measurement wherein one MOA equals 1/60 of a degree. As used herein, “MIL” or “MRAD” refers to milliradian, an angular measurement wherein one milliradian equals one-thousandth of a radian. A circle comprises 6.283 radians, or 6283 milliradians.

The term “PDF” refers to Portable Document Format. The term “JPEG” refers to Joint Photographic Experts Group. The term “TIFF” refers to Tagged Image File. Herein, “GIF” refers to Graphics Interchange Format. The term “PNG” refers to Portable Network Graphics. The term “PSD” refers to Photoshop Document. The term “EPS” refers to Encapsulated Postscript. The term “AID” refers to Adobe Illustrator Document. The term “INDD” refers to Adobe Indesign Document. The term “RAW” refers to Raw Image Formats. The term “BMP” refers to a bitmap image file, which is a digital image file format that uses pixels to represent an image.

The term “MP4” refers to MPEG-4 Part 13. The term “AVI” refers to Audio Video Interleave. The term “MOV” refers to QuickTime Multimedia file format. The term “WMV” refers to Windows Media Video. The term “MKV” refers to Matroska Video. The term “AVCHD” refers to Advanced Video Coding High Definition. The term “WebM” refers to Web Media File. The term “FLV” refers to Flash Video.

### Suitable Components for Use in the Disclosure

### Processing Units or Processors or Microprocessors

Suitable processing units, processors, or microprocessors for use in the present disclosure include, without limitation, digital processing units (DPUs), analog processing units (APUs), Field Programmable Gate Arrays (FPGAs), any other technology that may receive motion sensor output and generate command and/or control functions for objects under the control of the processing unit, and/or mixtures and combinations thereof.

Suitable digital processing units (DPUs) include, without limitation, any digital processing unit capable of accepting input from a plurality of devices and converting at least some of the input into output designed to select and/or control attributes of one or more of the devices. Exemplary examples of such DPUs include, without limitation, microprocessor, microcontrollers, or the like manufactured by Intel, Motorola, Ericsson, HP, Samsung, Hitachi, NRC, Applied Materials, AMD, Cyrix, Sun Microsystem, Philips, National Semiconductor, Qualcomm, or any other manufacture of microprocessors or microcontrollers, and/or mixtures or combinations thereof.

Suitable analog processing units (APUs) include, without limitation, any analog processing unit capable of accepting input from a plurality of devices and converting at least some of the input into output designed to control attributes of one or more of the devices. Such analog devices are available from manufacturers such as Analog Devices Inc.

### Smart Mobile Devices

Suitable smart mobile devices include, without limitation, smart phones, tablets, notebooks, desktops, watches, wearable smart devices, or any other type of mobile smart device. Non-limiting examples of smart phone, table, notebook, watches, wearable smart devices, or other similar device manufacturers include Apple, Dell, Google, HP, Huawei, Lenovo, Microsoft, OnePlus, Oppo, Samsung, Sony, Vivo, Motorola, Realme, and Xiaomi. It should be recognized that all of these mobile smart devices include at least one processing unit (often times more than one), memory, communication hardware and software, a rechargeable power supply, and at least one human cognizable output device, where the output device may to be audio, visual and/or audio visual.

### Non-Mobile, Computer and Server Devices

Suitable non-mobile, computer and server devices include, without limitation, desktop CPUs, sever mainframes, linked processing units of vehicles or integrated in the processing units of vehicles. Non-limiting examples of non-mobile, computer and server devices include Dell, HP, Lenovo, Apple, Intel, Microsoft, Supermicro, ASUS, Acer and IBM. It should be recognized that all of these mobile smart devices include at least one processing unit (often times more than one), memory, communication hardware and software, a rechargeable power supply, and at least one human cognizable output device, where the output device may to be audio, visual and/or audio visual. It should be recognized that these systems may be in communication with processing units of vehicles (land, air or sea, manned or unmanned) or integrated into the processing units of vehicles (land, air or sea, manned or unmanned).

### Input Devices

Suitable input devices for use in the present disclosure include, without limitation, (a) touch screen devices or other touch sensitive devices; (b) audio input devices such as microphones, etc.; (c) audio-visual input devices such as cameras, other optical input devices, etc.; (d) holographic input devices; (e) keyboard input devices; (f) cursor input devices; (g) motion sensors or motion sensing devices; (h) tactile or haptic input devices; (i) eye-tracking input devices; (j) head-tracking input devices; (k) other body part tracking devices; (l) body tracking devices; (m) any other input devices that generate output signals containing input data receivable and understandable by the processing units, or (n) any combination thereof.

### Motion Sensors

Suitable motion sensors or motion sensing devices for use in the present disclosure include, without limitation, optical sensors, acoustic sensors, thermal sensors, optoacoustic sensors, wave form sensors, pixel differentiators, or any other sensor or combination of sensors that are capable of sensing movement or changes in movement, or mixtures and combinations thereof. Suitable motion sensing apparatus include, without limitation, motion sensors of any form such as digital cameras, optical scanners, optical roller ball devices, capacitive pads, holographic devices, laser tracking devices, thermal devices, electromagnetic field (EMF) sensors, wave form sensors, any other device capable of sensing motion, changes in EMF, changes in a wave form, or the like or arrays of such devices or mixtures or combinations thereof. The sensors may be digital, analog, or a combination of digital and analog. For camera systems, the systems may sense motion within a zone, area, or volume in front of the lens or a plurality of lens. Optical sensors include any sensor using electromagnetic waves to detect movement or motion within in active zone. The optical sensors may operate in any region of the electromagnetic spectrum including, without limitation, radio frequency (RF), microwave, near infrared (IR), IR, far IR, visible, ultra violet (UV), or mixtures and combinations thereof. Exemplary optical sensors include, without limitation, camera systems, the systems may sense motion within a zone, an area or a volume in front of the lens. Acoustic sensor may operate over the entire sonic range which includes the human audio range, animal audio ranges, other ranges capable of being sensed by devices, or mixtures and combinations thereof. EMF sensors may be used and operate in any frequency range of the electromagnetic spectrum or any waveform or field sensing device that are capable of discerning motion with a given electromagnetic field (EMF), any other field, or combination thereof. Moreover, LCD screen(s), other screens and/or displays may be incorporated to identify which devices are chosen or the temperature setting, etc. Moreover, the interface may project a virtual control surface and sense motion within the projected image and invoke actions based on the sensed motion. The motion sensors may be used in conjunction with displays, keyboards, touch pads, touchless pads, sensors of any type, or other devices associated with a computer, a notebook computer or a drawing tablet or any mobile or stationary device, and/or device, head worn device, or stationary device.

### Output or User Feedback Devices

Suitable output devices of use in the present disclosure include, without limitation, (c) display devices such as cathode ray tube display devices, liquid crystal display devices, light emitting diode display devices, organic light emitting diode display devices, plasma display devices, touch screen display devices, other touch sensitive display devices, other optical input devices, or any combination thereof; (d) audio output devices such as speakers, ear bud devices, any other device that generates sound discernable by a user, animal, or robotic system, or any combination thereof; (e) audio-visual output devices; (f) holographic output devices; (g) optical output devices; (h) tactile or haptic output devices; (i) eye-tracking output devices; (j) head-tracking output devices; (k) any other devices that are configured to receive information from the processing units and producing output information discernible by a user, animal, or robotic system; or (l) any combination thereof.

### Predictive Methodology

Suitable predictive methodologies or predictive software system for use in the present disclosure include, without limitation, any predictive software algorithm, predictive software routine, artificial intelligence (AI) predictive software algorithm, AI predictive routine, any other software product capable of predicting user behavior based on user behavioral patterns, mannerism, quirks, etc., or any combination thereof.

### Predictive Analytics Models

### Classification Models

The classification model is probably the simplest of the various types of predictive analytics models. The classification model puts data in categories based on what the classification model learns from historical data.

### Clustering Models

Clustering models sort data into separate, nested smart groups based on similar attributes.

### Forecast Models

Forecast models are the most widely used predictive analytics models. Forecast models deals in metric value prediction, estimating numeric value for new data based on learnings from historical data.

Forecast models may be applied wherever historical numerical data is available.

Forecast models are designed to be able to consider multiple input parameters.

### Outlier Models

Outlier models are designed to recognize anomalous data entries within a dataset. Outlier Models are designed to be able to identify anomalous figures either by themselves or in conjunction with other numbers and categories.

Outlier models are particularly useful for predictive analytics in retail and finance industries.

### Time Series Models

Time series models are composed of a sequence of data points captured, using time as the input parameter. Time series models use historical data to develop numerical metrics for predicting future trends using that metrics. Time series models are potent methods for understanding the way a singular metric is developing over time with a level of accuracy beyond simple averages. Time series models also take into account seasons of the year or events that could impact the metric.

### Common Predictive Algorithms

Predictive algorithms use one of two things: machine learning or deep learning. Both are subsets of artificial intelligence (AI). Machine Learning involves structural data generally organized in tables. Machine Learning algorithms may be linear, nonlinear, or a combination of both. Linear algorithms are capable of being trained more quickly, while nonlinear are capable of being optimized for the problems being addressed. Deep Learning is a subset of machine learning and is designed to deal with unstructured data such as video, audio, text, social media posts and images, i.e., essentially the stuff that humans communicate with that are not numbers or metric reads.

Some common predictive algorithm include: random forest algorithms, generalized linear model (GLM) for two values, gradient boosted model (GBMs), K-Means, and prophet algorithms.

### Random Forest

Random Forest is derived from a combination of decision trees, none of which are related, and can use both classification and regression to classify vast amounts of data.

The name “Random Forest” is derived from the fact that the algorithm is a combination of decision trees. Each tree depends on the values of a random vector sampled independently with the same distribution for all trees in the “forest”. Each one is grown to the largest extent possible.

Predictive analytics algorithms try to achieve the lowest error possible by either using “boosting” (a technique which adjusts the weight of an observation based on the last classification) or “bagging” (which creates subsets of data from training samples, chosen randomly with replacement). Random Forest uses bagging. If you have a lot of sample data, instead of training with all of them, you can take a subset and train on that, and take another subset and train on that (overlap is allowed). All of this can be done in parallel. Multiple samples are taken from your data to create an average. While individual trees might be “weak learners,” the principle of Random Forest is that together they can comprise a single “strong learner.”

The popularity of the Random Forest models are explained by various advantages: (i) accurately and efficiently working with large databases; (ii) creating multiple trees to reduce the variance and bias of a smaller set or single tree; (iii) resistant to overfitting; (iv) capable of handling thousands of input variables without variable deletion; (v) capable of estimating what variables are important in classification; (vi) providing effective methods for estimating missing data; and (vii) maintaining accuracy when a large proportion of the data is missing.

### Generalized Linear Model (GLM) for Two Values

The GLMs are a more complex variant of a General Linear Model. GLMs take the latter model's comparison of the effects of multiple variables on continuous variables before drawing from an array of different distributions to find the “best fit” model. GLMs have the advantage that they may be trained very quickly. The response variable may have any form of exponential distribution type. GLMs are also able to deal with categorical predictors, while being relatively straightforward to interpret. On top of this, GLMs provide a clear understanding of how each of the predictors is influencing the outcome, and is fairly resistant to overfitting. However, GLMs require relatively large data sets and is susceptible to outliers.

### Gradient Boosted Models (GBMs)

The GBMs produce a prediction model composed of an ensemble of decision trees (each one of them a “weak learner,” as was the case with Random Forest), before generalizing. As its name suggests, it uses the “boosted” machine learning technique, as opposed to the bagging used by Random Forest. It is used for the classification model.

The distinguishing characteristic of GBMs is that it builds its trees one tree at a time. Each new tree helps to correct errors made by the previously trained tree-unlike in the Random Forest model, in which the trees bear no relation.

### K-Means

K-Means are highly popular, high-speed algorithms that involve placing unlabeled data points in separate groups based on similarities. K-Means are used for clustering models. K-Means try to figure out what the common characteristics are for individuals and groups them together. This grouping process is particularly helpful when you have a large data set and are looking to implement personalized targeting routines. For example, one particular group may share multiple characteristics on how they hold an image capturing system and share multiple characteristics on target acquisition and ranging. Thus, similarity groups may greatly reduce operating time, especially, in battlefield or combat situations.

### Prophet Algorithms

Prophet Algorithms are used in time series and forecast models. Prophet Algorithms are an open-source algorithm developed by Facebook, used internally by the company for forecasting. Prophet algorithms are of great use in capacity planning, such as allocating resources and goal setting. Prophet algorithms are automatic and flexible enough to incorporate heuristics and useful assumptions in target acquisition from images or image sequences.

### Exact Search Algorithms

Exact search algorithms are designed to find exact matches within a dataset, and include, without limitation, linear search algorithms used in many scenarios wherein a simple, straightforward search is required; binary search algorithms commonly used in ordered datasets for efficient searching in sorted arrays; hash-based search algorithms used in hash tables of databases and blockchains providing fast access to values based on hash keys; bloom filter search algorithms used for object identification and verification in in large object databases; bloom try or prefix tree search algorithms used in text processing applications, wherein the text is associated with objects in an object database; bloom Aho-Corasick search algorithms used in string matching, wherein the string is associated with objects in an object database; bloom suffix array search algorithms used in bioinformatics for identifying members of a group having similar target acquisition characteristics; bloom Boyer-Moore search algorithms used in text searching with efficiency in searching for patterns in large texts, wherein the text is associated with objects in an object database; bloom Karp-Rabin search algorithms used for pattern matching and string searching and are applied in plagiarism detection and finding similarities between text in different object databases, wherein the text is associated with objects in the different object databases; bloom Knuth-Morris-Pratt (KMP) search algorithms used in text searching and string and substring matching applications, wherein the text, strings, or substrings are associated with objects in an object database; bloom Sphinx search algorithms is a full-text search engine used in applications requiring fast and efficient search capabilities, wherein the text is associated with objects in the object databases; bloom B-tree and variant search algorithms used in database management systems to efficiently search, insert, and delete records of text associated with objects in the object databases; bloom AVL tree search algorithms are used for self-balancing binary search, making them suitable for applications requiring ordered data retrieval of text information associated with objects in the object databases; bloom splay tree search algorithms are employed in scenarios where frequently accessed elements should be moved to the root of the tree for faster access and include cache management in object database searching; radix tree search algorithms used in tables, string matching, and text storage of text information associated with objects in an object database; or any combination thereof.

### Distance-Based Algorithms

Distance-based algorithms are used to measure the similarity or dissimilarity between data points in a given space, such as Euclidean space. These algorithms play a crucial role in a wide range of applications across various domains, including data analysis, information retrieval, machine learning, geospatial analysis, and more.

The distance-based algorithms include, without limitation, Euclidean Distance is widely used in various fields, including image processing for measuring color similarity, computer vision for object recognition, and geographic information systems for calculating distances between coordinates; Manhattan Distance (L1 Norm) is used in route planning and transportation, like finding the shortest path on a grid-based city map. It's also employed in feature selection for machine learning; Minkowski Distance, which generalizes both Euclidean and Manhattan distances, is applied in pattern recognition, image analysis, and clustering tasks; Cosine Similarity is widely used in information retrieval and natural language processing, including text document similarity, recommendation systems, and search engine ranking; Jaccard Similarity is used for set-based data, such as document retrieval, plagiarism detection, and collaborative filtering in recommendation systems; Levenshtein Distance (Edit Distance) is applied in spell-checkers, string similarity for information retrieval, and data deduplication in databases; Mahalanobis Distance is used in multivariate statistics for clustering, classification, and outlier detection, such as in healthcare for disease detection; Haversine Distance is used in geographic information systems (GIS) for calculating distances between two points on the Earth's surface, such as for location-based services; Earth Mover's Distance (Wasserstein Distance) is used in image retrieval, computer vision, and transportation logistics to measure the distance between two probability distributions; any other distance-based algorithm, or any combination thereof.

### Approximate Search Algorithms

Approximate search algorithms are designed to find approximate matches or similarities in data, trading off some degree of accuracy for efficiency. These algorithms find application in a wide range of domains, including recommendation systems, content deduplication, image and video retrieval, data analytics, and more. They are particularly valuable when dealing with high-dimensional data or when fast retrieval is essential.

The approximate search algorithms include, without limitation, Locality-Sensitive Hashing (LSH) is applied in near-duplicate document detection, image retrieval, and recommendation systems to efficiently identify similar items; MinHash is used in estimating Jaccard similarity between sets, making it valuable in recommendation engines, content deduplication, and genomics for comparing gene expression profiles; SimHash is employed in near-duplicate detection for web pages and documents, as well as in detecting spam content; Random Projection is used for dimensionality reduction in high-dimensional data, such as text document clustering and image retrieval; Product Quantization is applied in large-scale image and video retrieval systems, content-based recommendation, and multimedia databases; Annoy (Approximate Nearest Neighbors Oh Yeah) is used for finding approximate nearest neighbors in recommendation systems, natural language processing, and image retrieval; Hierarchical Navigable Small-World (HNSW) Graphs are employed in approximate nearest neighbor search, enabling efficient search in high-dimensional spaces, often used in recommendation systems and data analytics; Randomized Algorithms for Nearest Neighbors are used in applications like image retrieval, recommendation systems, and anomaly detection for efficient similarity search; KD-Trees and Variants are used in multidimensional nearest neighbor search, such as in computer graphics, image processing, and data mining; Cover Trees are applied in nearest neighbor search, clustering, and data analysis, including bioinformatics for protein structure matching; Product Quantization for Nearest Neighbor Search is commonly used in content-based recommendation systems and image retrieval for approximate similarity search; Collision-Sensitive Hashing is applied in image and video retrieval, large-scale content-based recommendation, and multimedia databases; Semantic Hashing is used in text document retrieval, image search, and content recommendation systems for approximating document or image similarities; Bloom Filters are used for membership testing, often in applications like spell-checking, web caching, and network packet filtering; T-digest is used for approximate quantile and summary statistics estimation, particularly in data analytics, machine learning, and financial applications; Random Forests and Approximate Nearest Neighbors may be used to approximate nearest neighbor search in recommendation systems and content-based filtering; Fast Library for Approximate Nearest Neighbors (FLANN) is applied in image recognition, machine learning, and recommendation systems to find approximate nearest neighbors efficiently; or any combination thereof.

### Graph-Based Algorithms

Graph-based algorithms can be employed in similarity search when data can be represented as a graph or network. These algorithms are valuable for similarity search when dealing with data that can be represented as a graph or network structure. They can help identify nodes or entities that are similar based on their connections and characteristics within the graph.

The graph-based algorithms include, without limitation, Graph Matching Algorithms is used in chemical compound similarity search, where the goal is to find molecules with similar structures; Graph Neural Networks (GNNs) are applied in social network analysis for finding users with similar behavior or interests; Random Walk and Personalized PageRank algorithms are used in recommendation systems to find items similar to a user's past interactions; Community Detection Algorithms (e.g., Louvain Modularity, Girvan-Newman) algorithms are used in social network analysis to identify groups of users with similar interests or relationships; Link Prediction Algorithms are used in recommendation systems and network analysis to suggest connections or friendships between users; Graph Edit Distance Algorithms are used in bioinformatics for comparing molecular structures and in image recognition for content-based image retrieval; Graph Clustering Algorithms is used in social network analysis and image segmentation to find groups of nodes with similar properties; Spectral Graph Theory Algorithms are applied in recommendation systems and image recognition for measuring the similarity between nodes in a graph; Heterogeneous Graph Mining Algorithms are used in e-commerce recommendation systems to find products similar to what a user has viewed; Graph-Based Document Similarity Algorithms may be used in text document retrieval and content recommendation; Word Embedding and Graph Embedding are used in natural language processing for finding semantically similar words or documents; Graph Convolutional Networks (GCNs) are applied in recommendation systems and content recommendation to find similar items or users in a graph; Hierarchical Navigable Small-World (HNSW) Graphs are used for approximate nearest neighbor search and recommendation systems; Bipartite Graph Matching Algorithms are used in recommendation systems for matching users to products or job matching; Max Flow and Min Cut Algorithms (e.g., Ford-Fulkerson, Edmonds-Karp) are applied in network flow optimization, such as in transportation networks and network design; or any combination thereof.

### Text Search Algorithms

Text search algorithms are designed to find and retrieve specific pieces of text or documents from a collection based on user-defined queries. These algorithms play a vital role in information retrieval, natural language processing, and document management across a wide range of applications, including search engines, recommendation systems, content management, and more.

The text search algorithms include, without limitation, Keyword-Based Search is widely used in web search engines, document management systems, and databases for retrieving documents that contain specific keywords or phrases; Inverted Index algorithms are used in search engines, web crawling, and content retrieval systems for efficient document lookup based on terms; Term Frequency-Inverse Document Frequency (TF-IDF) algorithms are employed in information retrieval systems, document ranking, and text classification to measure the relevance of documents to a query; Boolean Retrieval algorithms are used in database systems, advanced search engines, and document retrieval for precise querying using logical operators (AND, OR, NOT); Proximity Search algorithms are applied in legal document search, molecular biology, and linguistics to find documents where keywords are located close to each other; Vector Space Model (VSM) algorithms are used in information retrieval systems, document clustering, and recommendation systems for ranking documents based on their similarity to a query; BM25 (Best Matching 25) algorithms are used in search engines, document retrieval, and content recommendation to rank documents by relevance to a query; Okapi BM25 algorithms are applied in information retrieval systems for improved document ranking and relevance ranking; BM25F (BM25 with Fields) algorithms are used in search engines and document retrieval systems where documents have multiple fields, and each field contributes differently to relevance; Latent Semantic Analysis (LSA) and Latent Dirichlet Allocation (LDA) algorithms are used in topic modeling, content recommendation, and document clustering; Hamming Distance algorithms are used in error detection and correction codes, network security for comparing binary strings, and genomics for comparing DNA sequences; Levenshtein Distance (Edit Distance) algorithms are used in spell-checkers, data deduplication, and DNA sequence alignment; Damerau-Levenshtein Distance algorithms are string similarity metrics that measures the minimum number of edit operations (insertions, deletions, substitutions, and transpositions of adjacent characters) required to transform one string into another and are used in applications like spell-checking, data cleansing, and record linkage to quantify the similarity between two strings, allowing for the detection and correction of typographical errors and textual discrepancies in datasets and documents; Jaro Similarity algorithms measure the similarity between two strings based on the number of common characters and the number of transpositions required to match the strings and are commonly used in record linkage, data deduplication, and fuzzy string matching applications to identify and group similar strings, such as names or addresses, in databases and datasets; Jaro-Winkler Similarity algorithms are an extension of the Jaro Similarity algorithms, which measures the similarity between two strings, taking into account the common characters and their positions and are used in record linkage and data cleansing to improve the accuracy of string matching, particularly for names and addresses, by giving more weight to the common prefix of the strings and penalizing longer string differences; Smith-Waterman Similarity algorithms are local sequence alignment algorithms used to find the optimal local alignment between two sequences, typically biological sequences like DNA, RNA, or proteins and are widely used in bioinformatics for tasks such as identifying similar regions within sequences, detecting sequence similarities between genes or proteins, and searching for patterns or motifs within biological data; Jaccard Similarity algorithms are is used in plagiarism detection, recommendation systems, and content similarity analysis; Sorensen-Dice Similarity algorithms are used to measure the similarity between two sets or lists of items based on the size of their intersection relative to their total size and are commonly used in various fields, including information retrieval, document similarity analysis, and natural language processing, to compare the similarity between two sets, such as words in documents, tags in content, or features in data; Tversky Similarity algorithms extend Jaccard and Dice coefficients by introducing parameters to control the sensitivity to common elements and differences between sets and are used in various fields, including information retrieval, recommendation systems, and network analysis, to compare and measure the similarity between sets, such as user preferences, tags, or item associations, with tunable parameters that allow fine-grained control over the matching criteria; Overlap Similarity algorithms measure the similarity between two sets by calculating the size of their intersection relative to the size of the smaller set, commonly used in information retrieval and text analysis to find common terms between documents or elements in datasets; Cosine Similarity algorithms are widely used in search engines, document clustering, and recommendation systems to measure document similarity; N-gram Matching algorithms are applied in DNA sequence analysis, text plagiarism detection, and spelling correction; Ratcliff-Obershelp Similarity algorithms are string similarity metrics that measures the similarity between two strings by identifying common substrings, often used in record linkage and data cleansing to match and group similar strings based on their shared substrings; Longest Common Substring/Subsequent Similarity algorithms measure the similarity between two strings by finding the longest contiguous substring or subsequence shared between them, frequently used in text comparison and plagiarism detection to identify common text segments and similarities between documents; Semantic Search algorithms, including Word Embeddings and Sentence-BERT, are used in question-answering systems, content recommendation, and natural language understanding tasks; K-Means Text Clustering algorithms are applied in content recommendation, topic modeling, and document categorization; Soundex and Metaphone: Soundex and Metaphone algorithms are employed in name matching, phonetic search, and fuzzy name matching in genealogy databases; Rabin-Karp Algorithms are used in search engines and string matching applications for finding substrings in texts; or any combination thereof.

### Spatial Indexing Algorithms

Spatial indexing algorithms are used to efficiently organize and search for spatial data, such as geographic coordinates, 2D or 3D points, and other spatial objects. These algorithms are important for performing efficient similarity search in various domains, including geospatial analysis, computer graphics, recommendation systems, and multidimensional data analysis.

The spatial indexing algorithms include, without limitation, Quadtree algorithms are used in geographic information systems (GIS) for efficient spatial data storage, map rendering, and collision detection in computer graphics; Octree algorithms are used in 3D computer graphics for voxel-based modeling, ray tracing, and terrain representation in GIS; R-tree algorithms are widely used in GIS for indexing geographic data, spatial databases for location-based services, and image retrieval based on spatial similarity; R*-tree algorithms are used in spatial databases for efficient indexing of geographic data and querying nearest neighbors; kd-Tree algorithms are used in ray tracing for computer graphics, nearest neighbor search in machine learning, and multidimensional indexing in databases; Grid Indexing algorithms are applied in geographic databases for point-in-polygon queries, as well as in climate modeling and spatial analytics; Geohash: Geohash is used in location-based services, geospatial data storage, and real-time spatial data indexing for applications like ride-sharing and geofencing; Hilbert Curve Indexing algorithms are applied in geographic information systems for map compression and efficient spatial query processing; MVR-tree (Minimum Volume R-tree) algorithms are used in spatial databases and GIS for efficient storage and retrieval of spatial data, such as regions and polygons; BVH (Bounding Volume Hierarchy) algorithms are used in computer graphics for ray tracing, collision detection, and rendering of complex 3D scenes; X-tree algorithms are used in spatial databases and geographic information systems for efficient query processing of spatial data; Z-order Curve Indexing algorithms are applied in geographic databases, image retrieval, and map rendering for efficient storage and query processing; ST-tree (Space-Time Tree) algorithms are used in spatiotemporal databases for indexing and querying data with both spatial and temporal attributes, such as tracking moving objects; Voronoi Diagram algorithms are used in GIS, computational geometry, and facility location analysis to determine proximity relationships and optimal locations; Geospatial Voronoi Diagram algorithms are used in location-based services, territorial analysis, and facility planning; M-tree algorithms are used in similarity search for multimedia data, such as image retrieval and content-based recommendation systems; BSP (Binary Space Partitioning) algorithms are used in computer graphics for efficient rendering and spatial partitioning of 3D scenes; any other spatial indexing algorithm, or any combination thereof.

### Machine Learning-Based Algorithms

Machine learning-based algorithms can be used for similarity search in various applications where finding similar items or data points is important. These algorithms are valuable in various domains, including recommendation systems, content similarity analysis, image retrieval, and content matching.

The machine learning-based algorithms include, without limitation, Siamese Network algorithms are used for face recognition in security systems and image similarity search in e-commerce Machine learning-based algorithms; Triplet Network algorithms are applied in image retrieval systems, where a query image is used to find similar images in a database; Contrastive Learning algorithms are used for content-based recommendation systems to find items similar to what a user has interacted with; Siamese Recurrent Neural Network (RNN) algorithms are used in speech recognition for identifying similar spoken phrases or voice patterns; Sequence-to-Sequence Model (Seq2Seq) algorithms are used in machine translation to find translations similar to a source sentence; Collaborative Filtering algorithms are used in recommendation systems to find items that similar users have liked or interacted with; Matrix Factorization algorithms are applied in recommendation systems for finding similar users or items by decomposing user-item interaction matrices; Autoencoders algorithms are applied in content-based recommendation systems to find items similar to those a user has interacted with, as well as for data compression; Word Embedding (Word2Vec, GloVe) algorithms are used in natural language processing for finding semantically similar words or phrases, as well as in document similarity analysis; Word Movers' Distance (WMD) algorithms are in natural language processing for text document similarity and recommendation systems; Sentence-BERT algorithms are used for sentence and document similarity in natural language processing and content recommendation; Product Quantization for Nearest Neighbor Search algorithms are applied in image retrieval systems to find similar images based on visual features; or any combination thereof.

### Generative Artificial Intelligence

Generative Artificial Intelligence (GenAI) refers to a computer-implemented system or process configured to generate new content, data, or outputs based on learned patterns, structures, or relationships derived from one or more input datasets. In certain embodiments, the system may utilize machine learning models, including but not limited to neural networks, deep learning architectures, transformers, variational autoencoders, generative adversarial networks, or hybrid computational frameworks, to analyze input data and produce novel outputs that exhibit characteristics similar to, or consistent with, the training data.

The input data may include, for example, digital images or video sequences captured by image capturing systems. The generated output may include, by way of example and not limitation, synthetic images, enhanced or reconstructed frames, interpolated video sequences, or modified visual representations derived from the captured data. During operation, the system may learn statistical, structural, or semantic patterns within image or video data and use such learned representations to produce outputs that are contextually relevant, visually coherent, or adapted for downstream processing within an image capturing system.

### Image Segmentation

Image segmentation generally refers to a computer-implemented process in which an input image is partitioned into multiple regions or segments, each of which corresponds to a particular object, a portion of an object, or background content. In certain embodiments, segmentation may be performed by assigning a label to individual pixels within the image, thereby generating a pixel-level classification output. Such processing may be carried out using machine learning models, which may include neural networks, deep learning architectures, or other computational techniques configured to analyze visual features such as edges, textures, shapes, and patterns. During operation, the model processes the input image to produce a segmented representation in which each pixel is associated with a category or identifier. In some implementations, the output may include class-level segmentation, wherein pixels are labeled according to a set of categories, e.g., “vehicle,” “road,” or “sky,” or instance-level segmentation, wherein unique identifiers are assigned to distinct objects belonging to the same class.

In certain embodiments, an segmentation model may be trained on labeled datasets, with parameters optimized to accurately delineate image regions under a variety of conditions, including changes in lighting, partial occlusions, and complex object boundaries. The segmentation process thereby provides a more detailed analysis of image content as compared to other computer vision tasks such as classification or detection, which may focus on assigning a single label to an image or identifying object locations with bounding boxes.

In certain embodiments, an image segmentation process may be configured to operate in different modes depending on the desired output. In an embodiment, a system may perform “semantic segmentation,” wherein each pixel of the image is assigned a class label corresponding to a predefined category, such that all pixels belonging to a particular object class, e.g., “vehicle” or “road,” are labeled consistently. In an embodiment, a system may perform “instance segmentation,” wherein pixels are not only assigned a class label but are further distinguished according to individual object instances, thereby allowing separate labeling of multiple objects of the same class within a single image. In an embodiment, a system may perform “panoptic segmentation,” wherein each pixel is assigned both a semantic class label and, where applicable, an instance identifier, thereby providing a unified representation that incorporates both “stuff” regions (e.g., background such as sky or road) and “thing” regions (e.g., discrete objects such as vehicles or buildings).

In some implementations, a segmentation process may include receiving an input image, processing the image using one or more machine learning models or neural network architectures configured to extract features such as edges, textures, and shapes, and generating a segmented output in which each pixel is associated with a class or instance label. The output may be presented as a structured data representation or as a visual mask in which regions of the image are distinguished according to their assigned labels.

### Image Classification

Image classification generally refers to a computer-implemented process in which an input image is analyzed and assigned to one or more predefined categories based on the visual content represented in the image. In certain embodiments, the process employs machine learning techniques, which may include neural networks, deep learning architectures, or other statistical models, to extract relevant features from the image. Such features may include, but are not limited to, shapes, textures, edges, patterns, or higher-level abstractions derived through learned model parameters. During operation, the model processes the image through a sequence of computational layers to produce a classification output, which may include a probability distribution or confidence score across a plurality of categories. Based on this evaluation, the system designates one or more categories as the classification result. For example, an input image may be classified into categories such as “vehicle,” “animal,” or “building,” although such examples are provided for illustration only and are not limiting.

In certain embodiments, the model is trained on datasets of labeled images, where parameters of the model are optimized to reduce misclassification. The classification process described herein is generally distinct from related computer vision tasks such as object detection or image segmentation, which focus on localizing or labeling multiple objects within an image. Instead, image classification typically involves assigning a label to the image as a whole. Such classification enables automated recognition and categorization of visual data, and may be applied in a variety of contexts.

In certain embodiments, an image classification system may comprise a plurality of functional modules. An image acquisition module may be configured to receive or capture digital image data from one or more sources, e.g., image capturing devices, sensors, or stored datasets. A preprocessing module may be configured to perform operations including, but not limited to, normalization, resizing, denoising, and optional augmentation of the image data in order to conform the input to the requirements of a classification model. A feature extraction module may be implemented using a neural network architecture, such as a convolutional neural network, a transformer-based model, or another machine learning framework, and may be configured to identify and encode salient visual features from the image data. A classification module may then be configured to map the extracted features to one or more output categories using a trained model. The output of the classification module may include, by way of example and not limitation, a discrete label (e.g., “vehicle,” “animal,” or “building”), or a probabilistic vector indicating the likelihood of each of a plurality of classes.

### Named Entity Recognition (NER)

Named Entity Recognition (NER) refers to a computer-implemented process for identifying and categorizing entities within input data, which may include textual, visual, auditory, or other non-textual forms of information, into one or more predefined categories. In certain embodiments, the process includes receiving input data from one or more sources, such as text documents, digital images, video streams, audio recordings, sensors, or structured datasets, and performing preprocessing operations, which may include normalization, tokenization, denoising, resizing, or format conversion, to prepare the data for analysis.

Feature extraction may then be performed using machine learning models, which may include neural networks, deep learning architectures, transformers, or hybrid computational frameworks, configured to capture modality-specific characteristics. For textual data, features may include syntactic, semantic, or contextual information derived from words, phrases, or sentences. For non-textual data, features may include visual patterns in images, acoustic characteristics in audio signals, temporal patterns in video sequences, or structured metadata in datasets.

During operation, the system evaluates the extracted features to detect entities and assigns each identified entity to one or more categories. The output may include a discrete label for each recognized entity, a probabilistic distribution across multiple categories, or another representation indicating the location, identity, or classification of entities within the input data. The system may be trained on annotated datasets corresponding to the modality of the input data, with model parameters optimized to achieve accurate recognition despite variations in context, noise, or format.

In certain embodiments, textual NER may be applied to identify entities such as persons, organizations, locations, dates, or events within written or spoken language. Non-textual NER may be applied to recognize visual objects, faces, spoken names, or other elements within images, video, audio, or structured data. The disclosed techniques enable automated identification and classification of entities across diverse data types, facilitating applications such as automated content tagging, information extraction from documents, face or object recognition in visual media, speech-to-entity extraction in audio streams, event detection in video, and metadata organization in multimedia or structured databases.

### Agent-Based Systems

Agent-Based Systems refer to computer-implemented frameworks comprising one or more autonomous or semi-autonomous agents configured to perform tasks, make decisions, or interact within an environment according to predefined rules, learned behaviors, or adaptive strategies. In certain embodiments, each agent may be configured to perceive its environment through input data obtained from one or more sources, such as sensors, databases, user interfaces, image capturing devices, and to process this information to determine appropriate actions or responses. Agents may analyze image or video data to detect objects, track movements, recognize patterns, or assess environmental conditions as part of their decision-making process.

Agents within the system may operate independently or collaboratively and may communicate with one another using protocols, messages, or shared data structures to achieve individual or collective objectives. In certain embodiments, the behavior of an agent may be guided by rule-based logic, decision trees, probabilistic models, reinforcement learning, neural networks, or other machine learning techniques, enabling the agent to adapt to dynamic or uncertain environments. The system may include mechanisms for monitoring agent performance, updating strategies based on feedback, and coordinating interactions to optimize overall system objectives.

### Reinforcement Learning

Reinforcement learning refers to a computer-implemented process in which a decision-making component or “agent” is configured to interact with an environment in order to learn strategies that maximize a cumulative reward signal. The agent may comprise, for example, a software module, a hardware-implemented controller, or a hybrid system that is operable to perceive the current state of the environment, select an action according to a learned or adaptive policy, receive feedback in the form of rewards or penalties, and update its policy to improve future decision-making.

The reinforcement learning process may be implemented using machine learning techniques, which may include, but are not limited to, neural networks, probabilistic models, deep reinforcement learning architectures, or other computational frameworks configured to approximate policies, value functions, or both. In certain embodiments, reinforcement learning may be modeled using frameworks such as Markov decision processes, and training may occur through iterative interactions between the agent and the environment. The agent may be further configured to balance exploration of new actions with exploitation of previously learned strategies in order to optimize performance under uncertain or dynamic conditions.

Unlike supervised learning, which relies on labeled training data, or unsupervised learning, which focuses on identifying structure within unlabeled data, reinforcement learning emphasizes the discovery of optimal behaviors through trial-and-error interaction.

### Computer Vision

Computer vision refers to a computer-implemented process in which a computational system is configured to analyze and interpret visual data, such as digital images or video streams, in order to extract meaningful information and perform tasks analogous to human visual perception. In certain embodiments, computer vision may be implemented using machine learning models, which may include but are not limited to convolutional neural networks (CNNs), vision transformers, encoder-decoder architectures, or other deep learning frameworks operable to process visual inputs and identify salient features such as edges, textures, shapes, motion patterns, or objects.

During operation, a computer vision system may be configured to receive one or more visual inputs and generate corresponding outputs, which may include, for example, assigning a class label to an image, detecting and localizing one or more objects within an image or video frame, segmenting regions at the pixel level, or recognizing visual patterns and relationships. Outputs may be expressed in the form of categorical labels, bounding boxes, keypoints, or segmentation masks, depending on the application. The system may be trained on datasets comprising annotated visual data and may be configured to optimize internal parameters to account for variations in lighting conditions, perspective, scale, occlusion, or noise present in the captured input.

### Discriminative Models

Discriminative models refer to computational models configured to learn a direct mapping between input data and corresponding output labels or categories by estimating decision boundaries that separate classes within a dataset. In certain embodiments, a discriminative model may be trained to approximate the conditional probability distribution P(y|x), where x represents the observed input data and y represents the associated class label. Unlike generative models, which are configured to model the joint distribution of inputs and outputs, e.g., P(x, y), and may be used to synthesize new data samples, discriminative models are designed primarily to classify or predict outcomes based on observed inputs.

Discriminative models may be implemented using various machine learning techniques, including but not limited to logistic regression, support vector machines, decision trees, random forests, convolutional neural networks (CNNs), transformer-based architectures, or other supervised learning frameworks. During operation, the discriminative model may receive an input, e.g., an image, an audio sample, or a text sequence, extract relevant features, and output a class prediction, probability distribution, or decision score corresponding to one or more predefined categories.

### Generative Models

Generative models refer to computational models configured to learn the underlying distribution of data in order to generate, simulate, or reconstruct new data instances that are statistically consistent with the observed training data. In certain embodiments, a generative model may be trained to approximate the joint probability distribution P(x, y), where x represents input features and y represents associated labels or latent variables, or in some cases the marginal distribution P(x) of the data itself. Unlike discriminative models, which focus on learning a decision boundary or conditional probability P(y|x) for classification or prediction tasks, generative models are directed toward capturing the structure and variability of the input space, thereby enabling both data synthesis and downstream inference.

Generative models may be implemented using a variety of machine learning approaches, including but not limited to probabilistic graphical models, variational autoencoders (VAEs), generative adversarial networks (GANs), diffusion models, autoregressive models, or transformer-based architectures. During operation, a generative model may be configured to receive a latent representation, random input, or conditioning signal, and produce an output in the form of synthesized data such as images, video, audio, text, or structured information.

Applications of generative models include, without limitation, image and video synthesis, data augmentation for training discriminative systems, natural language generation, simulation of physical or virtual environments, anomaly detection by comparison against expected distributions, and multimodal content generation. By modeling the data distribution itself, generative models enable computational systems to not only recognize and classify observed data but also create new, realistic data representations, thereby supporting advanced capabilities in artificial intelligence across diverse modalities.

### Deep Learning

Deep learning refers to a subset of machine learning techniques in which computational models employ multiple processing layers, often implemented as artificial neural networks, to learn hierarchical representations of data. In certain embodiments, a deep learning model may be configured to automatically extract increasingly abstract features from raw input data, e.g., pixels, audio waveforms, or text tokens, by propagating information through successive layers of nonlinear transformations. Unlike shallow learning methods, which rely on manually engineered features or limited depth, deep learning architectures enable end-to-end learning of complex patterns directly from large-scale datasets.

Deep learning models may be implemented using a variety of architectures, including but not limited to convolutional neural networks (CNNs), recurrent neural networks (RNNs), long short-term memory networks (LSTMs), transformers, autoencoders, generative adversarial networks (GANs), or hybrid architectures combining multiple network types. During operation, such models may be configured to process input data through stacked hidden layers, apply learned weights and activation functions, and generate outputs corresponding to predictions, classifications, feature embeddings, or synthesized data.

Applications of deep learning include, without limitation, (a) image and video analysis, e.g., classification, detection, segmentation, (b) natural language processing, e.g., machine translation, sentiment analysis, text generation, (c) speech recognition, medical diagnosis, robotics, and recommendation systems. By leveraging multiple levels of feature abstraction, deep learning models enable computational systems to recognize, interpret, and generate complex patterns across diverse data modalities, supporting advanced artificial intelligence capabilities in dynamic and high-dimensional environments.

### Natural Language Processing

Natural language processing (NLP), as described herein, refers to a domain of artificial intelligence directed toward enabling computational systems to analyze, interpret, generate, and otherwise process human language in textual or spoken form. In certain embodiments, NLP techniques may be configured to transform unstructured linguistic data into structured representations that can be utilized for tasks such as classification, translation, retrieval, or generation. Unlike traditional rule-based approaches, which rely on handcrafted grammars and lexicons, modern NLP systems frequently employ machine learning and deep learning models to capture semantic, syntactic, and contextual relationships directly from large-scale corpora of text or speech.

NLP models may be implemented using a variety of computational approaches, including but not limited to recurrent neural networks (RNNs), long short-term memory (LSTM) networks, convolutional neural networks (CNNs), attention-based models, and transformer architectures. During operation, such models may be configured to perform functions such as tokenization, part-of-speech tagging, named entity recognition, sentiment analysis, machine translation, text summarization, or dialogue generation. NLP systems may further be adapted to process multimodal inputs in which language data is combined with visual, auditory, or structured sources.

In certain embodiments, natural language processing may also be applied to textual content captured through image or video acquisition systems. For example, a camera or sensor may capture a scene containing written, printed, or digital text, which is then converted into machine-readable form using optical character recognition (OCR) or related techniques. The extracted text may subsequently be processed by an NLP system to perform functions such as translation, named entity recognition, contextual categorization, or semantic analysis. This integration of visual capture with NLP enables applications including, but not limited to, real-time translation of signage, automated processing of scanned documents, extraction of metadata from video streams, and other scenarios in which textual content is acquired through visual media.

### Computer Vision Algorithms

Computer vision algorithms refer to computational processes or procedures implemented to analyze, interpret, and extract meaningful information from visual data, such as images or video streams. In certain embodiments, computer vision algorithms may be configured to detect patterns, identify objects, recognize spatial relationships, segment regions, track motion, or perform other tasks that emulate aspects of human visual perception. The algorithms may operate individually or in combination and may employ a variety of computational techniques, including but not limited to traditional image processing methods, feature-based analysis, statistical models, machine learning, deep learning, and hybrid frameworks.

In certain embodiments, computer vision algorithms may include, for example, convolutional neural networks (CNNs), vision transformers, encoder-decoder architectures, region-based models, or optical flow and tracking methods. During operation, such algorithms may process input visual data to generate outputs such as object classifications, bounding boxes, keypoints, pixel-level segmentation masks, or visual descriptors. The algorithms may be trained, tuned, or optimized using annotated datasets, synthetic data, or self-supervised learning techniques to accurately interpret visual information under varying conditions of lighting, occlusion, perspective, motion, or noise.

In some embodiments, computer vision algorithms may be applied in conjunction with natural language processing (NLP) to interpret textual content embedded in images or video streams. For example, a vision algorithm may first detect regions containing printed or digital text, after which optical character recognition (OCR) may convert the visual text into machine-readable form. NLP algorithms may then process the extracted text for translation, named entity recognition, semantic analysis, or other language-related tasks. This integration enables multimodal applications in which visual and textual information are jointly analyzed to support real-time translation, document processing, augmented reality overlays, automated labeling, and other advanced functions.

### Multi-Modal Learning

Multi-modal learning refers to a computer-implemented process in which a computational system is configured to simultaneously process and integrate information from two or more distinct data modalities, such as visual, textual, auditory, or structured sensor data, to perform tasks that leverage correlations, relationships, or complementarities across modalities. In certain embodiments, multi-modal learning may be implemented using machine learning techniques, including but not limited to neural networks, deep learning architectures, transformers, attention-based models, encoder-decoder frameworks, or hybrid computational structures, that are operable to learn joint representations of heterogeneous data sources.

During operation, a multi-modal learning system may receive inputs from multiple sources, such as images or video, audio recordings, text, or structured data streams, and extract features specific to each modality. The system may then integrate the extracted features to perform tasks such as classification, object recognition, scene understanding, sentiment analysis, question answering, or content generation. The system may be trained on multi-modal datasets to optimize its parameters for coherent integration and reasoning across modalities, thereby improving performance compared to processing each modality independently.

In certain embodiments, multi-modal learning may involve combinations of computer vision and natural language processing, such as interpreting textual content captured in images or video using optical character recognition (OCR) followed by NLP analysis. Other embodiments may include audio-visual processing, sensor-data fusion, or integration of structured data with unstructured media. This multi-modal approach enables applications including, without limitation, autonomous navigation with visual and sensor-based context, video captioning, audio-visual content understanding, augmented or virtual reality systems, and interactive AI agents capable of interpreting complex environments.

By enabling computational systems to jointly analyze and reason over multiple types of data, multi-modal learning provides a framework for enhanced perception, decision-making, and content generation across diverse application domains, supporting intelligent and contextually aware behavior in complex, real-world environments.

### DETAILED DESCRIPTION OF THE DISCLOSURE

For the purposes of promoting an understanding of the principles of the present disclosure, reference is now made to the embodiments illustrated in the drawings and particular language will be used to describe the same. It is understood that no limitation of the scope of the claimed subject matter is intended by way of the present disclosure and the present disclosure is not limited to particular embodiments. As understood by one skilled in the art to which the present disclosure relates, various changes and modifications of the principles as described and illustrated are herein contemplated. It is also to be understood that the terminology used herein is for the purpose of describing particular embodiments only and is not intended to be limiting.

Any of the apparatuses and systems and interfaces and methods implementing them described herein may be used to determine information concerning distant objects of interest. Herein, objects of interest may include physical objects including (1) animate objects, e.g., persons, animals, plant life, and (2) inanimate objects, e.g., earth formations, articles of manufacture, bodies of water. Non-limiting examples of earth formations may include mountains, canyons, plateaus, plains, valleys, caves, beaches, rock formations such as sedimentary, metamorphic and volcanic landforms, and bodies of water including oceans, seas, lakes, rivers, ponds, streams, reservoirs, lagoons, canals, and glaciers. Non-limiting examples of articles of manufacture may include building structures, machines, clothing, weapons, land vehicles, air vehicles, sea vehicles, fluid containers, solids containers, antennas, and any other tangible article that is given a new form, quality, property, or combination through man-made or artificial means. Herein, objects of interest may also include two-dimensional indicia including, but not limited to letters, numbers, symbols, markings, color schemes, patterns, banners, and any other two-dimensional shapes and/or objects having a depth whereby such objects appear to be two-dimensional in shape.

In an embodiment, determining information concerning distant objects using artificial intelligence (AI) is provided, executed by one or more computer or computing devices.

In an embodiment, the apparatuses and systems and interfaces and methods implementing them described herein may be configured to use artificial intelligence and/or machine learning to determine a distance between a point of observation (observation point) and a distant object.

In an embodiment, the apparatuses and systems and interfaces and methods implementing them described herein may include using one or more image capturing devices communicatively coupled to one or more networks and/or cloud resources and use artificial intelligence and/or machine learning to determine a distance between the one or more image capturing devices and a distant object.

In an embodiment, the present disclosure is related to artificial intelligence driven apparatuses and systems and interfaces and methods implementing them for identifying distant objects identified in images.

In an embodiment, the present disclosure is related to an artificial intelligence based method of determining information concerning distant objects that are captured in images.

In an embodiment, the present disclosure is related to the implementation of a method for of determining information concerning distant objects using artificial intelligence processing software or executable instructions.

In an embodiment, the present disclosure is related to an artificial intelligence based method of determining information concerning distant objects.

In an embodiment, the present disclosure is related to artificial intelligence teaching and learning for identifying distant objects identified in images.

In an embodiment, the disclosure is related to an electronic device including a lens comprising one or more marks.

In an embodiment, the disclosure is related to an electronic device configured for use with one or more firearms.

In an embodiment, the present disclosure is related to apparatuses and systems and interfaces and methods implementing them using image capture and at least one artificial intelligence system configured to process image content to determine information concerning distant objects captured in an image including, but not limited to a distance from a point of image capture to the distant object.

In an embodiment, the disclosure is related to apparatuses and systems and interfaces and methods implementing them including an electronic device one or more image capturing devices communicatively coupled to a network and/or cloud resource including at least one artificial intelligence engine configured to determine a dimension of a distant object located apart from the electronic device. An artificial intelligence engine may include any number of underlying domains or fields such as machine learning (ML), computer vision (CV), robotics, natural language processing (NLP), reinforcement learning, and expert systems.

In an embodiment, the disclosure is related to apparatuses, systems, interfaces, and methods implementing them, including one or more object detection and/or object recognition techniques or combinations thereof. For example, the object detection and/or recognition may be performed on captured images to detect and recognize one or more objects using any suitable technique or combination of techniques.

In an embodiment, the apparatuses and systems and interfaces and methods implementing them described herein may be configured to use artificial intelligence and/or machine learning to determine a distance between at least one image capturing device and an object located a distance apart from the at least one image capturing device and captured in an image made by the at least one image capturing device. In an embodiment, captured images of this disclosure may be saved in file formats including image file formats and video file formats. Non-limiting examples of image file formats may include PDF, JPEG, TIFF, GIF, PNG, PSD, EPS, AID, INDD, RAW, and BMP. Non-limiting examples of video file formats may include MP4, AVI, MOV, WMV, MKV, AVCHD, WebM, and FLV. Captured images of this disclosure are not limited in frame size, resolution, aspect ratio, bitrate, file size, and frame rate.

In an embodiment, the disclosure is related to apparatuses and systems and interfaces and methods implementing them including an electronic device configured to determine a distance between the electronic device and a distant object. As such, in an embodiment the disclosure may be related to an electronic device configured as a rangefinder. In an embodiment, the electronic device may be communicatively coupled to a network/cloud including at least one artificial intelligence engine.

In an embodiment, the disclosure is related to an electronic device configured, at least in part, as an image capturing device and a distance detecting device for one or more identified objects in a captured image.

In an embodiment, the disclosure is related to an electronic device configured, at least in part, as an image capturing device and as an object identifying device configured to identify one or more objects in a captured image.

In an embodiment, the disclosure is related to an electronic device configured, at least in part, as an image capturing device, as an object identifying device and as a distance detecting device for one or more identified objects in the captured image.

In an embodiment, the disclosure is related to an electronic device configured, at least in part, as an image capturing device, as an object identifying device, as a distance detecting device for one or more identified objects in the captured image and as a size determination device for identifying one or more dimensions of one or more identified objects in the capture image. In an embodiment, an electronic device may include a database for storing object recognition information and object dimension information for detecting a distance to one or more identified and/or unidentified objects in a captured image. In an embodiment, an electronic device may be configured to add to the database information previously not stored in the database such as dimensional information and distance information for one or more additional objects.

In an embodiment, the disclosure is related to an electronic device configured to capture one or more images wherein the one or more images are processed by a computer aided by AI to recognize objects within the image(s) to determine the distance to a target. For example, if a recognized object is a large coffee cup having a known logo on the surface of the coffee cup, then the system will determine height, width, and diameter of the cup in the viewed image. The measurements will be used by the system to look up cup objects stored in the object databases. If the large coffee cup is found or a similar cup is found in one of the object databases, then the system will generate ranging information from the ranging information associated with the recognized object or a similar found object. The object databases are constructed to include large numbers of common objects and their associated manufactures logos.

In another example, a recognized object is a standard U.S. stop sign is 30 inches by 30 inches (or 30″×30″). Using a milliradian based measurement system, if a target is observed via an image capturing system of this disclosure and a captured image includes the stop sign near the target, then the software can measure the stop sign in milliradians (e.g., as 5.0 MILs tall or wide), and determine the distance to the target using the following MIL Relation Formula:

$$( {H}_{T} \times {C}_{T} ) / {H}_{0} = {R}_{T}$$

wherein:
for a range in yards, H_{T} is the height of the target in inches, C_{T} is a constant having a value equal to 27.77, H₀ is the height of the target in milliradians, and R_{T} is the range to the target in yards;
for a range in yards, H_{T} is the height of the target in yards, C_{T} is a constant having a value equal to 1000, H₀ is the height of the target in milliradians, and R_{T} is the range to the target in yards;
for a range in meters, H_{T} is the height of the target in inches, C_{T} is a constant having a value equal to 25.4, H₀ is the height of the target in milliradians, and R_{T} is the range to the target in meters;
for a range in meters, H_{T} is the height of the target in meters, C_{T} is a constant equal to 1000, H₀ is the height of the target in milliradians, and R_{T} is the range to the target in meters; and for a range in meters, H_{T} is the height of the target in centimeters, C_{T} is a constant equal to 10, H₀ is the height of the target in milliradians, and R_{T} is the range to the target in meters.

In this example, if H_{T} is 30 inches and H₀ is 5 MILs, then the target is a distance of or about 166.62 yards from the image capturing system.

This process will be able to compare any item stored in a database and accurately determine a size of an item and thereby be able to determine R_{T} more accurately. The accuracy of the R_{T} determination is only limited by the ability of the system to measure sizes of the items within an image including the target and to compare the target to items stored in the database.

A further embodiment of any of the foregoing embodiments of the present disclosure may further include an AI system or engine that includes (1) an input module configured to receive user input to configure machine learning; and (2) a machine learning module configured to adjust at least one of a weight and a parameter of an algorithm of an artificial intelligence system based on the user input.

A further embodiment of any of the foregoing embodiments of the present disclosure may include situations wherein the AI system or engine is selected from the group consisting of: a face recognition system, a natural language processing system, a speech recognition system, a pattern recognition system, an object recognition system, a voice recognition system, a motion prediction system, an object classification system, an action classification system, a content recognition system, and a threat detection system.

It is understood that distances in meters may be converted to yards and vice versa. A non-limiting sampling of conversions for various distances in meters and yards are provided in Tables 1 and 2 below.

TABLE 1

| Distance | Distance |
|---|---|
| (in meters) | (in yards) |
| 50.0 | 54.68 |
| 100.0 | 109.36 |
| 150.0 | 164.04 |
| 200.0 | 218.72 |
| 250.0 | 273.40 |
| 300.0 | 328.08 |
| 350.0 | 382.77 |
| 400.0 | 437.45 |
| 450.0 | 492.13 |
| 500.0 | 546.81 |
| 550.0 | 601.49 |
| 600.0 | 656.17 |

TABLE 2

| Distance | Distance |
|---|---|
| (in yards) | (in meters) |
| 50.0 | 45.72 |
| 100.0 | 91.44 |
| 150.0 | 137.16 |
| 200.0 | 182.88 |
| 250.0 | 228.6 |
| 300.0 | 274.32 |
| 350.0 | 320.04 |
| 400.0 | 365.76 |
| 450.0 | 411.48 |
| 500.0 | 457.2 |
| 550.0 | 502.92 |
| 600.0 | 548.64 |

As understood by the skilled artisan, 1.0 MRAD at 100.0 yards equals 9.14 cm (3.6 inches), 1.0 MRAD at 200.0 yards equals 18.29 cm (7.2 inches) and so forth as described in Table 3 below out to a distance of 600.0 yards. Likewise, 1.0 MRAD at 100.0 meters equals 10.0 cm and so forth as described in Table 4 below out to a distance of 600.0 meters.

TABLE 3

| Range | One MRAD | One MRAD |
|---|---|---|
| (in yards) | (in cm) | (in inches) |
| 100.0 | 9.14 | 3.6 |
| 200.0 | 18.29 | 7.2 |
| 300.0 | 27.43 | 10.8 |
| 400.0 | 36.58 | 14.4 |
| 500.0 | 45.72 | 18.0 |
| 600.0 | 54.86 | 21.6 |

TABLE 4

| Range | One MRAD | One MRAD |
|---|---|---|
| (in meters) | (in cm) | (in inches) |
| 100.0 | 10.00 | 3.94 |
| 200.0 | 20.00 | 7.87 |
| 300.0 | 30.00 | 11.81 |
| 400.0 | 40.00 | 15.75 |
| 500.0 | 50.00 | 19.69 |
| 600.0 | 60.00 | 23.62 |

### INTRODUCTION

The present disclosure is directed to apparatuses, devices, and systems, and interfaces and methods implementing them for determining information concerning distant objects of interest in a novel manner. As described herein, artificial intelligence (AI) is used to determine distances from one or more image capturing systems to one or more distant objects that are captured in one or more captured images by the one or more image capturing systems. The AI is used to identify one or more distant objects in the one or more captured images or image data according to input data such as one or more components, features, attributes, characteristics and associated information (the Aspects) of a plurality of objects that are stored in one or more databases of one or more internets and/or intranets and/or one or more local databases. Once the one or more distant objects in the one or more captured images or image data are identified, the AI is used to determine a level of confidence for each distant object according to the Aspects for each distant object whereby one or more objects meeting a particular confidence level threshold are then used by the AI to determine a distance to one or more particular targeted distant objects as provided in the field of view for each of the one or more captured images. The AI and/or machine learning of this disclosure improves over time by continuously learning from new data, analyzing user interaction, and adjusting its algorithms based on feedback.

In a simplified embodiment, a process for determining distances to one or more distant objects may include the following steps:
1. One or more images including one or more distant objects are acquired by one or more image capturing systems;
2. One or more target objects of the one or more distant objects are selected for distance determination, i.e., selected to be ranged.
3. One or more distant objects in the one or more captured images are identified.
4. The one or more distant objects in step 3 are prioritized according to highest confidence level as to the ability of artificial intelligence to use each of the one or more distant objects to reliably determine distant of the one or more distant objects from the one or more image capturing systems;
5. The AI engine or software uses the prioritization of one or more distant objects to determine a distance of each of the one or more target objects from the one or more image capturing systems;
6. In the event that one or more of the target objects move or otherwise are set in motion, the AI engine or software tracks the moving target objects and continuously uses one or more distant objects in the field of view of one or more captured images to determine distances to each of the one or more target objects according to steps 4 and 5;
7. The distance to each of the one or more targets is communicated to the one or more image capturing systems and/or one or more other devices of a user(s) of the one or more image capturing systems and/or one or more other devices of one or more other users.

Various methodologies may be used by the AI engine or software to both determine distances to identified distant objects in captured images and increase confidence levels for distant objects identified in captured images. For example, identified distant objects within a field of view of a captured image at a particular magnification that are standardized may be used to increase confidence levels for distance determination purposes. Known distances such automobile wheelbases and objects such as automobile windshields, doors, beverage containers, motorist regulatory signs, e.g., stop signs, and other objects of known dimensions are the highest level of confidence due to the consistency in appearance and dimensions. Another non-limiting example of objects of the highest level of confidence may include receivers or various parts on particular types of firearms that are the same dimensionally regardless the particular make/model or sub model of the firearm, e.g., Avtomat Kalashnikova (AK-47) lower receivers, ArmaLite Rifle-15 (AR15) uppers and lowers, and United States Rifle, Caliber 7.62 mm (M14) receivers. Objects of lower confidence levels include objects that tend to vary dimensionally, such as automobile wheels and tires, custom made items, firearm barrels, fencing, amongst others.

The AI engine or software may also use biological objects (flora and fauna) for determining distance by using known factors of biological objects such as color patterns, average heights, average widths, e.g., an average shoulder width for an adult male person, generally and/or regionally to increase confidence levels of determining distances to one or more target objects captured in images. Clothing and accessories including, but not limited hats, watches, patches and badges on clothing such as uniforms and colors and color schemes of clothing may also be used to increase confidence levels for determining distance to one or more target objects captured in images. For the types of objects in this paragraph, artificial intelligence will sort any such objects identified in a captured image according to highest confidence levels to produce the most accurate distance calculations to one or more target objects.

The AI engine or software may use data regarding one or more particular locations of one or more image capturing systems, e.g., via GPS, along with altitude, speed and direction of movement information for one or more image capturing systems and/or one or more target objects, e.g., real time location of an image capturing system on a UAV tracking one or more target objects. The AI engine or software may use location information for the one or more image capturing systems and compare the location information against the physical location of the one or more target objects in real time, near real time, or periodically to determine distance from the one or more image capturing systems to the one or more targets. The physical location for one or more target objects can be determined by known geographic markers including, but not limited to as trees, rocks, river bends, valleys and the like, hills and the like, identifiable road/highway features such as corners, turns, bridges, tunnels, rail lines, signage, and other interactions, residential and commercial property, and combinations thereof. The artificial intelligence can refine or increase distance determination accuracy by selecting one or more additional objects and/or markers to increase the overall confidence level regarding distance to one or more target objects. The AI engine or software may provide elevation information for one or more target objects including using accelerometer and inclinometer generated information to determine an angle(s) to one or more target objects.

In an embodiment, the AI engine or software uses a web based and/or cloud based database to search and pull the data for use in determining distance for one or more target objects. For optimum operation, the AI engine or software constantly updates and customizes data to ensure that the data for one or more prospective objects to be used for distance determination remains accurate.

The data to be utilized by the AI engine or software may be tailored for one or more particular operations and/or one or more particular locations of operation. Such a process may include uploading to one or more web based and/or cloud based databases and/or one or more local databases operational data as well location and/or region specific data. For example, in a military setting, location and/or region specific data may include information regarding road signs, crosswalk widths, enemy combatant ceremonial hat dimensions, military insignias, clothing regalia, and the like to increase the overall confidence level regarding distance to one or more target objects. Local databases such as databases for one or more image capturing systems and/or related devices provide a level of redundancy in the event access to the web based and/or cloud based databases is lost before or during use. Per storage capacity constraints, local databases receive web and/or cloud based data continuously storing the updated data locally for use as needed.

From a perspective of a person using an image capturing system of this disclosure, the image capturing system may include an image capturing device in communication with a visual display screen such as a monitor and/or a tablet screen and/or include an image capturing device equipped with a visual display screen whereby the user can select one or more objects and/or persons viewable in a captured image on the visual display screen as one or more targets for which distance to target information is sought. Herein, the one or more targets may also be referred to as one or more targets of interest (TOI). Once the TOI are selected, the artificial intelligence begins tracking and locking on the TOI and one or more objects on and/or near the TOI to determine the distance of each of the TOI from an optical instrument of the image capturing system. The visual display screen can display the distance to the TOI along with a confidence level as to the accuracy of the calculated distance to the TOI. In an embodiment, an image capturing system may optionally provide the distance to the TOI and the confidence levels audibly.

The confidence level threshold, the number of TOIs, and input data may be varied and the calculated distance information for one or more TOIs may be communicated to other local and/or remote devices and monitors of others. For example, in a military setting calculated distance information for one or more TOIs may be communicated by the user and/or artificial intelligence to high command and/or field command and/or other users in the field of operation.

### Electronic Apparatuses and Devices

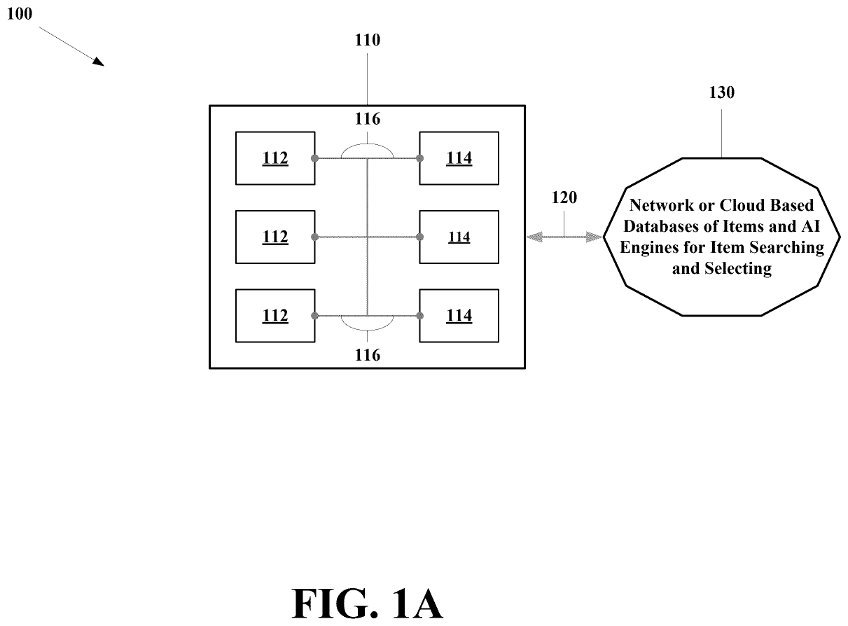

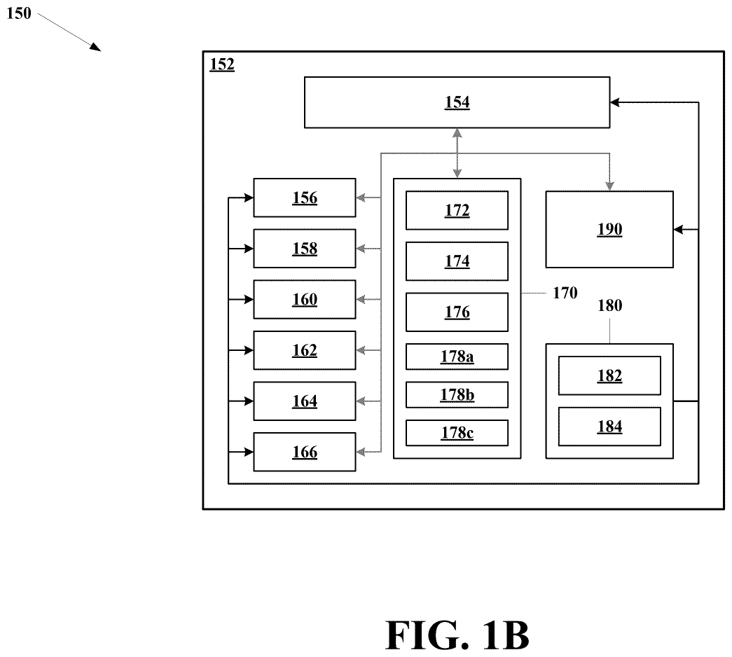

Referring now to FIG. 1A, a simplified illustration of a non-limiting embodiment of an electronic device or system, generally 100, is shown. In an embodiment, the electronic device or system 100 may include one or more image capturing systems 110 communicatively coupled via the gray arrowed bidirectional pathways 120 to a network/cloud based databases 130 that comprises one or more software systems using artificial intelligence (AI) routines or engines to search for items in the databases 130, select items in the databases 130, process data, learn, and make decisions as described herein (the AI Engines).

In an embodiment, one or more image capturing systems 110 may include one or more optical instruments 112 (here shown as three optical instruments) paired with the one or more image capturing devices 114 indicated by the connections 116. Non-limiting examples of one or more optical instruments 112 may include fixed and variable monocular telescopes, binoculars, riflescopes, camera lenses, periscopes, microscopes, and combinations thereof. Non-limiting examples of the one or more image capturing devices 114 may include one or more digital cameras, one or more smartphones, one or more computers, e.g., a laptop computer with a built-in keyboard and trackpad, one or more tablet computers, and combinations thereof. Depending on the type of one or more optical instruments 112 provided, the one or more one or more optical instruments 112 may be communicated with the one or more image capturing devices 114 via one or more instrument specific mounts, one or more adapters, and/or the like. In an embodiment, light collected by the one or more one or more optical instruments 112 may be channeled through an optical fiber to the one or more image capturing devices 114.

Reference is now made to FIG. 1B, a simplified illustration of a non-limiting embodiment of an electronic device or system, generally 150, is shown to include a housing 152. The housing 152 includes a processing unit or processor 154 in communication with or coupled to memory 156, one or more mass storage devices 158, one or more input devices 160, one or more output devices 162, a display unit 164, and communication hardware 166. The housing 152 also includes software system 170 including an operating system 172, communication software 174, an artificial intelligence (AI) system or engine 176, one or more local item databases 178a, item searching and selecting software routines 178b, and other software or executable instructions or routines 178c for implementing an application of this disclosure. The housing 152 also includes a power supply unit 180 including a power supply 182 and a battery backup 184. The housing 152 also includes one or more image capturing systems 190. The processing unit or processor 154 is in bilateral communication with the memory 156, the one or more mass storage devices 158, the one or more input devices 160, the one or more output devices 162, the display device 164, the communication hardware 166, and the image capturing system 190 so that the processing unit or processor 154 may execute the software system 170. The processing unit or processor 154 is configured to execute the instructions encoded in the software 178 or the software system 170 using the other system 170 components. The electronic device or system 150 may also be attached to the web or cloud databases 130 of FIG. 1A.

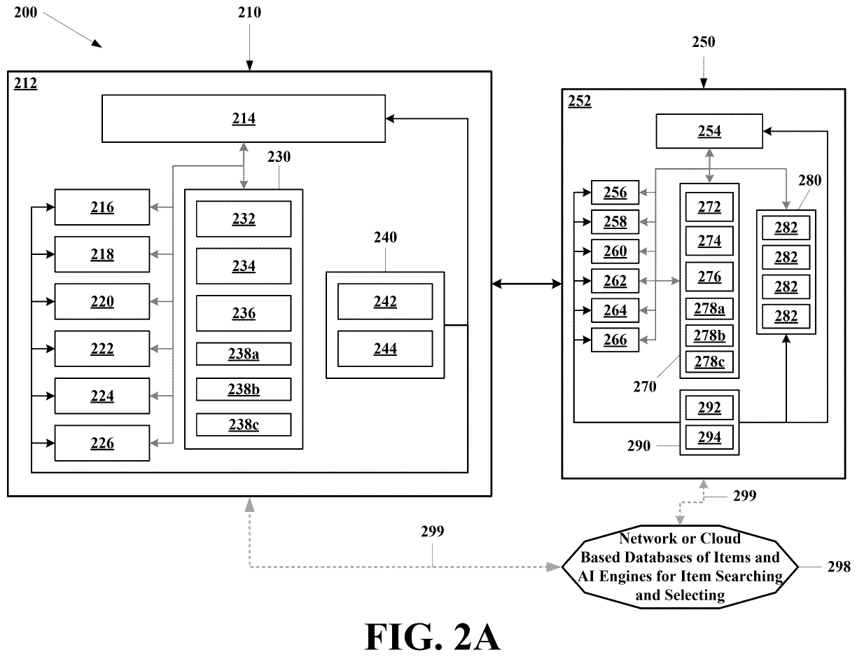

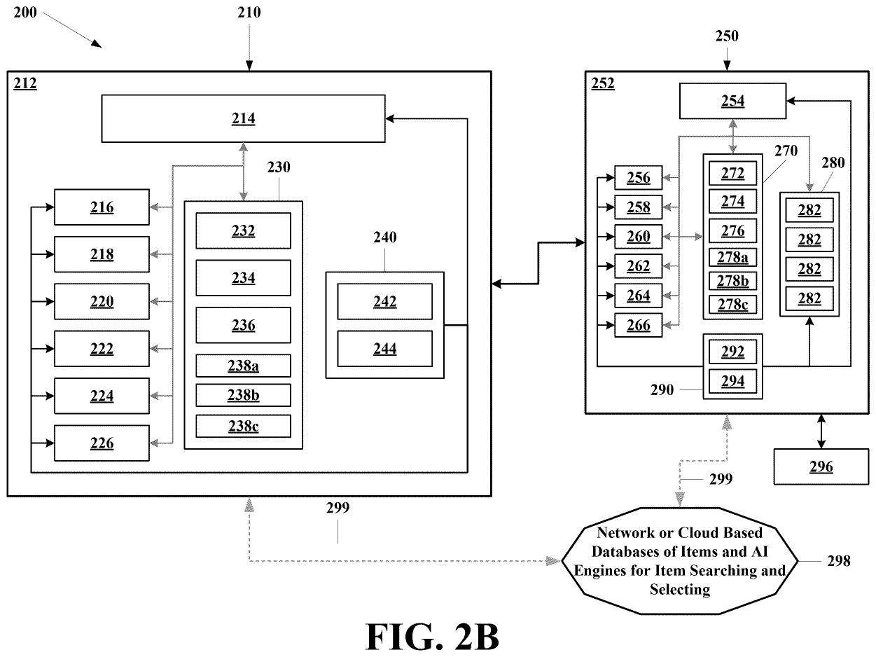

Reference is now made to FIG. 2A, a simplified illustration of another non-limiting embodiment of an electronic device or system, generally 200, is shown to include an electronic device 210 having a housing 212. The housing 212 includes a processing unit or processor 214 in communication with or coupled to memory 216, one or more mass storage devices 218, one or more input devices 220, one or more output devices 222, a display unit 224, and communication hardware 226. The housing 212 also includes software system 230 including an operating system 232, communication software 234, an artificial intelligence (AI) system or engine 236, one or more local item databases 238a, item searching and selecting software routines 238b, and other software or executable instructions or routines 238c for implementing an application of this disclosure. The housing 212 also includes a power supply unit 240 including a power supply 242 and a battery backup 244.

The apparatus or system 200 also includes one or more external imaging capturing systems 250 including a housing 252. The housing 252 includes a processing unit or processor 254 in communication with or coupled to memory 256, one or more mass storage devices 258, one or more input devices 260, one or more output devices 262, a display unit 264, and communication hardware 266. The housing 252 also includes software system 270 including an operating system 272, communication software 274, an artificial intelligence (AI) system or engine 276, one or more local item databases 278a, item searching and selecting software routines 278b, and other software or executable instructions or routines 278c for implementing an application of this disclosure. The housing 252 also includes an image capturing system 280 including one or more image capturing devices 282. The housing 252 also includes a power supply unit 290 including a power supply 292 and a battery backup 294.

In an embodiment, the one or more imaging capturing systems 250 may be in electrical communication with the electronic device 210. In an embodiment, the one or more imaging capturing systems 250 may be in wireless communication with the electronic device 210. Additionally, the electronic device or system 200 may also be communicatively coupled via the gray arrowed bidirectional pathways 299 to a network/cloud based databases 298 that comprises one or more software systems using artificial intelligence (AI) routines or engines to search for items in the databases 298, select items in the databases 298, process data, learn, and make decisions as described herein (the AI Engines).

Reference is now made to FIG. 2B, wherein an apparatus or system 200 may further include one or more optical instruments 296 paired with the one or more image capturing devices 282. Non-limiting examples of one or more optical instruments 296 may include fixed and variable monocular telescopes, binoculars, riflescopes, camera lenses, periscopes, microscopes, and combinations thereof. Depending on the type of one or more optical instruments 296 provided, the one or more one or more optical instruments 296 may be communicated with the one or more image capturing devices 282 via one or more instrument specific mounts, one or more adapters, and/or the like. In an embodiment, light collected by the one or more one or more optical instruments 296 may be channeled through an optical fiber to the one or more image capturing devices 282.

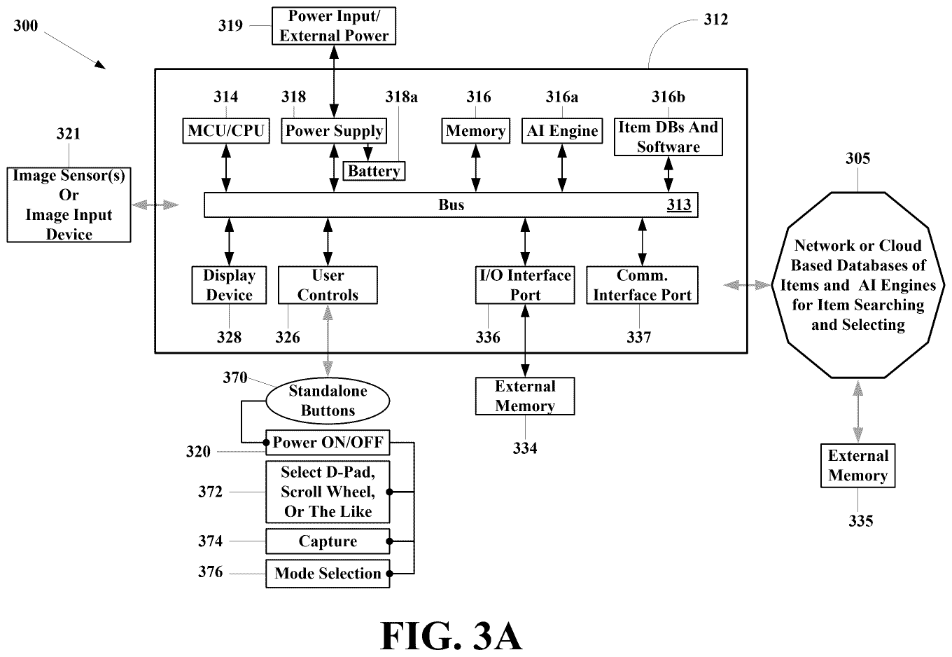

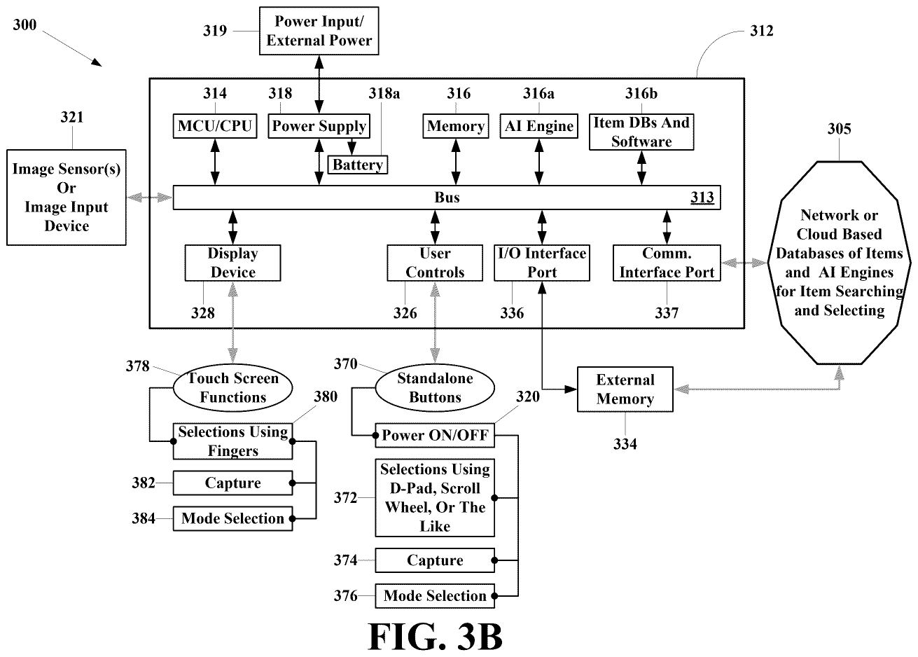

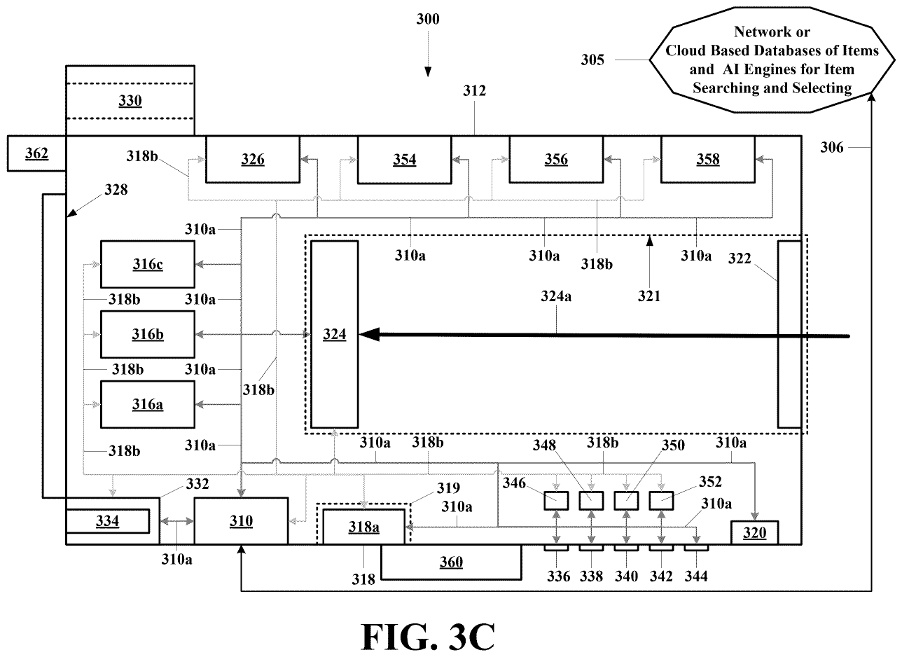

Reference is now made to FIG. 3A, a simplified illustration of a non-limiting embodiment of an electronic device or system, generally 300, of this disclosure is shown. As described herein, an electronic device or system 300 may be configured to capture one or more images of one or more objects and determine information concerning the one or more objects as provided in the one or more images. As such, in an embodiment an electronic device or system 300 of this disclosure may include at least a housing 312, a bus 313, a processing unit or processor such as a microcontroller unit 314 (“MCU 314”) including a central processing unit (“CPU”) in communication with or coupled to an internal memory 316 having software or executable instructions or routines including, but not limited to an, AI engine 316a readable by the CPU and including one or more local item databases and item searching and selecting software routines 316b, a power supply unit including a power supply 318, e.g., one or more rechargeable batteries 318a and/or a power input/external power supply 319, a power ON/OFF switch 320, an image capturing system 321 including an image sensor and at least one optical medium, one or more input devices 326 (or “user interfaces 326” including, for example, (1) standalone buttons 370 and/or (2) user controls 372 including a D-pad and/or a scroll wheel and/or the like, and/or (3) an image capture interface 374, e.g., a shutter button, and/or (4) a mode selection 376), a display unit including one or more visual displays 328, a first external memory 334 readable by the MCU 314, one or more electrical communication ports and interfaces 336 (or “Input/Output interface ports 336”), and a communication interface port 337 connectable with a network/cloud 305 including a second external memory 335.

Reference is now made to FIG. 3B, a simplified illustration of a non-limiting embodiment of an electronic device or system 300 of this disclosure is shown. In an embodiment, an electronic device or system 300 similar as described in FIG. 3A may be provided wherein the one or more visual displays 328 include one or more touch-sensitive visual displays 378, e.g., one or more touch screens, that may be configured as one or more additional user interfaces of the electronic device or system 300 in addition to the one or more input devices 326. In a non-limiting example, the one or more touch-sensitive visual displays 378 may include a touch-sensitive image capture interface and/or a touch-sensitive mode selection (see Selections Using Fingers 380). The one or more touch-sensitive visual displays 378 may also include an image capture interface 382 and/or a mode selection 384. In an embodiment, the one or more visual displays 328 may be configured as a digital viewfinder.

Reference is now made to FIG. 3C, a simplified illustration of a non-limiting embodiment of an electronic device or system 300 of this disclosure is shown. As described herein, an electronic device or system 300 may be configured to capture one or more images of one or more objects and determine information concerning the one or more objects as provided in the one or more images. As such, an electronic device or system 300 of this disclosure may include at least a housing 312 for housing a processing unit or processor such as a MCU 310 including a CPU, an internal memory 316a having software or executable instructions or routines including, but not limited to, an AI engine 316b readable by the MCU 310 and including one or more local item databases and item searching and selecting software routines 316c, a power supply unit including a power supply 318, a power ON/OFF switch 320, an image capturing system 321 including one or more lenses 322 and an image sensor 324, one or more input devices 326, a display unit 328 including one or more visual displays, and bidirectional communication pathways 310a (dark grey double arrowed lines) between the MCU 310 and all other electrical components capable of receiving or sending data.

In another embodiment, an electronic device or system 300 may also include one or more additional features including, for example, a viewfinder 330, a memory card slot 332 for an external memory 334 readable by the MCU 310, one or more electrical communication ports and interfaces 336 (or “Input/Output interface ports 336”), one or more speakers 338, a headset port 340, a microphone 342, and an external microphone port 344.

In an embodiment, an electronic device or system 300 may be coupled to a network or cloud 305 via wired technology 306, e.g., via wires, USB, cable, fiber optic cable, wireless technology, e.g., WiFi, cellular, satellite, radio frequency (“RF”), Bluetooth® technology, commercially available from Bluetooth SIG, Inc., Kirkland, Washington, U.S.A., other connection technologies, and combinations thereof. As such, a device 300 of this disclosure may include one or more components including, but not limited to, a cellular modem 346, an antenna 348, a GPS receiver 350, and a Bluetooth® chip 352.

In another embodiment, an electronic device or system 300 may also include one or more of an alphanumeric input device 354, e.g., a keyboard, a user interface (“UI”) navigation device 356, e.g., a mouse, and biometric security 358, e.g., one or more biometric security scanners such as fingerprint scanner and/or a face recognition scanner.

In another embodiment, an electronic device or system 300 may also include one or more mounting surfaces 360 including, but not limited to, one or more firearm mounting surfaces, one or more monopod mounting surfaces, and/or one or more tripod mounting surfaces. An electronic device or system 300 may also include one or more strap attachment surfaces 362 including, but not limited to, one or more eyelets, one or more snaps, and/or the like, and combinations thereof.

The size, shape, and surface ornamentation of a housing 312 of an electronic device or system 300 may be, but not limited to, any particular configuration such as one or more configurations as desired and/or as may otherwise be required for one or more particular operations of an electronic device or system 300. For example, in certain embodiments, an electronic device or system 300 may be provided as a portable handheld device with an outer surface configuration designed for handheld operation. In other embodiments, an electronic device or system 300 may be provided as an OEM product, e.g., for use with one or more land vehicles, air vehicles, or sea vehicles including a housing 312 for operable placement thereon. In an embodiment, an electronic device or system 300 may be configured for installation on one or more surfaces including, but not limited to (1) one or more exterior building surfaces such as facades, soffits, rooftops, windows, railing, decking, doors, light fixtures; (2) one or more interior building surfaces such as ceilings, walls, floors, support beams, light fixtures, rafters; (3) one or more other elevated outdoor construction surfaces, e.g., fences, gates, walls, benches, poles, towers, vessels, offshore platforms, dams, bridges, overpasses, windmills, tanks, smoke stacks, flare stacks, bollards; (4) one or more outdoor ground level surfaces, e.g., the earth, roads, runways, taxiways, parking areas; (5) one or more other elevated indoor surfaces, e.g., storage racks, shelving, tables; (6) one or more natural structures and/or landforms, e.g., one or more trees, one or more plateaus, one or more cliffs; and combinations thereof.

A housing 312 of this disclosure may be constructed from one or more materials durable for one or more operations and/or as may be required by law or regulation. Suitable materials of construction may include, but are not necessarily limited to, those materials resistant to chipping, cracking, excessive bending and reshaping as a result of ozone, weathering, heat, moisture, other outside mechanical and chemical influences, as well as physical impacts. In particular, a housing 312 may be constructed from materials including, but not necessarily limited to one or more metals, one or more plastics, one or more rubbers, one or more woods, one or more filled composite materials, and combinations thereof. One suitable metal may include stainless steel. Another suitable metal may include aluminum. Another suitable metal may include 6063 aluminum alloy. Another suitable metal may include 6061-T6 aluminum alloy. As understood by persons of ordinary skill in the art of optical aiming devices, a metal housing 312 may include a matte paint finish or a hard-coat anodized finish.

In an embodiment, control circuitry of an electronic device or system 300 may include a MCU 310, peripheral hardware including one or more input devices and one or more other PCB components for desired operation of an electronic device or system 300. In an embodiment, an MCU may include one or more of a central processing unit (“CPU”), a graphics processing unit (“GPU”), a serial bus interface, one or more voltage regulator circuits, one or more voltage measurement circuits, and combinations thereof. One or more input devices to implement one or more peripheral functions of an electronic device or system 300 may include, but are not limited to one or more motion sensors, one or more tilt sensors, one or more light sensors, one or more thermal sensors, one or more image sensors, one or more capacitive touch sensors, one or more biometric sensors, one or more time delay relay circuits, one or more clock circuits, one or more counter circuits, one or more wireless control circuits, one or more analog-to-digital converters, one or more digital-to-analog converters, one or more power regulation circuits, one or more voltage sensors, circuits to perform logic functions, one or more electromagnetic sensors, one or more GPS antennas, and combinations thereof. One non-limiting example of an electromagnetic sensor includes a radio frequency sensor (“RF sensor”). Other PCB components may include, but are not limited to one or more resistors, one or more capacitors, one or more inductors, one or more diodes, one or more relays, one or more transistors, and other electrical components as may be required for a particular operation of an electronic device or system 300 of this disclosure. In an embodiment, MCU logic of an electronic device or system 300 may be comprised of analog logic elements, digital logic elements, and combinations thereof.

In an embodiment, internal memory 316a may store one or more programs and/or one or more commands for an electronic device or system 300. In an embodiment, internal memory 316a may include one or more storage medium having at least one type of a flash memory, a hard disk, RAM, SRAM, ROM, EEPROM, PROM, and MRAM. In an embodiment, external memory 334 may include card type memory including, but not limited to one or more multimedia cards (“MMC”), one or more MMC micro, one or more SD memory cards, one or more XD memory cards, one or more magnetic discs, and one or more optical discs.

A power supply 318 may be configured to power an electronic device or system 300 including the various components of the electronic device or system 300. In an embodiment, a power supply 318 may be connected to the MCU 310 via electrical circuitry or electrical pathways 318b (light grey single arrowed lines) configured to regulate the voltage and current from the power supply 318, e.g., using a power management integrated circuit (“PMIC”) and/or the like. In an embodiment, a power supply 318 may include one or more battery compartments 319 containing one or more rechargeable batteries 318a, one or more external rechargeable batteries, one or more external power supplies configured to convert alternating current (“AC”) to direct current (“DC”) as understood in the art of electronic devices, or any combination thereof. Rechargeable batteries 318a may include, but are not limited to, one or more lithium-ion batteries, alkaline batteries, nickel metal hydride, one or more future removable rechargeable battery technologies not known at the time of this disclosure, and combinations thereof. Permanent rechargeable batteries 318a may include, but are not limited to, one or more lithium-ion batteries, lithium polymer batteries, nickel cadmium batteries, nickel metal hydride batteries, smart batteries comprising a built-in Battery Management System (“BMS”), one or more future permanent rechargeable battery technologies not known at the time of this disclosure, and combinations thereof.

In an embodiment, a power ON/OFF switch 320 of an electronic device or system 300 may be in electrical communication with a power supply 318 via the electrical circuitry or electrical pathways 318b and/or the like. In an embodiment, a power ON/OFF switch 320 may include a push-button switch. In an embodiment, a power ON/OFF switch 320 may include a toggle switch. In an embodiment, a power ON/OFF switch 320 may include a rocker switch. In an embodiment, a power ON/OFF switch 320 may include a slide switch. In an embodiment, a power ON/OFF switch 320 may include a capacitive touch control. In an embodiment, ON/OFF functionality may be voice activated.

In an embodiment, one or more lenses 322 of an image capturing system 321 of an electronic device or system 300 may include one or more fixed lenses and/or one or more interchangeable lenses. Exemplary lenses of an electronic device or system 300 may include, but are not limited to one or more standard lenses, one or more prime lenses, one or more wide-angle lenses, one or more telephoto lenses, one or more zoom lenses, one or more macro lenses, one or more fisheye lenses, one or more tilt-shift lenses, one or more anamorphic lenses, and combinations thereof.

In an embodiment, an image sensor 324 of an image capturing system 321 of an electronic device or system 300 may include a CCD sensor, a CMOS sensor, one or more future image sensor technologies not known at the time of this disclosure, and combinations thereof. A size of an image sensor 324 may vary as desired or as may otherwise be required for one or more operations of an electronic device or system 300. Although an electronic device or system 300 of this disclosure may be built to scale include a scalable image sensor 324, in an embodiment of a handheld type of an electronic device or system 300, an image sensor 324 may include a size similar as commonly provided in smartphones and digital cameras commercially available at the time of this disclosure, e.g., from or about 0.575 mm×0.575 mm up to or about 53.4×40.0 mm. In addition, an electronic shutter of an image sensor 324 of this disclosure may include, but is not limited to, a rolling shutter or a global shutter as understood in the art of digital imaging as well as one or more further image sensor electronic shutter technologies not known at the time of this disclosure. In an embodiment, an electronic device or system 300 may employ thermal imaging technology including an imaging sensor that is sensitive to frequencies in the infrared region of the electromagnetic spectrum.

In an embodiment, the one or more input devices 326 may include one or more knobs, dials, toggles, buttons, touch-sensitive visual displays, image capture interface, e.g., a shutter button, and combinations thereof configured to execute the one or more programs and/or one or more commands stored in the internal memory 316a. In an embodiment, the display unit 328 may include one or more touch-sensitive visual displays including one or more display elements such as graphics, text, icons, still images, video, and combinations thereof for individualized user control.

In an embodiment, the one or more visual displays of the one or more input devices 326 may also be provided as the one or more visual displays of the display unit 328 of an electronic device or system 300. As such, in addition to operating as the one or more input devices 326, the one or more visual displays of the display unit 328 may also be configured to display one or more images captured by the electronic device or system 300, one or more images stored in a database or inventory of the electronic device or system 300, and one or more images downloaded onto the electronic device or system 300. In an embodiment, the one or more visual displays of the display unit 328 may include one or more touch screens including touch-sensitive surfaces and/or sensor(s) configured to accept haptic and/or tactile contact input from users. In an embodiment, a point of contact between a touch screen type visual display of the display unit 328 and a user may include a handheld stylus pen. In an embodiment, a point of contact between a touch screen type visual display of the display unit 328 and a user may include a finger of a user. Herein, one or more touch screens may include one or more touch sensing technologies including, but not limited to capacitive, resistive, infrared (“IR”), surface acoustic wave technologies, and combinations thereof.

In an embodiment, one or more electrical communication ports and interfaces 336 of an electronic device or system 300 may include, but are not limited to coaxial inputs, USB ports, ADAT connections, FireWire connections, external power supply connections, e.g., AC power jack inputs, DC power jack inputs, and combinations thereof. Non-limiting examples of USB ports contemplated at the time of this disclosure include, but are not limited to USB Type A, USB Type B, USB Type C, USB 4.0, USB 3.0, USB 2.0, USB Mini, USB Micro, USB Micro B, and combinations thereof.

Depending on the one or more operating functions to be included on an electronic device or system 300, an electronic device or system 300 of this disclosure may further include one or more functional components including, but not limited to (1) one or more illumination sources, e.g., one or more LEDs and/or LED arrays, one or more incandescent bulbs, (2) one or more electronic compasses, (3) one or more accelerometers, (4) one or more angle sensors, (5) one or more low battery indicators, e.g., an indicator light, and combinations.

In an embodiment, the AI engine 316b is used by the application to search the item databases either locally in the local item database or via a communication network connection to web or cloud-based item databases. The AI engine 316b may use exact search formats or similarity search format depending on the objects identified in the Image Data. The AI engine 316b may also use selection formats based on the aspects associated with the identified objects in the Image Data as more fully described herein.

### Explanation of Logic for Computer/Programing

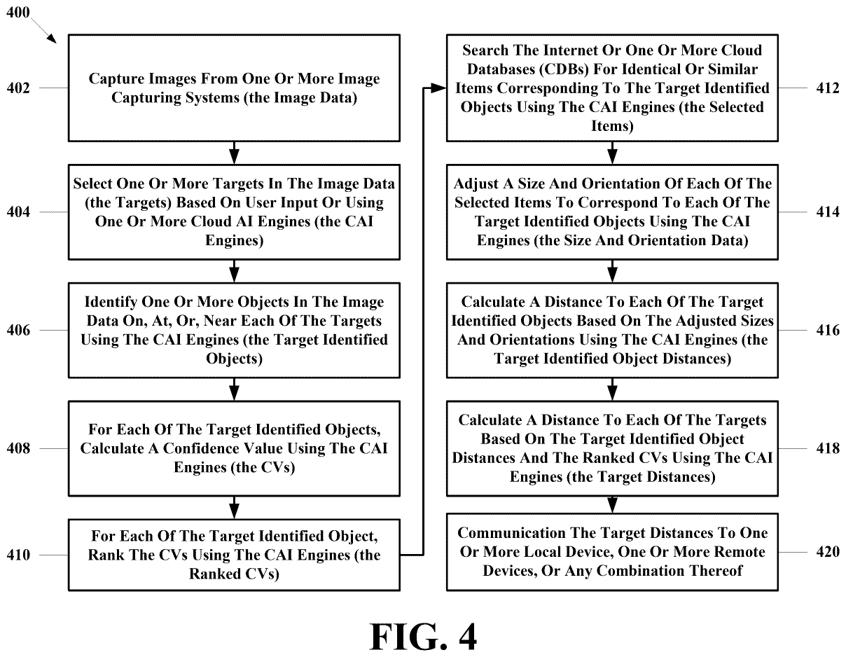

Referring now to FIG. 4, a conceptual flow chart of an embodiment of a device, apparatus, and system, and interface or method implementing them and their operation, generally 400, is shown beginning with an image data capturing step 402, wherein one or more image capturing systems 110 of an electronic device or system 100 capture one or more images in real time, near real time, or periodically and the input image data for the one or more captured images is continuously observed and analyzed by artificial intelligence system or AI engine in one or more network/cloud 130 databases (the Image Data). The Image Data may include one or more still images such as still images captured by a digital still camera and/or the like, one or more images, or frames, from a continuous sequence of images such as video images, any other type of captured image data, and combinations thereof.

Control then proceeds to a target selection step 404, wherein a user and/or the cloud AI engines select one or more targets in the Image Data (the Targets). For example, in an embodiment a captured image or a live video image may be displayed on one or more visual displays of one or more image capturing devices 114 of the one or more image capturing systems 110 and the user may touch by finger or handheld tool a visual display at a location corresponding to a location on the visual display to select a target in the captured image or live video image thereby informing the one or more cloud AI Engines of the target, or the cloud AI engines may select the Targets with or without user input.

Control then proceeds to an objects identification step 406, wherein the one or more cloud AI engines identify all recognizable objects in the Image Data including the Targets and objects associated with, on, at, or near each of the Targets and compare the recognizable objects in the Image Data to data for items stored on the one or more network/cloud 130 databases (the Target Identified Objects). The data for items stored on the one or more network/cloud 130 databases may be gathered from thousands or millions of images of each item from internets and/or intranets and stored on the one or more network/cloud 130 databases in one or more datasets. As an example, where a target is a person, one or more image recognition algorithms may use deep learning datasets comprising the stored item data to distinguish patterns for the Target Identified Objects in the Image Data and for people, biometric data including fingerprints, hand size and shape, finger sizes and shapes, iris features, iris data stored in iris recognition databases, facial features, facial data stored in facial recognition databases, height, weight, skin color, ethnicity, and any other biometric data associated with an individual. The one or more AI Engines recognize and prioritize the Target Identified Objects in order of reliability or consistency as to dimensional data (size and shape) for the Target Identified Objects according to (1) Target Identified Objects having known dimensions and (2) the orientation of the Target Identified Object in one or more captured images. Target Identified Objects with known dimensions may include, but are not limited to, articles of manufacture, structural objects, and biological objects. For purposes of this disclosure, articles of manufacture are recognized by the one or more AI Engines as being the most reliable type of objects in regard to dimensional data because such objects are typically manufactured in certain makes and models according to specifications of known and repeatable dimensions. However, where a make and model of an article of manufacture is not readily recognizable, e.g., a Target Identified Object such as used car tire of unknown make and model, the one or more AI Engines will assign less reliable dimensional data to such Target Identified Object. Structural objects may include known objects that may or may not be congruent, such as telephone posts, fencing, towers, dwelling places, commercial property, billboards, etc. Accordingly structural objects are assigned a range of dimensional data less reliable than articles of manufacture. For purposes of this disclosure, biological objects (flora and fauna) are considered the least reliable or least consistent objects regarding dimensional data as persons, animals and plant life can include ranges in size and shape both generally and in different parts of the world. As such, the one or more AI Engines may assign dimensional data to biological objects on a per location basis whereby such Target Identified Objects may be recognized as more reliable objects than otherwise calculated once particular dimensional data is assigned to the Target Identified Objects for particular locations. As an example, an average height may be assigned to an adult male person in The Netherlands and a different average height may be assigned to an adult male person in Japan. Likewise, a mature date palm tree (Phoenix dactylifera) located in the Kingdom of Saudi Arabia may be assigned an average height different from an average height assigned to a mature date palm tree located in North Africa. For purposes of this disclosure, a Target Identified Object captured in an image in a profile view is identified by the one or more AI Engines as more reliable than the same object captured in image distorted due to perspective. As an example, a front passenger door for a certain make and model automobile is regarded as more reliable when captured in a side profile view in an image including a side profile of the whole automobile compared to the same front passenger door being captured at an angle with the captured automobile oriented at a side perspective.

Control then proceeds to a confidence value calculation step 408, wherein a confidence value is calculated for each of the Target Identified Objects (the Confidence Values or the CVs) dimensional data by the one or more cloud AI engines as a confidence value expressed as a percentile, e.g., 95% confidence value, 70% confidence value, etc., and/or as a percentile value range, e.g., 95%-99% confidence value, 80%-85% confidence value, etc. In the event one or more Target Identified Objects leave the field of view and/or one or more new Target Identified Objects enter the field of view, the one or more cloud AI engines recalculate the CVs for the Target Identified Objects in the field of view. The one or more cloud AI engines may calculate CVs according to a default minimum confidence level or users may select a minimum confidence level prior to operation or during operation. Users may also change a minimum confidence level during operation. In military a setting, a minimum confidence level for a Target may depend, at least in part, on the type of munitions being used against the Target.

Control then proceeds to a confidence value ranking step 410, wherein the CVs of each Target Identified Objects for each target are ranked by the one or more cloud AI engines (the Ranked CVs) from a highest confidence level to a lowest confidence level. Control then proceeds to a search step 412, wherein the one or more cloud AI Engines search the one or more network/cloud databases 130 (the CDBs) and/or other collections of networks and/or intranets for stored item data for one or more items that are identical to or similar to each of the Target Identified Objects (the Selected Items). As an example, the one or more cloud AI engines may extract three-dimensional information from the CDBs 130 for the Selected Items.

Control then proceeds to a selected item size and orientation step 414, wherein each of the Selected Items is size adjusted and spatially oriented to match or correspond to each of the Target Identified Objects (the Size and Orientation Data) using algorithms and routines in the one or more cloud or DRAI engines. In a non-limiting embodiment, the one or more cloud or DRAI engines may use CNNs to analyze the Target Identified Objects in the Image Data pixel by pixel, extracting various features such as shapes, corners, edges of the Target Identified Objects to assist the one or more cloud AI engines understand spatial depth and the spatial relationships between different parts of the Target Identified Objects and their relative positions in the Image Data.

Control then proceeds to an object distance determination step 416, wherein a distance for each of the Target Identified Objects based on the Size and Orientation Data (the Target Identified Object Distances) is calculated using algorithms and routines in the one or more cloud AI engines. Control then proceeds to a target distance determination step 418, wherein a distance for each of the Targets is calculated based on the Target Identified Object Distances and the Ranked CVs (the Target Distances) using algorithms and routines in the one or more cloud AI engines. Control then proceeds to a target distance communication step 420, wherein the Target Distances are communicated to one or more image capturing systems 110 of one or more users, one or more devices of one or more other authorized personnel, or combinations thereof.

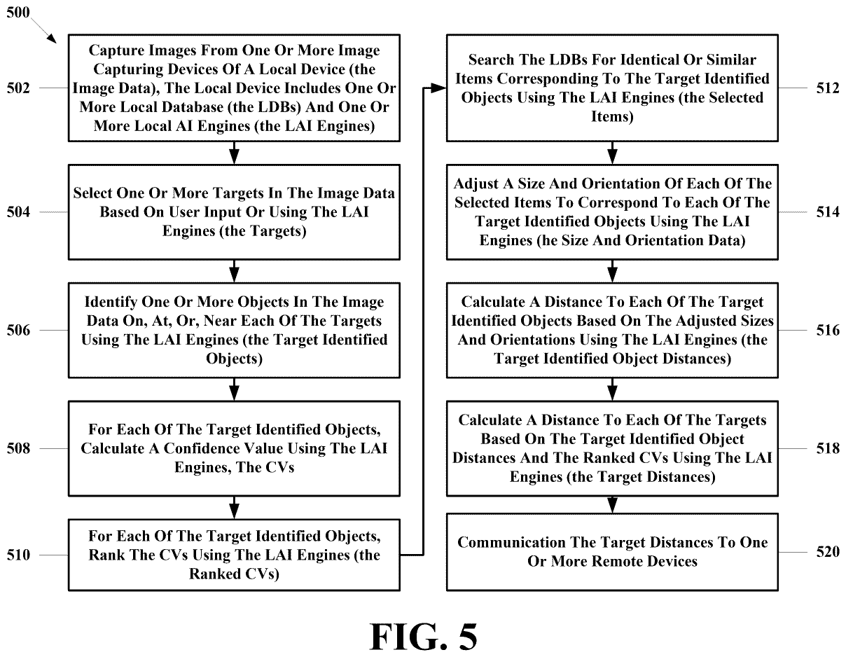

Referring now to FIG. 5, a conceptual flow chart of an embodiment of a device, apparatus, system, or interface and their operation, generally 500, is shown beginning with an image data capturing step 502, wherein one or more image capturing systems 190, 250, 280 of an electronic device or system 150, 200 capture one or more images in real time, near real time, or periodically and the input image data for the one or more captured images is stored on one or more local database (the LDBs) on the one or more mass storage devices 158, 258 and continuously observed and analyzed by one or more local artificial intelligence system or engine 176, 236 (or “LAI engines 176, 236”) (the Image Data). As described herein, the storage capacity of the one or more mass storage devices 158, 258 may vary on a per operation basis, but for any operation the storage capacity is sufficient for storing all or a portion of the AI engine 176, 236 in the LDBs. The Image Data may include one or more still images such as still images captured by a digital still camera and/or the like, one or more images, or frames, from a continuous sequence of images such as video images, or combinations thereof.

Control then proceeds to a target selection step 504, wherein a user or the LAI engines 176, 236 selects one or more targets in the Image Data (the Targets). For example, in an embodiment a captured image or a live video image may be displayed on a display unit 164, 224 and a user may touch the display unit 164, 224 by finger or handheld tool at one or more locations on the display unit 164, 224 corresponding to the Targets shown in the captured image or live video image thereby informing the LAI engines 176, 236 as to the Targets in the Image Data.

Control then proceeds to an object identification step 506, wherein the LAI engines 176, 236 identifies all recognizable objects in the Image Data and compares the recognizable objects in the Image Data to data for items stored on the LDBs (the Target Identified Objects). The data for items stored on the LDBs may be gathered from thousands or millions of images of each item from internets and/or intranets and stored on the LDBs in one or more datasets. As an example, where a Target is a person, one or more image recognition algorithms may use deep learning datasets comprising the stored item data to distinguish patterns for the Target Identified Objects in the Image Data. The LAI engines 176, 236 recognizes and prioritizes the Target Identified Objects in order of reliability or consistency as to dimensional data (size and shape) for the Target Identified Objects according to (1) Target Identified Objects having known dimensions and (2) the orientation of the Target Identified Object in one or more captured images. Target Identified Objects with known dimensions may include, but are not limited to articles of manufacture, structural objects, and biological objects. For purposes of this disclosure, articles of manufacture are recognized by the LAI engines 176, 236 as being the most reliable type of objects in regard to dimensional data because such objects are typically manufactured in certain makes and models according to specifications of known and repeatable dimensions. However, where a make and model of an article of manufacture is not readily recognizable, e.g., a Target Identified Object such as used car tire of unknown make and model, the LAI engines 176, 236 will assign less reliable dimensional data to such Target Identified Object. Structural objects may include known objects that may or may not be congruent, such as telephone posts, fencing, towers, dwelling places, commercial property, billboards, etc. Accordingly structural objects are assigned a range of dimensional data less reliable than articles of manufacture. For purposes of this disclosure, biological objects (flora and fauna) are considered the least reliable or least consistent objects regarding dimensional data as persons, animals and plant life can include ranges in size and shape both generally and in different parts of the world. As such, the LAI engines 176, 236 may assign dimensional data to biological objects on a per location basis whereby such Target Identified Objects may be recognized as more reliable objects than otherwise calculated once particular dimensional data is assigned to the Target Identified Objects for particular locations. As an example, an average height may be assigned to an adult male person in The Netherlands and a different average height may be assigned to an adult male person in Japan. Likewise, a mature date palm tree (Phoenix dactylifera) located in the Kingdom of Saudi Arabia may be assigned an average height different from an average height assigned to a mature date palm tree located in North Africa. For purposes of this disclosure, a Target Identified Object captured in an image in a profile view is identified by the LAI engines 176, 236 as more reliable than the same object captured in image distorted due to perspective. As an example, a front passenger door for a certain make and model automobile is regarded as more reliable when captured in a side profile view in an image including a side profile of the whole automobile compared to the same front passenger door being captured at an angle with the captured automobile oriented at a side perspective.

Control then proceeds to a confidence value calculation step 508, wherein a confidence value for each of the Target Identified Objects (the Confidence Values or the CVs) dimensional data is calculated by the LAI engines 176, 236 as a confidence level expressed as a percentile, e.g., 95% confidence value, 70% confidence value, etc., and/or as a percentile confidence value range, e.g., 95%-99% confidence value, 80%-85% confidence value, etc. In the event one or more Target Identified Objects leave the field of view and/or one or more new Target Identified Objects enter the field of view, the LAI engines 176, 236 recalculates the CVs for the Target Identified Objects in the field of view. The LAI engines 176, 236 may calculate CVs according to a default minimum confidence level or users may select a minimum confidence level prior to operation or during operation. Users may also change a minimum confidence level during operation. In military a setting, a minimum confidence level for a Target may depend, at least in part, on the type of munitions being used against the Target.

Control then proceeds to a confidence value ranking step 510, wherein the CVs of each Target Identified Objects for each target are ranked by the LAI engines 176, 236 (the Ranked CVs) from a highest confidence level to a lowest confidence level. Control then proceeds to a search step 512, wherein the LAI engines 176, 236 searches the LDBs for stored item data for one or more items that are identical to or similar as each of the Target Identified Objects (the Items). As an example, the LAI engines 176, 236 may extract three-dimensional information from the LDBs for one or more of the Items.

Control then proceeds to a selected item orientation step 514, wherein each of the Items is size adjusted and spatially oriented to match or correspond to each of the Target Identified Objects (the Size and Orientation Data) using algorithms and routines in the LAI engines 176, 236. In a non-limiting embodiment, the LAI engines 176, 236 may use CNNs to analyze the Target Identified Objects in the Image Data pixel by pixel, extracting various features such as shapes, corners, edges of the one or more Target Identified Objects to assist the LAI engines 176, 236 understand spatial depth and the spatial relationships between different parts of the one or more Target Identified Objects and their relative positions in the Image Data.

Control then proceeds to an object distance determination step 516, wherein distance data for each of the Target Identified Objects based on the Size and Orientation Data (the Target Identified Object Distances) is calculated using algorithms and routines in the LAI engines 176, 236. Control then proceeds to a target distance determination step 518, wherein distance data for each of the Targets is calculated based on the Target Identified Object Distances and the Ranked CVs (the Target Distances) using algorithms and routines in the LAI engines 176, 236. Control then proceeds to a target distance communication step 520, wherein the Target Distances are communicated to one or more image capturing systems 190, 250, 280 of one or more users, one or more devices of one or more other authorized personnel, and combinations thereof.

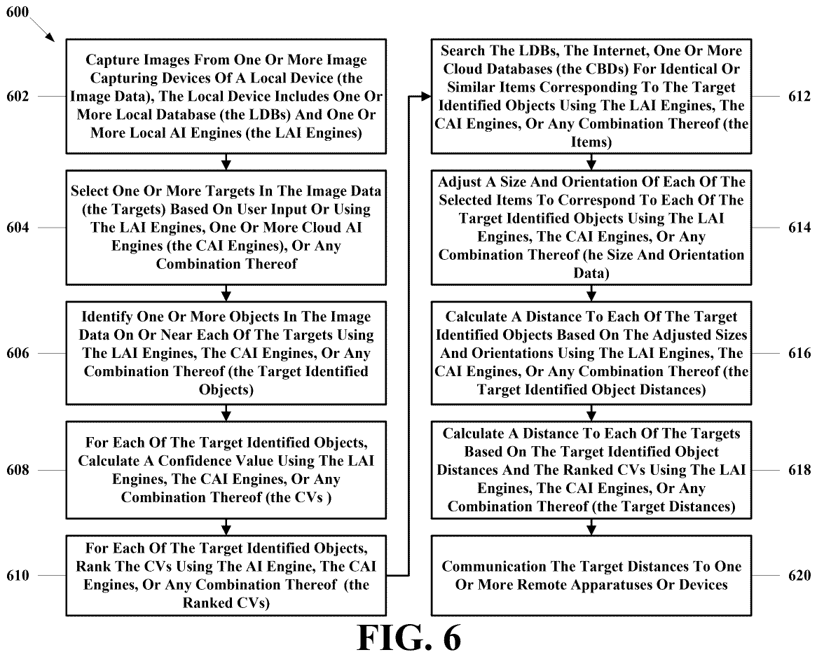

Referring now to FIG. 6, a conceptual flow chart of an embodiment of a device, apparatus, system, or interface and their operation, generally 600, is shown beginning with an image data capturing step 602, wherein one or more image capturing systems 190, 250, 280 of an electronic device or system 150, 200 capture one or more images in in real time, near real time, or periodically and the input image data for the one or more captured images is stored on one or more local databases (the LDBs) on the one or more mass storage devices 158, 258 and continuously observed and analyzed by both one or more local artificial intelligence system or engine 176, 236 (or “LAI engines 176, 236”) and the one or more local item databases 178a (the LDBs), the item searching and selecting software routines 178b, and the other software or executable instructions or routines 178c implementing the system and the LDBs 238a, item searching and selecting software routines 238b, and other software or executable instructions or routines 238c implementing the system, and by one or more artificial intelligence system or AI engines (the DRAI engines) in one or more network/cloud databases (the CDBs) and DRAI engines 130, 298, 305 (the Image Data). As described herein, the storage capacity of the one or more mass storage devices 158, 258 may vary on a per operation basis, but for any operation the storage capacity is sufficient for storing all or a portion of the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system in the LDBs. The Image Data may include one or more still images such as still images captured by a digital still camera and/or the like, one or more images, or frames, from a continuous sequence of images such as video images, or combinations thereof.

Control then proceeds to a target selection step 604, wherein a user or the AI engine 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the one or more network/cloud databases and the one or more AI engines 130, 298, 305 selects one or more targets in the Image Data (the Targets). For example, in an embodiment a captured image or a live video image may be displayed on a display unit 164, 224 and a user may touch the display unit 164, 224 by finger or handheld tool at one or more locations on the display unit 164, 224 corresponding to the Targets shown in the captured image or live video image thereby informing the LAI engines 176, 236 and the CBDs and the DRAI engines 130, 298, 305 as to The Targets in the Image Data.

Control then proceeds to an objects identification step 606, wherein the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the one or more network/cloud databases and the one or more AI engines 310, 298, 305 identify all recognizable objects in the Image Data and compares the recognizable objects in the Image Data to data for items stored on the LDBs and stored on the one or more network/cloud databases and the one or more AI engines 310, 298, 305 (the Target Identified Objects). The data for items stored on the LDB and on the CDBs and the DRAI engines 130, 298, 305 may be gathered from thousands or millions of images of each item from internets and/or intranets and stored on the LDBs in one or more datasets. As an example, where a Target is a person, one or more image recognition algorithms may use deep learning datasets comprising the stored item data to distinguish patterns for the Target Identified Objects in the Image Data. The LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the in the one or more network/cloud databases and the one or more AI engines 310, 298, 305 recognize and prioritize the Target Identified Objects in order of reliability or consistency as to dimensional data (size and shape) for the Target Identified Objects according to (1) Target Identified Objects having known dimensions and (2) the orientation of the Target Identified Object in one or more captured images. Target Identified Objects with known dimensions may include, but are not limited to articles of manufacture, structural objects, and biological objects. For purposes of this disclosure, articles of manufacture are recognized by the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the one or more network/cloud databases and the one or more AI engines 130, 298, 305 as being the most reliable type of objects in regard to dimensional data because such objects are typically manufactured in certain makes and models according to specifications of known and repeatable dimensions. However, where a make and model of an article of manufacture is not readily recognizable, e.g., a Target Identified Object such as used car tire of unknown make and model, the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the AI engine in one or more network/cloud databases and the one or more AI engines 130, 298, 305 will assign less reliable dimensional data to such Target Identified Object. Structural objects may include known objects that may or may not be congruent, such as telephone posts, fencing, towers, dwelling places, commercial property, billboards, etc. Accordingly structural objects are assigned a range of dimensional data less reliable than articles of manufacture. For purposes of this disclosure, biological objects (flora and fauna) are considered the least reliable or least consistent objects regarding dimensional data as persons, animals and plant life can include ranges in size and shape both generally and in different parts of the world. As such, the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or one or more network/cloud databases and the one or more AI engines 130, 298, 305 may assign dimensional data to biological objects on a per location basis whereby such Target Identified Objects may be recognized as more reliable objects than otherwise calculated once particular dimensional data is assigned to the Target Identified Objects for particular locations. As an example, an average height may be assigned to an adult male person in The Netherlands and a different average height may be assigned to an adult male person in Japan. Likewise, a mature date palm tree (Phoenix dactylifera) located in the Kingdom of Saudi Arabia may be assigned an average height different from an average height assigned to a mature date palm tree located in North Africa. For purposes of this disclosure, a Target Identified Object captured in an image in a profile view is identified by the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the one or more network/cloud and the one or more AI engines databases 130, 298, 305 as more reliable than the same object captured in image distorted due to perspective. As an example, a front passenger door for a certain make and model automobile is regarded as more reliable when captured in a side profile view in an image including a side profile of the whole automobile compared to the same front passenger door being captured at an angle with the captured automobile oriented at a side perspective.

Control then proceeds to a confidence value calculation step 608, wherein confidence values for each of the Target Identified Objects (the Confidence Values or the CVs) dimensional data is calculated by the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the one or more network/cloud databases and the one or more AI engines 130, 298, 305 as a confidence value expressed as a confidence value percentile, e.g., 95% confidence value, 70% confidence value, etc., and/or as a percentile confidence value range, e.g., 95%-99% confidence value, 80%-85% confidence value, etc. In the event one or more Target Identified Objects leave the field of view and/or one or more new Target Identified Objects enter the field of view, the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the one or more network/cloud databases and the one or more AI engines 130, 298, 305 recalculate the CVs for the Target Identified Objects in the field of view. The AI engine 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the one or more network/cloud databases and the one or more AI engines 130, 298, 305 may calculate CVs according to a default minimum confidence level or users may select a minimum confidence level prior to operation or during operation. Users may also change a minimum confidence level during operation. In military a setting, a minimum confidence level for a Target may depend, at least in part, on the type of munitions being used against the Target.

Control then proceeds to a confidence value ranking step 610, wherein the CVs of each Target Identified Objects for each target are ranked by the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the one or more network/cloud databases and the one or more AI engines 130, 298, 305 (the Ranked CVs) from a highest confidence level to a lowest confidence level. Control then proceeds to a search step 612, wherein the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the one or more network/cloud databases and the one or more AI engines searches the LDB and the one or more network/cloud 130, 298, 305 databases and/or other collections of networks and/or intranets for stored item data for one or more items that are identical to or similar as each of the Target Identified Objects (the Items). As an example, the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, may extract three-dimensional information from the LDB and/or the one or more network/cloud databases and the one or more AI engines 130, 298, 305 for one or more of the Items.

Control then proceeds to a selected item size and orientation step 614, wherein each of the Items is size adjusted and spatially oriented to match or correspond to each of the Target Identified Objects (the Size and Orientation Data) using algorithms and routines in the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the one or more network/cloud databases and the one or more AI engines 130, 298, 305. In a non-limiting embodiment, the LAI engines 176, 236 and/or the CDBs and the one or more AI engines 130, 298, 305 may use CNNs to analyze the Target Identified Objects in the Image Data pixel by pixel, extracting various features such as shapes, corners, edges of the one or more Target Identified Objects to assist the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the one or more network/cloud databases and the one or more AI engines 130, 298, 305 understand spatial depth and the spatial relationships between different parts of the one or more Target Identified Objects and their relative positions in the Image Data.

Control then proceeds to an object distance determination step 616, wherein distance data for each of the Target Identified Objects based on the Size and Orientation Data (the Target Identified Object Distances) is calculated using algorithms and routines in the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or in the one or more network/cloud databases and the one or more AI engines 130, 298, 305. Control then proceeds to a target distance determination step 618, wherein distance data for each of the Targets is calculated based on the Target Identified Object Distances and the Ranked CVs (the Target Distances) using algorithms and routines in the LAI engines 176, 236 and the LDBs 178a, the item searching and selecting software routines 178b, and the other software or executable instructions or routines 178c implementing the system and the LDBs 238a, item searching and selecting software routines 238b, and other software or executable instructions or routines 238c implementing the system, and/or the one or more network/cloud and the one or more AI engines 130, 298, 350 databases. Control then proceeds to a target distance communication step 620, wherein the Target Distances are communicated to one or more image capturing systems 190, 250, 280 of one or more users, one or more devices of one or more other authorized personnel, and combinations thereof.

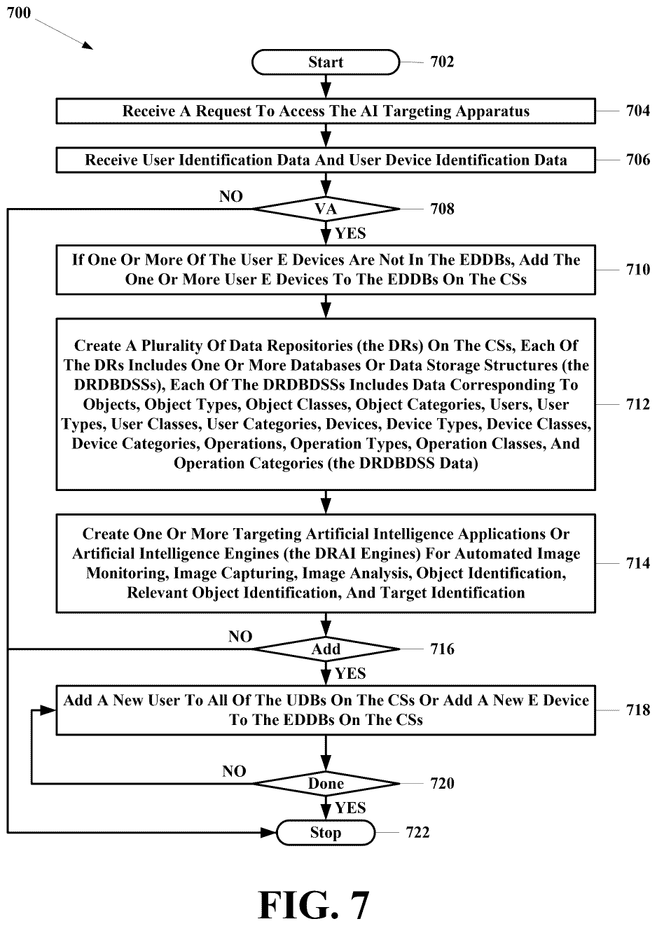

Referring now to FIG. 7, a conceptual flow chart for data structure creation for one or more embodiments of an AI targeting apparatus, system, or application and an interface and a method implementing them of this disclosure (the AI targeting apparatus), generally 700. The AI targeting apparatus comprises: (a) one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system; and (b) one or more cloud servers (the CSs) including one or more user databases (UDBs) including user identification data and one or more E device databases (the EDDBs) including E device identification data. Non-limiting examples of the user identification data may include a user name, a user ID (UID), a Universal Unique Identifier (UUID), or combination thereof, a user password, a phone number, an email address, other user identification information or any combination thereof. A user name may include but is not limited to a full name of a person, initials of a person, a combination of letters, a combination of number, or any combination thereof. The E device identification data comprise a unique identifier assigned to each E device. Non-limiting examples of the E device identification data may include E device manufacturer data, E device serial number data, E device operating system data, Identifier for Advertisers (IDFA) for iOS® devices, Android Advertising ID (AAID) for Android® devices, Google Advertising ID (GAID) for the Google® ecosystem, proprietary Secure ID, Media Access Control address (MAC address), International Mobile Equipment Identity (IMEI) for mobile devices, Universally Unique Identifier (UUID), Item Unique Identification (IUID), Unique Device Identification (UDI), Unique Device Identifier (UDID), or any combination thereof.

The conceptual flow chart 700 includes a start step 702. If the embodiment of the apparatus or system is configured to limit access thereto, then the apparatus or system includes the following introductory steps. The introductory steps include an access request step 704, wherein a potential user (or “accessor”) requests access to the apparatus or system from one or the E devices (the user input E device). Control then proceeds to an identification step 706, wherein the potential user provides user identification data and E device identification data for one or more E devices (the user E devices) under the supervision and/or control of the potential user.

Control then proceeds to a verify/authentication (VA) test step 708, wherein the apparatus or system determines whether the potential user is included in the UDBs. Non-limiting examples of user authentication processes may include verifying passwords, passcodes, usernames, biometric data including fingerprints, hand size and shape, finger sizes and shapes, iris features, iris data stored in iris recognition databases, facial features, facial data stored in facial recognition databases, height, weight, skin color, ethnicity, and any other biometric data associated with an individual, tokens (physical or virtual), certificate-based authentication (CBA), key-based authentication, hardware key authentication, one-time passwords (OTPs), single sign-on (SSO), authentication through mobile devices with methods such as PINs, and combinations thereof. Non-limiting examples of E device authentication processes may include verifying digital certificates (SSL/TLS certificates), device fingerprints, USB security keys, smart card authentication, Network access control (NAC), or any combination thereof. In an embodiment, an E device to be verified and/or authenticated may include an electronic device or system 100 and/or an image capturing system 130 as described in FIG. 1. In an embodiment, an apparatus to be verified and/or authenticated may include an electronic device or system 200 and/or an image capturing system 280 as described in FIG. 2. In an embodiment, an apparatus to be verified and/or authenticated may include an electronic device or system 300 and/or image capturing system 321 as described in FIGS. 3A-3C. In addition to (1) an electronic device or system 100, 200, 300 and (2) an image capturing system 190, 250, 280, 321, one or more other apparatuses may require verification/authentication as may be required. For example, in a military and/or law enforcement type scenario, one or more other apparatuses may include, but are not limited to one or more weapons, one or more weapons systems, one or more computing devices, one or more communication devices, one or more transmitting devices, and combinations thereof.

If the potential user is included in the UBDs, then control proceeds to along a YES path an add user E device step 710, wherein one or more of the user E devices are added to the EDDBs on the CSs; otherwise, control is transferred along a NO path to a stop step 720 denying the potential user access to the apparatus or system.

Control then proceeds to a data repository creation step 712 creates a plurality of data repositories (the DRs) on the CSs, each of the DRs includes one or more databases (the DRDBs) or data storage structures (the DRDSSs) (herein collectively “the DRDBDSSs”). Each of the DRDBDSSs includes data corresponding to objects, object types, object classes, object categories, users, user types, user classes, user categories, apparatuses, apparatus types, apparatus classes, apparatus categories, operations, operation types, operation classes, and operation categories (herein collectively “the DRDBDSS data”).

From the data repository creation step 712, control proceeds to an artificial intelligence application or engine creation step 714, wherein one or more targeting artificial intelligence applications or artificial intelligence engines (the DRAI Engines) for automated image monitoring, image capturing, image analysis, Object identification, Relevant Object identification, and target identification are created. From the artificial intelligence application or engine creation step 714, control proceeds to an add new user or new E device test step 716, wherein one or more new users or one or more new E devices may be added to the UDBs or the EDDBs of the CSs. If a new user or a new E device is to be added, then control proceeds to an add new user or new E device step 718, wherein a new user and new user identification data is added to the UDBs on the CSs, or a new E device and new E device identification data is added to the EDDBs on the CSs. Control then proceeds to a done test step 720, wherein if no more users or E devices are to be added, then control is transferred to the stop step 722; otherwise, control is transferred back to the add new user or new E device step 718.

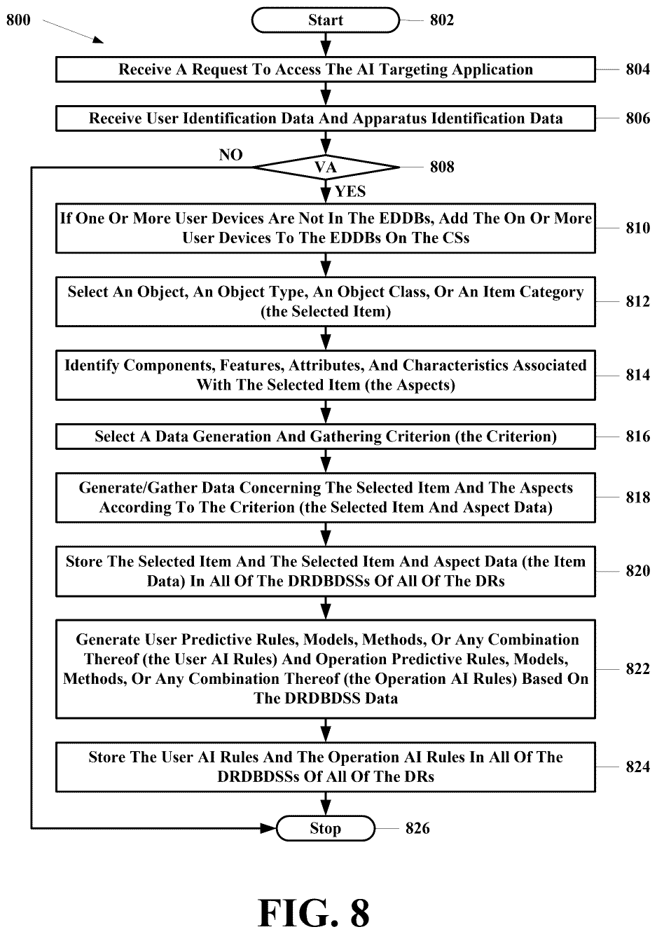

Referring now to FIG. 8, a conceptual flow chart for adding information regarding all conceivable distant objects of interest into the DRDBDSSs (the stored objects) for one or more embodiments of the apparatuses or systems of this disclosure, generally 800, is shown to include a start step 802. If the embodiment of the apparatus or system is configured to limit access thereto, then the AI targeting apparatus include the following introductory steps. The introductory steps include an access request step 804, wherein a potential user (or “accessor”) requests access to the AI targeting apparatus. Control then proceeds to an identification step 806, wherein the potential user provides user identification data and E device identification data for one or more E devices under the supervision and/or control of the potential user as described above in reference to FIG. 7 for one or more E devices under the supervision and/or control of the potential user including an electronic device or system 100, 200, 300 and/or an image capturing system 190, 250, 280, 321.

Control then proceeds to a verify/authentication test (VA) step 808, wherein the AI targeting apparatus determines whether the potential user is included in the UDBs as described above in reference to FIG. 7. If the potential user is included in the UDBs on the CSs, then control proceeds along a YES path to an add user E device step 810, wherein one or more of the user E devices are added to the EDDBs on the CSs; otherwise, control is transferred along a NO path to a stop step 826 denying the potential user access to the AI targeting application.

If the embodiment of the AI targeting apparatus is not configured to limit access thereto, then control proceeds directly to the add user E device step 810. Control then proceeds to an object selection step 812, wherein objects to be stored in the DRDBDSSs of all of the DRs are selected and itemized according to an object, an object type, an object class, and/or an object category (the Selected Item).

Control then proceeds to an object aspect identification step 814, wherein one or more components, features, attributes, characteristics and associated information for each of the Selected Item to be stored in the DRDBDSSs of all of the DRs are identified (the Aspects). The Aspects may include, but are not limited to dimensional data, shape or form type data, color and color pattern type data, make/model data for articles of manufacture, entity behavioral tendencies, entity routines, sensor data, user data, motion data, environmental data, temporal data, contextual data, biometric data, any other object data, or any combination thereof. Control then proceeds to a data generation and gathering criterion selection step 816, wherein specific parameters, patterns, and/or distributions are selected for use in generating and gathering data for each of the Selected Item to be stored in the DRDBDSSs of all of the DRs according to the Aspects of each of the Selected Item (the Criterion). Control then proceeds to a data generating step 818, wherein the Aspects and the Criterion for each Item are used to generate and/or gather data to be stored in the DRDBDSSs of all of the DRs for each Item (the Object Data). For example, Object Data for each Item may be gathered from thousands or millions of images of each Item from internets and/or intranets and stored in the DRDBDSSs of all of the DRs in one or more datasets. Control then proceeds to an object data storage step 820, wherein the Object Data for each Item is stored in the DRDBDSSs of all of the DRs.

Control then proceeds to an AI rule generation step 822, wherein user predictive rules, models, methods, and combinations thereof (the user AI rules) and the operation predictive rules, models, methods, and combinations thereof (the operation AI rules) are generated based on the Object Data for each Item stored in the DRDBDSSs of all of the DRs. Control then proceeds to an AI rules storage step 824, wherein the user AI rules and the operation AI rules are stored in the DRDBDSSs of all of the DRs, and then control proceeds to the stop step 826.

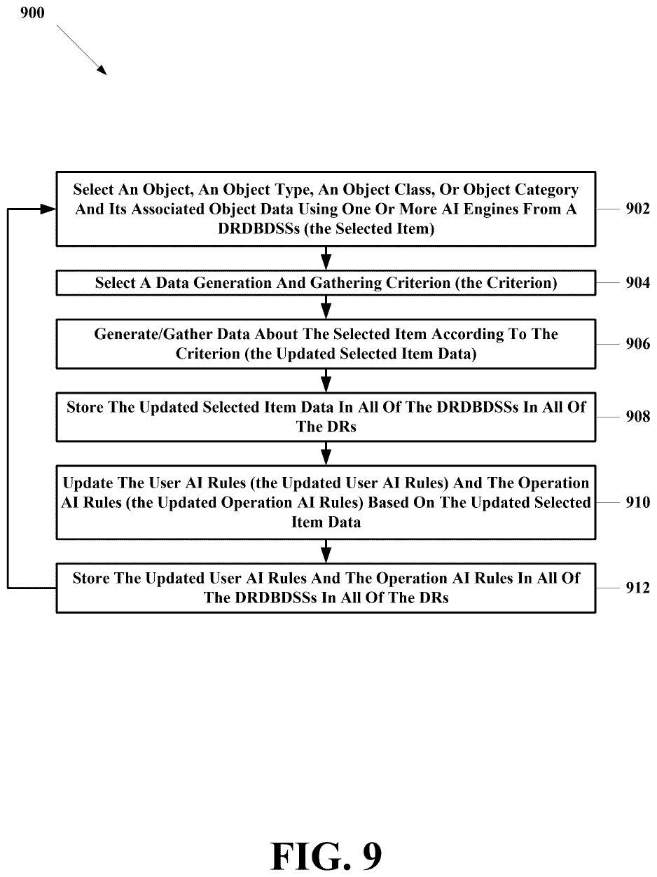

Referring now to FIG. 9, a conceptual flow chart for a ML process for adding objects to the DRDBDSSs and for updating information regarding objects stored in the DRDBDSSs of all of the DRs for one or more embodiments of an AI targeting application of this disclosure, generally 900. In an embodiment, the ML process of this disclosure may run continuously automatically in the background executing operations without any direct user interaction as described in the conceptual flow chart 900. In an embodiment, the ML process of this disclosure may start in conjunction with starting of an AI targeting application and end when the AI targeting application stops.

The ML process includes an item selection step 902, wherein an object and/or an object type and/or an object class and/or an object category and associated Object Data on the DRDBDSSs of all of the DRs is selected for updating (the Selected Item). Control then proceeds to a data generate and data gather criterion selection step 904, wherein specific parameters, patterns, and distributions are selected for use in generating object data for each of the stored objects (the Criterion). Control then proceeds to a data generation step 906, wherein the Criterion are used to generate and/or gather object data concerning the Item (the Updated Selected Item Data). All accessible data structures may be searched to generate the Updated Selected Item Data, including both public and private internets and intranets. For people, the gathered and generated information and data include social media data, relationship data, biometric data such as fingerprints, hand size and shape, finger sizes and shapes, iris features, iris data stored in iris recognition databases, facial features, facial data stored in facial recognition databases, height, weight, skin color, ethnicity, any other biometric data associated with an individual, and any other data specific to the individual.

Control then proceeds to a data storage step 908, wherein the Updated Selected Item Data are stored in all of the DRDBDSSs of all of the DRs. Control then proceeds to an AI rule update step 910, wherein the user AI rules stored in all of the DRDBDSSs of all of the DRs are updated (the Updated User AI Rules) and the operation AI rules stored in all of the DRDBDSSs of all of the DRs are updated (the Updated Operation AI Rules) based on the Updated Selected Item Data. Control then proceeds to an AI rule store step 912, wherein the Updated User AI rules and the Updated Operation AI rules are stored in all of the DRDBDSSs of all of the DRs. Control then proceeds back to the item selection step 902.

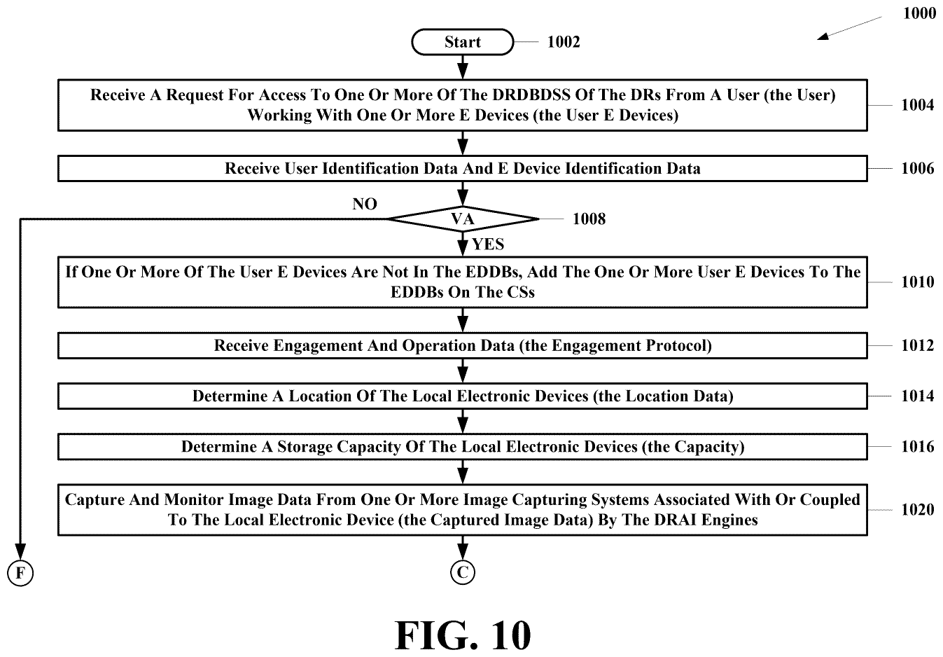

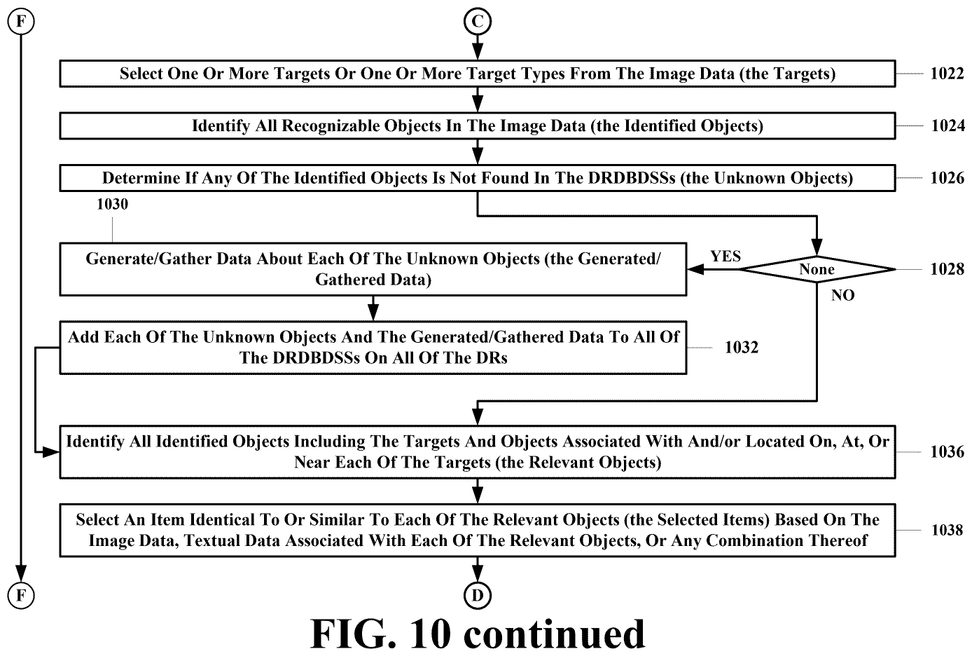

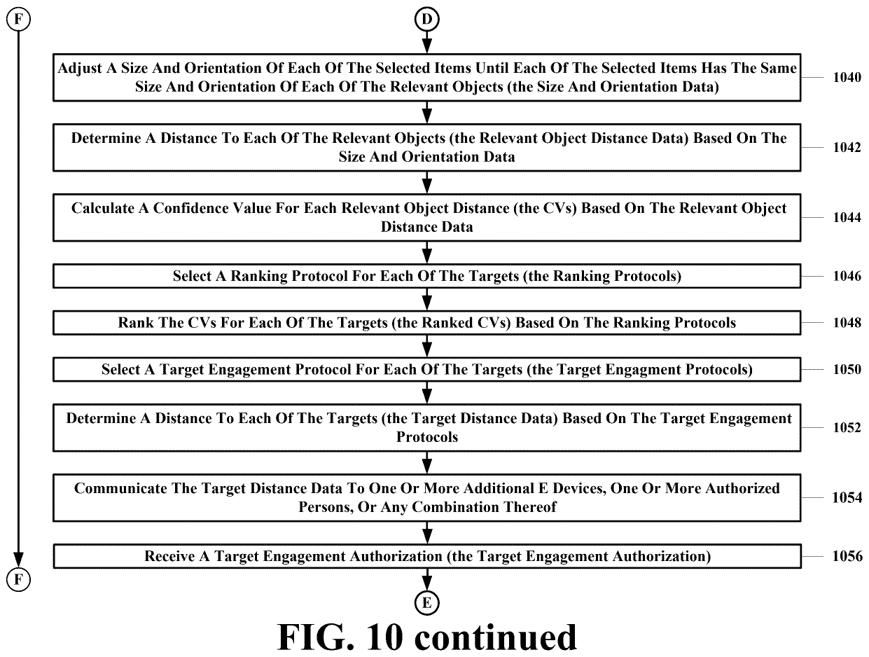

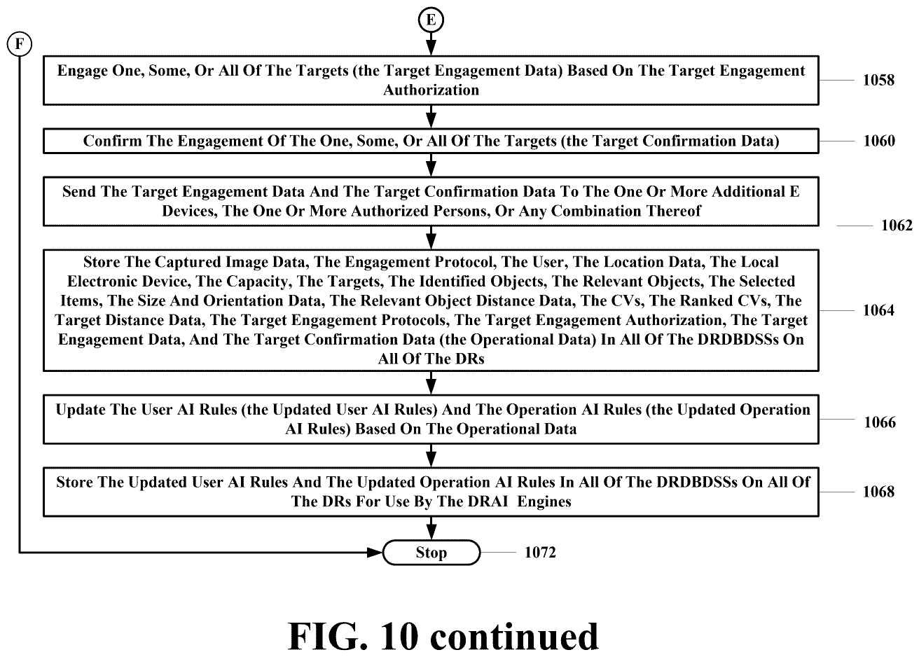

Referring now to FIG. 10, a conceptual flow chart of an embodiment of an AI targeting apparatus, system, or application and an interface or a method implementing them (the AI Targeting Apparatus), generally 1000, is shown to include a start step 1002. If the embodiment of the AI targeting apparatus is configured to limit access thereto, then the AI targeting apparatus includes the following introductory steps. The introductory steps include an access request step 1004, wherein a potential user (or “accessor”) requests access to the AI targeting apparatus. Control then proceeds to an identification step 1006, wherein the potential user provides user identification data and E device identification data for one or more E devices under the supervision and/or control of the potential user as described above in reference to FIG. 7 for one or more E devices under the supervision and/or control of the potential user including an electronic device or system 100, 200, 300 and/or an image capturing system 190, 250, 280, 321.

Control then proceeds to a verify/authentication test (VA) step 1008, wherein the AI targeting apparatus determines whether the potential user is included in the UDBs as described above in reference to FIG. 7. If the potential user is included in the UDBs on the CSs, then control proceeds along a YES path to an add user E device step 1010, wherein one or more of the user E devices are added to the EDDBs on the CSs; otherwise, control is transferred along a NO path via the circled F continuation marker to a stop step 1072 on another page of FIG. 10 denying the potential user access to the AI targeting application. It should be recognized that the VA test step 1008 may grant the user and the local electronic devices under control of the user full access to all information and data in all of the DRDBDSSs of all of the DRs or the VA test step 1008 may grant limited access to the information and data in all of the DRDBDSSs of all of DRs, wherein the limited grant may be based on the user, the local electronic devices, or the use to which the user intended to use the AI targeting apparatus of this disclosure.

If the embodiment of the AI targeting apparatus is not configured to limit access thereto, then the AI targeting apparatus proceeds directly to the add user E device step 1010. Control then proceeds to an engagement and operation data receiving step 1012 receives engagement data and/or operation data for one or more intended operations is input into the AI targeting apparatus and/or generated by the AI targeting apparatus are configured to detail one or more tasks to be performed by a user and/or the local electronic devices (the Engagement Protocol). Engagement data and operation data may be general in nature and/or specific in nature. In general, engagement data includes a collection of information detailing the actions and interactions of one or more users of an electronic device or system 100, 200, 300 with one or more targets. In general, operation data includes a collection of information related to planning, executing and analyzing interactions of users of local electronic devices at least one being an electronic device or system 100, 200, 300 with one or more targets. For military and/or law enforcement type scenarios, non-limiting examples of engagement data may include rules of engagement, including authorized ordnance and/or munitions, intended or anticipated targets, specified level or degree of damage to target, appropriate responses to targets, target locations, prioritization of targets, and combinations thereof; and non-limiting examples of operation data may include objectives, desired end states, mission sets, operational environments, operational terrains, target capabilities analysis, and combinations thereof. In such exemplary scenarios, engagement data and/or operation data may originate from high command and/or field command and/or users in the field of operation and/or generated by the AI engines. For hunting type scenarios, non-limiting examples of engagement data may include (1) lawful activities including lawful means and methods, authorized weaponry including authorized firearms, air guns, arrow guns, archery, crossbows, falconry, and (2) unlawful activities; and non-limiting examples of operation data may include licensing requirements, restricted areas, permissible animals to hunt, dates and/or periods of time for a particular hunting activity, tagging requirements. In such scenarios, as an example, engagement data and/or operation data may originate from one or more governmental and/or regulatory sources, a user hunting one or more particular game and/or from the AI engines. Other non-limiting scenarios may include surveillance type scenarios including aerial surveillance type scenarios, security type scenarios, surveying type scenarios, sporting activities such as golf. For an activity such as golfing, engagement data and operation data may be limited or focused in scope, e.g., focused to the ranging of flags on greens to determine a distance to a hole or pin for each flag for a user (golfer) during course play.

Control then proceeds to a location determination step 1014, wherein location information or data for a user and/or the user E devices (the Location) for one or more intended operations may be input into the AI targeting application or determined by information including GPS coordinates, IP addresses, nearby Wi-Fi® networks, cell tower signals, visual features from images captured by an image capturing system 190, 250, 280, 321 (the Captured Images), and combinations thereof, e.g., one or more cloud artificial intelligence applications or engines (the DRAI engines) of the AI targeting apparatus may triangulate a most probable location of a user and/or an apparatus based on the information, wherein location accuracy may be increased through data analysis of historical location patterns and environmental factors such as weather data and/or traffic data.

Control then proceeds to a storage capacity determination step 1016, wherein the storage capacity for one or more of the local electronic devices is sufficient for storing the image data from the one or more image capturing devices. Control then proceeds to an image monitoring step 1020, wherein input image data for one or more images captured by an image capturing system 190, 250, 280, 321 is continuously monitored, observed, and analyzed by the one or more data repository AI applications or engines (the DRAI engines) associated with all of the DRs, and then control is transferred to a continuation step circled C on another page of FIG. 10, and then to a target selection step 1022.

At the target selection step 1022, the user or the DRAI engines selects one or more targets or target types in the one or more Captured Images. Once the one or more targets or target types are selected (the Targets), control then proceeds to a recognizable object identification step 1024, wherein all recognizable objects in the one or more Captured Images are identified (the Identified Objects) that will later be compared by the DRAI engines to Items stored the DRDBDSSs of all of the DRs. As an example, where one of the Targets is a person, the DRAI engines are configured to use one or more image recognition algorithms to create deep learning datasets comprising the Object Data for each Item to distinguish patterns for the Identified Objects in the one or more Captured Images. In another embodiment, the one or more image recognition algorithms may be configured to review all images one, some, or all of the DRDBDSSs of all of the DRs, or any combination thereof and determine a common or consistent appearance of an image of a particular Item therein and also to identify uncommon or inconsistent appearances of an image of the particular Item therein. In limited visibility conditions including, without limitation, whiteouts, heavy rain, heavy snow, fog, dust storms, sandstorms, hurricanes, tornadoes, or any combination thereof, the DRAI engines using data from various image capturing devices capable of detecting light of various wavelengths including visible light, ultraviolent light, infrared light, short wavelength infrared light, any other light wavelength, may not be capable of detecting any recognizable objects. Also, the DRAI engines may be further configured to detect recognizable objects influenced by depth of field limitations of one or more of the one or more Captured Images, wherein one or more objects in one or more Captured Images may be out of focus. As such, where the one or more Captured Images include continuous sequence of images including change to the depth of field, as one or more out of focus objects come into focus with a change in depth of field, the DRAI engines can then recognize such objects as Identified Objects and detect or determine variations in the Aspects for the Identified Objects from both in focus and out of focus images.

Control then proceeds to an unknown object determination step 1026, wherein the DRAI engines are configured to determine whether any of the Identified Objects are not found in any of the DRDBDSSs of all of the DRs (the Unknown Object or Objects). Control then proceeds to an unknown object determination test step 1028, wherein if there are any Unknown Objects then control proceeds along a YES path to an unknown object data generate/gather step 1030; otherwise, control is transferred along a NO path to an identified object identification step 1036.

At the unknown object data generate/gather step 1030, aspects and criterion are generated and/or gathered for each of the Unknown Objects (the Generated/Gathered Data), which is used to generate and/or gather Object Data for each of the Unknown Objects. As an example, the DRAI engines can use one or more components, features, attributes, characteristics, and associated information as described above to generate and assign Aspects to each of the Unknown Objects. All accessible data structures may be searched to generate data for each of the unknown objects, including both public and private internets and intranets.

Control then proceeds to an unknown object addition step 1032, wherein each of the Unknown Objects and the Generated/Gathered Data are added to all of the DRDBDSSs of all of the DRs becoming the Object Data for each of the Unknown Objects. Control then proceeds the identified object identification step 1036, wherein all known Identified Objects in the one or more Captured Images including the Targets and objects associated with and/or located on, at, or near each of the Targets are identified (the Relevant Objects). Herein, an Identified Object associated with one or more of the Targets may also be referred to as an (Associated Object). An Associated Object may include an Identified Object that is used with or in relation to a particular Target, e.g., (1) an Associated Object may be a flag or banner attached to a rope or halyard of a flagpole Target; (2) an Associated Object may be a deer feeder for a deer Target; (3) an Associated Object may be an inlet valve for a fluid container Target. Herein, an Identified Object located nearest one or more of the Targets may also be referred to as a (Closer Distance Object). In an embodiment, a Closer Distance Object may include one or more Identified Objects attached to or otherwise in contact with a particular Target. Examples of Closer Distance Objects include, without limitation, (1) a military insignia located on clothing worn by a human Target, (2) a patch located on clothing worn by a human Target; (3) a park bench on which a human Target is sitting; (4) a vehicle in which a human Target is sitting; (5) a firearm held by a human Target; (5) an insect located on a face or other part of a human Target; (6) a ladder leaning on a vehicle Target; (7) an object resting on a vehicle Target; (8) any other object affixed to a Target, attached to a Target, located on a Target, associated with a Target; or (9) any combination thereof.

Control then proceeds to an item selection step 1038, wherein the DRAI engines search the Object Data for each of the Relevant Objects for an Item from the Items in any of the DRDBDSSs of all of the DRs that is identical to or similar to that Relevant Object (based on one or more similarity routines in the DRAI engines) (the Selected Items) including size and shape related information for the Selected Items extracted from the DRDBDSSs of all of the DRs. As an example, the DRAI engines may be configured to extract three-dimensional information from any of the DRDBDSSs of all of the DRs for one or more of the Selected Items. Control is then transferred to a continuation step circled D on another page of FIG. 10, and then proceeds to an adjust selected item sizing and orientation step 1040.

At the adjust selected item size and orientation step 1040 the each of the Selected Items is size adjusted and spatially oriented to match or correspond to each of the Relevant Objects (the Size and Orientation Data). In a non-limiting embodiment, the DRAI engines may be configured to use convolutional neural network (CNNs) to analyze the Relevant Objects in one or more Captured Images pixel by pixel, extracting various features such as shapes, corners, edges of the one or more of the Relevant Objects to improve the DRAI engines capability to analyze spatial depth and the spatial relationships between different parts of the one or more of the Relevant Objects and their relative positions in one or more of the Captured Images.

Control then proceeds to a distance determination step 1042, wherein distance data for each of the Relevant Objects is determined based on the Size and Orientation Data of each of the Relevant Objects as matched from the Size and Orientation Data of the Selected Items (the Relevant Object Distance Data). In an embodiment where one or more Captured Images include the Relevant Objects at different angles as captured via a plurality of image capturing systems 190, 250, 280, 321 at a plurality of locations, the DRAI engines are configured to calculate depth of each of the Relevant Objects by measuring disparity between the Relevant Objects in each of the one or more Captured Images.

Control then proceeds to a confidence value calculation step 1044, wherein a confidence value is calculated for each of the Relevant Object Distance Data and generally expressed as a percentile, e.g., 95% confidence value, 70% confidence value, etc., and/or as a percentile confidence value range, e.g., 95%-99% confidence value, 80%-85% confidence lever, etc. (the CVs) using algorithms or routine in the DRAI engines. The highest confidence value is realized for Identified Objects that are located directly on a Target or touching a Target as described above in the examples of a Closer Distance Object. In a scenario, a Closer Distance Object may be located out in front of a Target at a distance from an image capturing system 190, 250, 280, 321 less than the Target or vice versa, wherein the DRAI engines may be configured to use one or more other Identified Objects, including shadows of any Identified Objects and/or any Unknown Objects, to calculate depth estimation between the Closer Distance Object and the Target. As such, in a scenario where the Object Data for a particular Relevant Object may render a confidence value for the Relevant Object of 99% or greater when a Relevant Object is located adjacent a Target, i.e., located at a similar depth as a Target from an image capturing system 190, 250, 280, 321, if and when there is a difference in depth between the Relevant Object and the Target, then the confidence value for the Relevant Object decreases.

Control then proceeds to a ranking protocol selection step 1046, wherein for each of the Targets, a ranking protocol based on percentile rank or percentile rank range of the Relevant Objects is selected (the Ranking Protocols). For example, in an embodiment the Ranking Protocols may be selected in increments of five percentage points, e.g., 95% or greater, 90%-94%, 85%-89%, 80%-84%, etc., or other increments as desired. Also, ranking protocols of Relevant Objects for different types of Targets may vary. As an example, in military or law enforcement sniping activities accurate ranging of an enemy combatant Target is crucial as it allows a sniper to calculate bullet drop to hit the Target at long distances, e.g., 90.0 meters or greater. Thus, an enemy combatant Target may require the Ranking Protocols including a CV of 99% or greater. Whereas, for perimeter security purposes where a user wants to determine a distance of a person or animal Target near a perimeter, an estimated distance of the Target to the perimeter may suffice requiring the Ranking Protocols including a CV of only 75% or greater. In addition, a particular type of Target may require a different Ranking Protocol for Relevant Objects according to a particular Engagement Protocol. As an example, where a user such as a sniper may require a Ranking Protocol including CVs of 99% or greater for determining a distance to a person such as an enemy combatant, a user such as a border patrol agent may require a lower Ranking Protocol including CVs of 90% or greater for determining the distance of a person located near a border patrolled by the border patrol agent.

Control then proceeds to a confidence value ranking step 1048, wherein the CVs of each of the Relevant Objects for each of the Targets are ranked in accord with the Ranking Protocols to form ranked Relevant Object CVs (the Ranked CVs). For example, in an embodiment of the Ranking Protocol ranks the CVs in increments of five percentage points, Relevant Objects with a confidence level of 95% or greater are placed in a 95%-99% confidence level range of the Ranking Protocol. With the CVs of each of the Relevant Objects for each of the Targets ranked, control then proceeds to a target distance engagement protocol selection step 1050, wherein a determination is made as to how many of the Ranked CVs are to be used in calculating a distance to each of the Targets (the Target Engagement Protocols) using algorithms and routines in the DRAI engines. Said another way, a determination is made as to how many of the Ranked CVs are to be used in calculating a distance to a Target beginning with the highest of the Ranked CVs down, e.g., only use the Ranked CVs of 85% or greater to calculate a distance to a Target using algorithms and routines in the AI engines. The Target Engagement Protocols may vary according to a particular Engagement Protocol.

Control then proceeds to a target distance determination step 1052, wherein the Target Engagement Protocol for each of the Targets is used to determine distance data for each of the Targets, i.e., to determine a distance of each of the Targets from the image capturing system 190, 250, 280, 321 (the Target Distance Data) using algorithms and routines in the DRAI engines. Control then proceeds to a target distance communication step 1054, wherein the Target Distance Data for each of the Targets is communicated to one or more devices including the one or more electronic devices or systems 100, 200, 300 of one or more users, the one or more devices of one or more other authorized personnel, or combinations thereof. In a non-limiting example, in a military scenario Target Distance Data for each of the Targets may be communicated to (1) the electronic devices or systems 100, 200, 300 for one or more special operations units, (2) one or more authorized personnel including, for example, command and control and/or one or more field officers, or any combination thereof.

It should be recognized that in certain embodiments, the protocols steps may be optional as the apparatuses or system and the interfaces and methods implements them may be preconfigured to use a standard set of protocols depending on the Targets or Target Types.

Control then proceeds to a target engagement authorization step 1056, wherein instructions on how and when to engage each of the Targets are communicated to one or more users of an electronic device or system 100, 200, 300. Control is then transferred to a continuation step circled E on another page of FIG. 10, and then to an engagement step 1058, wherein one, some or all of the Targets are engaged at one or more points in time based on the Target engagement authorization instructions (the Target Engagement Data).

Control then proceeds to a target engagement confirmation step 1060, wherein the Target Engagement Data is input into the AI targeting application and/or generated by the AI engines, wherein the DRAI application or DRAI engines are configured to detail success or failure of engagement according to an assessment of whether stated objectives were achieved, i.e., whether or not the engagement was carried out as instructed (the Target Confirmation Data). As an example, in a military scenario the Target Confirmation Data may comprise data including, but not limited to the total number of participants that engaged each Target, the type(s) of weapons and total number of weapons used during the engagement, Target casualties, Target destruction, Target damage and/or disablement, civilian casualties, the total elapsed time to execute an engagement, time(s) of day engagement was carried out, the amount of munition used during the engagement, and combinations thereof. Control then proceeds to a target confirmation data communication step 1062, wherein the Target Confirmation Data is communicated or sent to one or more devices including one or more electronic devices or systems 100, 200, 300 of one or more users, one or more devices of one or more other authorized personnel, or combinations thereof.

Control then proceeds to a data storage step 1064, wherein the image data, the engagement protocol, the user, the location, the Local Electronic Device, the capacity, the targets, the identified objects, the relevant objects, the Selected items, the Size and Orientation Data, the relevant object distance data, the CVs, the ranked CVs, the target distance data, the target engagement authorization, the target engagement data, and the target confirmation data (the operational data) are stored in all of the DRDBDSSs on all of the DRs. The Operational Data may also be stored in real-time in a continuous manner as generated at any of the previous steps described above. The data stored may also include one, some, or all of the Image Data, one, some, or all of the Engagement Protocol, one, some, or all of the users, one, some, or all of the Locations, one, some, or all of the Devices or Apparatuses, one, some, or all of the Capacities, one, some, or all of the Targets, one, some, or all of the Identified Objects, one, some, or all of the Relevant Objects, one, some, or all of the Selected Items, the Size and Orientation Data, one, some, or all of the Relevant Object Distances Data, one, some, or all of the CVs, one, some, or all of the Ranked CVs, one, some, or all of the Target Distances Data, the Target Engagement Authorization, the Elimination Targets, one, some, or all of the Target Engagement Data, and one, some, or all of the Target Confirmation Data.

Control then proceeds to an AI Rule update step 1066, wherein the user AI rules, models, and/or methods are updated (the Updated User AI Rules) and the operation AI rules, models, and/or methods are updated (the Updated Operation AI Rules) based on the Operational Data stored in the DRDBDSSs of all of the DRs, or any combination thereof. Control then proceeds to an updated AI rule storage step 1068, wherein the Updated User AI Rules and the Updated Operation AI Rules are stored in all of the DRDBDSSs on all of the DRs for use by the DRAI engines. The Operational Data, the Updated User AI Rules and the Updated Operations AI Rules may be downloaded in a continuous manner as generated. Control then proceeds to the stop step 1072, wherein the application is terminated via invoking a stop command, turning the apparatus or device 100 off, or changing locations.

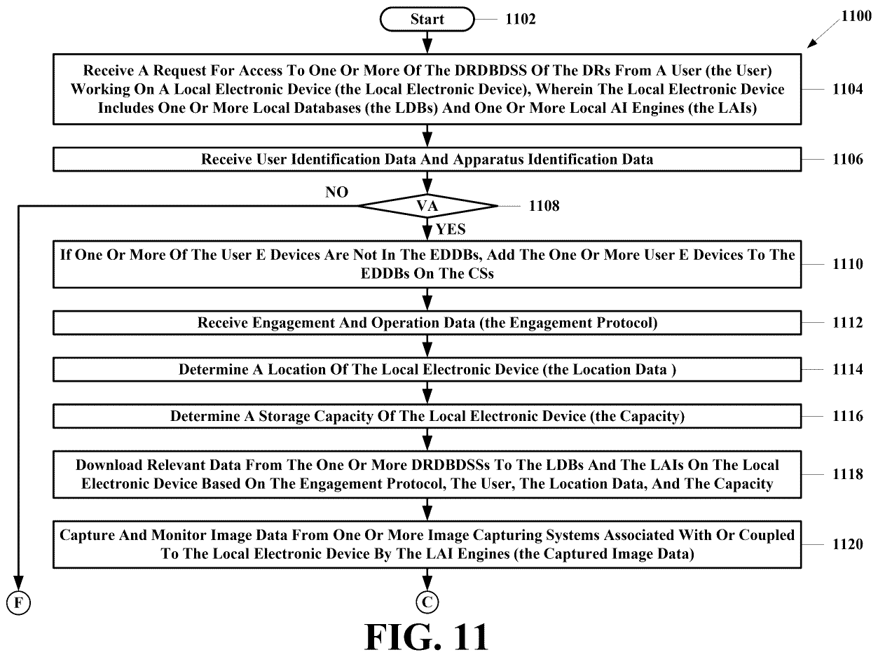

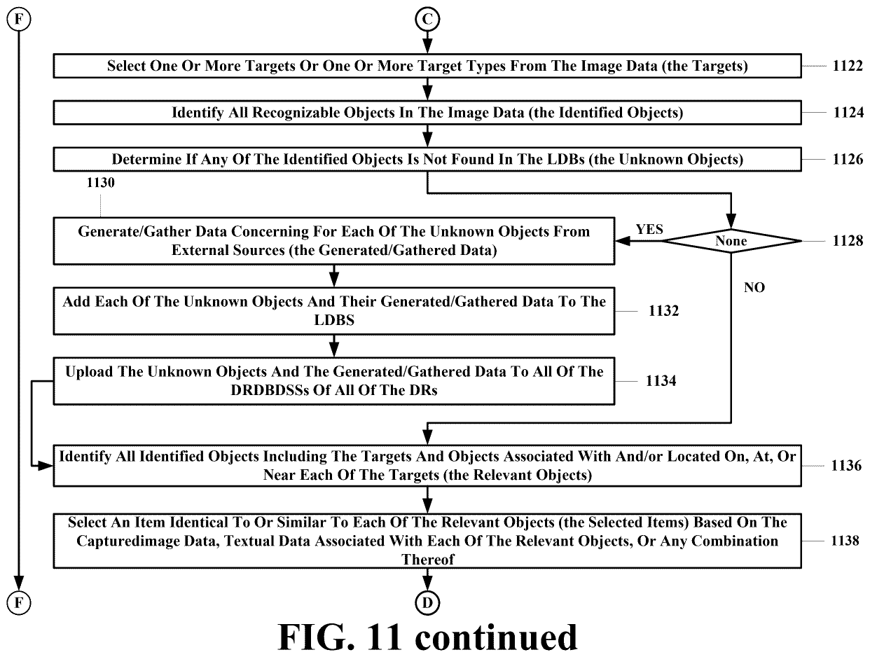

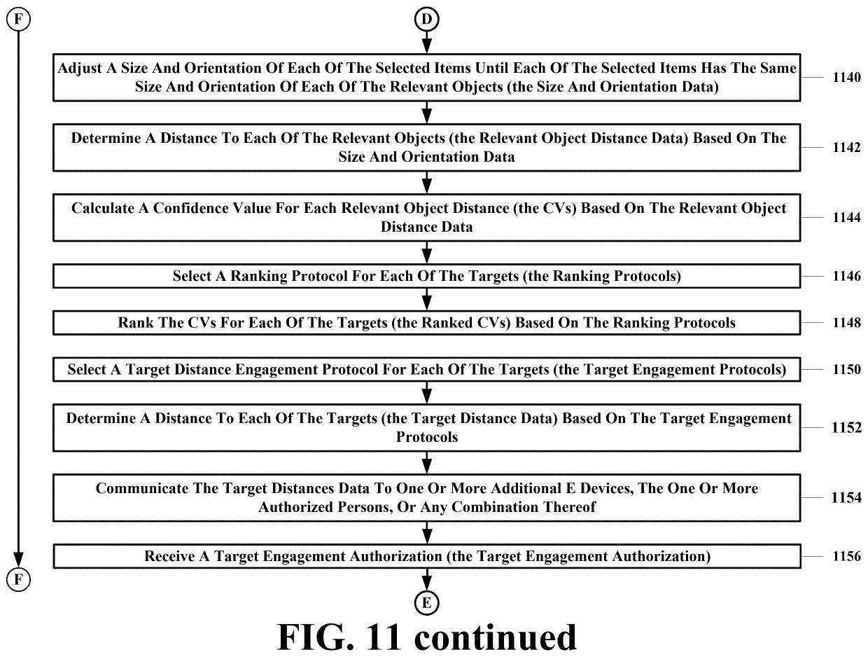

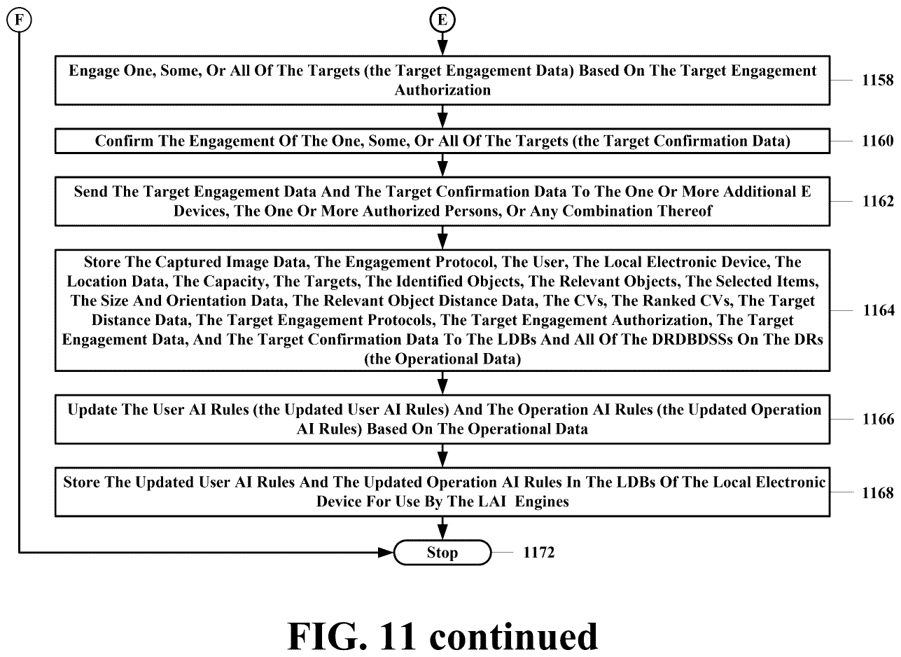

Referring now to FIG. 11, a conceptual flow chart of an embodiment of an AI targeting apparatus, system, or application and an interface or a method implementing them (the AI Targeting Apparatus), generally 1100, is shown to include a start step 1102. If the embodiment of the AI Targeting Apparatus is configured to limit access thereto, then the AI Targeting Apparatus the following introductory steps. The introductory steps include an access request step 1104, wherein a potential user (or “accessor”) requests access to the AI targeting apparatus. Control then proceeds to an identification step 1106, wherein the potential user provides user identification data and E device identification data for one or more E devices under the supervision and/or control of the potential user as described above in reference to FIG. 7 for one or more E devices under the supervision and/or control of the potential user including an electronic device or system 100, 200, 300 and/or an image capturing system 190, 250, 280, 321.

Control then proceeds to a verify/authentication test (VA) step 1108, wherein the AI targeting apparatus determines whether the potential user is included in the UDBs as described above in reference to FIG. 7. If the potential user is included in the UDBs on the CSs, then control proceeds along a YES path to an add user E device step 1110, wherein one or more of the user E devices are added to the EDDBs on the CSs; otherwise, control is transferred via the circled F continuation marker to a stop step 1172 on another page of FIG. 11 denying the potential user access to the AI targeting application. It should be recognized that the VA test step 1108 may grant the user and the local electronic device under control of the user full access to all information and data in all of the DRDBDSSs and of all of the DRs or the VA test step 1108 may grant limited access to the information and data in all of the DRDBDSSs of all of DRs, wherein the limited grant may be based on the user, the local electronic devices, or the use to which the user intended to use the AI targeting application of this disclosure.

If the embodiment of the AI targeting apparatus is not configured to limit access thereto, then the AI targeting apparatus proceeds directly to the add user E device step 1110. Control then proceeds to an engagement and operation data receiving step 1112, receives engagement data and/or operation data for one or more intended operations is input into the AI targeting application and/or generated by the AI targeting application are configured to detail one or more tasks to be performed by a user and/or the local electronic device (the Engagement Protocol). Engagement data and operation data may be general in nature and/or specific in nature. In general, engagement data includes a collection of information detailing the actions and interactions of one or more users of an electronic device or system 100, 200, 300 with one or more targets. In general, operation data includes a collection of information related to planning, executing and analyzing interactions of users of local electronic devices at least one being an electronic device or system 100, 200, 300 with one or more targets. For military and/or law enforcement type scenarios, non-limiting examples of engagement data may include rules of engagement, including authorized ordnance and/or munitions, intended or anticipated targets, specified level or degree of damage to target, appropriate responses to targets, target locations, prioritization of targets, and combinations thereof; and non-limiting examples of operation data may include objectives, desired end states, mission sets, operational environments, operational terrains, target capabilities analysis, and combinations thereof. In such exemplary scenarios, engagement data and/or operation data may originate from high command and/or field command and/or users in the field of operation and/or generated by the LAI Engines (or the “LAIs”). For hunting type scenarios, non-limiting examples of engagement data may include (1) lawful activities including lawful means and methods, authorized weaponry including authorized firearms, air guns, arrow guns, archery, crossbows, falconry, and (2) unlawful activities; and non-limiting examples of operation data may include licensing requirements, restricted areas, permissible animals to hunt, dates and/or periods of time for a particular hunting activity, tagging requirements. In such scenarios, as an example, engagement data and/or operation data may originate from one or more governmental and/or regulatory sources, a user hunting one or more particular game and/or from the LAIs. Other non-limiting scenarios may include surveillance type scenarios including aerial surveillance type scenarios, security type scenarios, surveying type scenarios, sporting activities such as golf. For an activity such as golfing, engagement data and operation data may be limited or focused in a scope, e.g., focused to the ranging of flags on greens to determine a distance to a hole or pin for each flag for a user (golfer) during course play.

Control then proceeds to a location determination step 1114, wherein location information or data for the user and/or the local electronic device for one or more intended operations may be input into the AI targeting application or determined by information including GPS coordinates, IP address, nearby Wi-Fi® networks, cell tower signals, visual features from images captured by an image capturing system 190, 250, 280, 321 (the Captured Images), and combinations thereof, e.g., the LAIs of the AI targeting application may triangulate a most probable location of a user and/or an apparatus based on the information, wherein location accuracy may be increased through data analysis of historical location patterns and environmental factors such as weather data and/or traffic data.

Control then proceeds to a storage capacity determination step 1116, wherein the storage capacity for the local electronic device is sufficient for storing all or a portion of the DRAI engines and the DRDBDSSs content of the AI targeting application in the LDBs and the LAIs. Control then proceeds to a relevant data download step 1118 wherein relevant data is downloaded in a continuous manner from all of the DRDBDSSs of all of the DRs to the LDBs and the LAIs of the electronic device 100, 200, 300 based on the capacity of the electronic device. Relevant data may include, but is not limited to, engagement data and/or operation data, the verified user, the identified location of the user and/or the electronic device 100, 200, 300, the storage capacity of the electronic device 100, 200, 300 and/or an image capturing system 190, 250, 280, 321, and combinations thereof. As an example, for a particular operation such as a military operation, only the object data germane to the particular location of the operation may be necessary for storage on the LDBs, e.g., Object Data as to enemy combatants and related equipment as well as Object Data for each Item commonly found in the location. Continuous downloading of relevant data onto the LDBs ensures that the best possible information is provided for use in real-time and/or near real-time. The LAIs of the AI targeting application may also remove any duplicate data from the LDBs. Control then proceeds to an image monitoring step 1120, wherein input image data for one or more images captured by an image capturing system 190, 250, 280, 321 is continuously monitored, observed, and analyzed by the LAIs, and then control is transferred to a continuation step circled C on another page of FIG. 11, and then to a target selection step 1122.

At the target selection step 1122, the user or the LAIs selects one or more targets or target types (the Targets) in the one or more Captured Images. Once the Targets are selected, control then proceeds to a recognizable object identification step 1124, wherein all recognizable objects in the Captured Images are identified (the Identified Objects) that will be later be compared by the LAIs to Items stored on the LDBs and/or on the DRDBDSSs of all of the DRs. As an example, where one of the Targets is a person, the LAIs are configured to use one or more image recognition algorithms may use deep learning datasets comprising the Object Data for each Item to distinguish patterns for the Identified Objects in the Captured Images. In another embodiment, the LAIs using the one or more image recognition algorithms may be configured to review all images stored in the LDBs, in one, some, or all of the DRDBDSSs of all of the DRs, or any combination thereof and determine a common or consistent appearance of an image of a particular Item therein and also to identify uncommon or inconsistent appearances of an image of the particular Item therein. In limited visibility conditions including, without limitation, whiteouts, heavy rain, heavy snow, fog, dust storms, sandstorms, hurricanes, tornadoes, or any combination thereof, the LAIs using data from various image capturing devices capable of detecting light of various wavelengths including visible light, ultraviolent light, infrared light, short wavelength infrared light, any other light wavelength, may not be capable of detecting any recognizable objects. Also, the LAIs may be further configured to detect recognizable objects influenced by depth of field limitations of one or more of the Captured Images, wherein one or more objects in one or more Captured Images may be out of focus. As such, where the Captured Images include continuous sequence of images including change to the depth of field, as one or more out of focus objects come into focus with a change in depth of field, the LAIs can then recognize such objects as Identified Objects and detect or determine variations in the Aspects for the Identified Objects from both in focus and out of focus images.

Control then proceeds to an unknown object determination step 1126, wherein the LAIs are configured to determine whether any of the Identified Objects are not found in any of the LDBs, and/or any of the DRDBDSSs of all of the DRs (the Unknown Object or Objects). Control then proceeds to an unknown object determination test step 1128, wherein if there are any Unknown Objects then control proceeds along a YES path to an unknown object data gathering step 1130; otherwise control is transferred along a NO path to an identified object identification step 1136.

At the unknown object data generation step 1130, Aspects and Criterion are generated and/or gathered for each of the Unknown Objects (the Generated/Gathered Data), which is used to generate and/or gather Object Data for each Unknown Object. As an example, the LAIs can use one or more components, features, attributes, characteristics, and associated information as described above to generate and assign Aspects to each of the Unknown Objects. All accessible data structures may be searched to generate data for each of the unknown objects, including both public and private internets and intranets.

Control then proceeds to an unknown object addition step 1132, wherein the each of the Unknown Objects and the Generated/Gathered Data are added to the LDBs becoming the Object Data for each of the Unknown Objects. Control then proceeds to an uploading step 1134, wherein each of the Unknown Objects and the Object Data are uploaded from the electronic device or system 100, 200, 300 to all of the DRDBDSSs of the DRs. Control then proceeds to the identified object identification step 1136, all known Identified Objects in the Captured Images including the Targets and objects associated with and/or located on, at, or near each of the Targets are identified (the Relevant Objects). Herein, an Identified Object associated with one or more of the Targets may also be referred to as an (Associated Object). An Associated Object may include an Identified Object that is used with or in relation to a particular Target, e.g., (1) an Associated Object may be a flag or banner attached to a rope or halyard of a flagpole Target; (2) an Associated Object may be a deer feeder for a deer Target; (3) an Associated Object may be an inlet valve for a fluid container Target. Herein, an Identified Object located nearest one or more of the Targets may also be referred to as a (Closer Distance Object). In an embodiment, a Closer Distance Object may include one or more Identified Objects attached to or otherwise in contact with a particular Target. Examples of Closer Distance Objects include, without limitation, (1) a military insignia located on clothing worn by a human Target, (2) a patch located on clothing worn by a human Target; (3) a park bench on which a human Target is sitting; (4) a vehicle in which a human Target is sitting; (5) a firearm held by a human Target; (5) an insect located on a face or other part of a human Target; (6) a ladder leaning on a vehicle Target; (7) an object resting on a vehicle Target; (8) any other object affixed to a Target, attached to a Target, located on a Target, associated with a Target; or (9) any combination thereof.

Control then proceeds to an item selection step 1138, wherein the LAIs search the Object Data for each of the Relevant Objects for an Item from the Items stored in any of the LDBs and/or the DRDBDSSs of all of the DRs that is identical to or similar to that Relevant Object (based on one or more similarity routines in the LAIs) (the Selected Items) including size and shape related information for each of the Selected Items extracted from the LDBs and/or the DRDBDSSs of all of the DRs. As an example, the LAIs may be configured to extract three-dimensional information from any of the LDBs and/or the DRDBDSSs of all of the DRs for each of the Selected Items. Control is then transferred to a continuation step circled D on another page of FIG. 11, and then to a selected item size and orientation step 1140.

At the selected item orientation step 1140, each of the Selected Items is size adjusted and spatially oriented to match or correspond to each of the Relevant Objects. In a non-limiting embodiment, the LAIs may be configured to use convolutional neural networks (CNNs) to analyze the Relevant Objects in the Captured Images pixel by pixel, to extract various features such as shapes, corners, edges of the each of the Relevant Objects to improve the LAIs capability to analyze spatial depth and the spatial relationships between different parts of the one or more of the Relevant Objects and their relative positions in one or more of the Captured Images.

Control then proceeds to a distance determination step 1142, wherein distance data for each of the Relevant Objects is determined based on the Size and Orientation Data of each of the Relevant Objects as matched from the Size and Orientation Data of the Selected Items (the Relevant Object Distance Data). In an embodiment where one or more Captured Images include the Relevant Objects at different angles as captured via a plurality of image capturing systems 190, 250, 280, 321 at a plurality of locations, the LAIs are configured to calculate depth of each of the Relevant Objects by measuring disparity between the Relevant Objects in each of the Captured Images.

Control then proceeds to a confidence value calculation step 1144, wherein a confidence value is calculated for each of the Relevant Object Distance Data and generally expressed as a percentile, e.g., 95% confidence value, 70% confidence value, etc., and/or as a percentile confidence value range, e.g., 95%-99% confidence value, 80%-85% confidence value, etc. (the CVs) using algorithms or routine in the LAIs. The highest confidence value is realized for Identified Objects that are located directly on a Target or touching a Target as described above in the examples of a Closer Distance Object. In a scenario, a Closer Distance Object may be located out in front of a Target at a distance from an image capturing system 190, 250, 280, 321 less than the Target or vice versa, wherein the LAIs may be configured to use one or more other Identified Objects, including shadows of any Identified Objects and/or any Unknown Objects, to calculate depth estimation between the Closer Distance Object and the Target. As such, in a scenario where the Object Data for a particular Relevant Object may render a confidence value for the Relevant Object of 99% or greater when a Relevant Object is located adjacent a Target, i.e., located at a similar depth as a Target from an image capturing system 190, 250, 280, 321, if and when there is a difference in depth between the Relevant Object and the Target, then the confidence value for the Relevant Object decreases.

Control then proceeds to a ranking protocol selection step 1146, wherein for each of the Targets, a ranking protocol based on percentile rank or percentile rank range of the Relevant Objects is selected (the Ranking Protocols). For example, in an embodiment the Ranking Protocols may be selected in increments of five percentage points, e.g., 95% or greater, 90%-94%, 85%-89%, 80%-84%, etc., or other increments as desired. Also, ranking protocols of Relevant Objects for different types of Targets may vary. As an example, in military or law enforcement sniping activities accurate ranging of an enemy combatant Target is crucial as it allows a sniper to calculate bullet drop to hit the Target at long distances, e.g., 90.0 meters or greater. Thus, an enemy combatant Target may require the Ranking Protocols to include a CV of 99% or greater. Whereas, for perimeter security purposes where a user wants to determine a distance of a person or animal Target near a perimeter, an estimated distance of the Target to the perimeter may suffice requiring the Ranking Protocols to include a CV of only 75% or greater. In addition, a particular type of Target may require a different Ranking Protocol for Relevant Objects according to a particular Engagement Protocol. As an example, where a user such as a sniper may require a particular Ranking Protocol to include a CV of 99% or greater for determining a distance to a person such as an enemy combatant, a user such as a border patrol agent may require a lower Ranking Protocol to include a CV of 90% or greater for determining the distance of a person located near a border patrolled by the border patrol agent.

Control then proceeds to a confidence value ranking step 1148, wherein the CVs of each of the Relevant Objects for each of the Targets are ranked in accord with the Ranking Protocols to form ranked CVs (the Ranked CVs). For example, in an embodiment of a Ranking Protocol ranks the CVs in increments of five percentage points. Thus, Relevant Objects with a confidence level of 95% or greater are placed in a 95%-99% confidence value range of the Ranking Protocol. With the CVs of each of the Relevant Objects for each of the Targets ranked, control then proceeds to a target distance engagement protocol selection step 1150, wherein a determination is made as to how many of the Ranked CVs are to be used in calculating a distance to each of the Targets (the Target Engagement Protocols) using algorithms and routines in the LAIs. Said another way, a determination is made as to how many of the Ranked CVs are to be used in calculating a distance to a particular Target beginning with the highest of the Ranked CVs down, e.g., only use the Ranked CVs of 85% or greater to calculate a distance to a Target using algorithms and routines in the LAIs. A particular Target Engagement Protocol may vary according to a particular Engagement Protocol.

Control then proceeds to a target distance determination step 1152, wherein the Target Engagement Protocol for each of the Targets is used to determine a distance to each of the Targets, i.e., to determine a distance to each of the Targets from an image capturing system 190, 250, 280, 321 (the Target Distance Data) using algorithms and routines in the LAIs. Control then proceeds to a target distance communication step 1154, wherein the Target Distance Data for each of the Targets is communicated to one or more devices including one or more electronic devices or systems 100, 200, 300 of one or more users, one or more devices of one or more other authorized personnel, or combinations thereof. In a non-limiting example, in a military scenario Target Distance Data for each of the Targets may be communicated to (1) the electronic device or system 100, 200, 300 for one or more special operations units, and (2) one or more authorized personnel including, for example, command and control and/or one or more field officers, or (3) any combination thereof.

It should be recognized that in certain embodiments, the protocols steps may be optional as the apparatuses or system and the interfaces and methods implementing them may be preconfigured to use a standard set of protocols depending on the Targets or Target Types.

Control then proceeds to a target engagement authorization step 1156, wherein instructions on how and when to engage each of the Targets are communicated to one or more users of an electronic device or system 100, 200, 300. Control is then transferred to a continuation step circled E on another page of FIG. 11, and then to an engagement step 1158, wherein one, some or all of the Targets are engaged at one or more points in time based on the Target engagement authorization instructions (the Target Engagement Data).

Control then proceeds to a target engagement confirmation step 1160, wherein the Target Engagement Data is input into the AI targeting application and/or generated by the LAIs, wherein the LAIs are configured to detail success or failure of engagement according to an assessment of whether stated objectives were achieved, i.e., whether or not the engagement was carried out as instructed (the Target Confirmation Data). As an example, in a military scenario the Target Confirmation Data may comprise data including, but not limited to the total number of participants that engaged each Target, the type(s) of weapons and total number of weapons used during the engagement, Target casualties, Target destruction, Target damage and/or disablement, civilian casualties, the total elapsed time to execute an engagement, time(s) of day engagement was carried out, the amount of munition used during the engagement, and combinations thereof. Control then proceeds to a target confirmation data communication step 1162, wherein the Target Confirmation Data is communicated or sent to one or more devices including one or more electronic devices or systems 100, 200, 300 of one or more users, one or more devices of one or more other authorized personnel, and combinations thereof.

Control then proceeds to a data storage step 1164, wherein the image data, the engagement protocol, the user, the location, the Local Electronic Device, the capacity, the targets, the identified objects, the relevant objects, the Selected items, the Size and Orientation Data, the relevant object distance data, the CVs, the ranked CVs, the target distance data, the target engagement authorization, the target engagement data, and the target confirmation data (the operational data) are stored in the LDBs and in all of the DRDBDSSs on all of the DRs. The Operational Data may also be stored in real-time in a continuous manner as generated at any of the previous steps described above. The data stored may also include one, some, or all of the Image Data, the Engagement Protocol, one, some, or all of the users, one, some, or all the Locations, the one, some, or all of the Electronic Devices, one, some, or all of the Capacities, one, some, or all of the Targets, one, some, or all of the Identified Objects, one, some, or all of the Relevant Objects, one, some, or all of the Selected Items, the Size and Orientation Data, one, some, or all of the Relevant Object Distances Data, one, some, or all of the CVs, one, some, or all of the Ranked CVs, one, some, or all of the Target Distances Data, one, some, or all of the Target Engagement Authorization, one, some, or all of the Elimination Targets, one, some, or all of the Target Engagement Data, and one, some, or all of the Target Confirmation Data.

Control then proceeds to an AI Rules update step 1166, wherein the user AI rules, models, and/or methods are updated (the Updated User AI Rules) and the operation AI rules, models, and/or methods are updated (the Updated Operation AI Rules) based on the Operational Data stored in the LDBs, the DRDBDSSs of all of the DRs, or any combination thereof. Control then proceeds to an updated AI rule storage step 1168, wherein the Updated User AI Rules and the Updated Operation AI Rules are stored in the LDBs and in all of the DRDBDSSs of all of the DRs for use by the LAIs and the DRAI engines on all of the DRs. The Operational Data, the Updated User AI Rules and Updated Operation AI Rules may be downloaded in a continuous manner as generated. Control then proceeds to the stop step 1172, wherein the application is terminated via invoking a stop command, turning the apparatus or device 100 off or changing locations.

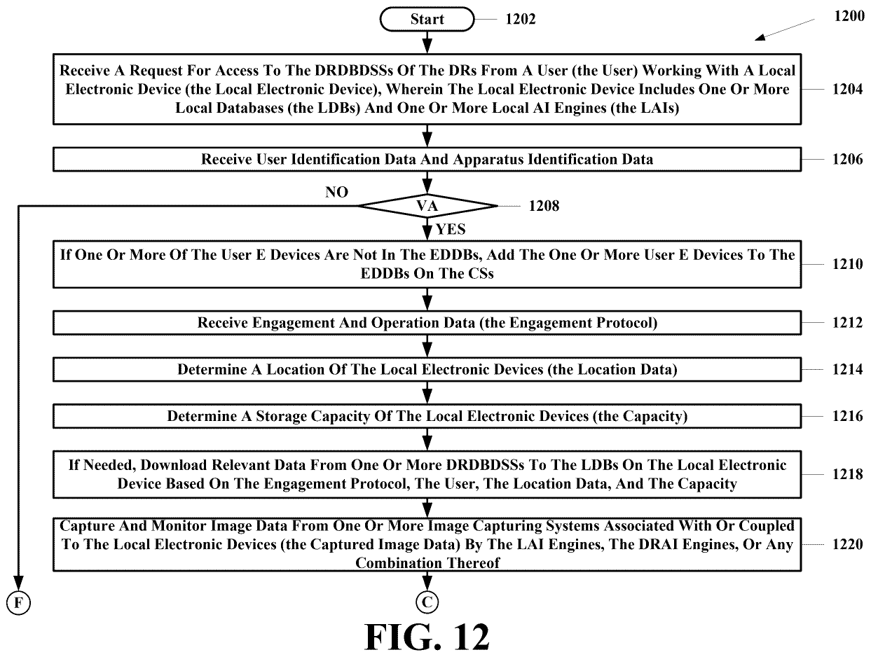

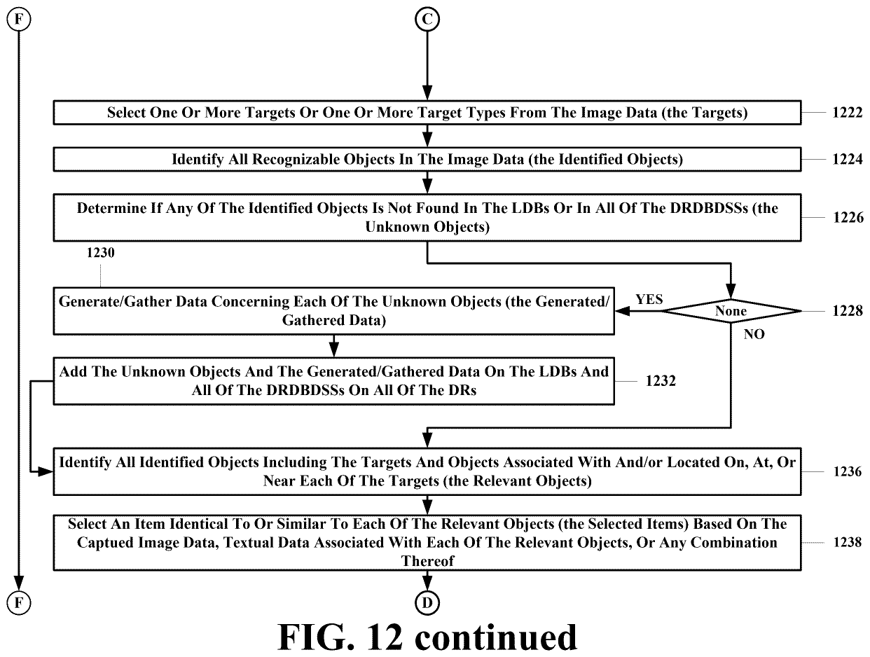

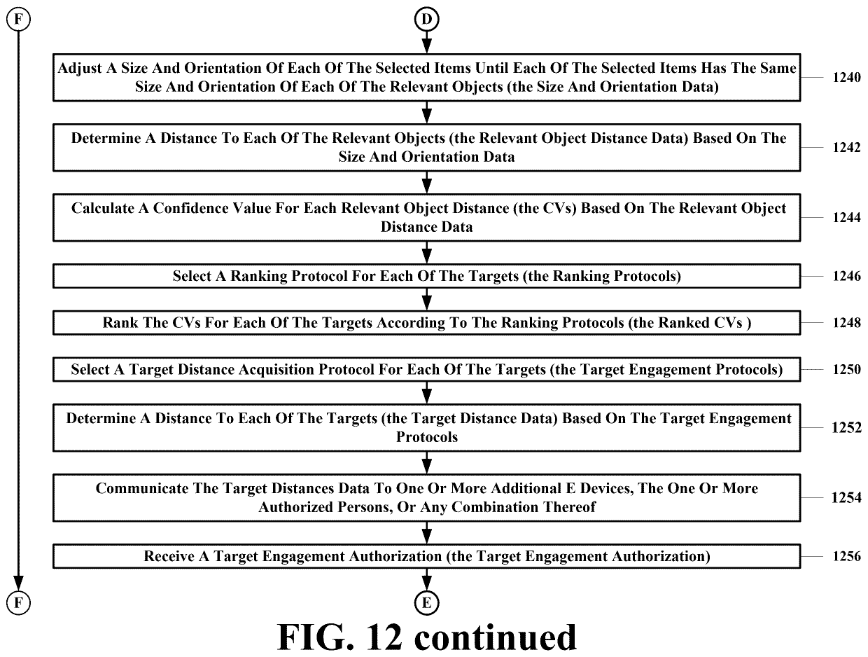

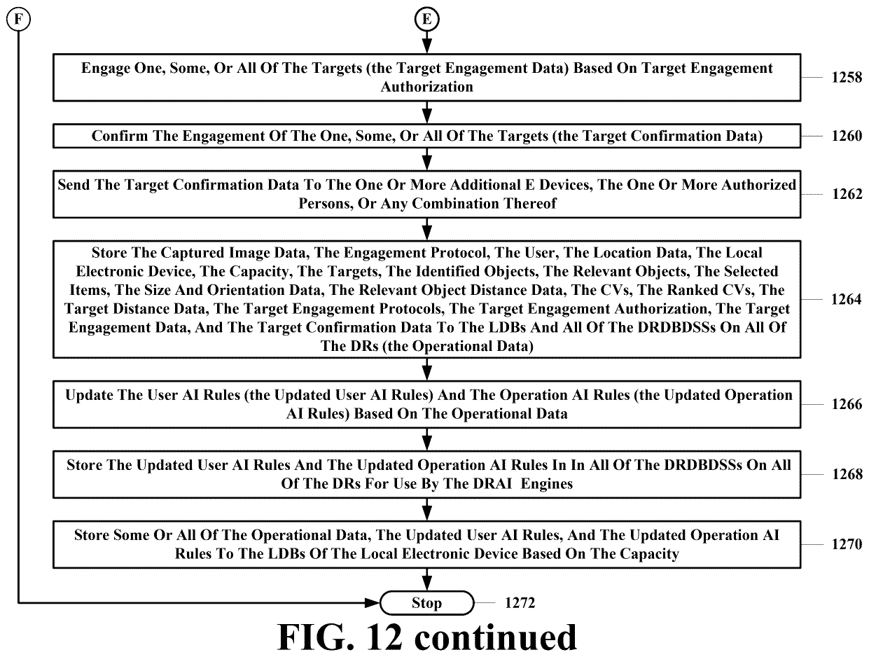

Referring now to FIG. 12, a conceptual flow chart of an embodiment of an AI targeting apparatus, system, or application and an interface or a method implementing them (the AI Targeting Apparatus), generally 1200, is shown to include a start step 1202. If the embodiment of the AI Targeting Apparatus is configured to limit access thereto, then the AI Targeting Apparatus include the following introductory steps. The introductory steps include an access request step 1204, wherein a potential user (or “accessor”) requests access to the AI targeting apparatus. Control then proceeds to an identification step 1206, wherein the potential user provides user identification data and E device identification data for one or more E devices under the supervision and/or control of the potential user as described above in reference to FIG. 7 for one or more E devices under the supervision and/or control of the potential user including an electronic device or system 100, 200, 300 and/or an image capturing system 190, 250, 280, 321.

Control then proceeds to a verify/authentication test (VA) step 1208, wherein the AI targeting apparatus determines whether the potential user is included in the UDBs as described above in reference to FIG. 7. If the potential user is included in the UDBs on the CSs, then control proceeds along a YES path to an add user E device step 1210; otherwise, control is transferred via the circled F continuation marker to a stop step 1272 on another page of FIG. 12 denying the potential user access to the AI targeting application. It should be recognized that the VA test step 1208 may grant the user and the local electronic devices under control of the user full access to all information and data in all of the DRDBDSSs and of all of the DRs or the VA test step 1208 may grant limited access to the information and data in all of the DRDBDSSs of all of DRs, wherein the limited grant may be based on the user, the local electronic devices, or the use to which the user intended to use the AI targeting application of this disclosure.

If the embodiment of the AI targeting apparatus is not configured to limit access thereto, then the AI targeting apparatus proceeds directly to the add user E device step 1210. Control then proceeds to an engagement and operation data receiving step 1212, receives engagement data and/or operation data for one or more intended operations is input into the AI targeting application and/or generated by the AI targeting application are configured to detail one or more tasks to be performed by a user and/or the local electronic devices (the Engagement Protocol). Engagement data and operation data may be general in nature and/or specific in nature. In general, engagement data includes a collection of information detailing the actions and interactions of one or more users of an electronic device or system 100, 200, 300 with one or more targets. In general, operation data includes a collection of information related to planning, executing and analyzing interactions of users of local electronic devices at least one being an electronic device or system 100, 200, 300 with one or more targets. For military and/or law enforcement type scenarios, non-limiting examples of engagement data may include rules of engagement, including authorized ordnance and/or munitions, intended or anticipated targets, specified level or degree of damage to target, appropriate responses to targets, target locations, prioritization of targets, and combinations thereof; and non-limiting examples of operation data may include objectives, desired end states, mission sets, operational environments, operational terrains, target capabilities analysis, and combinations thereof. In such exemplary scenarios, engagement data and/or operation data may originate from high command and/or field command and/or users in the field of operation and/or generated by the LAIs and/or the DRAI engines. For hunting type scenarios, non-limiting examples of engagement data may include (1) lawful activities including lawful means and methods, authorized weaponry including authorized firearms, air guns, arrow guns, archery, crossbows, falconry, and (2) unlawful activities; and non-limiting examples of operation data may include licensing requirements, restricted areas, permissible animals to hunt, dates and/or periods of time for a particular hunting activity, tagging requirements. In such scenarios, as an example, engagement data and/or operation data may originate from one or more governmental and/or regulatory sources, a user hunting one or more particular game and/or from the LAIs and/or the DRAI engines. Other non-limiting scenarios may include surveillance type scenarios including aerial surveillance type scenarios, security type scenarios, surveying type scenarios, sporting activities such as golf. For an activity such as golfing, engagement data and operation data may be limited or focused in a scope, e.g., focused to the ranging of flags on greens to determine a distance to a hole or pin for each flag for a user (golfer) during course play.

Control then proceeds to a location determination step 1214, wherein location information or data for the user and/or the local electronic device for one or more intended operations (the Location) may be input into the AI targeting application or determined by information including GPS coordinates, IP address, nearby Wi-Fi® networks, cell tower signals, visual features from images captured by an image capturing system 190, 250, 280, 321 (the Captured Images), and combinations thereof, e.g., the DRAI engines and/or the LAIs of the AI targeting application may be configured to triangulate a most probable location of a user and/or an apparatus based on the information, wherein location accuracy may be increased through data analysis of historical location patterns and environmental factors such as weather data and/or traffic data.

Control then proceeds to a storage capacity determination step 1216, wherein the storage capacity for the local electronic device is sufficient for storing all or a portion of the DRAI engines and the DRDBDSSs content of the AI targeting application in the LDBs and the LAIs. Control then proceeds to a relevant data download step 1218 wherein relevant data is downloaded in a continuous manner from all of the DRDBDSSs of all of the DRs to the LDBs and the LAIs of the electronic device or system 100, 200, 300 based on the capacity of the electronic device. Relevant data may include, but is not limited to, engagement data and/or operation data, the verified user, the identified location of the user and/or the electronic device or system 100, 200, 300, the storage capacity of the electronic device or system 100, 200, 300 and/or an image capturing system 190, 250, 280, 321, and combinations thereof. As an example, for a particular operation such as a military operation, only the object data germane to the particular location of the operation may be necessary for storage on the LDBs, e.g., Object Data as to enemy combatants and related equipment as well as Object Data for each Item commonly found in the location. Continuous downloading of relevant data onto the LDBs ensures that the best possible information is provided for use in real-time and/or near real-time. The LAIs and/or the DRAI engines of the AI targeting application may also remove any duplicate data from the LDBs. Control then proceeds to an image monitoring step 1220, wherein input image data for one or more images captured by an image capturing system 190, 250, 280, 321 is continuously observed and analyzed by the LAIs and/or the DRAI engines, and then control is transferred to a continuation step circled C on another page of FIG. 12, and then to a target selection step 1222.

At the target selection step 1222, the user or the LAIs and/or the DRAI engines select one or more targets or target types (the Targets) in the Captured Images. Once the Targets are selected, control then proceeds to a recognizable object identification step 1224, wherein all recognizable objects in the Captured Images are identified (the Identified Objects) that will be later be compared by the LAIs and/or the DRAI engines to Items stored on the LDBs and/or on the DRDBDSSs of all of the DRs. As an example, where one of the Targets is a person, the LAIs and/or the DRAI engines are configured to use one or more image recognition algorithms may use deep learning datasets comprising the Object Data for each Item to distinguish patterns for the Identified Objects in the Captured Images. In another embodiment, the LAIs and/or the DRAI engines using the one or more image recognition algorithms may be configured to review all images stored in the LDBs, in one, some, or all of the DRDBDSSs of all of the DRs, or any combination thereof and determine a common or consistent appearance of an image of a particular Item therein and also to identify uncommon or inconsistent appearances of an image of the particular Item therein. In limited visibility conditions including, without limitation, whiteouts, heavy rain, heavy snow, fog, dust storms, sandstorms, hurricanes, tornadoes, or any combination thereof, the LAIs and/or the DRAI engines using data from various image capturing devices capable of detecting light of various wavelengths including visible light, ultraviolent light, infrared light, short wavelength infrared light, any other light wavelength, may not be capable of detecting any recognizable objects. Also, the LAIs and/or the CIA engines may be further configured to detect recognizable objects influenced by depth of field limitations of one or more of the Captured Images, wherein one or more objects in one or more Captured Images may be out of focus. As such, where the Captured Images include continuous sequence of images including change to the depth of field, as one or more out of focus objects come into focus with a change in depth of field, the LAIs and/or DRAI engines can then recognize such objects as Identified Objects and detect or determine variations in the Aspects for the Identified Objects from both in focus and out of focus images.

Control then proceeds to an unknown object determination step 1226, wherein the LAIs and/or the DRAI engines are configured to determine whether any of the Identified Objects are not found in any of the LDBs, and/or any of the DRDBDSSs of all of the DRs (the Unknown Object or Objects). Control then proceeds to an unknown object determination test step 1228, wherein if there are any Unknown Objects then control proceeds along a YES path to an unknown object data generate/gather step 1230; otherwise, control is transferred along a NO path to an identified object identification step 1236.

At the unknown object data generate/gather step 1230, the Aspects and the Criterion are used to generate and/or gather data for each of the Unknown Objects (the Gathered/Generated Data), which is used to generate and/or gather Object Data for each Unknown Object. As an example, the LAIs and/or the DRAI engines can use one or more components, features, attributes, characteristics and associated information as described above to generate and assign Aspects to each of the Unknown Objects. All accessible data structures may be searched to generate data for each of the unknown objects, including both public and private internets and intranets.

Control then proceeds to an unknown object addition step 1232, wherein each of the Unknown Objects and the Gathered/Generated Data are added to the LDBs and all of the DRDBDDs on all of the DRs becoming the Object Data for each of the Unknown Objects.

At the identified object identification step 1236, all known Identified Objects in the Captured Images including the Targets and objects associated with and/or located on, at, or near the each of the Targets are identified (the Relevant Objects). Herein, an Identified Object associated with one or more of the Targets may also be referred to as an (Associated Object). An Associated Object may include an Identified Object that is used with or in relation to a particular Target, e.g., (1) an Associated Object may be a flag or banner attached to a rope or halyard of a flagpole Target; (2) an Associated Object may be a deer feeder for a deer Target; (3) an Associated Object may be an inlet valve for a fluid container Target. Herein, an Identified Object located nearest one or more of the Targets may also be referred to as a (Closer Distance Object). In an embodiment, a Closer Distance Object may include one or more Identified Objects attached to or otherwise in contact with a particular Target. Examples of Closer Distance Objects include, without limitation, (1) a military insignia located on clothing worn by a human Target, (2) a patch located on clothing worn by a human Target; (3) a park bench on which a human Target is sitting; (4) a vehicle in which a human Target is sitting; (5) a firearm held by a human Target; (5) an insect located on a face or other part of a human Target; (6) a ladder leaning on a vehicle Target; (7) an object resting on a vehicle Target; (8) any other object affixed to a Target, attached to a Target, located on a Target, associated with a Target; or (9) any combination thereof.

Control then proceeds to an item selection step 1238, wherein the LAIs and/or the DRAI engines search the Object Data for each of the Relevant Objects for an Item from the Items stored in any of the LDBs and/or the DRDBDSSs of all of the DRs that is identical to or similar to that Relevant Object based on one or more similarity routines in the LAIs and/or the DRAI engines (the Selected Items) including size and shape related information for one or more Selected Items extracted from the LDBs and/or the DRDBDSSs of all of the DRs. As an example, the LAIs and/or the AI engines may be configured to extract three-dimensional information from any of the LDBs and/or the DRDBDSSs of all of the DRs for each of the Selected Items. Control is then transferred to a continuation step circled D on another page of FIG. 12, and then to a selected item sizing and orientation step 1240.

At the selected item size and orientation step 1240, the each of the Selected Items is size adjusted and spatially oriented to match or correspond to each of the Relevant Objects. In a non-limiting embodiment, the LAIs and/or the DRAI engines may use convolutional neural network (CNNs) to analyze the Relevant Objects in the Captured Images pixel by pixel, to extract various features such as shapes, corners, edges of each of the Relevant Objects to improve the LAIs and/or the DRAI engines capability to analyze spatial depth and the spatial relationships between different parts of the one or more Relevant Objects and their relative positions one or more of the Captured Images.

Control then proceeds to a distance determination step 1242, wherein distance data for each of the Relevant Objects is determined based on the Size and Orientation Data of each of the Relevant Objects as matched from the Size and Orientation Data of the Selected Items (the Relevant Object Distance Data). In an embodiment where one or more Captured Images include the Relevant Objects at different angles as captured via a plurality of image capturing systems 190, 250, 280, 321 at a plurality of locations, the LAIs and/or the DRAI engines are configured to calculate depth of each of the Relevant Objects by measuring disparity between the Relevant Objects in each of the one or more Captured Images.

Control then proceeds to a confidence value calculation step 1244, wherein a confidence value is calculated for each of the Relevant Object Distance Data and generally expressed as a percentile, e.g., 95% confidence value, 70% confidence value, etc., and/or as a percentile confidence value range, e.g., 95%-99% confidence value, 80%-85% confidence value, etc. (the CVs) using algorithms or routine in the LAIs and/or the DRAI engines. The highest confidence value is realized for Identified Objects that are located directly on a Target or touching a Target as described above in the examples of a Closer Distance Object. In a scenario, a Closer Distance Object may be located out in front of a Target at a distance from an image capturing system 190, 250, 280, 321 less than the Target or vice versa, wherein LAIs and/or the DRAI engines may use one or more other Identified Objects, including shadows of any Identified Objects and/or any Unknown Objects, to calculate depth estimation between the Closer Distance Object and the Target. As such, in a scenario where the Object Data for a particular Relevant Object may render a confidence value for the Relevant Object of 99% or greater when a Relevant Object is located adjacent a Target, i.e., located at a similar depth as a Target from an image capturing system 190, 250, 280, 321, if and when there is a difference in depth between the Relevant Object and the Target, then the confidence value for the Relevant Object decreases.

Control then proceeds to a ranking protocol selection step 1246, wherein for each of the Targets, a ranking protocol based on percentile rank or percentile rank range of the Relevant Objects is selected (the Ranking Protocols). For example, in an embodiment the Ranking Protocols may be selected in increments of five percentage points, e.g., 95% or greater, 90%-94%, 85%-89%, 80%-84%, etc., or other increments as desired. Also, ranking protocols of Relevant Objects for different types of Targets may vary. As an example, in military or law enforcement sniping activities accurate ranging of an enemy combatant Target is crucial as it allows a sniper to calculate bullet drop to hit the Target at long distances, e.g., 90.0 meters or greater. Thus, an enemy combatant Target may require the Ranking Protocols to include a CV of 99% or greater. Whereas, for perimeter security purposes where a user wants to determine a distance of a person or animal Target near a perimeter, an estimated distance of the Target to the perimeter may suffice requiring the Ranking Protocols to include a CV of only 75% or greater. In addition, a particular type of Target may require a different Ranking Protocol for Relevant Objects according to a particular Engagement Protocol. As an example, where a user such as a sniper may require a particular Ranking Protocol to include a CV of 99% or greater for determining a distance to a person such as an enemy combatant, a user such as a border patrol agent may require a lower Ranking Protocol to include a CV of 90% or greater for determining the distance of a person located near a border patrolled by the border patrol agent.

Control then proceeds to a confidence value ranking step 1248, wherein the CVs of each of the Relevant Objects for each of the Targets are ranked in accord with the Ranking Protocols to form ranked CVs (the Ranked CVs). For example, in an embodiment of a particular Ranking Protocol may rank the CVs in increments of five percentage points. Thus, Relevant Objects with a confidence value of 95% or greater are placed in a 95%-99% confidence value range of the particular Ranking Protocol. With the CVs of each of the Relevant Objects for each of the Targets ranked, control then proceeds to a target distance Engagement protocol selection step 1250, wherein a determination is made as to how many of the Ranked CVs are to be used in calculating a distance to each of the Targets (the Target Engagement Protocols) using algorithms and routines in LAIs and/or the DRAI engines. Said another way, a determination is made as to how many of the Ranked CVs are to be used in calculating a distance to a particular Target beginning with the highest of the Ranked CVs down, e.g., only use the Ranked CVs of 85% or greater to calculate a distance to a Target using algorithms and routines in the AI engines. A particular Target Engagement Protocol may vary according to a particular Engagement Protocol.

Control then proceeds to a target distance determination step 1252, wherein the Target Engagement Protocols for each of the Targets is used to determine a distance to each of the Targets, i.e., to determine a distance of each of the Targets from an image capturing system 190, 250, 280, 321 (the Target Distance Data) using algorithms and routines in LAIs and/or the DRAI engines. Control then proceeds to a target distance communication step 1254, wherein the Target Distance Data for each of the Targets is communicated to one or more devices including one or more electronic devices or systems 100, 200, 300 of one or more users, one or more devices of one or more other authorized personnel, or combinations thereof. In a non-limiting example, in a military scenario Target Distance Data for each of the Targets may be communicated to (1) the electronic device or system 100, 200, 300 for one or more special operations units, and (2) one or more authorized personnel including, for example, command and control and/or one or more field officers, or (3) any combination thereof.

It should be recognized that in certain embodiments, the protocols steps may be optional as the apparatuses or system and the interfaces and methods implements them may be preconfigured to use a standard set of protocols depending on the Targets or Target Types.

Control then proceeds to a target engagement authorization step 1256, wherein instructions on how and when to engage each of the Targets are communicated to one or more users of an electronic device or system 100, 200, 300. Control is then transferred to a continuation step circled E on another page of FIG. 12, and then to an engagement step 1258, wherein one, some or all of the Targets are engaged at one or more points in time based on the Target engagement authorization instructions (the Target Engagement Data).

Control then proceeds to a target engagement confirmation step 1260, wherein the Target Engagement Data is input into the AI targeting application and/or generated by the AI engines, wherein the LAIs and/or the DRAI engines are configured to detail success or failure of engagement according to an assessment of whether stated objectives were achieved, i.e., whether or not the engagement was carried out as instructed (the Target Confirmation Data). As an example, in a military scenario the Target Confirmation Data may comprise data including, but not limited to the total number of participants that engaged each Target, the type(s) of weapons and total number of weapons used during the engagement, Target casualties, Target destruction, Target damage and/or disablement, civilian casualties, the total elapsed time to execute an engagement, time(s) of day engagement was carried out, the amount of munition used during the engagement, and combinations thereof. Control then proceeds to a target confirmation data communication step 1262, wherein the Target Confirmation Data is communicated or sent to one or more devices including one or more electronic devices or systems 100, 200, 300 of one or more users, one or more devices of one or more other authorized personnel, and combinations thereof.

Control then proceeds to a data storage step 1264, wherein the image data, the engagement protocol, the user, the location, the Local Electronic Device, the capacity, the targets, the identified objects, the relevant objects, the Selected items, the Size and Orientation Data, the relevant object distance data, the CVs, the ranked CVs, the target distance data, the target engagement authorization, the target engagement data, and the target confirmation data (the Operational Data) are stored in the LDBs and in all of the DRDBDSSs on all of the DRs. The Operational Data may also be stored in real-time in a continuous manner as generated at any of the previous steps described above. The data stored may also include one, some, or all of the Image Data, the Engagement Protocol, one, some, or all of the users, one, some, or all of the Locations, one, some, or all of the Electronic Devices, one, some, or all of the Capacities, one, some, or all of the Targets, one, some, or all of the Identified Objects, one, some, or all of the Relevant Objects, one, some, or all of the Selected Items, one, some, or all of the Size and Orientation Data, one, some, or all of the Relevant Object Distance Data, one, some, or all of the CVs, one, some, or all of the Ranked CVs, one, some, or all of the Target Distance Data, one, some, or all of the Target Engagement Authorization, one, some, or all of the Elimination Targets, the Target Engagement Data, and one, some, or all of the Target Confirmation Data.

Control then proceeds to an AI Rule update step 1266, wherein the user AI rules, models, and/or methods are updated (the Updated User AI Rules) and the operation AI rules, models, and/or methods are updated (the Updated Operation AI Rules) based on the Operational Data stored in the LDBs, the DRDBDSSs of all of the DRs, or any combination thereof. Control then proceeds to an update AI Rule storage step 1268, wherein the Updated User AI Rules and the Updated Operation AI Rules are stored in the LDBs and in all of the DRDBDSSs of all of the DRs for use by the LAIs and the DRAI engines. Control then proceeds to an operational data and AI rule storage step 1270, wherein the Operational Data and the Updated User AI Rules and the Updated Operation AI Rules are stored in the LDBs and in all of the DRDBDSSs of all of the DRs. Control then proceeds to the stop step 1272, wherein the application is terminated via invoking a stop command, turning the apparatus or device 100 off or changing locations.

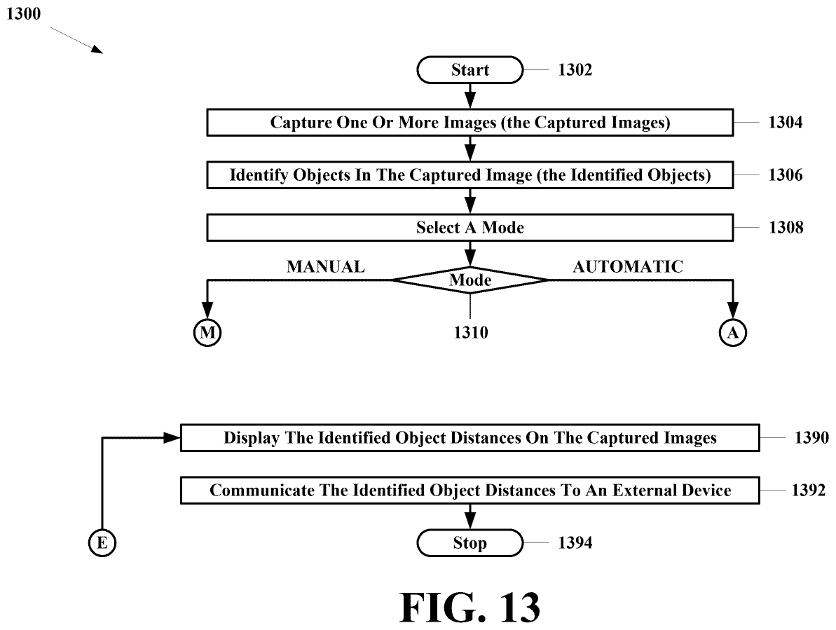

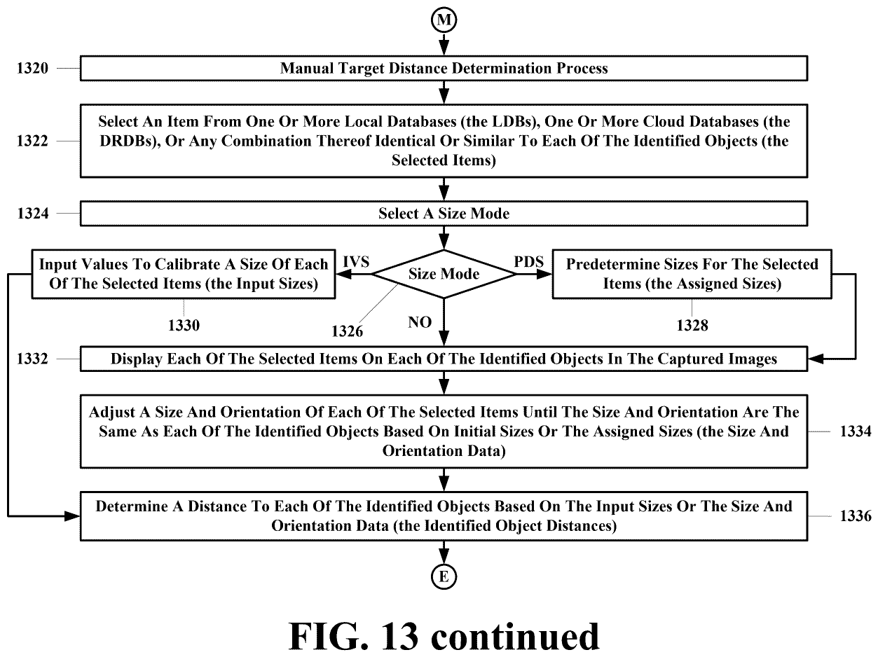

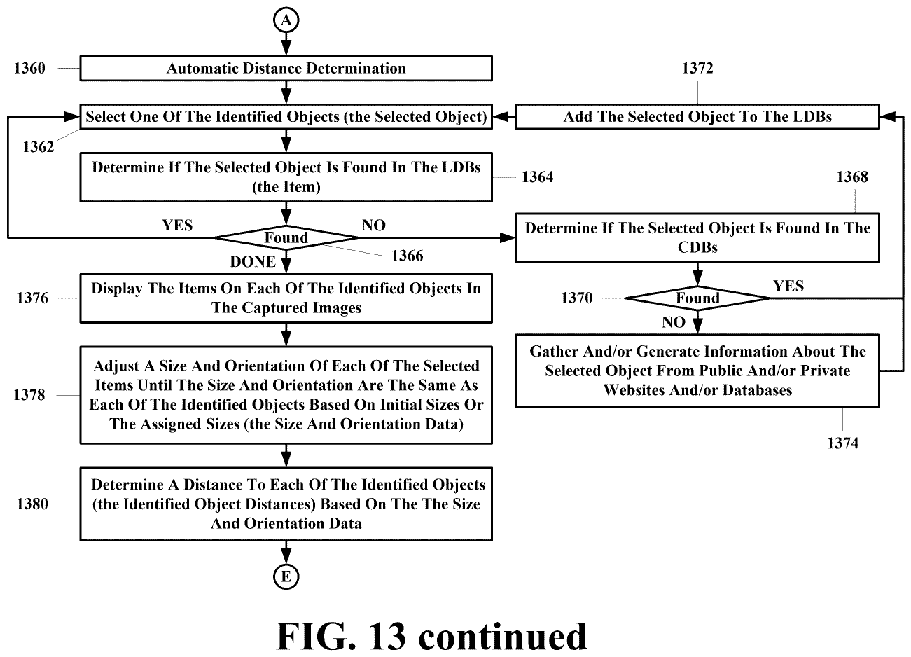

Referring now to FIG. 13, a conceptual flow chart of an embodiment of an apparatus, system, or interface and their operation, generally 1300, is shown to include a start step 1302, which starts the apparatus, system, or interface. Control then proceeds to a capture image step 1304, wherein one or more images are captured in real time, near real-time, or periodically (the Captured Images) from one or more image capturing devices such as one or more cameras. Control then proceeds to an identify object step 1306, wherein objects are identified (the Identified Objects) in the Captured Images. Control then proceeds to a select mode step 1308, wherein the user or the LAIs and/or the DRAI engines are configured to select a mode of target acquisition. Control then proceeds to a mode test step 1310, wherein if the selected mode is manual, then control is transferred along a MANUAL path to a continuation step circled M, which is a marker to transfer control to a manual target distance determination process 1320 in a continuation page of FIG. 13; otherwise, control is transferred along an AUTOMATIC path to a continuation step circled A, which is a marker to transfer control to an automatic target distance determination process 1360 in a continuation page of FIG. 13.

Of course, it should be recognized that more than one image may be captured and that more than one distance to more than one object or target may be determined.

For the manual target distance determination process 1320, the conceptual flow chart 1300 further includes a select item step 1322, wherein the apparatus, system, or interface is configured to select an item identical or similar to each of the Identified Objects (the Selected Items) from one or more LDBs, one or more cloud databases (the CDBs), or any combination thereof in the Captured Images. Control then proceeds to a size mode select step 1324, wherein the user selects a size selection mode or the apparatus, system, or interface is configured to select a size selection mode. Control then proceeds to a size mode test step 1326. If the selected size mode is to assign predetermined sizes to each of the Selected Items, then control proceeds along a PDS path to a predetermined size step 1328, wherein a predetermined size for each of the Selected Items is assigned from a set of sizes for each of the Selected Items at a known distance (the Assigned Sizes) and then proceeds along a NO path to a display the selected item step 1332, wherein each of the Selected items is displayed on each of the Identified Objects in the Captured Images. Control then proceeds to an adjust a size step 1334, wherein a size of each of the Selected Items is adjusted until the size of each of the Selected Objects is the same size as each of the Identified Objects (the Size and Orientation Data). Control then proceeds to a distance determination step 1336, wherein a distance to each of the Identified Objects is determined based on the Size and Orientation Data of each of the Selected Items.

If the selected size mode is to input values to calibrate a size for each of the Selected Items, then control proceeds along an IVS path an input value step 1330, wherein the user directly enters calibration size values for each of the Selected Items (the Input Sizes) so that the size of each of the Selected Items is calibrated based on the Input Sizes. Control then proceeds directly to the distance determination step 1336. Of course, it should be recognized that each of the Selected Items should be at the same distance as each of the Identified Objects in the Captured Images. For example, if an Identified Object is a flower near a deer, the target or an Identified Object, then sizing the flower will give a distance to the flower, which is used for determining a distance to the deer. As another example, if an Identified Object is an item held in a hand of a person, who is the target or an Identified Object, then sizing the item will give a distance to the item, which is used for determining a distance to the person.

Control then proceeds to a continuation step circled E, which is a marker to transfer control to a display distance step 1390, wherein the determined distances to each of the Identified Objects in the Captured Images is provided on the one or more visual displays 128 on the first page of FIG. 13. Of course, the distances may be provided via a speaker or any other non-display output device. Control then proceeds to a communication distance step 1392, wherein the distances to each of the Identified Objects are supplied to any external device such as one or more E devices, one or more cell phones, other mobile devices, or any combination thereof. Control then proceeds to a stop step 1394, which exits the apparatus, system, or interface, terminates the apparatus, system, or interface via invoking a stop command, turning the apparatus or device 100 off, or changing locations.

If the selection mode is the AUTOMATIC path, then control proceeds along the circled A to the automatic distance determination step 1360. Control then proceeds to a select an object step 1362, wherein one of the identified objects is selected (the selected object). Control then proceeds to a determine object found step 1364, wherein a determination is made as to whether the selected object is found in the LDBs. Control then proceeds to a found object test step 1366. If the selected object is found in the LDBs, then control is transferred along a YES path back to the select an object step 1362. If the selected object is not found in the LBDs, then control is transferred along a NO path to a second determine identified object step 1368, wherein a determination is made as to whether the selected object is found in the CDBs. Control then proceeds, to second found object test step 1370. If the selected object is found in the CDBs, then control is transferred along a YES path to an add the selected object step 1372, wherein the selected object is added to the LDBs and then control proceeds back to the select an object step 1362. If the selected object is not found in the CDBs, then control is transferred along a NO path to a gather and/or generate information step 1374, wherein information is gathered and/or generated about the non-found selected object from public website, private websites, public databases, private databases, or any combination thereof, and selecting another identified object. Then control is transferred to the add the selected object step 1372, wherein the selected object is added to the LDBs and then back to the select an object step 1362. If all of the identified objects have either been found in the LDBs or added to the LDBs, then control is transferred along a DONE path to a found item display step 1376, wherein each of the found items is displayed on the corresponding identified object in the captured images. Control then proceeds to a found item adjust size step 1378, wherein a size of each of the found items is adjusted until the size and orientation of each of the found items are the same as the sizes of each of the corresponding identified objects (the Size and Orientation Data). Control then proceeds to a distance determination step 1380, wherein a distance to each of the identified objects is determined based on the Size and Orientation Data of each of the found items. Control then proceeds to a continuation circled E step, which is a marker to transfer control to the display distance step 1390 on the first page of FIG. 13. Control then proceeds to the communication distance step 1392, and finally to the stop step 1394.

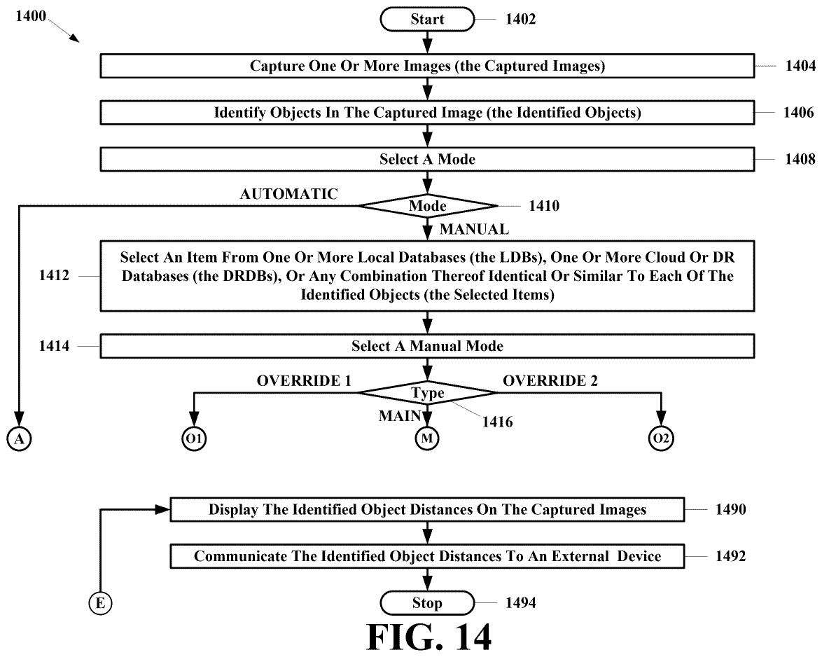

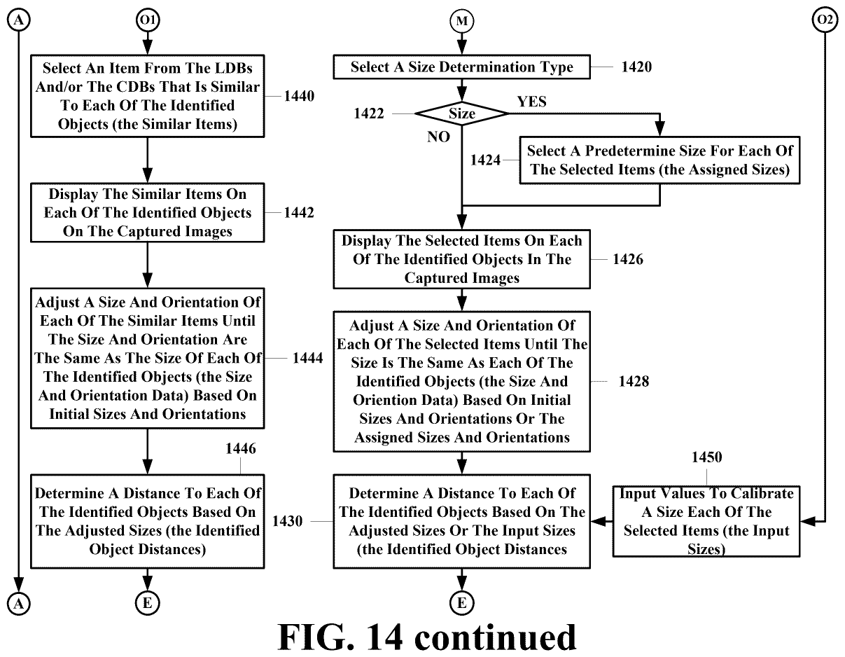

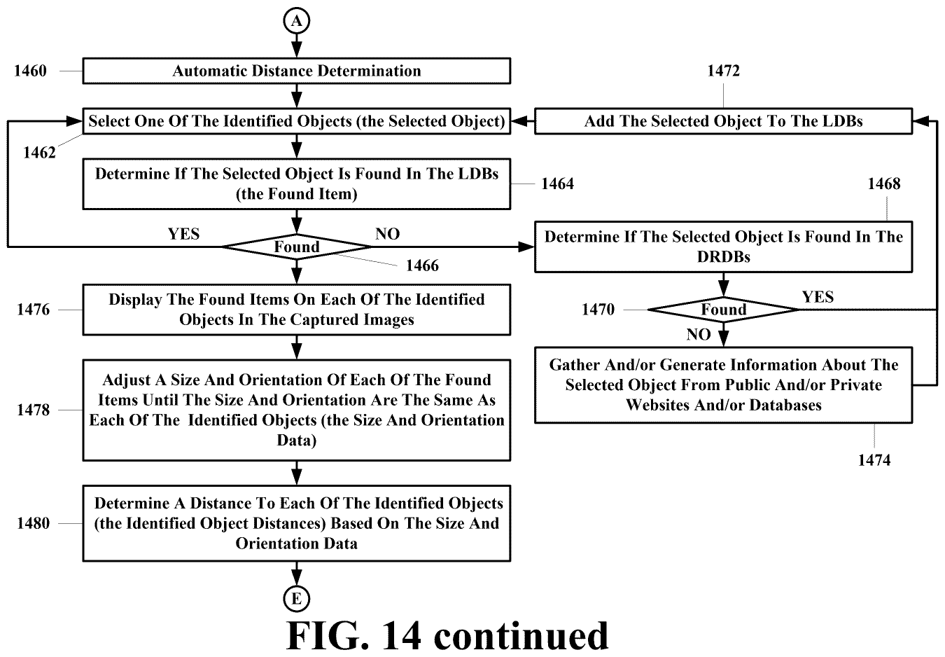

Referring now to FIG. 14, a conceptual flow chart of an embodiment of an apparatus, system, or interface and their operation, generally 1400, is shown to include a start step 1402. Control then proceeds to a capture image step 1404, wherein one or more images is captured in real time, near real-time, or periodically (the Captured Images) from one or more image capturing devices such as one or more cameras. Control then proceeds to an identify objects step 1406, wherein one or more objects are identified (the Identified Objects) in the Captured Images. Control then proceeds to a mode select step 1408, wherein a mode is selected (the Selected Mode). Control then proceeds to a mode test step 1410, wherein if a manual mode is selected, then control is transferred along a MANUAL path to a select item step 1412, wherein an item from one or more local databases (the LDBs) or one or more web or cloud databases (the CDBs) is selected that identically corresponds to each of the identified objects (Selected Items); otherwise, control is transferred along an AUTOMATIC path to a continuation step circled A on another page of FIG. 14. In FIG. 14, the circled E is a marker indicating that a step in another page of FIG. 14 is transferring control back to a previously defined step of FIG. 14 and circled M, circled O1, and circled O2 are continuation markers indicating that the manual path types are continued on another page of FIG. 14.

After the select item step 1412 of the MANUAL path, control then proceeds to a manual type select step 1414, wherein a manual type is selected (the Selected Type). Control then proceeds to a select a manual type test step 1416, wherein if the Selected Type is:
(a) a main manual entry format type, then control is transferred along a MAIN path to the continuation step circled M, which transfers control to a select size determination type step 1420, wherein a size type is selected (the Selected Type);
(b) a first override format type, which is invoked when no identical item is found in the one or more LDBs or in the one or more CDBs corresponding each of the identified objects, then control is transferred along an OVERRIDE 1 path via the circled O1 continuation step to a similar item select step 1440, wherein an item similar to each of the identified objects is selected from the one or more LDBs or the one or more CDBs (the similar item); or
(c) a second override format type, then control is transferred along an OVERRIDE 2 path via the circled O2 continuation step to an input calibration values step 1450, wherein size values for calibrating a size of each of the identified objects are input to a device 100 (the input sizes).

For the MAIN path, control then proceeds from the select size determination type step 1420 to a size type test step 1422. If the size type is to assign predetermined sizes, then control proceeds to a predetermined size step 1424, wherein a size for each of the selected items in the LDBs is predetermined from a set of sizes for the selected items at known distances and wherein each of the selected items is shown on the one or more visual displays 128 at the known distances and then to a display the selected item step 1426, wherein the selected items are displayed on the identified objects in the captured images; otherwise, control proceeds directly to the display the selected item step 1426. Control then proceeds to an adjust size and orientation step 1428, wherein a size and orientation of each of the selected items is adjusted until the size of each of the selected items is the same as the size of the identified objects based on initial sizes of each of the selected items or the assigned sizes (the Size and Orientation Data). Control then proceeds to a distance determination step 1430, wherein a distance to each of the identified objects is determined based on the Size and Orientation Data of the corresponding selected item. Control then proceeds to the circled E step to a display distance step 1490 on the first page of FIG. 14, wherein the determined distance to each of the identified objects on the captured images is provided on the one or more visual displays 128. Of course, the distance may be provided via a speaker or any other non-display output device. Control then proceeds to a communication distance step 1492, wherein the distance to the identified object is supplied to any external device such as one or more E devices, one or more cell phones, other mobile devices, or any combination thereof. Control then proceeds to a stop step 1494, which exits the apparatus, system, or interface, terminates the apparatus, system, or interface via invoking a stop command, turning the apparatus or device 100 off, or changing locations.

For the OVERRIDE 1 path, control then proceeds to a similar item select step 1440, wherein an item from the LDBs, the CDBs, or any combination thereof is selected (the similar items). Control then proceeds to a display the similar item step 1442, wherein the similar items are displayed on the identified objects in the captured images. Control then proceeds to an adjust similar item size and orientation step 1444, wherein a size of each of the similar items is adjusted to a size and orientation of each of the identified objects in the captured images (the Size and Orientation Data). Control then proceeds to a determine distance step 1446, wherein a distance to each of the identified objects is determined based on the initial size of each of the similar items. Control then proceeds to the circled E step to a display distance step 1490 on the first page of FIG. 14, wherein the distances to each of the identified objects on the captured images is displayed to a user via the one or more visual displays 128. Control then proceeds to the communication distance step 1492, wherein the distances to each of the identified objects are supplied to any external device such as one or more E devices, one or more cell phones, other mobile devices, or any combination thereof. The OVERRIDE 1 path allows a user to input size information for the identified object and distance information for the selected item in the LDBs, the CDBs, or any combination thereof. Control then proceeds to a stop step 1494, wherein the application is terminated via invoking a stop command, turning the apparatus or device 100 off or changing locations.

For the OVERRIDE 2 path, control then proceeds to an input calibration size value step 1450 to each of the identified objects (the input sizes). Control then proceeds to the distance determination step 1430, wherein the input sizes are used to determine a distance to each of the identified objects. The OVERRIDE 2 path allows a user to input sizes of each of selected items from the LDBs, the CDBs, or any combination thereof and override the values for the selected items with different values to modify selected items in the LDBs, the CDBs, or any combination thereof. As such, the LDBs, the CDBs, or any combination thereof may increase over time at a user level in place of or in addition to any updates made to the LDBs by a managing program or other database.

If the selection mode the AUTOMATIC path, then control proceeds to the automatic distance determination step 1460. Control then proceeds to a select an object step 1462, wherein one of the identified objects is selected (the selected object). Control then proceeds to a determine object found step 1464, wherein a determination is made as to whether the selected object is found in the LDBs. Control then proceeds to a found object test step 1466. If the selected object is found in the LDBs, then control is transferred along a YES path back to the select an object step 1462. If the selected object is not found in the LBDs, then control is transferred along a NO path to a second determine identified object step 1468, wherein a determination is made as to whether the selected object is found in the CDBs. Control then proceeds, to second found object test step 1470. If the selected object is found in the CDBs, then control is transferred along a YES path to an add the selected object step 1472, wherein the selected object is added to the LDBs and then control proceeds back to the select an object step 1462. If the selected object is not found in the CDBs, then control is transferred along a NO path to a gather and/or generate information step 1474, wherein information is gathered and/or generated about the selected object from public website, public databases, public databases, private databases, or any combination thereof, and selecting another identified object. Then control is transferred to the add the selected object to the LDBs step 1472 and then to the select an object step 1462. If all of the identified objects have either been found in the LDBs or added to the LDBs, then control is transferred to a found item display step 1476, wherein each of the found items is displayed on the corresponding identified object in the captured images. Control then proceeds to a found item adjust size and orientation step 1478, wherein a size and orientation of each of the found items is adjusted until the size of each of the found items are the same as the sizes of each of the corresponding identified objects (the Size and Orientation Data). Control then proceeds to a distance determination step 1480, wherein a distance to each of the identified objects is determined based on the Size and Orientation Data of each of the found items. Control then proceeds to a continuation circled E step, which is a marker to transfer control to a display distance step 1490 on the first page of FIG. 14. Control then proceeds to the communication distance step 1492, and finally to the stop step 1494.

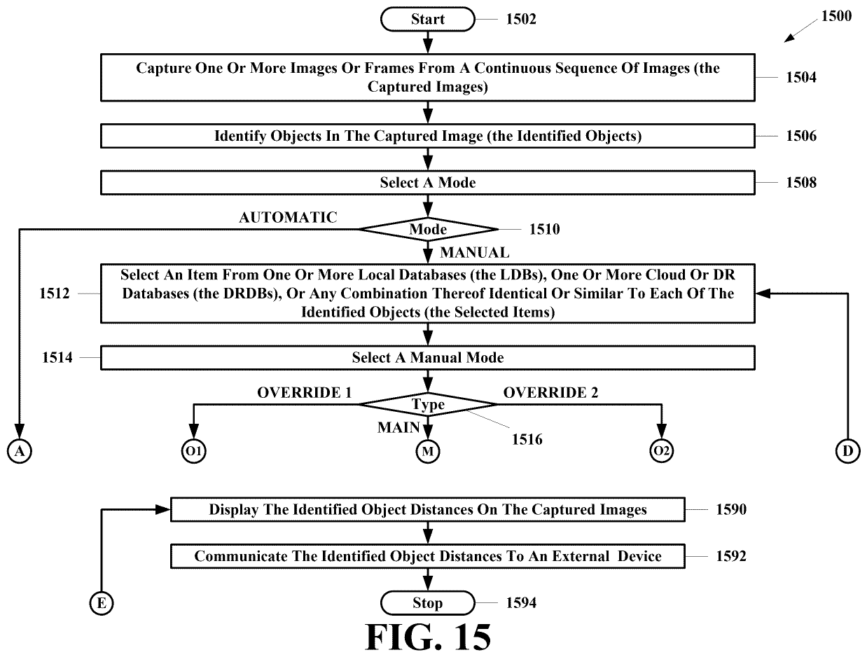

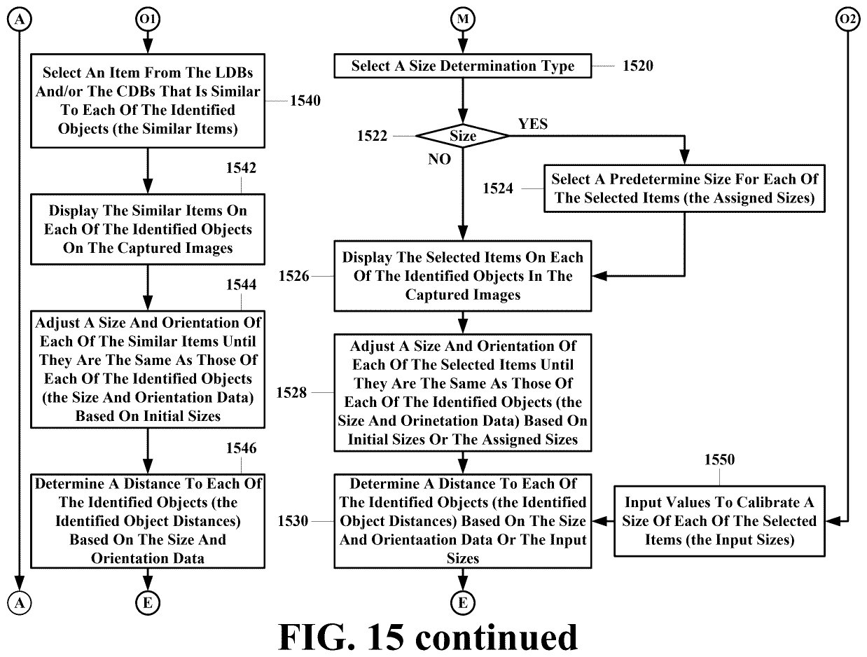

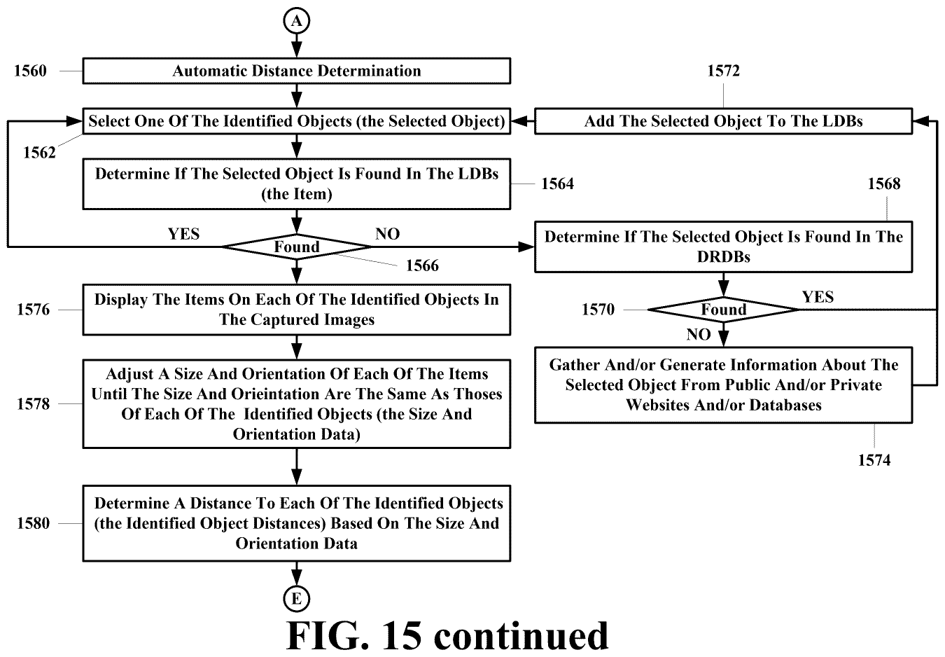

Referring now to FIG. 15, a conceptual flow chart of an embodiment of an apparatus, system, or interface and their operation, generally 1500, is shown to include a start step 1502. Control then proceeds to a capture image step 1504, wherein one or more images or frames from a continuous sequence of images are captured in real time, near real-time, or periodically (the captured images) by one or more devices configured to capture an image from a continuous sequence of images such as one or more video cameras. Control then proceeds to an identify object step 1506, wherein one or more objects are identified (the identified objects) in the captured images. Control then proceeds to a mode select step 1508, wherein a mode is selected (the selected mode). Control then proceeds to a mode test step 1510, wherein if the selected mode is to a manual distance determination process, then control is transferred along a MANUAL path to a select item step 1512, wherein an item from one or more local databases (the LDBs) or one or more web or cloud databases (the CDBs) is selected that identically corresponds to each of the identified objects (the selected items); otherwise, control is transferred along an AUTOMATIC path to a continuation step circled A on another page of FIG. 15. In FIG. 15, the circled E is a marker indicating that a step in another page of FIG. 15 is transferring control back to a previously defined step of FIG. 15 and circled O1 and circled O2 are continuation markers indicating that the manual path types are continued on another page of FIG. 15.

After the select item step 1512 of the Manual path, control then proceeds to a manual type select step 1514, wherein a manual type is selected (the selected type). Control then proceeds to a select a manual type test step 1516. If the selected manual type is:
(a) a main manual entry format type, then control is transferred along a MAIN path to the continuation step circled M, which transfers control to a select size determination type step 1520, wherein a size type is selected (the Selected Type);
(b) a first override format type, which is invoked when no identical item is found in the LDBs or the CDBs corresponding to each of the identified objects, then control is transferred along an OVERRIDE 1 path via the circled O1 continuation step to a similar item select step 1540, wherein an item similar to each of the identified objects is selected from the LDBs or the CDBs (the similar items); or
(c) a second override format type, then control is transferred along an OVERRIDE 2 path via the circled O2 continuation step to an input calibration values step 1550, wherein size values for calibrating a size of each of the identified objects is input to a device 100 (the input sizes).

For the MAIN path, control then proceeds from the select size determination type step 1520 (the size type) to a size type test step 1522. If the size type is to assign predetermined sizes, then control proceeds to a predetermined size step 1524, wherein a size for each of the selected items in the LDBs is predetermined from a set of sizes for the selected items at known distances and wherein each of the selected items is shown on the one or more visual displays 128 at the known distances and then to a display the selected item step 1526, wherein the selected items are displayed on the identified objects in the captured images; otherwise, control then proceeds directly to the display the selected item step 1526. Control then proceeds to an adjust size and orientation step 1528, wherein a size and orientation of each of the selected items is adjusted until the size of each of the selected items is the same as the size of the identified objects based on initial sizes of each of the selected items or the assigned sizes (the Size and Orientation Data). Control then proceeds to a distance determination step 1530, wherein a distance to each of the identified objects is determined based on the Size and Orientation Data of the corresponding selected item. Control then proceeds to the circled E continuation step and then to a display distance step 1590 on the first page of FIG. 15, wherein the determined distance to each of the identified objects on the captured images is provided on the one or more visual displays 128. Of course, the distance may be provided via a speaker or any other non-display output device. Control then proceeds to a communication distance step 1592, wherein the distance to each of the identified object are supplied to any external device such as one or more E devices, one or more cell phones, other mobile devices, or any combination thereof. Control then proceeds to a stop step 1594, which exits the apparatus, system, or interface, terminates the apparatus, system, or interface via invoking a stop command, turning the apparatus or device 100 off, or changing locations.

For the OVERRIDE 1 path, control then proceeds to the similar item select step 1540, wherein an item from the LDBs, the CDBs, or any combination thereof is selected (the similar items). Control then proceeds to a display the similar item step 1542, wherein the similar items are displayed on the identified objects in the captured images. Control then proceeds to an adjust similar item size and orientation step 1544, wherein a size or orientation of each of the similar items is adjusted to a size and orientation of each of the identified objects in the captured images (the Size and Orientation Data). Control then proceeds to a determine distance step 1546, wherein a distance to each of the identified objects is determined based on the Size and Orientation Data of each of the similar items. Control then proceeds to the circled E continuation step and then to the display distance step 1590 on the first page of FIG. 15, wherein the distances to each of the identified objects on the captured images is displayed to a user via the one or more visual displays 128. Control then proceeds to the communication distance step 1592, wherein the distances to each of the identified objects are supplied to any external device such as one or more E devices, one or more cell phones, other mobile devices, or any combination thereof. Control then proceeds to the stop step 1594, wherein the application is terminated via invoking a stop command, turning the apparatus or device 100 off or changing locations. The OVERRIDE 1 path allows a user to input size information for the identified object and distance information for the selected item in the LDBs, the CDBs, or any combination thereof.

For the OVERRIDE 2 path, control then proceeds to an input calibration size value step 1550, wherein the user inputs sizes to each of the identified objects (the input sizes). Control then proceeds to the distance determination step 1530, wherein the input sizes are used to determine a distance to each of the identified objects. The OVERRIDE 2 path allows a user to input sizes of each of the selected items from the LDBs and override the size values for the selected items with different size values to modify one or more selected items in the LDBs, the CDBs, or any combination thereof and override the values for the selected items with different values to modify selected items in the LDBs, the CDBs, or any combination thereof. As such, the LDBs, the CDBs, or any combination thereof may increase over time at a user level in place of or in addition to any updates made to the LDBs by a managing program or other database.

If the selection mode the AUTOMATIC path, then control proceeds to the automatic distance determination step 1560. Control then proceeds to a select an object step 1562, wherein one of the identified objects is selected (the selected object). Control then proceeds to a determine object found step 1564, wherein a determination is made as to whether the selected object is found in the LDBs. Control then proceeds to a found object test step 1566. If the selected object is found in the LDBs, then control is transferred along a YES path back to the select an object step 1562. If the selected object is not found in the LBDs, then control is transferred along a NO path to a second determine identified object step 1568, wherein a determination is made as to whether the selected object is found in the CDBs. Control then proceeds, to second found object test step 1570. If the selected object is found in the CDBs, then control is transferred along a YES path to an add the selected object step 1572, wherein the selected object is added to the LDBs and then control proceeds back to the select an object step 1562. If the selected object is not found in the CDBs, then control is transferred along a NO path to a gather and/or generate information step 1574, wherein information is gathered and/or generated about the selected object from public website, public databases, public databases, private databases, or any combination thereof, and selecting another identified object. Then control is transferred to the add the selected object to the LDBs step 1572 and then to the select an object step 1562. If all of the identified objects have either been found in the LDBs or added to the LDBs, then control is transferred to a found item display step 1576, wherein each of the found items is displayed on the corresponding identified object in the captured images. Control then proceeds to a found item adjust size step 1578, wherein a size or orientation of each of the found items is adjusted until the size of each of the found items are the same as the sizes of each of the corresponding identified objects (the Size and Orientation Data). Control then proceeds to a distance determination step 1580, wherein a distance to each of the identified objects is determined based on the Size and Orientation Data of each of the found items. Control then proceeds to a continuation circled E step, which is a marker to transfer control to a display distance step 1590 on the first page of FIG. 15. Control then proceeds to the communication distance step 1592, and finally to the stop step 1594.

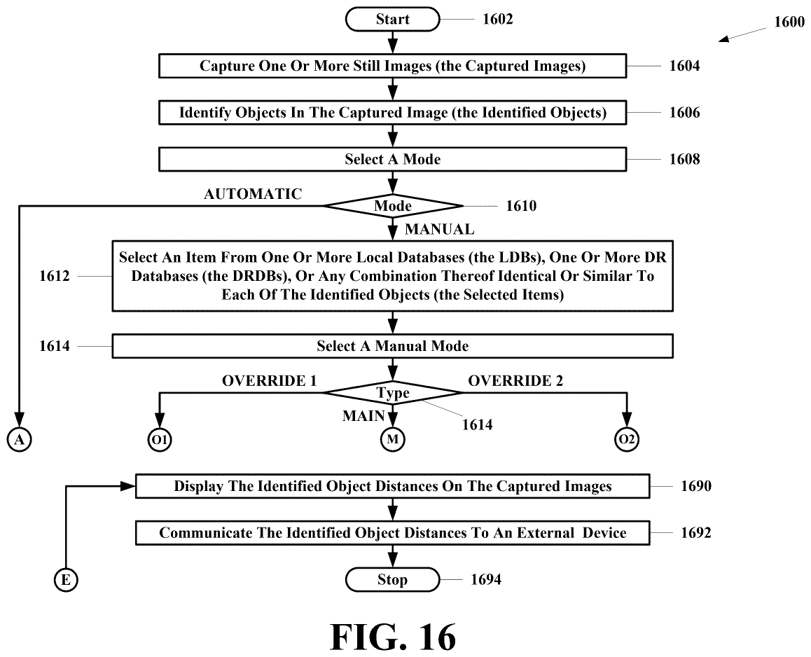

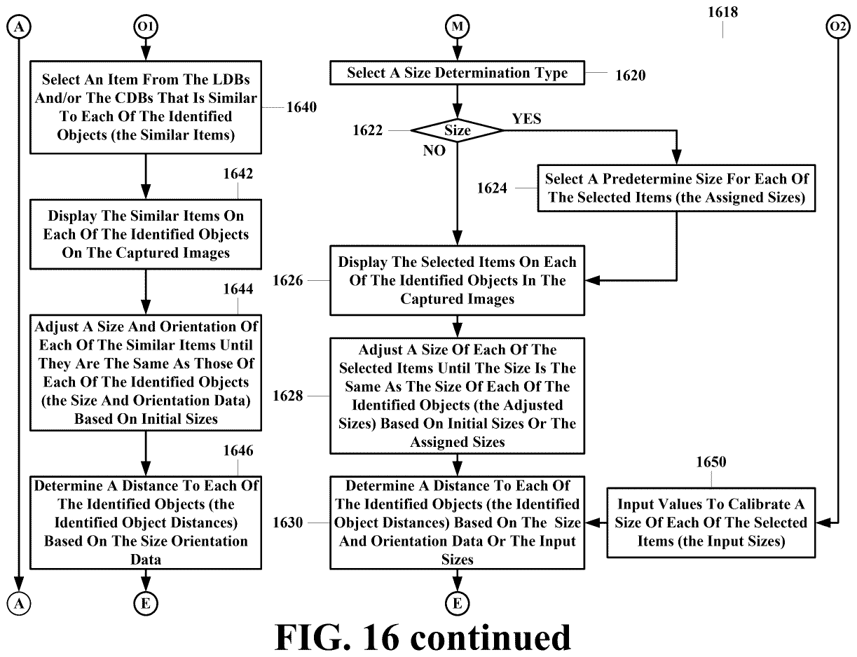

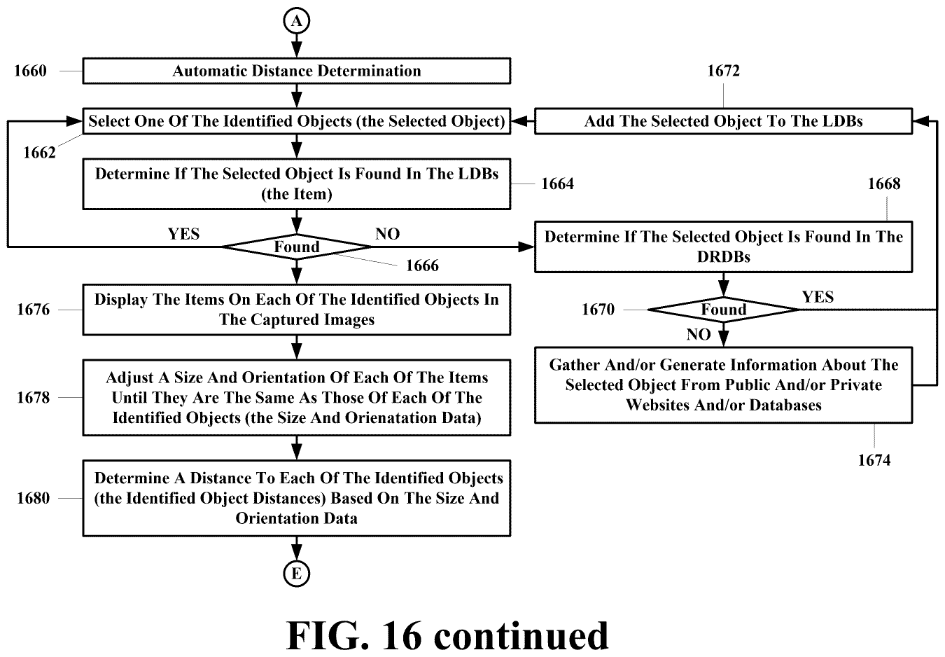

Referring now to FIG. 16, a conceptual flow chart of an embodiment of an apparatus, system, or interface and their operation, generally 1600, is shown to include a start step 1602. Control then proceeds to a capture image step 1604, wherein one or more still images are captured in real time, near real-time, or periodically (the captured images) by one or more devices configured to capture one or more still images. Control then proceeds to an identify object step 1606, wherein one or more objects are identified (the identified objects) in the captured images. Control then proceeds to a mode select step 1608, wherein a mode is selected (the selected mode). Control then proceeds to a mode test step 1610, wherein if the selected mode is to a manual distance determination process, then control is transferred along a MANUAL path to a select item step 1612, wherein an item from one or more local databases (the LDBs) or one or more web or cloud databases (the CDBs) is selected that identically corresponds to each of the identified objects (the selected items); otherwise, control is transferred along an AUTOMATIC path to a continuation step circled A on another page of FIG. 16. In FIG. 16, the circled E is a marker indicating that a step in another page of FIG. 16 is transferring control back to a previously defined step of FIG. 16 and circled O1 and circled O2 are continuation markers indicating that the manual path types are continued on another page of FIG. 16.

After the select item step 1612 of the MANUAL path control then proceeds to a manual type select step 1614, wherein a manual type is selected (the selected type). Control then proceeds to a select a manual type test step 1616. If the selected manual type is:
(a) a main manual entry format type, then control is transferred along a MAIN path to the continuation step circled M, which transfers control to a select size determination type step 1620, wherein a size type is selected (the selected type);
(b) a first override format type, which is invoked when no identical item is found in the LDBs or the CDBs corresponding to each of the identified objects, then control is transferred along an OVERRIDE 1 path via the circled O1 continuation step to a similar item select step 1640, wherein an item similar to each of the identified objects is selected from the LDBs or the CDBs (the similar items); or
(c) a second override format type, then control is transferred along an OVERRIDE 2 path via the circled O2 continuation step to an input calibration values step 1650, wherein size values for calibrating a size of each of the identified objects is input to a device 100 (the input sizes).

For the MAIN path, control then proceeds from the select size determination type step 1620 (the size type) to a size type test step 1622. If the size type is to assign predetermined sizes, then control proceeds to a predetermined size step 1624, wherein a size for each of the selected items in the LDBs is predetermined from a set of sizes for the selected items at known distances and wherein each of the selected items is shown on the one or more visual displays 128 at the known distances and then to a display the selected item step 1626, wherein the selected items are displayed on the identified objects in the captured images; otherwise, control then proceeds directly to the display the selected item step 1626. Control then proceeds to an adjust size or orientation step 1628, wherein a size and orientation of each of the selected items is adjusted until the size and orientation of each of the selected items is the same as the size and orientation of each of the identified objects (the Size and Orientation Data). Control then proceeds to a distance determination step 1630, wherein a distance to each of the identified objects is determined based on the Size and Orientation Data of the corresponding selected item. Control then proceeds to the circled E continuation step and then to a display distance step 1690 on the first page of FIG. 16, wherein the determined distance to each of the identified objects on the captured images is provided on the one or more visual displays 128. Of course, the distance may be provided via a speaker or any other non-display output device. Control then proceeds to a communication distance step 1692, wherein the distance to each of the identified objects are supplied to any external device such as one or more E devices, one or more cell phones, other mobile devices, or any combination thereof. Control then proceeds to a stop step 1694, which exits the apparatus, system, or interface, terminates the apparatus, system, or interface via invoking a stop command, turning the apparatus or device 100 off, or changing locations.

For the OVERRIDE 1 path, control then proceeds to the similar item select step 1640, wherein an item from the LDBs, the CDBs, or any combination thereof is selected (the similar items). Control then proceeds to a display the similar item step 1642, wherein the similar items are displayed on the identified objects in the captured images. Control then proceeds to an adjust similar item size step 1644, wherein a size of each of the similar items is adjusted to a size of each of the identified objects in the captured images. Control then proceeds to a determine distance step 1646, wherein a distance to each of the identified objects is determined based on the initial size of each of the similar items. Control then proceeds to the circled E continuation step and then to the display distance step 1690 on the first page of FIG. 16, wherein the distances to each of the identified objects on the captured images is displayed to a user via the one or more visual displays 128. Control then proceeds to the communication distance step 1692 and then proceeds to the stop step 1694. The OVERRIDE 1 path allows a user to input size information for the identified object and distance information for the selected item in the LDBs, the CDBs, or any combination thereof.

For the OVERRIDE 2 path, control then proceeds to an input calibration size value step 1650, wherein the user inputs sizes to each of the identified objects (the input sizes). Control then proceeds to the distance determination step 1630, wherein the input sizes are used to determine a distance to each of the identified objects. The OVERRIDE 2 path allows a user to input sizes of each of the selected items from the LDBs and override the size values for the selected items with different size values to modify one or more selected items in the LDBs, the CDBs, or any combination thereof and override the values for the selected items with different values to modify selected items in the LDBs, the CDBs, or any combination thereof. As such, the LDBs, the CDBs, or any combination thereof may increase over time at a user level in place of or in addition to any updates made to the LDBs by a managing program or other database.

If the selection mode the AUTOMATIC path, then control proceeds to the automatic distance determination step 1660. Control then proceeds to a select an object step 1662, wherein one of the identified objects is selected (the selected object). Control then proceeds to a determine object found step 1664, wherein a determination is made as to whether the selected object is found in the LDBs. Control then proceeds to a found object test step 1666. If the selected object is found in the LDBs, then control is transferred along a YES path back to the select an object step 1662. If the selected object is not found in the LBDs, then control is transferred along a NO path to a second determine identified object step 1668, wherein a determination is made as to whether the selected object is found in the CDBs. Control then proceeds, to second found object test step 1670. If the selected object is found in the CDBs, then control is transferred along a YES path to an add the selected object step 1672, wherein the selected object is added to the LDBs and then control proceeds back to the select an object step 1662. If the selected object is not found in the CDBs, then control is transferred along a NO path to a gather and/or generate information step 1674, wherein information is gathered and/or generated about the selected object from public website, public databases, public databases, private databases, or any combination thereof, and selecting another identified object. Then control is transferred to the add the selected object to the LDBs step 1672 and then to the select an object step 1662. If all of the identified objects have either been found in the LDBs or added to the LDBs, then control is transferred to a found item display step 1676, wherein each of the found items is displayed on the corresponding identified object in the captured images. Control then proceeds to a found item adjust size and orientation step 1678, wherein a size and orientation of each of the found items is adjusted until the size and orientation of each of the found items are the same as the sizes of each of the corresponding identified objects (the Size and Orientation Data). Control then proceeds to a distance determination step 1680, wherein a distance to each of the identified objects is determined based on the Size and Orientation Data of each of the found items. Control then proceeds to a continuation circled E step, which is a marker to transfer control to the display distance step 1690 on the first page of FIG. 16. Control then proceeds to the communication distance step 1692, and finally to the stop step 1694.

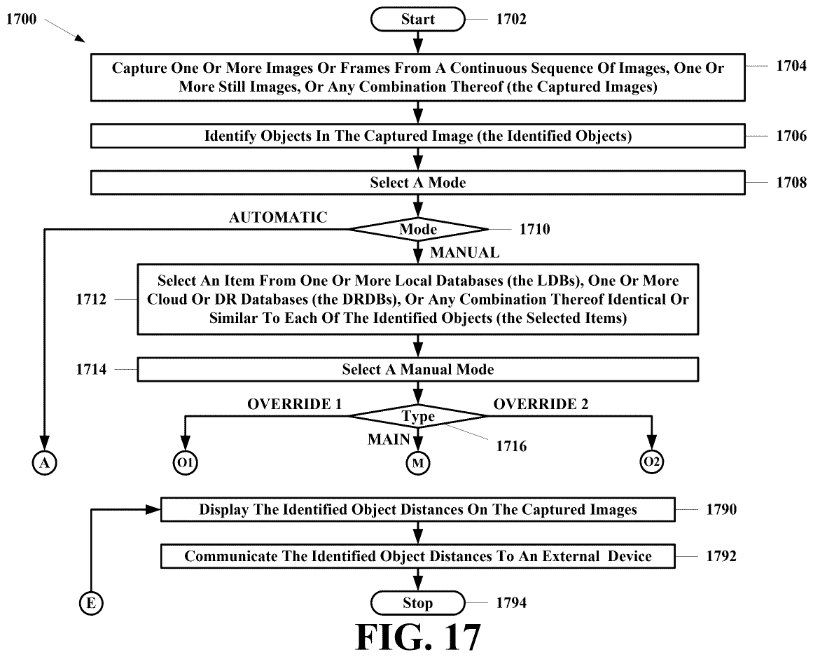

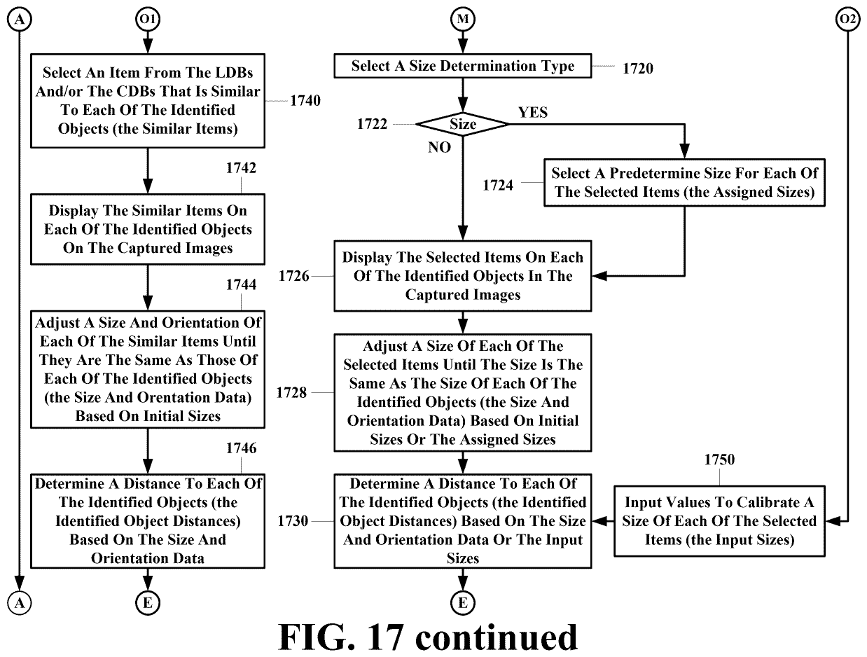

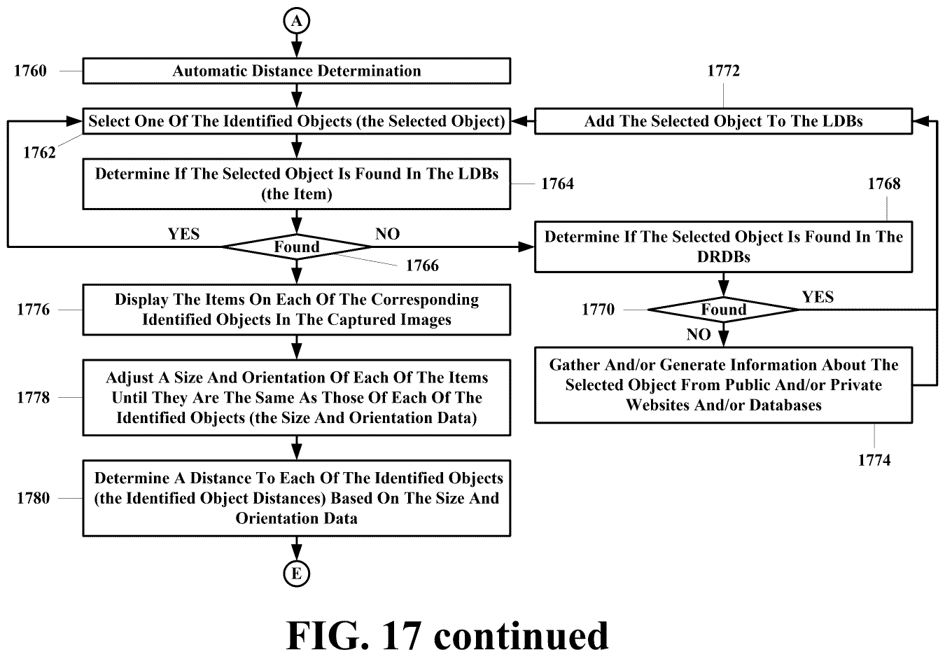

Referring now to FIG. 17, a conceptual flow chart of an embodiment of an apparatus, system, or interface and their operation, generally 1700, is shown to include a start step 1702. Control the proceeds to a capture image step 1704, wherein one or more images or frames from a continuous sequence of images, one or more still images, or any combination thereof are captured in real time, near real-time, or periodically (the captured images). Control then proceeds to an identify object step 1706, wherein one or more objects are identified (the identified objects) in the captured images. Control then proceeds to a mode select step 1708, wherein a mode is selected (the selected mode). Control then proceeds to a mode test step 1710, wherein if the selected mode is to a manual distance determination process, then control is transferred along a MANUAL path to a select item step 1712, wherein an item from one or more local databases (the LDBs) or one or more web or cloud databases (the CDBs) is selected that identically corresponds to each of the identified objects (the selected items); otherwise, control is transferred along an AUTOMATIC path to a continuation step circled A indicating that additional steps are shown on another page of FIG. 17. In FIG. 17, the circled E are markers indicating that a step in another page of FIG. 17 is transferring control back to a previously defined step of FIG. 17 and circled O1 and circled O2 are continuation markers circled M indicating that the manual path types are continued on another page of FIG. 17.

After the select item step 1712 of the Manual path, control then proceeds to a manual type select step 1714, wherein a manual type is selected (the selected type). Control then proceeds to a select a manual type test step 1716. If the selected manual type is:
(a) a main manual entry format type, then control is transferred along a MAIN path to the continuation step circled M, which transfers control to a select size determination type step 1720, wherein a size type is selected (the selected type);
(b) a first override format type, which is invoked when no identical item is in found the LDBs or the CDBs corresponding to each of the identified objects, then control is transferred along an OVERRIDE 1 path via the circled O1 continuation step to a similar item select step 1740, wherein an item similar to each of the identified objects is selected from the LDBs or the CDBs (the similar items); or
(c) a second override format type, then control is transferred along an OVERRIDE 2 path via the circled O2 continuation step to an input calibration value step 1750, wherein size values for calibrating a size of each of the identified objects is input to a device 100 (the input sizes).

For the MAIN path, control then proceeds from the select size determination type step 1720 (the size type) to a size type step 1722. If the size type is to assign predetermined sizes, then control proceeds to a predetermined size step 1724, wherein a size for each of the selected items in the LDBs is predetermined from a set of sizes for the selected items at known distances and wherein each of the selected items is shown on the one or more visual displays 128 at the known distances and then to a display the selected item step 1726, wherein the selected items are displayed on the identified objects in the captured images; otherwise, control then proceeds directly to the display the selected item step 1726. Control then proceeds to an adjust size and orientation step 1728, wherein a size and orientation of each of the selected items is adjusted until the size and orientation of each of the selected items is the same as the size and orientation of the identified objects based on initial sizes of each of the selected items or the assigned sizes (the Size and Orientation Data). Control then proceeds to a distance determination step 1730, wherein a distance to each of the identified objects is determined based on the size of the corresponding selected item. Control then proceeds to the circled E continuation step and then to a display distance step 1790 on the first page of FIG. 17, wherein the determined distance to each of the identified objects on the captured images is provided on the one or more visual displays 128. Of course, the distance may be provided via a speaker or any other non-display output device. Control then proceeds to a communication distance step 1792, wherein the distance to each of the identified objects are supplied to any external device such as one or more E devices, one or more cell phones, other mobile devices, or any combination thereof. Control then proceeds to a stop step 1794, which exits the apparatus, system, or interface, terminates the apparatus, system, or interface via invoking a stop command, turning the apparatus or device 100 off, or changing locations.

For the OVERRIDE 1 path, control then proceeds to the similar item select step 1740, wherein an item from the LDBs, the CDBs, or any combination thereof is selected (the similar items). Control then proceeds to a display the similar item step 1742, wherein the similar items are displayed on the identified objects in the captured images. Control then proceeds to an adjust similar item size step 1744, wherein a size of each of the similar items is adjusted to a size of each of the identified objects in the captured images. Control then proceeds to a determine distance step 1746, wherein a distance to each of the identified objects is determined based on the initial size of each of the similar items. Control then proceeds to the circled E continuation step and then to the display distance step 1790 on the first page of FIG. 17, where the distances to each of the identified objects on the captured images is displayed to a user via the one or more visual displays 128. Control then proceeds to the communication distance step 1792 and then to the stop step 1794. The OVERRIDE 1 path allows a user to input size information for the identified object and distance information for the selected item in the LDBs, the CDBs, or any combination thereof.

For the OVERRIDE 2 path, control then proceeds to the input calibration size value step 1750, wherein the user inputs sizes to each of the identified objects (the input sizes). Control then proceeds to the distance determination step 1730, wherein the input sizes are used to determine a distance to each of the identified objects. The OVERRIDE 2 path allows a user to input sizes of each of the selected items from the LDBs and override the size values for the selected items with different values to modify one or more selected items in the LDBs, the CDBs, or any combination thereof and override the values for the selected items with different values to modify selected items in the LDBs, the CDBs, or any combination thereof. As such, the LDBs, the CDBs, or any combination thereof may increase over time at a user level in place of or in addition to any updates made to the LDBs by a managing program or other database. Control then proceeds to the circled E continuation step and then to a display distance step 1790 on the first page of FIG. 17. Control then proceeds to the communication distance step 1792, and finally to the stop step 1794.

If the selection mode the AUTOMATIC path, then control proceeds to the automatic distance determination step 1760. Control then proceeds to a select an object step 1762, wherein one of the identified objects is selected (the selected object). Control then proceeds to a determine object found step 1764, wherein a determination is made as to whether the selected object is found in the LDBs. Control then proceeds to a found object test step 1766. If the selected object is found in the LDBs, then control is transferred along a YES path back to the select an object step 1762. If the selected object is not found in the LBDs, then control is transferred along a NO path to a second determine identified object step 1768, wherein a determination is made as to whether the selected object is found in the CDBs. Control then proceeds, to second found object test step 1770. If the selected object is found in the CDBs, then control is transferred along a YES path to an add the selected object step 1772, wherein the selected object is added to the LDBs and then control proceeds back to the select an object step 1762. If the selected object is not found in the CDBs, then control is transferred along a NO path to a gather and/or generate information step 1774, wherein information is gathered and/or generated about the selected object from public website, public databases, public databases, private databases, or any combination thereof, and selecting another identified object. Then control is transferred to the add the selected object to the LDBs step 1772 and then to the select an object step 1762. If all of the identified objects have either been found in the LDBs or added to the LDBs, then control is transferred to a found item display step 1776, wherein each of the found items is displayed on the corresponding identified object in the captured images. Control then proceeds to a found item adjust size step 1778, wherein a size of each of the found items is adjusted until the size of each of the found items are the same as the sizes of each of the corresponding identified objects. Control then proceeds to a distance determination step 1780, wherein a distance to each of the identified objects is determined based on the sizes of each of the found items. Control then proceeds to a continuation circled E step, which is a marker to transfer control to a display distance step 1790 on the first page of FIG. 17. Control then proceeds to the communication distance step 1792, and finally to the stop step 1794.

### EXPERIMENTS OF THE DISCLOSURE

The disclosure will be better understood with reference to the following non-limiting examples, which are illustrative only and not intended to limit the present disclosure to a particular embodiment.

### Example 1

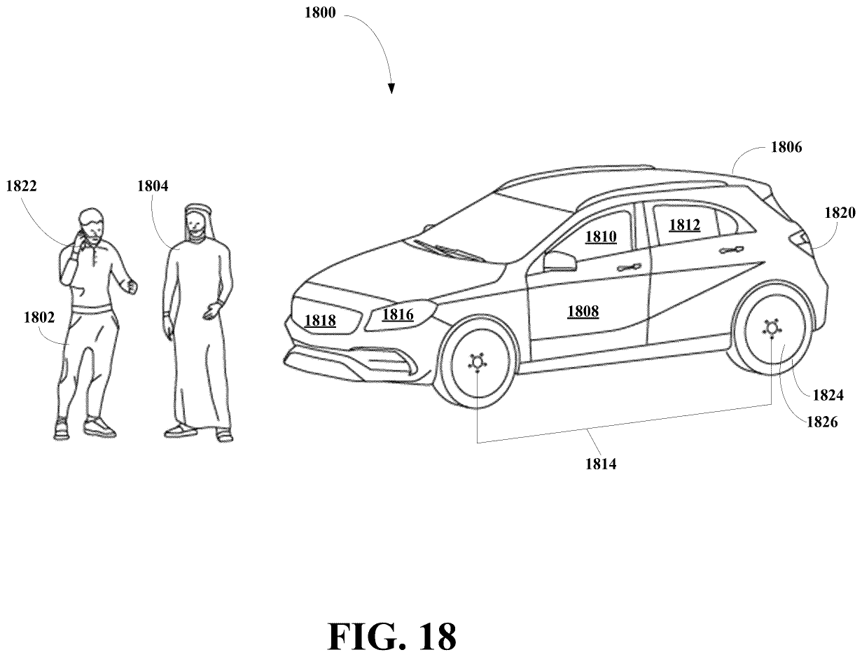

In a first non-limiting example an image capturing system 190, 250, 280 including an image capturing device 114, 140, 282 captures an image 1800 as shown in FIG. 18, comprising Image Data including a first person 1802 and a second person 1804 standing near an automobile 1806. The Image Data is provided on a display unit 164, 224, 264 and a user selects the second person 1804 as a Target. Once the second person 1804 is selected as the Target, an artificial intelligence system or AI engine in one or more network/cloud databases and AI engines 130, 298, 305 identifies all recognizable objects in the Image Data prioritizing the recognizable objects according to Confidence Values generated for each of the recognizable objects regarding dimensional information for each recognizable object. An exemplary prioritized listing of recognizable objects in the Image Data may include: (1) a driver's door 1808 of the automobile 1806, (2) a driver's door window 1810 of the automobile 1806, (3) a passenger's door window 1812 of the automobile 1806, (4) a wheel base 1814 of the automobile 1806, (5) a headlight 1816 of the automobile 1806, (6) a front grill 1818 of the automobile 1806, (7) a taillight assembly 1820 of the automobile 1806, (8) a smartphone 1822 held in a hand of the first person 1802, (9) the first person 1802, (10) the second person 1804, (11) the visible tires 1824 of the automobile 1806, and (12) the visible rims 1826 of wheel assemblies of the automobile 1806.

The artificial intelligence system or AI engine in one or more network/cloud databases and AI engines 130, 298, 305 calculates distance data for each of the recognizable objects providing the user with a distance of the Target second person 1804 from the image capturing device 114, 140, 282.

### Example 2

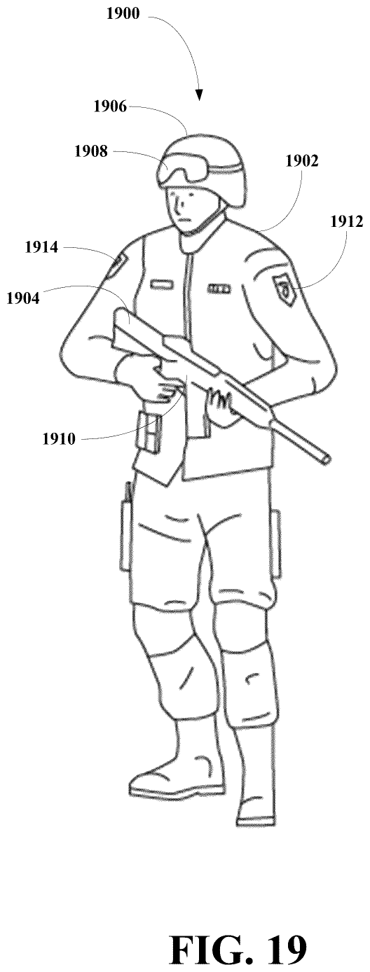

In a second non-limiting example an image capturing system 190, 250, 280 including an image capturing device 114, 140, 282 captures an image 1900 as shown in FIG. 19, comprising Image Data including an enemy combatant 1902 carrying an AK-47 1904. The Image Data is provided on a display unit 164, 224, 264 and a user selects the enemy combatant 1902 as a Target according to Operational Data input into an artificial intelligence system or AI engine in one or more network/cloud databases and AI engines 130, 298, 305.

Once the enemy combatant 1902 is selected as the Target, an artificial intelligence system or AI engine in one or more network/cloud databases and AI engines 130, 298, 305 identifies all recognizable objects in the Image Data, e.g., the enemy combatant 1902, including the military uniform worn by enemy combatant 1902 including insignia on the uniform, the AK-47 1904, a helmet 1906 worn by the enemy combatant 1902, ballistic eyewear 1908 of the enemy combatant 1902 located on the helmet 1906, prioritizing the recognizable objects according to Confidence Values generated for each of the recognizable objects according to dimensional information for each recognizable object according to the Operational Data. An exemplary prioritized listing of recognizable objects in the Image Data may include: (1) a lower receiver 1910 of the AK-47 1904, (2) a first patch 1912 located on a left arm sleeve of the military uniform of the enemy combatant 1902, (3) a second patch 1914 located on a right arm sleeve of the military uniform of the enemy combatant 1902, (4) the helmet 1906, (5) the ballistic eyewear 1908, (6) shoulder to shoulder measurement of the enemy combatant 1902 according to a center mass of enemy combatants provided in the Operational Data, and (7) a height measurement of the enemy combatant 1902 provided in the Operational Data.

The artificial intelligence system or AI engine in one or more network/cloud databases and AI engines 130, 298, 305 calculates distance data for each of the recognizable objects providing the user with a distance of the Target enemy combatant 1902 from the image capturing device 114, 140, 282.

### Example 3

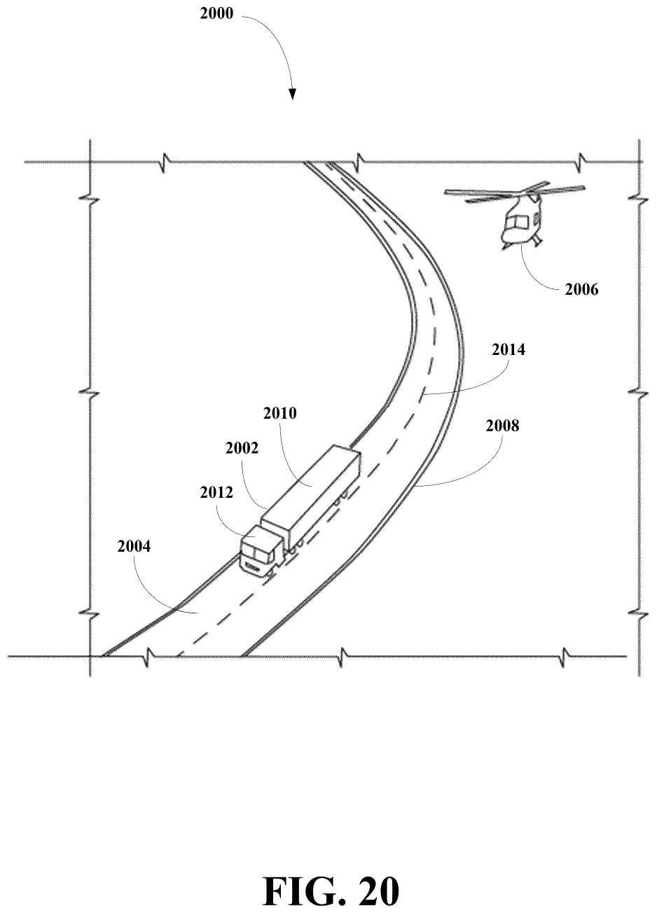

Referring to FIG. 20, in a third non-limiting example an image 2000 capturing system 190, 250, 280 including an image capturing device 114, 140, 282 is used to determine the location of a moving Target such as a tractor trailer 2002 traveling down a paved road 2004. In this example, the image capturing device 114, 140, 282 is mounted to a helicopter 2006 whereby an artificial intelligence system or AI engine in one or more network/cloud databases and AI engines 130, 298, 305 uses GPS to determine (1) the location of the helicopter 2006 and image capturing device 114, 140, 282 mounted thereto, (2) the altitude of the helicopter 2006 and image capturing device 114, 140, 282 mounted thereto, and (3) the speed of the helicopter 2006 and image capturing device 114, 140, 282 mounted thereto. At the same time, the image capturing device 114, 140, 282 captures one or more images in real time, near real time, or periodically and the artificial intelligence system or AI engine in one or more network/cloud databases and AI engines 130, 298, 305 identifies all recognizable objects in the Image Data including the tractor trailer 2002 and environment such as the paved road 2004, natural geographical features and man-made structural features.

The artificial intelligence system or AI engine in one or more network/cloud databases and AI engines 130, 298, 305 generates a map providing the location of the helicopter 2006 on a map, i.e., Position A. The artificial intelligence system or AI engine in one or more network/cloud databases and AI engines 130, 298, 305 also identifies a curve 2008 in the paved road 2004 where the tractor trailer 2002 is located and use this Image Data to pinpoint a location of the tractor trailer 2002 on the map, i.e., Position B, in real time, near real time, or periodically. The artificial intelligence system or AI engine in one or more network/cloud databases and AI engines 130, 298, 305 uses Position A and Position B to determine a distance between the tractor trailer 2002 and the image capturing device 114, 140, 282 mounted to the helicopter 2006 (GPS Distance Information). The artificial intelligence system or AI engine in one or more network/cloud databases and AI engines 130, 298, 305 prioritize the GPS Distance Information and the recognizable objects according to Confidence Values generated for the GPS Distance Information and for each of the recognizable objects according to dimensional information for each recognizable object. An exemplary prioritized listing of recognizable objects in the Image Data may include: (1) the trailer 2010 of the tractor trailer 2002, (2) the tractor 2012 of the tractor trailer 2002, (3) the paved road 2004, and (4) the lane divider markings 2014 of the paved road 2004.

The artificial intelligence system or AI engine in one or more network/cloud databases and AI engines 130, 298, 305 calculates distance data for each of the recognizable objects providing the user with a distance of the Target tractor trailer 2002 from the image capturing device 114, 140, 282 mounted to the helicopter 2006.

### Example 4

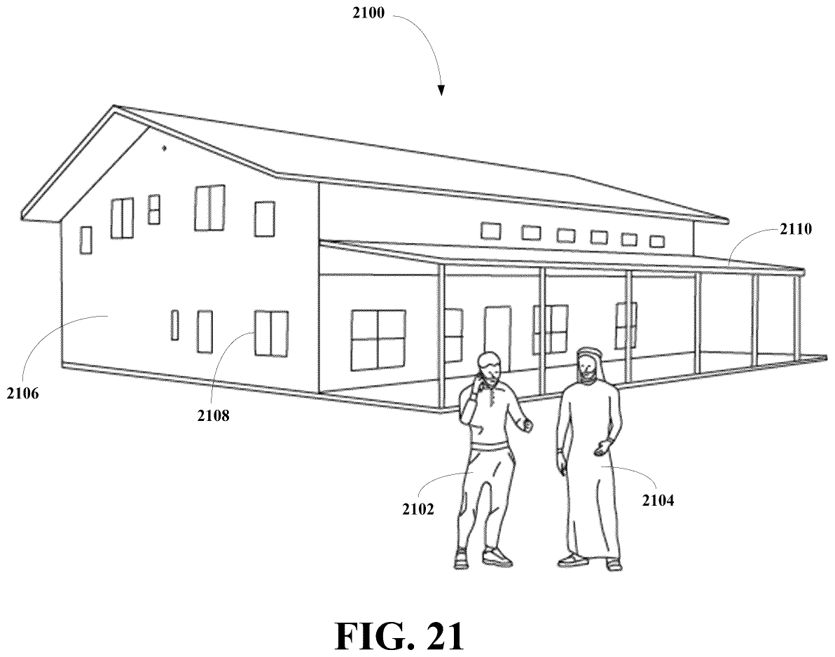

Referring to FIG. 21, in a fourth non-limiting example an image 2100 capturing system 190, 250, 280 including an image capturing device 114, 140, 282 is used to determine distance information for Target persons 2102 and 2104 located out in front of a building 2106, an artificial intelligence system or AI engine in one or more network/cloud databases and AI engines 130, 298, 305 uses one or more satellite images to identify (1) the location of an image capturing device 114, 140, 282, (2) a location of the building 2106, (3) dimensions of the building 2106, and (4) items located and/or near the building 2106, e.g., windows 2108, deck roof 2110, driveway (not shown), fencing (not shown), HVAC unit (not shown), solar panels (not shown), chimney (not shown). According to the identified locations of the image capturing device 114, 140, 282 and the building 2106, the artificial intelligence system or AI engine in one or more network/cloud databases and AI engines 130, 298, 305 calculates a distance between the image capturing device 114, 140, 282 and the building 2106 (Distance One).

The image capturing device 114, 140, 282 captures the captured image 2100 of the Target persons 2102 and 2104 located out in front of the building 2106. The artificial intelligence system or AI engine in one or more network/cloud databases and AI engines 130, 298, 305 compares the size of the building 2106 in the captured image 2100 to the size of each of the Target persons 2102 and 2104 to determine a distance of the Target persons 2102 and 2104 from the building 2106 (Distance Two). The artificial intelligence system or AI engine in one or more network/cloud databases and AI engines 130, 298, 305 uses Distance One and Distance Two to calculate a distance of the image capturing device 114, 140, 282 from the Target persons 2102 and 2104 (Distance Three).

The present disclosure may be described according to one or more of the following Embodiments.

Embodiment 1. An apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices, the DRs, and the IC devices;
   the apparatus or system configured to:
capture, via the image capturing systems, one or more images or one or more image sequences (the image data);
T select, via user input or the DRAI engines, one or more targets in the image data (the targets);
identify, via the DRAI engines, all recognizable objects in the image data on, at, or near each of the targets (the target identified objects);
calculate, via the DRAI engines, a confidence value for each of the target identified objects (the CVs);
rank, via the DRAI engines, each of the CVs (the ranked CVs);
O select, via the DRAI engines, an item identical to or similar to the target identified objects (the selected items) from the CDBs;
adjust, via the DRAI engines, a sizing and an orientation of each of the selected items until the size and orientation of each of the selected items is identical to a size and orientation of each of the target identified objects (the Size and Orientation Data); OD determine, via the DRAI engines, a distance to each of the target identified objects (the target identified object distances) based on the Size and Orientation Data of each of the selected items;
TD determine, via the DRAI engines, a distance to each of the targets (the target distances) based on the target identified object distances and the ranked CVs using algorithms and routines in the DRAI engines; and
communicate, via one of the one or more output devices, the target distances to the users, the authorized personnel, or combinations thereof.

Embodiment 2. An interface implementing an apparatus or system, the apparatus or system comprises:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices, the DRs, and the IC devices,
   the interface configured to:
capture, via the image capturing systems, one or more images or one or more image sequences (the image data);
T select, via user input or the DRAI engines, one or more targets in the image data (the targets);
identify, via the DRAI engines, all recognizable objects in the image data on, at, or near each of the targets (the target identified objects);
calculate, via the DRAI engines, a confidence value for each of the target identified objects (the CVs);
rank, via the DRAI engines, each of the CVs (the ranked CVs);
O select, via the DRAI engines, an item identical to or similar to the target identified objects (the selected items) from the CDBs;
adjust, via the DRAI engines, a sizing and an orientation of each of the selected items until the size and orientation of each of the selected items is identical to a size and orientation of each of the target identified objects (the Size and Orientation Data);
OD determine, via the DRAI engines, a distance to each of the target identified objects (the target identified object distances) based on the Size and Orientation Data of each of the selected items;
TD determine, via the DRAI engines, a distance to each of the targets (the target distances) based on the target identified object distances and the ranked CVs using algorithms and routines in the DRAI engines; and
communicate, via one of the one or more output devices, the target distances to the users, the authorized personnel, or combinations thereof.

Embodiment 3. The apparatus or system of Embodiment 1 or Embodiment 2, wherein:
the image capturing systems are configured to capture the image data in real time, near real time, or periodically.

Embodiment 4. The apparatus or system of Embodiment 3, wherein:
the image data include one or more still images, one or more images or frames from a continuous sequence of images, one or more images or frames from a live video stream, other types of captured image data, or combinations thereof.

Embodiment 5. The apparatus or system of Embodiment 4, wherein:
the user input comprises a touch by finger or handheld tool one or more images of the image data.

Embodiment 6. The apparatus or system of Embodiment 5, wherein:
the ranked CVs are ranked from a highest confidence value to a lowest confidence value or are ranked according to a ranking protocol.

Embodiment 7. The apparatus or system of Embodiment 6, wherein:
the ranking protocol comprises percentage value ranges or levels.

Embodiment 8. The apparatus or system of Embodiment 7, wherein:
each of the selected items includes an image and size and orientation data at one or more down range distances.

Embodiment 9. A method implemented on an apparatus or system, the apparatus or system comprises:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices, the DRs, and the IC devices,
   the method comprising:
capturing, via the image capturing systems, one or more images or one or more image sequences (the image data);
selecting, via user input or the DRAI engines, one or more targets in the image data (the targets);
identifying, via the DRAI engines, all recognizable objects in the image data on, at, or near each of the targets (the target identified objects);
calculating, via the DRAI engines, a confidence value for each of the target identified objects (the CVs);
ranking, via the DRAI engines, each of the CVs (the ranked CVs);
selecting, via the DRAI engines, an item identical to or similar to the target identified objects (the selected items) from the CDBs;
adjusting, via the DRAI engines, a sizing and an orientation of each of the selected items until the size and orientation of each of the selected items is identical to a size and orientation of each of the target identified objects (the Size and Orientation Data); OD determining, via the DRAI engines, a distance to each of the target identified objects (the target identified object distances) based on the Size and Orientation Data of each of the selected items;
TD determining, via the DRAI engines, a distance to each of the targets (the target distances) based on the target identified object distances and the ranked CVs using algorithms and routines in the DRAI engines; and communicating, via one of the one or more output devices, the target distances to the users, the authorized personnel, or combinations thereof.

Embodiment 10. The method of Embodiment 9, wherein:
the capturing occurs in real time, near real time, or periodically.

Embodiment 11. The method of Embodiment 10, wherein:
the image data include one or more still images, one or more images or frames from a continuous sequence of images, one or more images or frames from a live video stream, other types of captured image data, or combinations thereof.

Embodiment 12. The method of Embodiment 11, wherein:
the user input comprises a touch by finger or handheld tool one or more images of the image data.

Embodiment 13. The method of Embodiment 12, wherein:
the ranked CVs are ranked from a highest confidence value to a lowest confidence value or are ranked according to a ranking protocol.

Embodiment 14. The method of Embodiment 13, wherein:
the ranking protocol comprises percentage value ranges or levels.

Embodiment 15. The method of Embodiment 14, wherein:
each of the selected items includes an image and size and orientation data at one or more down range distances.

Embodiment 16. An apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines),
communication hardware and software, and routines for implementing the apparatus or system;
one or more image capturing devices (the IC devices); and
communication pathways between the E devices, the DRs, and the IC devices,
   the apparatus or system configured to:
capture, via the image capturing systems, one or more images or one or more image sequences (the image data);
target select, via user input or the LAI engines, one or more targets in the image data (the targets);
identify, via the LAI engines, all recognizable objects in the image data on, at, or near each of the targets (the target identified objects);
calculate, via the LAI engines, a confidence value for each of the target identified objects (the CVs);
rank, via the LAI engines, each of the CVs (the ranked CVs);
item select, via the LAI engines, an item identical to or similar to the target identified objects (the selected items) from the LDBs;
adjust, via the LAI engines, a sizing and an orientation of each of the selected items until the size and orientation of each of the selected items is identical to a size and orientation of each of the target identified objects (the Size and Orientation Data);
OD determine, via the LAI engines, a distance to each of the target identified objects (the target identified object distances) based on the Size and Orientation Data of each of the selected items;
TD determine, via the LAI engines, a distance to each of the targets (the target distances) based on the target identified object distances and the ranked CVs using algorithms and routines in the DRAI engines; and
communicate, via the communication pathways, the target distances to the users, the authorized personnel, or combinations thereof.

Embodiment 17. An interface implemented on an apparatus or system,
the apparatus or system comprising:
   one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
   one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
   one or more image capturing devices (the IC devices); and
   communication pathways between the E devices, the DRs, and the IC devices,
      the interface configured to:
capture, via the image capturing systems, one or more images or one or more image sequences (the image data);
target select, via user input or the LAI engines, one or more targets in the image data (the targets);
identify, via the LAI engines, all recognizable objects in the image data on, at, or near each of the targets (the target identified objects);
calculate, via the LAI engines, a confidence value for each of the target identified objects (the CVs);
rank, via the LAI engines, each of the CVs (the ranked CVs);
item select, via the LAI engines, an item identical to or similar to the target identified objects (the selected items) from the LDBs;
adjust, via the LAI engines, a sizing and an orientation of each of the selected items until the size and orientation of each of the selected items is identical to a size and orientation of each of the target identified objects (the Size and Orientation Data);
OD determine, via the LAI engines, a distance to each of the target identified objects (the target identified object distances) based on the Size and Orientation Data of each of the selected items;
TD determine, via the LAI engines, a distance to each of the targets (the target distances) based on the target identified object distances and the ranked CVs using algorithms and routines in the DRAI engines; and
communicate, via the communication pathways, the target distances to the users, the authorized personnel, or combinations thereof.

Embodiment 18. The apparatus or system of Embodiment 16 or Embodiment 17, wherein:
the image capturing systems are configured to capture the image data in real time, near real time, or periodically.

Embodiment 19. The apparatus or system of Embodiment 18, wherein:
the image data include one or more still images, one or more images or frames from a continuous sequence of images, one or more images or frames from a live video stream, other types of captured image data, or combinations thereof.

Embodiment 20. The apparatus or system of Embodiment 19, wherein:
the user input comprises a touch by finger or handheld tool one or more images of the image data.

Embodiment 21. The apparatus or system of Embodiment 20, wherein:
the ranked CVs are ranked from a highest confidence value to a lowest confidence value or are ranked according to a ranking protocol.

Embodiment 22. The apparatus or system of Embodiment 21, wherein:
the ranking protocol comprises percentage value ranges or levels.

Embodiment 23. The apparatus or system of Embodiment 22, wherein:
each of the selected items includes an image and size and orientation data at one or more down range distances.

Embodiment 24. A method implemented on an apparatus or system,
the apparatus or system comprising:
   one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
   one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
   one or more image capturing devices (the IC devices); and
   communication pathways between the E devices, the DRs, and the IC devices,
      the method comprising:
capturing, via the image capturing systems, one or more images or one or more image sequences (the image data);
target selecting, via user input or the LAI engines, one or more targets in the image data (the targets);
identifying, via the LAI engines, all recognizable objects in the image data on, at, or near each of the targets (the target identified objects);
calculating, via the LAI engines, a confidence value for each of the target identified objects (the CVs);
ranking, via the LAI engines, each of the CVs (the ranked CVs);
item selecting, via the LAI engines, an item identical to or similar to the target identified objects (the selected items) from the LDBs;
adjusting, via the LAI engines, a sizing and an orientation of each of the selected items until the size and orientation of each of the selected items is identical to a size and orientation of each of the target identified objects (the Size and Orientation Data);
OD determining, via the LAI engines, a distance to each of the target identified objects (the target identified object distances) based on the Size and Orientation Data of each of the selected items;
TD determining, via the LAI engines, a distance to each of the targets (the target distances) based on the target identified object distances and the ranked CVs using algorithms and routines in the DRAI engines; and
communicating, via the communication pathways, the target distances to the users, the authorized personnel, or combinations thereof.

Embodiment 25. The method of Embodiment 24, wherein:
the capturing occurs in real time, near real time, or periodically.

Embodiment 26. The method of Embodiment 25, wherein:
the image data include one or more still images, one or more images or frames from a continuous sequence of images, one or more images or frames from a live video stream, other types of captured image data, or combinations thereof.

Embodiment 27. The method of Embodiment 26, wherein:
the user input comprises a touch by finger or handheld tool one or more images of the image data.

Embodiment 28. The method of Embodiment 27, wherein:
the ranked CVs are ranked from a highest confidence value to a lowest confidence value or are ranked according to a ranking protocol.

Embodiment 29. The method of Embodiment 28, wherein:
the ranking protocol comprises percentage value ranges or levels.

Embodiment 30. The method of Embodiment 29, wherein:
each of the selected items includes an image and size and orientation data at one or more down range distances.

Embodiment 31. An apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines),
communication hardware and software, and routines for implementing the apparatus or system;
one or more image capturing devices (the IC devices); and
communication pathways between the E devices, the DRs, and the IC devices,
   the apparatus or system configured to:
capture, via the image capturing systems, one or more images or one or more image sequences (the image data);
target select, via user input or the LAI engines, the DRAI engines, or any combination thereof, one or more targets in the image data (the targets);
identify, via the LAI engines, the DRAI engines, or any combination thereof, all recognizable objects in the image data on, at, or near each of the targets (the target identified objects);
calculate, via the LAI engines, the DRAI engines, or any combination thereof, a confidence value for each of the target identified objects (the CVs);
rank, the LAI engines, the DRAI engines, or any combination thereof, each of the CVs (the ranked CVs);
item select, via user input or the LAI engines, the DRAI engines, or any combination thereof, an item identical to or similar to the target identified objects (the selected items) from the LDBs, the CDBs, or any combination thereof;
adjust, via the LAI engines, the DRAI engines, or any combination thereof, a sizing and an orientation of each of the selected items until the size and orientation of each of the selected items is identical to a size and orientation of each of the target identified objects (the Size and Orientation Data);
OD determine, the LAI engines, the DRAI engines, or any combination thereof, a distance to each of the target identified objects (the target identified object distances) based on the Size and Orientation Data of each of the selected items;
TD determine, the LAI engines, the DRAI engines, or any combination thereof, a distance to each of the targets (the target distances) based on the target identified object distances and the ranked CVs using algorithms and routines in the DRAI engines; and
communicate, via the communication pathways, the target distances to the users, the authorized personnel, or combinations thereof.

Embodiment 32. An interface implemented on an apparatus or system,
the apparatus or system comprising:
   one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
   one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
   one or more image capturing devices (the IC devices); and
   communication pathways between the E devices, the DRs, and the IC devices,
      the interface configured to:
capture, via the image capturing systems, one or more images or one or more image sequences (the image data);
target select, via user input or the LAI engines, the DRAI engines, or any combination thereof, one or more targets in the image data (the targets);
identify, via the LAI engines, the DRAI engines, or any combination thereof, all recognizable objects in the image data on, at, or near each of the targets (the target identified objects);
calculate, via the LAI engines, the DRAI engines, or any combination thereof, a confidence value for each of the target identified objects (the CVs);
rank, the LAI engines, the DRAI engines, or any combination thereof, each of the CVs (the ranked CVs);
item select, via user input or the LAI engines, the DRAI engines, or any combination thereof, an item identical to or similar to the target identified objects (the selected items) from the LDBs, the CDBs, or any combination thereof;
adjust, via the LAI engines, the DRAI engines, or any combination thereof, a sizing and an orientation of each of the selected items until the size and orientation of each of the selected items is identical to a size and orientation of each of the target identified objects (the Size and Orientation Data);
OD determine, the LAI engines, the DRAI engines, or any combination thereof, a distance to each of the target identified objects (the target identified object distances) based on the Size and Orientation Data of each of the selected items;
TD determine, the LAI engines, the DRAI engines, or any combination thereof, a distance to each of the targets (the target distances) based on the target identified object distances and the ranked CVs using algorithms and routines in the DRAI engines; and
communicate, via the communication pathways, the target distances to the users, the authorized personnel, or combinations thereof.

Embodiment 33. The apparatus or system of Embodiment 31 or Embodiment 32, wherein:
the image capturing systems are configured to capture the image data in real time, near real time, or periodically.

Embodiment 34. The apparatus or system of Embodiment 33, wherein:
the image data include one or more still images, one or more images or frames from a continuous sequence of images, one or more images or frames from a live video stream, other types of captured image data, or combinations thereof.

Embodiment 35. The apparatus or system of Embodiment 34, wherein:
the user input comprises a touch by finger or handheld tool one or more images of the image data.

Embodiment 36. The apparatus or system of Embodiment 35, wherein:
the ranked CVs are ranked from a highest confidence value to a lowest confidence value or are ranked according to a ranking protocol.

Embodiment 37. The apparatus or system of Embodiment 36, wherein:
the ranking protocol comprises percentage value ranges or levels.

Embodiment 38. The apparatus or system of Embodiment 37, wherein:
each of the selected items includes an image and size and orientation data at one or more down range distances.

Embodiment 39. A method implemented on an apparatus or system,
the apparatus or system comprising:
   one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
   one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
   one or more image capturing devices (the IC devices); and
   communication pathways between the E devices, the DRs, and the IC devices,
      the method comprising:
capturing, via the image capturing systems, one or more images or one or more image sequences (the image data);
target selecting, via user input or the LAI engines, the DRAI engines, or any combination thereof, one or more targets in the image data (the targets);
identifying, via the LAI engines, the DRAI engines, or any combination thereof, all recognizable objects in the image data on, at, or near each of the targets (the target identified objects);
calculating, via the LAI engines, the DRAI engines, or any combination thereof, a confidence value for each of the target identified objects (the CVs);
ranking, the LAI engines, the DRAI engines, or any combination thereof, each of the CVs (the ranked CVs);
item selecting, via user input or the LAI engines, the DRAI engines, or any combination thereof, an item identical to or similar to the target identified objects (the selected items) from the LDBs, the CDBs, or any combination thereof;
adjusting, via the LAI engines, the DRAI engines, or any combination thereof, a sizing and an orientation of each of the selected items until the size and orientation of each of the selected items is identical to a size and orientation of each of the target identified objects (the Size and Orientation Data);
OD determining, the LAI engines, the DRAI engines, or any combination thereof, a distance to each of the target identified objects (the target identified object distances) based on the Size and Orientation Data of each of the selected items;
TD determining, the LAI engines, the DRAI engines, or any combination thereof, a distance to each of the targets (the target distances) based on the target identified object distances and the ranked CVs using algorithms and routines in the DRAI engines; and
communicating, via the communication pathways, the target distances to the users, the authorized personnel, or combinations thereof.

Embodiment 40. The method of Embodiment 39, wherein:
the capturing occurs in real time, near real time, or periodically.

Embodiment 41. The method of Embodiment 40, wherein:
the image data include one or more still images, one or more images or frames from a continuous sequence of images, one or more images or frames from a live video stream, other types of captured image data, or combinations thereof.

Embodiment 42. The method of Embodiment 41, wherein:
the user input comprises a touch by finger or handheld tool one or more images of the image data.

Embodiment 43. The method of Embodiment 42, wherein:
the ranked CVs are ranked from a highest confidence value to a lowest confidence value or are ranked according to a ranking protocol.

Embodiment 44. The method of Embodiment 43, wherein:
the ranking protocol comprises percentage value ranges or levels.

Embodiment 45. The method of Embodiment 44, wherein:
each of the selected items includes an image and size and orientation data at one or more down range distances.

Embodiment 46. An apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud servers (the CSs) including one or more user databases (the UDBs) including user identification data and a E device database (the EDDBs) including E device identification data; and
communication pathways between the E devices and the CSs,
   the apparatus or system configured to:
receive, via one of the E devices (the user input E device), a start function;
if the apparatus or system is configured to limit access thereto, then:
   receive, via the CSs from the user input E device, a user access request;
   receive, via the CSs from the user input E device, user identification data and E device identification data, the E device identification data comprise one or more E devices under the control of the user (the user E devices);
   verify/authenticate, via the CSs, if the user will be granted access to the apparatus or system based on the user identification data and the E device identification data;
   if the potential user is included in the UBDs, then:
      if one or more of the user E devices are not in the EDDBs, then add the one or more of the user E devices to the EDDBs on the CSs;
      create, via the user input E device, a plurality of data repositories (the DRs) on the CSs;
      create, via the user input E device, one or more artificial intelligence applications or artificial intelligence engines (the DRAI engines) on the CSs;
      receive, via the user input E device, an add new users and/or new E devices request;
      if a new user or a new E device is to be added, then add a new user to the UDBs or a new E device to the EDDBs on the CSs; and
      if additional users or E devices are to be added, then add a new user and new user identification data to the UDBs or a new E device and new E device identification data to the EDDBs on the CSs; and
   if no additional users or E devices are to be added or the user is not included in the UDBs, then stop.
Embodiment 47. An interface implemented on an apparatus or system,
the apparatus or system comprising:
   one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
   one or more cloud servers (the CSs) including one or more user databases (the UDBs) including user identification data and a E device database (the EDDBs) including E device identification data; and
   communication pathways between the E devices and the CSs,
      the interface is configured to:
receive, via one of the E devices (the user input E device), a start function;
if the embodiment of the AI targeting apparatus is configured to limit access thereto, then:
   receive, via the CSs from the user input E device, a user access request;
   receive, via the CSs from the user input E device, user identification data and E device identification data for one or more E devices under the control of the user (the user E devices);
   verify/authenticate, via the CSs, if the user will be granted access to the apparatus or system based on the user identification data and the E device identification data;
   if the potential user is included in the UBDs, then:
      if one or more of the user E devices are not in the EDDBs, then add the one or more of the user E devices to the EDDBs on the CSs;
      create, via the user input E device, a plurality of data repositories (the DRs) on the CSs;
      create, via the user input E device, one or more artificial intelligence applications or artificial intelligence engines (the DRAI engines) on the CSs;
      receive, via the user input E device, an add new users and/or new E devices request;
      if a new user or a new E device is to be added, then add a new user to the UDBs or a new E device to the EDDBs on the CSs; and
      if additional users or E devices are to be added, then add a new user and new user identification data to the UDBs or a new E device and new E device identification data to the EDDBs on the CSs;
   if no additional users or E devices are to be added, then stop.

Embodiment 48. A method implemented on an apparatus or system,
the apparatus or system comprising:
   one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
   one or more cloud servers (the CSs) including one or more user databases (the UDBs) including user identification data and a E device database (the EDDBs) including E device identification data; and
   communication pathways between the E devices and the CSs,
      the method comprising:
receiving, via one of the E devices (the user input E device), a start function;
if the embodiment of the AI targeting apparatus is configured to limit access thereto, then:
   receiving, via the CSs from the user input E device, a user access request;
   receiving, via the CSs from the user input E device, user identification data and E device identification data for one or more E devices under the control of the user (the user E devices);
   verify/authenticate, via the CSs, if the user will be granted access to the apparatus or system based on the user identification data and the E device identification data;
   if the potential user is included in the UBDs, then:
      if one or more of the user E devices are not in the EDDBs, then adding the one or more of the user E devices to the EDDBs on the CSs;
      creating, via the user input E device, a plurality of data repositories (the DRs) on the CSs;
      creating, via the user input E device, one or more artificial intelligence applications or artificial intelligence engines (the DRAI engines) on the CSs;
      receiving, via the user input E device, an add new users and/or new E devices request;
      if a new user or a new E device is to be added, then adding a new user to the UDBs or a new E device to the EDDBs on the CSs; and
      if additional users or E devices are to be added, then adding a new user and new user identification data to the UDBs or a new E device and new E device identification data to the EDDBs on the CSs;
      if no additional users or E devices are to be added, then stopping.

Embodiment 49. The apparatus or system of Embodiment 46, Embodiment 47 or Embodiment 48, wherein
the user identification data comprise a user name, a user ID (UID), a Universal Unique Identifier (UUID), or combination thereof, a user password, a phone number, an email address, other user identification information or any combination thereof.

Embodiment 50. The apparatus or system of Embodiment 49, wherein
the user name comprises a full name of a person, initials of a person, a combination of letters, a combination of number, or any combination thereof.

Embodiment 51. The apparatus or system of Embodiment 46, Embodiment 47 or Embodiment 48, wherein
the E device identification data comprise a unique identifier assigned to each E device.

Embodiment 52. The apparatus or system of Embodiment 51, wherein
the E device identification data comprise E device manufacturer data, E device serial number data, E device operating system data, Identifier for Advertisers (IDFA) for iOS® devices, Android Advertising ID (AAID) for Android® devices, Google Advertising ID (GAID) for the Google® ecosystem, proprietary Secure ID, Media Access Control address (MAC address), International Mobile Equipment Identity (IMEI) for mobile devices, Universally Unique Identifier (UUID), Item Unique Identification (IUID), Unique Device Identification (UDI), Unique Device Identifier (UDID), or any combination thereof.

Embodiment 53. The apparatus or system of Embodiment 46, Embodiment 47 or Embodiment 48, wherein
each of the DRs includes one or more databases (DBs) or data storage structures (DSSs) (collectively the DRDBDSSs).

Embodiment 54. The apparatus or system of Embodiment 53, wherein
each of the DRDBDSSs includes data corresponding to objects, object types, object classes, object categories, users, user types, user classes, user categories, apparatuses, apparatus types, apparatus classes, apparatus categories, operations, operation types, operation classes, and operation categories (the DRDBDSS data).

Embodiment 55. The apparatus or system of Embodiment 46, Embodiment 47 or Embodiment 48, wherein
the DRAI engines comprise routines for recognizing objects in captured images from an image capturing device.

Embodiment 56. An apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud servers (the CSs) including one or more user databases (the UDBs) including user identification data and a E device database (the EDDBs) including E device identification data;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices, the CSs, the DRs, and the IC devices,
   the apparatus or system configured to:
receive, via one of the E devices (the user input E device), a start function;
if the apparatus or system is configured to limit access thereto, then:
   receive, via the CSs from the user input E device, a user access request;
   receive, via the CSs from the user input E device, user identification data and E device identification data, the E device identification data comprise one or more E devices under control the user (the user E devices);
   verify/authenticate, via the E devices, whether the potential user will be provided access to the apparatus or system based on the user identification data and the one or more user devices identification data;
   if the potential user is included in the UBDs, then:
      if one or more of the user E devices are not in the EDDBs, then add the one or more of the user E devices to the EDDBs on the CSs;
      select, via the user input E device, objects to be stored in the DRDBDSSs of all of the DRs itemized according to an object type and/or an object class and/or an object category (the selected items);
      identify, via the user input E device, one or more components, features, attributes, characteristics, and associated information for each Item to be stored in the DRDBDSSs of all of the DRs (the aspects);
      select, via the user input E device, specific parameters, patterns, and distributions for use in generating or gathering data on each of the selected items base on the aspects of each of the selected items (the criterion);
      gather/generate, via the user input E device, gather and/or generate data for each of the selected items (the item data);
      store, via the user input E device, the item data in the DRDBDSSs of all of the DRs;
      generate, via the E devices, user predictive rules, models, methods, and combinations thereof (the user AI rules) and the operation predictive rules, models, methods, and combinations thereof (the operation AI rules) based on the item data; and
      store, via the user input E device, the user AI rules and the operation AI rules in the DRDBDSSs of all of the DRs; and
   if no additional users or E devices are to be added or the user is not included in the UDBs, then stop.

Embodiment 57. An interface implemented on an apparatus or system,
the apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud servers (the CSs) including one or more user databases (the UDBs) including user identification data and a E device database (the EDDBs) including E device identification data;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices, the CSs, the DRs, and the IC devices,
   the interface configured to:
receive, via one of the E devices (the user input E device), a start function;
if the apparatus or system is configured to limit access thereto, then:
   receive, via the CSs from the user input E device, a user access request;
   receive, via the CSs from the user input E device, user identification data and E device identification data, the E device identification data comprise one or more E devices under control the user (the user E devices);
   verify/authenticate, via the E devices, whether the potential user will be provided access to the apparatus or system based on the user identification data and the one or more user devices identification data;
   if the potential user is included in the UBDs, then:
      if one or more of the user E devices are not in the EDDBs, then add the one or more of the user E devices to the EDDBs on the CSs;
      select, via the user input E device, objects to be stored in the DRDBDSSs of all of the DRs itemized according to an object type and/or an object class and/or an object category (the selected items);
      identify, via the user input E device, one or more components, features, attributes, characteristics, and associated information for each Item to be stored in the DRDBDSSs of all of the DRs (the aspects);
      select, via the user input E device, specific parameters, patterns, and distributions for use in generating or gathering data on each of the selected items base on the aspects of each of the selected items (the criterion);
      gather/generate, via the user input E device, gather and/or generate data for each of the selected items (the item data);
      store, via the user input E device, the item data in the DRDBDSSs of all of the DRs;
      generate, via the E devices, user predictive rules, models, methods, and combinations thereof (the user AI rules) and the operation predictive rules, models, methods, and combinations thereof (the operation AI rules) based on the item data; and
      store, via the user input E device, the user AI rules and the operation AI rules in the DRDBDSSs of all of the DRs; and
   if no additional users or E devices are to be added or the user is not included in the UDBs, then stop.

Embodiment 58. A method implemented on an apparatus or system,
the apparatus or system comprising:
   one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system,
      the method comprising:
receiving, via one of the E devices (the user input E device), a start function;
if the apparatus or system is configured to limit access thereto, then:
   receiving, via the CSs from the user input E device, a user access request;
   receiving, via the CSs from the user input E device, user identification data and E device identification data, the E device identification data comprise one or more E devices under control the user (the user E devices);
   verifying/authenticating, via the E devices, whether the potential user will be provided access to the apparatus or system based on the user identification data and the one or more user devices identification data;
   if the potential user is included in the UBDs, then:
      if one or more of the user E devices are not in the EDDBs, then adding the one or more of the user E devices to the EDDBs on the CSs;
      selecting, via the user input E device, objects to be stored in the DRDBDSSs of all of the DRs itemized according to an object type and/or an object class and/or an object category (the selected items);
      identifying, via the user input E device, one or more components, features, attributes, characteristics, and associated information for each Item to be stored in the DRDBDSSs of all of the DRs (the aspects);
      selecting, via the user input E device, specific parameters, patterns, and distributions for use in generating or gathering data on each of the selected items base on the aspects of each of the selected items (the criterion);
      gathering/generating, via the user input E device, gather and/or generate data for each of the selected items (the item data);
      storing, via the user input E device, the item data in the DRDBDSSs of all of the DRs;
      generating, via the E devices, user predictive rules, models, methods, and combinations thereof (the user AI rules) and the operation predictive rules, models, methods, and combinations thereof (the operation AI rules) based on the item data; and
      storing, via the user input E device, the user AI rules and the operation AI rules in the DRDBDSSs of all of the DRs; and
   if no additional users or E devices are to be added or the user is not included in the UDBs, then stopping.

Embodiment 59. The apparatus or system of Embodiment 56, Embodiment 57 or Embodiment 58, wherein
the aspects include dimensional data, shape or form type data, color and color pattern type data, make/model data for articles of manufacture, entity behavioral tendencies, entity routines, sensor data, user data, motion data, environmental data, temporal data, contextual data, biometric data, any other object data, or any combination thereof.

Embodiment 60. An apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices, the DRs, and the IC devices,
   the apparatus or system configured to:
select, via the E devices, an object and/or an object type and/or an object class and/or an object category and associated Object Data on the DRDBDSSs of all of the DRs is selected for updating (the selected item);
select, via the E devices, specific parameters, patterns, and distributions are selected for use in generating object data for each of the stored objects (the criterion);
generate/gather, via the E devices, data about the selected item (the updated selected item data).
store, via the E devices, the updated selected item data in all of the DRDBDSSs of all of the DRs;
update, via the E devices, the user AI rules stored in all of the DRDBDSSs of all of the DRs are updated (the updated user AI rules) and the operation AI rules stored in all of the DRDBDSSs of all of the DRs are updated (the updated operation AI rules) based on the updated selected item data;
store, via the E devices, the updated user AI rules and the updated operation AI rules are stored in all of the DRDBDSSs of all of the DRs; and
transfer, via the E devices, control back to the item selecting action.

Embodiment 61. An interface implemented on an apparatus or system,
the apparatus or system comprising:
   one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
   one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
   one or more image capturing devices (the IC devices); and
   communication pathways between the E devices, the DRs, and the IC devices,
      the interface configured to:
select, via the E devices, an object and/or an object type and/or an object class and/or an object category and associated Object Data on the DRDBDSSs of all of the DRs is selected for updating (the selected item);
select, via the E devices, specific parameters, patterns, and distributions are selected for use in generating object data for each of the stored objects (the criterion);
generate/gather, via the E devices, data about the selected item (the updated selected item data).
store, via the E devices, the updated selected item data in all of the DRDBDSSs of all of the DRs;
update, via the E devices, the user AI rules stored in all of the DRDBDSSs of all of the DRs are updated (the updated user AI rules) and the operation AI rules stored in all of the DRDBDSSs of all of the DRs are updated (the updated operation AI rules) based on the updated selected item data;
store, via the E devices, the updated user AI rules and the updated operation AI rules are stored in all of the DRDBDSSs of all of the DRs; and
transfer, via the E devices, control back to the item selecting action.

Embodiment 62. The apparatus or system of Embodiment 60 or Embodiment 61, wherein
the updated selected item data comprises all data accessible in public internets, private internets, public intranets, private intranets, or any combination.

Embodiment 63. A method implemented on an apparatus or system,
the apparatus or system comprising:
   one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
   one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
   one or more image capturing devices (the IC devices); and
   communication pathways between the E devices, the DRs, and the IC devices,
      the method comprising:
selecting, via the E devices, an object and/or an object type and/or an object class and/or an object category and associated Object Data on the DRDBDSSs of all of the DRs is selected for updating (the selected item);
selecting, via the E devices, specific parameters, patterns, and distributions are selected for use in generating object data for each of the stored objects (the criterion);
generating/gathering, via the E devices, data about the selected item (the updated selected item data).
storing, via the E devices, the updated selected item data in all of the DRDBDSSs of all of the DRS;
updating, via the E devices, the user AI rules stored in all of the DRDBDSSs of all of the DRs are updated (the updated user AI rules) and the operation AI rules stored in all of the DRDBDSSs of all of the DRs are updated (the updated operation AI rules) based on the updated selected item data;
storing, via the E devices, the updated user AI rules and the updated operation AI rules are stored in all of the DRDBDSSs of all of the DRs; and
transferring, via the E devices, control back to the item selecting.

Embodiment 64. The method of Embodiment 63, wherein
the updated selected item data comprises all data accessible in public internets, private internets, public intranets, private intranets, or any combination.

Embodiment 65. An AI targeting apparatus, system, or application (the AI Targeting Apparatus) comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud servers (the CSs) including user database (UDBs) including user identification data and a E device database (the EDDBs) including E device identification data;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices and the CSs,
   the AI Targeting Apparatus configured to:
receive, via one of the E devices (the user E device), a start function;
if the AI targeting apparatus is configured to limit access thereto, then:
   receive, via the CSs from the user E device, a user access request;
   receive, via the CSs from the user E device, user identification data and E device identification data, the E device identification data comprise one or more E devices under the control of the user (the user E devices);
   verify/authenticate, via the CSs, if the user will be granted access to the AI targeting apparatus based on the user identification data and the E device identification data;
   if the potential user is included in the UBDs, then:
      if one or more of the user E devices are not in the EDDBs, then add the one or more of the user E devices to the EDDBs on the CSs;
      create, via the user input E device, a plurality of data repositories (the DRs) on the CSs;
      receive, via the user E device, engagement data and/or operation data for one or more intended operations is input into the AI Targeting Apparatus and/or generated by the AI Targeting Apparatus including details of one or more tasks to be performed by a user and/or the local electronic devices (the Engagement Protocol);
      determine, via the CSs and/or the user E device, location information or data for a user and/or the user E devices (the Location);
      determine, via the CSs and/or the user E device, a storage capacity for the user E device is sufficient for storing the image data from the Image Capturing Devices (the Capacity);
      monitor and capture, via the Image Capturing Devices, image data (the Capture Image Data);
      select, via the user or the DRAI engines, one or more targets or target types in the Captured Images (the Targets);
      identify, via the DRAI engines, all recognizable objects in the Captured Image Data are identified (the Identified Objects);
      determine, via the DRAI engines, whether any of the Identified Objects are not found in the DRDBDSSs (the Unknown Object or Objects);
      if any of the Unknown Object or Objects are not found in the DRDBDSSs, then:
         generate/gather, via the user E device or the CSs, aspects and criterion are generated and/or gathered for each of the Unknown Objects (the Generated or Gathered Data);
         add, via the CSs or the user E device, the Generated or Gathered Data for each of the Unknown Objects in the DRDBDSSs;
      identify, the DRAI engines, all known Identified Objects in the one or more Captured Images including the Targets and objects associated with and/or located on, at, or near each of the Targets are identified (the Relevant Objects);
      select, via the DRAI engines, an item from the DRDBDSSs that is identical or similar to each of the Relevant Objects (the Selected Items);
      adjust, via the DRAI engines, a size and a spatial orientation of each of the Selected Items until the size and the spatial orientation of each of the Selected Items corresponds to each of the Relevant Objects (the Sizes and Orientations);
      determine, via the DRAI engines, distance data for each of the Relevant Objects based on the Sizes and Orientations of the Selected Items (the Relevant Object Distance Data);
      calculate, via the DRAI engines, a confidence value for each of the Relevant Object Distance Data (the CVs);
      select, via the user or the DRAI engines, a ranking protocol for each of the Targets based on percentile rank or percentile rank range of the Relevant Objects (the Ranking Protocols);
      select, via the DRAI engines, the CVs of each of the Relevant Objects for each of the Targets in accord with the Ranking Protocols to form ranked Relevant Object CVs (the Ranked CVs);
      select, via the DRAI engines, a target engagement protocol concerning a number of Ranked CVs used to calculate a distance to each of the Targets (the Target Engagement Protocols);
      determine, via the DRAIs, a distance to each of the Targets based on the Target Engagement Protocols (the Target Distance Data);
      communication, via the user E device, the Target Distance Data for each of the Targets to one or more E devices;
      receive, via the user E device from an authorizing authority, instructions on how and when to engage each of the Targets (the Target Engagement Protocols);
      engage, via the user, one, some or all of the Targets at one or more points in time based on the Target Engagement Protocol (the Target Engagement Data);
      confirm, via the DRAIs, a success or failure of engagement for each of the Targets according to an assessment of whether stated objectives were achieved (the Target Confirmation Data);
      communicate, via the user E device, the Target Confirmation Data to one or more E devices of one or more users, authorized personnel, or combinations thereof;
      store, via the E device and the CSs, the image data, the engagement protocol, the user, the location, the Local Electronic Device, the capacity, the targets, the identified objects, the relevant objects, the Selected items, the Size and Orientation Data, the relevant object distance data, the CVs, the ranked CVs, the target distance data, the target confirmation data (the operational data) in all of the DRDBDSSs on all of the DRs;
      update, via the CSs, the user AI rules, models, and/or methods (the Updated User AI Rules) and the operation AI rules, models, and/or methods (the Updated Operation AI Rules) based on the Operational Data stored in the DRDBDSSs of all of the DRs, or any combination thereof;
      store, via the CSs, the Updated User AI Rules and the Updated Operation AI Rules in all of the DRDBDSSs on all of the DRs for use by the DRAI engines;
      receive, via the user E device, a stop function to stop or exit the AI Targeting Apparatus; and
   if the user is not included in the UDBs, then stop or exit the AI Targeting Apparatus.

Embodiment 66. The AI Targeting Apparatus of Embodiment 65, wherein
the user identification data comprise a user name, a user ID (UID), a Universal Unique Identifier (UUID), or combination thereof, a user password, a phone number, an email address, other user identification information or any combination thereof.

Embodiment 67. The AI Targeting Apparatus of Embodiment 66, wherein
the user name comprises a full name of a person, initials of a person, a combination of letters, a combination of number, or any combination thereof.

Embodiment 68. The AI Targeting Apparatus of Embodiment 65, wherein
the E device identification data comprise a unique identifier assigned to each E device.

Embodiment 69. The AI Targeting Apparatus of Embodiment 68, wherein
the E device identification data comprise E device manufacturer data, E device serial number data, E device operating system data, Identifier for Advertisers (IDFA) for iOS® devices, Android Advertising ID (AAID) for Android® devices, Google Advertising ID (GAID) for the Google® ecosystem, proprietary Secure ID, Media Access Control address (MAC address), International Mobile Equipment Identity (IMEI) for mobile devices, Universally Unique Identifier (UUID), Item Unique Identification (IUID), Unique Device Identification (UDI), Unique Device Identifier (UDID), or any combination thereof.

Embodiment 70. The AI Targeting Apparatus of Embodiment 65, wherein
each of the DRs includes one or more databases (DBs) or data storage structures (DSSs) (collectively the DRDBDSSs).

Embodiment 71. The AI Targeting Apparatus of Embodiment 70, wherein
each of the DRDBDSSs includes data corresponding to objects, object types, object classes, object categories, users, user types, user classes, user categories, apparatuses, apparatus types, apparatus classes, apparatus categories, operations, operation types, operation classes, and operation categories (the DRDBDSS data).

Embodiment 72. The AI Targeting Apparatus of Embodiment 65, wherein
the DRAI engines comprise routines for recognizing objects in captured images from an image capturing device.

Embodiment 73. An interface implemented on an apparatus or system,
the apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud servers (the CSs) including user database (UDBs) including user identification data and a E device database (the EDDBs) including E device identification data;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices and the CSs,
   the interface configured to:
receive, via one of the E devices (the user E device), a start function;
if the AI targeting apparatus is configured to limit access thereto, then:
   receive, via the CSs from the user E device, a user access request;
   receive, via the CSs from the user E device, user identification data and E device identification data, the E device identification data comprise one or more E devices under the control of the user (the user E devices);
   verify/authenticate, via the CSs, if the user will be granted access to the AI targeting apparatus based on the user identification data and the E device identification data;
   if the potential user is included in the UBDs, then:
      if one or more of the user E devices are not in the EDDBs, then add the one or more of the user E devices to the EDDBs on the CSs;
      create, via the user input E device, a plurality of data repositories (the DRs) on the CSs;
      receive, via the user E device, engagement data and/or operation data for one or more intended operations is input into the AI Targeting Apparatus and/or generated by the AI Targeting Apparatus including details of one or more tasks to be performed by a user and/or the local electronic devices (the Engagement Protocol);
      determine, via the CSs and/or the user E device, location information or data for a user and/or the user E devices (the Location);
      determine, via the CSs and/or the user E device, a storage capacity for the user E device is sufficient for storing the image data from the Image Capturing Devices (the Capacity);
      monitor and capture, via the Image Capturing Devices, image data (the Capture Image Data);
      select, via the user or the DRAI engines, one or more targets or target types in the Captured Images (the Targets);
      identify, via the DRAI engines, all recognizable objects in the one or more Captured Images are identified (the Identified Objects);
      determine, via the DRAI engines, whether any of the Identified Objects are not found in the DRDBDSSs (the Unknown Object or Objects);
      if any of the Unknown Object or Objects are not found in the DRDBDSSs, then:
         generate/gather, via the user E device or the CSs, aspects and criterion are generated and/or gathered for each of the Unknown Objects (the Generated or Gathered Data);
         add, via the CSs or the user E device, the Generated or Gathered Data for each of the Unknown Objects in the DRDBDSSs;
      identify, the DRAI engines, all known Identified Objects in the one or more Captured Images including the Targets and objects associated with and/or located on, at, or near each of the Targets are identified (the Relevant Objects);
      select, via the DRAI engines, an item from the DRDBDSSs that is identical or similar to each of the Relevant Objects (the Selected Items);
      adjust, via the DRAI engines, a size and a spatial orientation of each of the Selected Items until the size and the spatial orientation of each of the Selected Items corresponds to each of the Relevant Objects (the Sizes and Orientations);
      determine, via the DRAI engines, distance data for each of the Relevant Objects based on the Sizes and Orientations of the Selected Items (the Relevant Object Distance Data);
      calculate, via the DRAI engines, a confidence value for each of the Relevant Object Distance Data (the CVs);
      select, via the user or the DRAI engines, a ranking protocol for each of the Targets based on percentile rank or percentile rank range of the Relevant Objects (the Ranking Protocols);
      select, via the DRAI engines, the CVs of each of the Relevant Objects for each of the Targets in accord with the Ranking Protocols to form ranked Relevant Object CVs (the Ranked CVs);
      select, via the DRAI engines, a target engagement protocol concerning a number of Ranked CVs used to calculate a distance to each of the Targets (the Target Engagement Protocol);
      determine, via the CIAs, a distance to each of the Targets based on the Target Engagement Protocols (the Target Distance Data);
      communication, via the user E device, the Target Distance Data for each of the Targets to one or more E devices;
      receive, via the user E device from an authorizing authority, instructions on how and when to engage each of the Targets (the Target Engagement Protocol);
      engage, via the user, one, some or all of the Targets at one or more points in time based on the Target Engagement Protocol (the Target Engagement Data);
      confirm, via the DRAIs, a success or failure of engagement for each of the Targets according to an assessment of whether stated objectives were achieved (the Target Confirmation Data);
      communicate, via the user E device, the Target Confirmation Data to one or more E devices of one or more users, authorized personnel, or combinations thereof;
      store, via the E device and the CSs, the image data, the engagement protocol, the user, the location, the Local Electronic Device, the capacity, the targets, the identified objects, the relevant objects, the Selected items, the Size and Orientation Data, the relevant object distance data, the CVs, the ranked CVs, the target distance data, the target engagement authorization, the target engagement data, and the target confirmation data (the operational data) in all of the DRDBDSSs on all of the DRs;
      update, via the CSs, the user AI rules, models, and/or methods (the Updated User AI Rules) and the operation AI rules, models, and/or methods (the Updated Operation AI Rules) based on the Operational Data stored in the DRDBDSSs of all of the DRs, or any combination thereof;
      store, via the CSs, the Updated User AI Rules and the Updated Operation AI Rules in all of the DRDBDSSs on all of the DRs for use by the DRAI engines;
      receive, via the user E device, a stop function to stop or exit the AI Targeting Apparatus and
   if the user is not included in the UDBs, then stop or exit the AI Targeting Apparatus.

Embodiment 74. A method implemented on an apparatus or system,
the apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud servers (the CSs) including user database (UDBs) including user identification data and a E device database (the EDDBs) including E device identification data;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices and the CSs,
   the method comprising:
receiving, via one of the E devices (the user E device), a start function;
if the AI targeting apparatus is configured to limit access thereto, then:
   receiving, via the CSs from the user E device, a user access request;
   receiving, via the CSs from the user E device, user identification data and E device identification data, the E device identification data comprise one or more E devices under the control of the user (the user E devices);
   verifying/authenticating, via the CSs, if the user will be granted access to the AI targeting apparatus based on the user identification data and the E device identification data;
   if the potential user is included in the UBDs, then:
      if one or more of the user E devices are not in the EDDBs, then adding the one or more of the user E devices to the EDDBs on the CSs;
      creating, via the user input E device, a plurality of data repositories (the DRs) on the CSs;
      receiving, via the user E device, engagement data and/or operation data for one or more intended operations is input into the AI Targeting Apparatus and/or generated by the AI Targeting Apparatus including details of one or more tasks to be performed by a user and/or the local electronic devices (the Engagement Protocol);
      determining, via the CSs and/or the user E device, location information or data for a user and/or the user E devices (the Location);
      determining, via the CSs and/or the user E device, a storage capacity for the user E device is sufficient for storing the image data from the Image Capturing Devices (the Capacity);
      monitoring and capturing, via the Image Capturing Devices, image data (the Capture Image Data);
      selecting, via the user or the DRAI engines, one or more targets or target types in the Captured Images (the Targets);
      identifying, via the DRAI engines, all recognizable objects in the one or more Captured Images are identified (the Identified Objects);
      determining, via the DRAI engines, whether any of the Identified Objects are not found in the DRDBDSSs (the Unknown Object or Objects);
      if any of the Unknown Object or Objects are not found in the DRDBDSSs, then:
         generating/gathering, via the user E device or the CSs, aspects and criterion are generated and/or gathered for each of the Unknown Objects (the Generated or Gathered Data);
         adding, via the CSs or the user E device, the Generated or Gathered Data for each of the Unknown Objects in the DRDBDSSs;
      identifying, the DRAI engines, all known Identified Objects in the one or more Captured Images including the Targets and objects associated with and/or located on, at, or near each of the Targets are identified (the Relevant Objects);
      selecting, via the DRAI engines, an item from the DRDBDSSs that is identical or similar to each of the Relevant Objects (the Selected Items);
      adjusting, via the DRAI engines, a size and a spatial orientation of each of the Selected Items until the size and the spatial orientation of each of the Selected Items corresponds to each of the Relevant Objects (the Sizes and Orientations);
      determining, via the DRAI engines, distance data for each of the Relevant Objects based on the Sizes and Orientations of the Selected Items (the Relevant Object Distance Data);
      calculating, via the DRAI engines, a confidence value for each of the Relevant Object Distance Data (the CVs);
      selecting, via the user or the DRAI engines, a ranking protocol for each of the Targets based on percentile rank or percentile rank range of the Relevant Objects (the Ranking Protocols);
      selecting, via the DRAI engines, the CVs of each of the Relevant Objects for each of the Targets in accord with the Ranking Protocols to form ranked Relevant Object CVs (the Ranked CVs);
      selecting, via the DRAI engines, a target engagement protocol concerning a number of Ranked CVs used to calculate a distance to each of the Targets (the Target Engagement Protocols);
      determining, via the CIAs, a distance to each of the Targets based on the Target engagement Protocols (the Target Distance Data);
      communication, via the user E device, the Target Distance Data for each of the Targets to one or more E devices;
      receiving, via the user E device from an authorizing authority, instructions on how and when to engage each of the Targets (the Target Engagement Protocol);
      engaging, via the user, one, some or all of the Targets at one or more points in time based on the Target Engagement Protocol (the Target Engagement Data);
      confirming, via the DRAIs, a success or failure of engagement for each of the Targets according to an assessment of whether stated objectives were achieved (the Target Confirmation Data);
      communicating, via the user E device, the Target Confirmation Data to one or more E devices of one or more users, authorized personnel, or combinations thereof;
      storing, via the E device and the CSs, the image data, the engagement protocol, the user, the location, the Local Electronic Device, the capacity, the targets, the identified objects, the relevant objects, the Selected items, the Size and Orientation Data, the relevant object distance data, the CVs, the ranked CVs, the target distance data, the target engagement authorization, the target engagement data, and the target confirmation data (the operational data) in all of the DRDBDSSs on all of the DRs;
      updating, via the CSs, the user AI rules, models, and/or methods (the Updated User AI Rules) and the operation AI rules, models, and/or methods (the Updated Operation AI Rules) based on the Operational Data stored in the DRDBDSSs of all of the DRs, or any combination thereof;
      storing, via the CSs, the Updated User AI Rules and the Updated Operation AI Rules in all of the DRDBDSSs on all of the DRs for use by the DRAI engines;
      receiving, via the user E device, a stop function to stop or exit the AI Targeting Apparatus; and
   if the user is not included in the UDBs, then stop or exit the AI Targeting Apparatus.

Embodiment 75. The interface of Embodiment 73 or method Embodiment 74, wherein the user identification data comprise a user name, a user ID (UID), a Universal Unique Identifier (UUID), or combination thereof, a user password, a phone number, an email address, other user identification information or any combination thereof.

Embodiment 76. The Embodiment of Embodiment 75, wherein
the user name comprises a full name of a person, initials of a person, a combination of letters, a combination of number, or any combination thereof.

Embodiment 77. The interface of Embodiment 73 or method Embodiment 74, wherein the E device identification data comprise a unique identifier assigned to each E device.

Embodiment 78. The Embodiment of Embodiment 77, wherein
the E device identification data comprise E device manufacturer data, E device serial number data, E device operating system data, Identifier for Advertisers (IDFA) for iOS® devices, Android Advertising ID (AAID) for Android® devices, Google Advertising ID (GAID) for the Google® ecosystem, proprietary Secure ID, Media Access Control address (MAC address), International Mobile Equipment Identity (IMEI) for mobile devices, Universally Unique Identifier (UUID), Item Unique Identification (IUID), Unique Device Identification (UDI), Unique Device Identifier (UDID), or any combination thereof.

Embodiment 79. The interface of Embodiment 73 or method Embodiment 74, wherein each of the DRs includes one or more databases (DBs) or data storage structures (DSSs) (collectively the DRDBDSSs).

Embodiment 80. The Embodiment of Embodiment 79, wherein
each of the DRDBDSSs includes data corresponding to objects, object types, object classes, object categories, users, user types, user classes, user categories, apparatuses, apparatus types, apparatus classes, apparatus categories, operations, operation types, operation classes, and operation categories (the DRDBDSS data).

Embodiment 81. The interface of Embodiment 73 or method Embodiment 74, wherein the DRAI engines comprise routines for recognizing objects in captured images from an image capturing device.

Embodiment 82. An AI targeting apparatus, system, or application (the AI Targeting Apparatus) comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud servers (the CSs) including user database (UDBs) including user identification data and a E device database (the EDDBs) including E device identification data;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices and the CSs,
   the AI Targeting Apparatus configured to:
receive, via one of the E devices (the user E device), a start function;
if the AI targeting apparatus is configured to limit access thereto, then:
   receive, via the CSs from the user E device, a user access request;
   receive, via the CSs from the user E device, user identification data and E device identification data, the E device identification data comprise one or more E devices under the control of the user (the user E devices);
   verify/authenticate, via the CSs, if the user will be granted access to the AI targeting apparatus based on the user identification data and the E device identification data;
   if the potential user is included in the UBDs, then:
      if one or more of the user E devices are not in the EDDBs, then add the one or more of the user E devices to the EDDBs on the CSs;
      create, via the user input E device, a plurality of data repositories (the DRs) on the CSs;
      receive, via the user E device, engagement data and/or operation data for one or more intended operations is input into the AI Targeting Apparatus and/or generated by the AI Targeting Apparatus including details of one or more tasks to be performed by a user and/or the local electronic devices (the Engagement Protocol);
      determine, via the CSs and/or the user E device, location information or data for a user and/or the user E devices (the Location);
      determine, via the CSs and/or the user E device, a storage capacity for the user E device is sufficient for storing the image data from the Image Capturing Devices (the Capacity);
      download, via the CSs to the user E device, relevant data in a continuous manner from the DRDBDSSs of the DRs to the LDBs and the LAI engines (the Relevant Data);
      monitor and capture, via the Image Capturing Devices, image data (the Capture Image Data);
      select, via the user or the LAI engines, one or more targets or target types in the Captured Images (the Targets);
      identify, via the LAI engines, all recognizable objects in the one or more Captured Images are identified (the Identified Objects);
      determine, via the LAI engines, whether any of the Identified Objects are not found in the LDBs (the Unknown Object or Objects);
      if any of the Unknown Object or Objects are not found in the LDBs, then:
         generate/gather, via the user E device or the CSs, aspects and criterion are generated and/or gathered for each of the Unknown Objects (the Generated or Gathered Data);
         add, via the CSs or the user E device, the Generated or Gathered Data for each of the Unknown Objects in the LDBs;
         upload, via the user E device, the Generated or Gathered Data for each of the Unknown Objects in the DRDBDSSs;
      identify, the LAI engines, all known Identified Objects in the one or more Captured Images including the Targets and objects associated with and/or located on, at, or near each of the Targets are identified (the Relevant Objects);
      select, via the LAI engines, an item from the LDBs that is identical or similar to each of the Relevant Objects (the Selected Items);
      adjust, via the LAI engines, a size and a spatial orientation of each of the Selected Items until the size and the spatial orientation of each of the Selected Items corresponds to each of the Relevant Objects (the Sizes and Orientations);
      determine, via the LAI engines, distance data for each of the Relevant Objects based on the Sizes and Orientations of the Selected Items (the Relevant Object Distance Data);
      calculate, via the LAI engines, a confidence value for each of the Relevant Object Distance Data (the CVs);
      select, via the user or the LAI engines, a ranking protocol for each of the Targets based on percentile rank or percentile rank range of the Relevant Objects (the Ranking Protocols);
      select, via the LAI engines, the CVs of each of the Relevant Objects for each of the Targets in accord with the Ranking Protocols to form ranked Relevant Object CVs (the Ranked CVs);
      select, via the LAI engines, a target engagement protocol concerning a number of Ranked CVs used to calculate a distance to each of the Targets (the Target Engagement Protocol);
      determine, via the LAI engines, a distance to each of the Targets based on the Target Engagement Protocols (the Target Distance Data);
      communication, via the user E device, the Target Distance Data for each of the Targets to one or more E devices;
      receive, via the user E device from an authorizing authority, instructions on how and when to engage each of the Targets (the Target Engagement Protocol);
      engage, via the user, one, some or all of the Targets at one or more points in time based on the Target Engagement Protocol (the Target Engagement Data);
      confirm, via the LAI engines, a success or failure of engagement for each of the Targets according to an assessment of whether stated objectives were achieved (the Target Confirmation Data);
      communicate, via the user E device, the Target Confirmation Data to one or more E devices of one or more users, authorized personnel, or combinations thereof;
      store, via the E device and the CSs, the image data, the engagement protocol, the user, the location, the Local Electronic Device, the capacity, the targets, the identified objects, the relevant objects, the Selected items, the Size and Orientation Data, the relevant object distance data, the CVs, the ranked CVs, the target distance data, the target engagement authorization, the target engagement data, and the target confirmation data (the operational data) in all of the DRDBDSSs on all of the DRs;
      update, via the CSs, the user AI rules, models, and/or methods (the Updated User AI Rules) and the operation AI rules, models, and/or methods (the Updated Operation AI Rules) based on the Operational Data stored in the DRDBDSSs of all of the DRs, or any combination thereof;
      store, via the CSs, the Updated User AI Rules and the Updated Operation AI Rules in all of the DRDBDSSs on all of the DRs for use by the LAI engines;
      receive, via the user E device, a stop function to stop or exit the AI Targeting Apparatus; and
   if the user is not included in the UDBs, then stop or exit the AI Targeting Apparatus.

Embodiment 83. The AI Targeting Apparatus of Embodiment 82, wherein

the user identification data comprise a user name, a user ID (UID), a Universal Unique Identifier (UUID), or combination thereof, a user password, a phone number, an email address, other user identification information or any combination thereof.

Embodiment 84. The AI Targeting Apparatus of Embodiment 83, wherein
the user name comprises a full name of a person, initials of a person, a combination of letters, a combination of number, or any combination thereof.

Embodiment 85. The AI Targeting Apparatus of Embodiment 82, wherein
the E device identification data comprise a unique identifier assigned to each E device.

Embodiment 86. The AI Targeting Apparatus of Embodiment 85, wherein the E device identification data comprise E device manufacturer data, E device serial number data, E device operating system data, Identifier for Advertisers (IDFA) for iOS® devices, Android Advertising ID (AAID) for Android® devices, Google Advertising ID (GAID) for the Google® ecosystem, proprietary Secure ID, Media Access Control address (MAC address), International Mobile Equipment Identity (IMEI) for mobile devices, Universally Unique Identifier (UUID), Item Unique Identification (IUID), Unique Device Identification (UDI), Unique Device Identifier (UDID), or any combination thereof.

Embodiment 87. The AI Targeting Apparatus of Embodiment 82, wherein
each of the DRs includes one or more databases (DBs) or data storage structures (DSSs) (collectively the DRDBDSSs).

Embodiment 88. The AI Targeting Apparatus of Embodiment 87, wherein
each of the DRDBDSSs includes data corresponding to objects, object types, object classes, object categories, users, user types, user classes, user categories, apparatuses, apparatus types, apparatus classes, apparatus categories, operations, operation types, operation classes, and operation categories (the DRDBDSS data).

Embodiment 89. An interface implemented on an apparatus or system,
the apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud servers (the CSs) including user database (UDBs) including user identification data and a E device database (the EDDBs) including E device identification data;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices and the CSs,
   the interface configured to:
receive, via one of the E devices (the user E device), a start function;
if the AI targeting apparatus is configured to limit access thereto, then:
   receive, via the CSs from the user E device, a user access request;
   receive, via the CSs from the user E device, user identification data and E device identification data, the E device identification data comprise one or more E devices under the control of the user (the user E devices);
   verify/authenticate, via the CSs, if the user will be granted access to the AI targeting apparatus based on the user identification data and the E device identification data;
   if the potential user is included in the UBDs, then:
      if one or more of the user E devices are not in the EDDBs, then add the one or more of the user E devices to the EDDBs on the CSs;
      create, via the user input E device, a plurality of data repositories (the DRs) on the CSs;
      receive, via the user E device, engagement data and/or operation data for one or more intended operations is input into the AI Targeting Apparatus and/or generated by the AI Targeting Apparatus including details of one or more tasks to be performed by a user and/or the local electronic devices (the Engagement Protocol);
      determine, via the CSs and/or the user E device, location information or data for a user and/or the user E devices (the Location);
      determine, via the CSs and/or the user E device, a storage capacity for the user E device is sufficient for storing the image data from the Image Capturing Devices (the Capacity);
      select, via the user or the LAI engines, one or more targets or target types in the Captured Images (the Targets);
      identify, via the LAI engines, all recognizable objects in the one or more Captured Images are identified (the Identified Objects);
      determine, via the LAI engines, whether any of the Identified Objects are not found in the LDBs (the Unknown Object or Objects);
      if any of the Unknown Object or Objects are not found in the LDBs, then:
         generate/gather, via the user E device or the CSs, aspects and criterion are generated and/or gathered for each of the Unknown Objects (the Generated or Gathered Data);
         add, via the CSs or the user E device, the Generated or Gathered Data for each of the Unknown Objects in the LDBs;
         upload, via the user E device, the Generated or Gathered Data for each of the Unknown Objects in the DRDBDSSs;
      identify, the LAI engines, all known Identified Objects in the one or more Captured Images including the Targets and objects associated with and/or located on, at, or near each of the Targets are identified (the Relevant Objects);
      select, via the LAI engines, an item from the LDBs that is identical or similar to each of the Relevant Objects (the Selected Items);
      adjust, via the LAI engines, a size and a spatial orientation of each of the Selected Items until the size and the spatial orientation of each of the Selected Items corresponds to each of the Relevant Objects (the Sizes and Orientations);
      determine, via the LAI engines, distance data for each of the Relevant Objects based on the Sizes and Orientations of the Selected Items (the Relevant Object Distance Data);
      calculate, via the LAI engines, a confidence value for each of the Relevant Object Distance Data (the CVs);
      select, via the user or the LAI engines, a ranking protocol for each of the Targets based on percentile rank or percentile rank range of the Relevant Objects (the Ranking Protocols);
      select, via the LAI engines, the CVs of each of the Relevant Objects for each of the Targets in accord with the Ranking Protocols to form ranked Relevant Object CVs (the Ranked CVs);
      select, via the LAI engines, a target engagement protocol concerning a number of Ranked CVs used to calculate a distance to each of the Targets (the Target Engagement Protocols);
      determine, via the LAI engines, a distance to each of the Targets based on the Target Engagement Protocols (the Target Distance Data);
      communication, via the user E device, the Target Distance Data for each of the Targets to one or more E devices;
      receive, via the user E device from an authorizing authority, instructions on how and when to engage each of the Targets (the Target Engagement Protocol);
      engage, via the user, one, some or all of the Targets at one or more points in time based on the Target Engagement Protocol (the Target Engagement Data);
      confirm, via the LAI engines, a success or failure of engagement for each of the Targets according to an assessment of whether stated objectives were achieved (the Target Confirmation Data);
      communicate, via the user E device, the Target Confirmation Data to one or more E devices of one or more users, authorized personnel, or combinations thereof;
      store, via the E device and the CSs, the image data, the engagement protocol, the user, the location, the Local Electronic Device, the capacity, the targets, the identified objects, the relevant objects, the Selected items, the Size and Orientation Data, the relevant object distance data, the CVs, the ranked CVs, the target distance data, the target engagement authorization, the target engagement data, and the target confirmation data (the operational data) in all of the DRDBDSSs on all of the DRs;
      update, via the CSs, the user AI rules, models, and/or methods (the Updated User AI Rules) and the operation AI rules, models, and/or methods (the Updated Operation AI Rules) based on the Operational Data stored in the DRDBDSSs of all of the DRs, or any combination thereof;
      store, via the CSs, the Updated User AI Rules and the Updated Operation AI Rules in all of the DRDBDSSs on all of the DRs for use by the LAI engines;
      receive, via the user E device, a stop function to stop or exit the AI Targeting Apparatus and
   if the user is not included in the UDBs, then stop or exit the AI Targeting Apparatus.

Embodiment 90. A method implemented on an apparatus or system,
the apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud servers (the CSs) including user database (UDBs) including user identification data and a E device database (the EDDBs) including E device identification data;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices and the CSs,
   the method comprising:
receiving, via one of the E devices (the user E device), a start function;
if the AI targeting apparatus is configured to limit access thereto, then:
   receiving, via the CSs from the user E device, a user access request;
   receiving, via the CSs from the user E device, user identification data and E device identification data, the E device identification data comprise one or more E devices under the control of the user (the user E devices);
   verifying/authenticating, via the CSs, if the user will be granted access to the AI targeting apparatus based on the user identification data and the E device identification data;
   if the potential user is included in the UBDs, then:
      if one or more of the user E devices are not in the EDDBs, then adding the one or more of the user E devices to the EDDBs on the CSs;
      creating, via the user input E device, a plurality of data repositories (the DRs) on the CSs;
      receiving, via the user E device, engagement data and/or operation data for one or more intended operations is input into the AI Targeting Apparatus and/or generated by the AI Targeting Apparatus including details of one or more tasks to be performed by a user and/or the local electronic devices (the Engagement Protocol);
      determining, via the CSs and/or the user E device, location information or data for a user and/or the user E devices (the Location);
      determining, via the CSs and/or the user E device, a storage capacity for the user E device is sufficient for storing the image data from the Image Capturing Devices (the Capacity);
      selecting, via the user or the LAI engines, one or more targets or target types in the Captured Images (the Targets);
      identifying, via the LAI engines, all recognizable objects in the one or more Captured Images are identified (the Identified Objects);
      determining, via the LAI engines, whether any of the Identified Objects are not found in the LDBs (the Unknown Object or Objects);
      if any of the Unknown Object or Objects are not found in the LDBs, then:
         generating/gathering, via the user E device or the CSs, aspects and criterion are generated and/or gathered for each of the Unknown Objects (the Generated or Gathered Data);
         adding, via the CSs or the user E device, the Generated or Gathered Data for each of the Unknown Objects in the LDBs;
         uploading, via the user E device, the Generated or Gathered Data for each of the Unknown Objects in the DRDBDSSs;
      identifying, the LAI engines, all known Identified Objects in the one or more Captured Images including the Targets and objects associated with and/or located on, at, or near each of the Targets are identified (the Relevant Objects);
      selecting, via the LAI engines, an item from the LDBs that is identical or similar to each of the Relevant Objects (the Selected Items);
      adjusting, via the LAI engines, a size and a spatial orientation of each of the Selected Items until the size and the spatial orientation of each of the Selected Items corresponds to each of the Relevant Objects (the Sizes and Orientations);
      determining, via the LAI engines, distance data for each of the Relevant Objects based on the Sizes and Orientations of the Selected Items (the Relevant Object Distance Data);
      calculating, via the LAI engines, a confidence value for each of the Relevant Object Distance Data (the CVs);
      selecting, via the user or the LAI engines, a ranking protocol for each of the Targets based on percentile rank or percentile rank range of the Relevant Objects (the Ranking Protocols);
      selecting, via the LAI engines, the CVs of each of the Relevant Objects for each of the Targets in accord with the Ranking Protocols to form ranked Relevant Object CVs (the Ranked CVs);
      selecting, via the LAI engines, a target engagement protocol concerning a number of Ranked CVs used to calculate a distance to each of the Targets (the Target Engagement Protocols);
      determining, via the CIAs, a distance to each of the Targets based on the Target Engagement Protocols (the Target Distance Data);
      communication, via the user E device, the Target Distance Data for each of the Targets to one or more E devices;
      receiving, via the user E device from an authorizing authority, instructions on how and when to engage each of the Targets (the Target Engagement Protocol);
      engaging, via the user, one, some or all of the Targets at one or more points in time based on the Target Engagement Protocol (the Target Engagement Data);
      confirming, via the LAI engines, a success or failure of engagement for each of the Targets according to an assessment of whether stated objectives were achieved (the Target Confirmation Data);
      communicating, via the user E device, the Target Confirmation Data to one or more E devices of one or more users, authorized personnel, or combinations thereof;
      storing, via the E device and the CSs, the image data, the engagement protocol, the user, the location, the Local Electronic Device, the capacity, the targets, the identified objects, the relevant objects, the Selected items, the Size and Orientation Data, the relevant object distance data, the CVs, the ranked CVs, the target distance data, the target engagement authorization, the target engagement data, and the target confirmation data (the operational data) in all of the DRDBDSSs on all of the DRs;
      updating, via the CSs, the user AI rules, models, and/or methods (the Updated User AI Rules) and the operation AI rules, models, and/or methods (the Updated Operation AI Rules) based on the Operational Data stored in the DRDBDSSs of all of the DRs, or any combination thereof;
      storing, via the CSs, the Updated User AI Rules and the Updated Operation AI Rules in all of the DRDBDSSs on all of the DRs for use by the LAI engines;
      receiving, via the user E device, a stop function to stop or exit the AI Targeting Apparatus; and
   if the user is not included in the UDBs, then stop or exit the AI Targeting Apparatus.

Embodiment 91. The interface of Embodiment 89 or method Embodiment 90, wherein the user identification data comprise a user name, a user ID (UID), a Universal Unique Identifier (UUID), or combination thereof, a user password, a phone number, an email address, other user identification information or any combination thereof.

Embodiment 92. The Embodiment of Embodiment 91, wherein
the user name comprises a full name of a person, initials of a person, a combination of letters, a combination of number, or any combination thereof.

Embodiment 93. The interface of Embodiment 89 or method Embodiment 90, wherein the E device identification data comprise a unique identifier assigned to each E device.

Embodiment 94. The Embodiment of Embodiment 93, wherein
the E device identification data comprise E device manufacturer data, E device serial number data, E device operating system data, Identifier for Advertisers (IDFA) for iOS® devices, Android Advertising ID (AAID) for Android® devices, Google Advertising ID (GAID) for the Google® ecosystem, proprietary Secure ID, Media Access Control address (MAC address), International Mobile Equipment Identity (IMEI) for mobile devices, Universally Unique Identifier (UUID), Item Unique Identification (IUID), Unique Device Identification (UDI), Unique Device Identifier (UDID), or any combination thereof.

Embodiment 95. The interface of Embodiment 89 or method Embodiment 90, wherein each of the DRs includes one or more databases (DBs) or data storage structures (DSSs) (collectively the DRDBDSSs).

Embodiment 96. The Embodiment of Embodiment 95, wherein
each of the DRDBDSSs includes data corresponding to objects, object types, object classes, object categories, users, user types, user classes, user categories, apparatuses, apparatus types, apparatus classes, apparatus categories, operations, operation types, operation classes, and operation categories (the DRDBDSS data).

Embodiment 97. An AI targeting apparatus, system, or application (the AI Targeting Apparatus) comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud servers (the CSs) including user database (UDBs) including user identification data and a E device database (the EDDBs) including E device identification data;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices and the CSs,
   the AI Targeting Apparatus configured to:
receive, via one of the E devices (the user E device), a start function;
if the AI targeting apparatus is configured to limit access thereto, then:
   receive, via the CSs from the user E device, a user access request;
   receive, via the CSs from the user E device, user identification data and E device identification data, the E device identification data comprise one or more E devices under the control of the user (the user E devices);
   verify/authenticate, via the CSs, if the user will be granted access to the AI targeting apparatus based on the user identification data and the E device identification data;
   if the potential user is included in the UBDs, then:
      if one or more of the user E devices are not in the EDDBs, then add the one or more of the user E devices to the EDDBs on the CSs;
      create, via the user input E device, a plurality of data repositories (the DRs) on the CSs;
      receive, via the user E device, engagement data and/or operation data for one or more intended operations is input into the AI Targeting Apparatus and/or generated by the AI Targeting Apparatus including details of one or more tasks to be performed by a user and/or the local electronic devices (the Engagement Protocol);
      determine, via the CSs and/or the user E device, location information or data for a user and/or the user E devices (the Location);
      determine, via the CSs and/or the user E device, a storage capacity for the user E device is sufficient for storing the image data from the Image Capturing Devices (the Capacity);
      if needed, download, via the CSs to the user E device, relevant data in a continuous manner from the DRDBDSSs of the DRs to the LDBs and the LAI engines (the Relevant Data);
      monitor and capture, via the IC devices, image data (the Capture Image Data);
      select, via the user or the DRAI engines, one or more targets or target types in the Captured Images (the Targets);
      identify, via the DRAI engines, all recognizable objects in the one or more Captured Images are identified (the Identified Objects);
      determine, via the DRAI engines, whether any of the Identified Objects are not found in the DRDBDSSs (the Unknown Object or Objects);
      if any of the Unknown Object or Objects are not found in the DRDBDSSs, then:
         generate/gather, via the user E device or the CSs, aspects and criterion are generated and/or gathered for each of the Unknown Objects (the Generated or Gathered Data);
         add, via the CSs or the user E device, the Generated or Gathered Data for each of the Unknown Objects in the DRDBDSSs;
      identify, the DRAI engines, all known Identified Objects in the one or more Captured Images including the Targets and objects associated with and/or located on, at, or near each of the Targets are identified (the Relevant Objects);
      select, via the DRAI engines, an item from the DRDBDSSs that is identical or similar to each of the Relevant Objects (the Selected Items);
      adjust, via the DRAI engines, a size and a spatial orientation of each of the Selected Items until the size and the spatial orientation of each of the Selected Items corresponds to each of the Relevant Objects (the Sizes and Orientations);
      determine, via the DRAI engines, distance data for each of the Relevant Objects based on the Sizes and Orientations of the Selected Items (the Relevant Object Distance Data);
      calculate, via the DRAI engines, a confidence value for each of the Relevant Object Distance Data (the CVs);
      select, via the user or the DRAI engines, a ranking protocol for each of the Targets based on percentile rank or percentile rank range of the Relevant Objects (the Ranking Protocols);
      select, via the DRAI engines, the CVs of each of the Relevant Objects for each of the Targets in accord with the Ranking Protocols to form ranked Relevant Object CVs (the Ranked CVs);
      select, via the DRAI engines, a target engagement protocol concerning a number of Ranked CVs used to calculate a distance to each of the Targets (the Target Engagement Protocols);
      determine, via the CIAs, a distance to each of the Targets based on the Target Engagement Protocols (the Target Distance Data);
      communication, via the user E device, the Target Distance Data for each of the Targets to one or more E devices;
      receive, via the user E device from an authorizing authority, instructions on how and when to engage each of the Targets (the Target Engagement Protocol);
      engage, via the user, one, some or all of the Targets at one or more points in time based on the Target Engagement Protocol (the Target Engagement Data);
      confirm, via the DRAIs, a success or failure of engagement for each of the Targets according to an assessment of whether stated objectives were achieved (the Target Confirmation Data);
      communicate, via the user E device, the Target Confirmation Data to one or more E devices of one or more users, authorized personnel, or combinations thereof;
      store, via the E device and the CSs, the image data, the engagement protocol, the user, the location, the Local Electronic Device, the capacity, the targets, the identified objects, the relevant objects, the Selected items, the Size and Orientation Data, the relevant object distance data, the CVs, the ranked CVs, the target distance data, the target engagement authorization, the target engagement data, and the target confirmation data (the operational data) in all of the DRDBDSSs on all of the DRs;
      update, via the CSs, the user AI rules, models, and/or methods (the Updated User AI Rules) and the operation AI rules, models, and/or methods (the Updated Operation AI Rules) based on the Operational Data stored in the DRDBDSSs of all of the DRs, or any combination thereof;
      store, via the CSs and the user E device, the Updated User AI Rules and the Updated Operation AI Rules in all of the DRDBDSSs on all of the DRs for use by the DRAI engines;
      store, via the CSs and the user E device, some or all of the operational data, the updated User AI rules, and the Updated Operation AI Rules to the LDBs based on the Capacity for use by the LAI engines;
      receive, via the user E device, a stop function to stop or exit the AI Targeting Apparatus; and
   if the user is not included in the UDBs, then stop or exit the AI Targeting Apparatus.

Embodiment 98. The AI Targeting Apparatus of Embodiment 97, wherein
the user identification data comprise a user name, a user ID (UID), a Universal Unique Identifier (UUID), or combination thereof, a user password, a phone number, an email address, other user identification information or any combination thereof.

Embodiment 99. The AI Targeting Apparatus of Embodiment 98, wherein
the user name comprises a full name of a person, initials of a person, a combination of letters, a combination of number, or any combination thereof.

Embodiment 100. The AI Targeting Apparatus of Embodiment 97, wherein
the E device identification data comprise a unique identifier assigned to each E device.

Embodiment 101. The AI Targeting Apparatus of Embodiment 100, wherein
the E device identification data comprise E device manufacturer data, E device serial number data, E device operating system data, Identifier for Advertisers (IDFA) for iOS® devices, Android Advertising ID (AAID) for Android® devices, Google Advertising ID (GAID) for the Google® ecosystem, proprietary Secure ID, Media Access Control address (MAC address), International Mobile Equipment Identity (IMEI) for mobile devices, Universally Unique Identifier (UUID), Item Unique Identification (IUID), Unique Device Identification (UDI), Unique Device Identifier (UDID), or any combination thereof.

Embodiment 102. The AI Targeting Apparatus of Embodiment 97, wherein
each of the DRs includes one or more databases (DBs) or data storage structures (DSSs) (collectively the DRDBDSSs).

Embodiment 103. The AI Targeting Apparatus of Embodiment 102, wherein
each of the DRDBDSSs includes data corresponding to objects, object types, object classes, object categories, users, user types, user classes, user categories, apparatuses, apparatus types, apparatus classes, apparatus categories, operations, operation types, operation classes, and operation categories (the DRDBDSS data).

Embodiment 104. The AI Targeting Apparatus of Embodiment 97, wherein
the DRAI engines comprise routines for recognizing objects in captured images from an image capturing device.

Embodiment 105. An interface implemented on an apparatus or system,
the apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud servers (the CSs) including user database (UDBs) including user identification data and a E device database (the EDDBs) including E device identification data;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices and the CSs,
   the interface configured to:
receive, via one of the E devices (the user E device), a start function;
if the AI targeting apparatus is configured to limit access thereto, then:
   receive, via the CSs from the user E device, a user access request;
   receive, via the CSs from the user E device, user identification data and E device identification data, the E device identification data comprise one or more E devices under the control of the user (the user E devices);
   verify/authenticate, via the CSs, if the user will be granted access to the AI targeting apparatus based on the user identification data and the E device identification data;
   if the potential user is included in the UBDs, then:
      if one or more of the user E devices are not in the EDDBs, then add the one or more of the user E devices to the EDDBs on the CSs;
      create, via the user input E device, a plurality of data repositories (the DRs) on the CSs;
      receive, via the user E device, engagement data and/or operation data for one or more intended operations is input into the AI Targeting Apparatus and/or generated by the AI Targeting Apparatus including details of one or more tasks to be performed by a user and/or the local electronic devices (the Engagement Protocol);
      determine, via the CSs and/or the user E device, location information or data for a user and/or the user E devices (the Location);
      determine, via the CSs and/or the user E device, a storage capacity for the user E device is sufficient for storing the image data from the Image Capturing Devices (the Capacity);
      if needed, download, via the CSs to the user E device, relevant data in a continuous manner from the DRDBDSSs of the DRs to the LDBs and the LAI engines (the Relevant Data);
      monitor and capture, via the IC devices, image data (the Capture Image Data);
      select, via the user or the DRAI engines, one or more targets or target types in the Captured Images (the Targets);
      identify, via the DRAI engines, all recognizable objects in the one or more Captured Images are identified (the Identified Objects);
      determine, via the DRAI engines, whether any of the Identified Objects are not found in the DRDBDSSs (the Unknown Object or Objects);
      if any of the Unknown Object or Objects are not found in the DRDBDSSs, then:
         generate/gather, via the user E device or the CSs, aspects and criterion are generated and/or gathered for each of the Unknown Objects (the Generated or Gathered Data);
         add, via the CSs or the user E device, the Generated or Gathered Data for each of the Unknown Objects in the DRDBDSSs;
      identify, the DRAI engines, all known Identified Objects in the one or more Captured Images including the Targets and objects associated with and/or located on, at, or near each of the Targets are identified (the Relevant Objects);
      select, via the DRAI engines, an item from the DRDBDSSs that is identical or similar to each of the Relevant Objects (the Selected Items);
      adjust, via the DRAI engines, a size and a spatial orientation of each of the Selected Items until the size and the spatial orientation of each of the Selected Items corresponds to each of the Relevant Objects (the Sizes and Orientations);
      determine, via the DRAI engines, distance data for each of the Relevant Objects based on the Sizes and Orientations of the Selected Items (the Relevant Object Distance Data);
      calculate, via the DRAI engines, a confidence value for each of the Relevant Object Distance Data (the CVs);
      select, via the user or the DRAI engines, a ranking protocol for each of the Targets based on percentile rank or percentile rank range of the Relevant Objects (the Ranking Protocols);
      select, via the DRAI engines, the CVs of each of the Relevant Objects for each of the Targets in accord with the Ranking Protocols to form ranked Relevant Object CVs (the Ranked CVs);
      select, via the DRAI engines, a target engagement protocol concerning a number of Ranked CVs used to calculate a distance to each of the Targets (the Target Engagement Protocols);
      determine, via the CIAs, a distance to each of the Targets based on the Target Engagement Protocols (the Target Distance Data);
      communication, via the user E device, the Target Distance Data for each of the Targets to one or more E devices;
      receive, via the user E device from an authorizing authority, instructions on how and when to engage each of the Targets (the Target Engagement Protocol);
      engage, via the user, one, some or all of the Targets at one or more points in time based on the Target Engagement Protocol (the Target Engagement Data);
      confirm, via the DRAIs, a success or failure of engagement for each of the Targets according to an assessment of whether stated objectives were achieved (the Target Confirmation Data);
      communicate, via the user E device, the Target Confirmation Data to one or more E devices of one or more users, authorized personnel, or combinations thereof;
      store, via the E device and the CSs, the image data, the engagement protocol, the user, the location, the Local Electronic Device, the capacity, the targets, the identified objects, the relevant objects, the Selected items, the Size and Orientation Data, the relevant object distance data, the CVs, the ranked CVs, the target distance data, the target engagement authorization, the target engagement data, and the target confirmation data (the operational data) in all of the DRDBDSSs on all of the DRs;
      update, via the CSs, the user AI rules, models, and/or methods (the Updated User AI Rules) and the operation AI rules, models, and/or methods (the Updated Operation AI Rules) based on the Operational Data stored in the DRDBDSSs of all of the DRs, or any combination thereof;
      store, via the CSs and the user E device, the Updated User AI Rules and the Updated Operation AI Rules in all of the DRDBDSSs on all of the DRs for use by the DRAI engines;
      store, via the CSs and the user E device, some or all of the operational data, the updated User AI rules, and the Updated Operation AI Rules to the LDBs based on the Capacity for use by the LAI engines;
      receive, via the user E device, a stop function to stop or exit the AI Targeting Apparatus; and
   if the user is not included in the UDBs, then stop or exit the AI Targeting Apparatus.

Embodiment 106. A method implemented on an apparatus or system,
the apparatus or system comprising:
one or more electronic devices (the E devices), each of the E devices includes one or more processing units, memory, one or more mass storage devices, an operating system or structure, one or more input devices including one or more display devices and one or more image capturing devices, one or more output devices, one or more local databases (the LDBs), one or more local artificial intelligence engines (the LAI engines), communication hardware and software, and routines for implementing the apparatus or system;
one or more cloud servers (the CSs) including user database (UDBs) including user identification data and a E device database (the EDDBs) including E device identification data;
one or more cloud-based data depositories (the DRs) including one or more servers (the servers), the servers include one or more processing units, memory, one or more mass storage devices, an operating system or structure, one or more input devices including one or more display devices and one or more image capturing devices, one or more output devices, one or more data web-based or cloud-based data bases (the CDBs), one or more web-based or cloud-based artificial intelligence engines (the DRAI engines), communication hardware and software, and routines for implementing the apparatus or system;
one or more image capturing devices (the IC devices); and
communication pathways between the E devices and the CSs,
   the method comprising:
receiving, via one of the E devices (the user E device), a start function;
if the AI targeting apparatus is configured to limit access thereto, then:
   receiving, via the CSs from the user E device, a user access request;
   receiving, via the CSs from the user E device, user identification data and E device identification data, the E device identification data comprise one or more E devices under the control of the user (the user E devices);
   verifying/authenticating, via the CSs, if the user will be granted access to the AI targeting apparatus based on the user identification data and the E device identification data;
   if the potential user is included in the UBDs, then:
      if one or more of the user E devices are not in the EDDBs, then adding the one or more of the user E devices to the EDDBs on the CSs;
      creating, via the user input E device, a plurality of data repositories (the DRs) on the CSs;
      receiving, via the user E device, engagement data and/or operation data for one or more intended operations is input into the AI Targeting Apparatus and/or generated by the AI Targeting Apparatus including details of one or more tasks to be performed by a user and/or the local electronic devices (the Engagement Protocol);
      determining, via the CSs and/or the user E device, location information or data for a user and/or the user E devices (the Location);
      determining, via the CSs and/or the user E device, a storage capacity for the user E device is sufficient for storing the image data from the Image Capturing Devices (the Capacity);
      if needed, downloading, via the CSs to the user E device, relevant data in a continuous manner from the DRDBDSSs of the DRs to the LDBs and the LAI engines (the Relevant Data);
      monitoring and capturing, via the IC devices, image data (the Capture Image Data);
      selecting, via the user or the DRAI engines, one or more targets or target types in the Captured Images (the Targets);
      identifying, via the DRAI engines, all recognizable objects in the one or more Captured Images are identified (the Identified Objects);
      determining, via the DRAI engines, whether any of the Identified Objects are not found in the DRDBDSSs (the Unknown Object or Objects);
      if any of the Unknown Object or Objects are not found in the DRDBDSSs, then:
         generating/gathering, via the user E device or the CSs, aspects and criterion are generated and/or gathered for each of the Unknown Objects (the Generated or Gathered Data);
         adding, via the CSs or the user E device, the Generated or Gathered Data for each of the Unknown Objects in the DRDBDSSs;
      identifying, the DRAI engines, all known Identified Objects in the one or more Captured Images including the Targets and objects associated with and/or located on, at, or near each of the Targets are identified (the Relevant Objects);
      selecting, via the DRAI engines, an item from the DRDBDSSs that is identical or similar to each of the Relevant Objects (the Selected Items);
      adjusting, via the DRAI engines, a size and a spatial orientation of each of the Selected Items until the size and the spatial orientation of each of the Selected Items corresponds to each of the Relevant Objects (the Sizes and Orientations);
      determining, via the DRAI engines, distance data for each of the Relevant Objects based on the Sizes and Orientations of the Selected Items (the Relevant Object Distance Data);
      calculating, via the DRAI engines, a confidence value for each of the Relevant Object Distance Data (the CVs);
      selecting, via the user or the DRAI engines, a ranking protocol for each of the Targets based on percentile rank or percentile rank range of the Relevant Objects (the Ranking Protocols);
      selecting, via the DRAI engines, the CVs of each of the Relevant Objects for each of the Targets in accord with the Ranking Protocols to form ranked Relevant Object CVs (the Ranked CVs);
      selecting, via the DRAI engines, a target engagement protocol concerning a number of Ranked CVs used to calculate a distance to each of the Targets (the Target Engagement Protocols);
      determining, via the CIAs, a distance to each of the Targets based on the Target Engagement Protocols (the Target Distance Data);
      communication, via the user E device, the Target Distance Data for each of the Targets to one or more E devices;
      receiving, via the user E device from an authorizing authority, instructions on how and when to engage each of the Targets (the Target Engagement Protocol);
      engaging, via the user, one, some or all of the Targets at one or more points in time based on the Target Engagement Protocol (the Target Engagement Data);
      confirming, via the DRAIs, a success or failure of engagement for each of the Targets according to an assessment of whether stated objectives were achieved (the Target Confirmation Data);
      communicating, via the user E device, the Target Confirmation Data to one or more E devices of one or more users, authorized personnel, or combinations thereof;
      storing, via the E device and the CSs, the image data, the engagement protocol, the user, the location, the Local Electronic Device, the capacity, the targets, the identified objects, the relevant objects, the Selected items, the Size and Orientation Data, the relevant object distance data, the CVs, the ranked CVs, the target distance data, the target engagement authorization, the target engagement data, and the target confirmation data (the operational data) in all of the DRDBDSSs on all of the DRs;
      updating, via the CSs, the user AI rules, models, and/or methods (the Updated User AI Rules) and the operation AI rules, models, and/or methods (the Updated Operation AI Rules) based on the Operational Data stored in the LDBs and the DRDBDSSs of all of the DRs, or any combination thereof;
      storing, via the CSs and the user E device, the Updated User AI Rules and the Updated Operation AI Rules in all of the DRDBDSSs on all of the DRs for use by the DRAI engines;
      storing, via the CSs and the user E device, some or all of the operational data, the updated User AI rules, and the Updated Operation AI Rules to the LDBs based on the Capacity for use by the LAI engines;
      receiving, via the user E device, a stop function to stop or exit the AI Targeting Apparatus; and
   if the user is not included in the UDBs, then stop or exit the AI Targeting Apparatus.

Embodiment 107. The interface of Embodiment 105 or the method of Embodiment 106, wherein
the user identification data comprise a user name, a user ID (UID), a Universal Unique Identifier (UUID), or combination thereof, a user password, a phone number, an email address, other user identification information or any combination thereof.

Embodiment 108. The Embodiment of Embodiment 107, wherein
the user name comprises a full name of a person, initials of a person, a combination of letters, a combination of number, or any combination thereof.

Embodiment 109. The interface of Embodiment 105 or the method of Embodiment 106, wherein
the E device identification data comprise a unique identifier assigned to each E device.

Embodiment 110. The Embodiment of Embodiment 109, wherein
the E device identification data comprise E device manufacturer data, E device serial number data, E device operating system data, Identifier for Advertisers (IDFA) for iOS® devices, Android Advertising ID (AAID) for Android® devices, Google Advertising ID (GAID) for the Google® ecosystem, proprietary Secure ID, Media Access Control address (MAC address), International Mobile Equipment Identity (IMEI) for mobile devices, Universally Unique Identifier (UUID), Item Unique Identification (IUID), Unique Device Identification (UDI), Unique Device Identifier (UDID), or any combination thereof.

Embodiment 111. The interface of Embodiment 105 or the method of Embodiment 106, wherein
each of the DRs includes one or more databases (DBs) or data storage structures (DSSs) (collectively the DRDBDSSs).

Embodiment 112. The Embodiment of Embodiment 111, wherein
each of the DRDBDSSs includes data corresponding to objects, object types, object classes, object categories, users, user types, user classes, user categories, apparatuses, apparatus types, apparatus classes, apparatus categories, operations, operation types, operation classes, and operation categories (the DRDBDSS data).

Embodiment 113. The interface of Embodiment 105 or the method of Embodiment 106, wherein
the DRAI engines comprise routines for recognizing objects in captured images from an image capturing device.

Embodiment 114. An apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the apparatus or system configured to:
receive, via the one of the E devices (referred to herein as the user E device), a start function;
capture, via the IC devices, one or more images (referred to herein as the captured images);
identify, via the user E device, one or more objects (referred to herein as the identified objects) in the captured images;
receive, via the user E device, a selection mode (referred to herein as the selected mode);
if the selection mode is a manual processing format, then:
   receive, via the user E device, an item from the LDBs, the CDBs, or any combination thereof identical or similar to each of the identified objects (referred to herein as the selected items);
   receive, via the user E device, a size selection mode;
   if the size selection mode is to assign predetermined sizes to each of the selected items, then:
      receive, via the user E device, an assigned predetermined size for each of the selected items from a set of sizes for each of the selected items at a known distance (referred to as the assigned sizes);
      display, via the user E device, each of the selected items on each of the identified objects in the captured images;
      adjust, via the user E device, a size of each of the selected items to a size of each of the identified objects;
      determine, via the user E device, a distance to each of the identified objects based on the size of each of the selected items;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
   if the size selection mode is to input values to calibrate a size for each of the selected items, then:
      receive, via the user E device, size values for calibrating a size of each of the selected items (referred to herein as the input sizes);
      determine, via the user E device, a distance to each of the identified objects based on the corresponding input size of each of the selected items;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
if the selection mode is an automatic processing format, then:
   receive, via the user E device, a selected object from one of the identified objects (referred herein to as the selected object);
   determine, via the user E device, whether each of the identified objects is found in the LDBs:
      if an identified object is not found in the LDBs, then:
         if the identified object is found in the CDBs, then add the identified object to the LDBs; otherwise, gather and/or generate information about the identified object from public websites, private websites, public databases, private databases, or any combination thereof, and add the identified object with the gathered and/or generated information to the LDBs;
   receive, via the user E device, an item from the LDBs for each of the identified objects (referred to as the selected items);
   display, via the user E device, each of the selected items on each of the corresponding identified objects in the capture images;
   adjust, via the user E device, a size of each of the found items until a size of each of the selected items is the same as the size of each of the corresponding identified objects;
   determine, via the user E device, a distance to each of the identified objects based on the sizes of each of the selected items;
   display, via the user E device on the display device, the determined distance to each of the identified objects on the captured images;
   communicate, via the user E device, the distance to each of the identified objects to one or more E devices, one or more cell phone, other mobile devices, or any combination thereof; and
   receive, via the user E device, a stop function.

Embodiment 115. An interface implementing an apparatus or system, the apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the interface configured to:
receive, via the one of the E devices (referred to herein as the user E device), a start function;
capture, via the IC devices, one or more images (referred to herein as the captured images);
identify, via the user E device, one or more objects (referred to herein as the identified objects) in the captured images;
receive, via the user E device, a selection mode (referred to herein as the selected mode);
if the selection mode is a manual processing format, then:
   receive, via the user E device, an item from the LDBs, the CDBs, or any combination thereof identical or similar to each of the identified objects (referred to herein as the selected items);
   receive, via the user E device, a size selection mode;
   if the size selection mode is to assign predetermined sizes to each of the selected items, then:
      receive, via the user E device, an assigned predetermined size for each of the selected items from a set of sizes for each of the selected items at a known distance (referred to herein as the assigned sizes);
      display, via the user E device, each of the selected items on each of the identified objects;
      adjust, via the user E device, a size of each of the selected items to the size of each of the identified objects;
      determine, via the user E device, a distance to each of the identified objects based on the size of each of the selected items;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
   if the size selection mode is to input values to calibrate a size for each of the selected items, then:
      receive, via the user E device, size values for calibrating a size of each of the selected items (referred herein to as the input sizes);
      determine, via the user E device, a distance to each of the identified objects based on the size of each of the selected items;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
if the selection mode is an automatic processing format, then:
   receive, via the user E device, a selected object from one of the identified objects (referred to herein as the selected object);
   determine, via the user E device, whether each of the identified objects is found in the LDBs:
      if an identified object is not found in the LDBs, then:
         if the identified object is found in the CDBs, then add the identified object to the LDBs; otherwise, gather and/or generate information about the identified object from public websites, private websites, public databases, private databases, or any combination thereof, and add the identified object with the gathered and/or generated information to the LDBs;
   receive, via the user E device, an item from the LDBs for each of the identified objects (referred to as the selected items);
   display, via the user E device, each of the selected items on each of the corresponding identified objects in the capture images;
   adjust, via the user E device, a size of each of the selected items until the size of each of the found items is the same as the size of each of the corresponding identified objects;
   determine, via the user E device, a distance to each of the identified objects based on the sizes of each of the found items;
   display, via the user E device on the display device, the determined distance to each of the identified objects on the captured images;
   communicate, via the user E device, the distance to each of the identified objects to one or more E devices, one or more cell phone, other mobile devices, or any combination thereof; and
   receive, via the user E device, a stop function.

Embodiment 116. A method implemented on an apparatus or system, the apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred herein to as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the method comprising:
receiving, via the one of the E devices (referred to herein as the user E device), a start function;
capturing, via the IC devices, one or more images (referred to herein as the captured images);
identifying, via the user E device, one or more objects (referred to herein as the identified objects) in the captured images;
receiving, via the user E device, a selection mode (referred to herein as the selected mode);
if the selection mode is a manual processing format, then:
   receiving, via the user E device, an item from the LDBs, the CDBs, or any combination thereof identical or similar to each of the identified objects (referred to herein as the selected items);
   receiving, via the user E device, a size selection mode;
   if the size selection mode is to assign predetermined sizes to each of the selected items, then:
      receiving, via the user E device, an assigned predetermined size for each of the selected items from a set of sizes for each of the selected items at a known distance (referred to herein as the assigned sizes);
      displaying, via the user E device, each of the selected items on each of the identified objects;
      adjusting, via the user E device, a size of each of the selected items to the size of each of the identified objects;
      determining, via the user E device, a distance to each of the identified objects based on the size of each of the selected items;
      displaying, via the user E device on the display device, the determined distance to each of the identified objects on the captured images;
      communicating, via the user E device, the distance to each of the identified objects to one or more E devices, one or more cell phone, other mobile devices, or any combination thereof; and
      receiving, via the user E device, a stop function;
   if the size selection mode is to input values to calibrate a size for each of the selected items, then:
      receiving, via the user E device, size values for calibrating a size of each of the selected items (referred to herein as the input sizes);
      determining, via the user E device, a distance to each of the identified objects based on the size of each of the selected items;
      displaying, via the user E device on the display device, the determined distance to each of the identified objects on the captured images;
      communicating via the user E device, the distance to each of the identified objects to one or more E devices, one or more cell phone, other mobile devices, or any combination thereof; and
      receiving via the user E device, a stop function;
if the selection mode is an automatic processing format, then:
   receiving, via the user E device, a selected object from one of the identified objects (referred to herein as the selected object);
   determining, via the user E device, whether each of the identified objects is found in the LDBs:
      if an identified object is not found in the LDBs, then:
         if the identified object is found in the CDBs, then adding the identified object to the LDBs; otherwise, gathering and/or generating information about the identified object from public websites, private websites, public databases, private databases, or any combination thereof, and adding the identified object with the gathered and/or generated information to the LDBs;
   receiving, via the user E device, an item from the LDBs for each of the identified objects (referred to as the selected items);
   displaying, via the user E device, each of the selected items on a corresponding identified object in the capture images;
   adjusting, via the user E device, a size of each of the found items until the size of each of the selected items is the same as the size of each of the corresponding identified objects;
   determining, via the user E device, a distance to each of the identified objects based on the sizes of each of the found items;
   displaying, via the user E device on the display device, the determined distance to each of the identified objects on the captured images;
   communicating, via the user E device, the distance to each of the identified objects to one or more E devices, one or more cell phone, other mobile devices, or any combination thereof; and
   receiving, via the user E device, a stop function.

Embodiment 117. An apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the apparatus or system configured to:
receive, via the one of the E devices (referred to herein as the user E device), a start function;
capture, via the IC devices, one or more images (referred to herein as the captured images);
identify, via the user E device, one or more objects (referred to herein as the identified objects) in the captured images;
receive, via the user E device, a selection mode (referred to herein as the selected mode);
if the selection mode is a manual processing format, then:
   receive, via the user E device, an item from the LDBs, the CDBs, or any combination thereof identical or similar to each of the identified objects (referred to herein as the selected items);
   receive, via the user E device, a manual selection type;
   if the selection type is a main manual processing format, then:
      receive, via the user E device, a size determination type;
      if the size determination type is to assign predetermined sizes to the selected items, then:
         retrieve, via the user E device, a size for each of the selected items at known distances from the LDBs, the CDBs, or any combination thereof; and
         display, via the user E device on the display device, each of the selected items with the predetermined size on the of the corresponding identified objects in the captured images;
      if the size determination type is not to assign predetermined sizes to the selected items, then:
         display, via the user E device on the display device, each of the selected items on each of the corresponding identified objects in the captured images;
      adjust, via the user E device, a size of each of the selected items until the size of each of the selected items is the same as a size of each of the corresponding identified objects;
      determine, via the user E device, a distance to each of the identified objects based on the size of each of the corresponding selected items;
      display, via the user E device on the display device, the determined distance to each of the identified objects on the captured images;
      communicate, via the user E device, the distance to each of the identified objects to one or more E devices, one or more cell phones, other mobile devices, or any combination thereof; and
      receive, via the user E device, a stop function;
   if the selection type is a first override selection processing format, then:
      select, via the user E device, an item similar to each of the identified objects from the LDBs, the CDBs, or any combination thereof (referred to herein as the similar items);
      display, via the user E device on the display device, the similar items on the identified objects in the captured images;
      adjust, via the user E device, a size of each of the similar items to a size of each of the identified objects in the captured images;
      determine, via the user E device, a distance to each of the identified objects based on the size of each of the corresponding similar items;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
   if the selection type is a second override selection processing, then:
      receive, via the user E device, size values for calibrating a size of each of the identified objects (referred to herein as the input sizes);
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
if the selection mode is an automatic processing format, then:
   determine, via the user E device, whether each of the identified objects is found in the LDBs or the:
      if an identified object is not found in the LDBs, then:
         if the identified object is found in the CDBs, then add the identified object to the LDBs; otherwise, gather and/or generate information about the identified object from public websites, private websites, public databases, private databases, or any combination thereof, and add the identified object with the gathered and/or generated information to the LDBs;
   receive, via the user E device, an item from the LDBs for each of the identified objects (referred to as the selected items);
   display, via the user E device on the display device, each of the items on their corresponding identified objects in the captured images;
   adjust, via the user E device, a size of each of the found items until the sizes of each of the found items are the same as the sizes of each of the corresponding identified object;
   determine, via the user E device, a distance to each of the identified objects based on the sizes of each of the items;
   display, via the user E device on the display device, the determined distance to each of the identified objects on the captured images;
   communicate, via the user E device, the distance to each of the identified objects to one or more E devices, one or more cell phone, or other mobile devices; and
   receive, via the user E device, a stop function.

Embodiment 118. An interface implementing an apparatus or system, the apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the interface configured to:
receive, via the one of the E devices (referred to herein as the user E device), a start function;
capture, via the IC devices, one or more images (referred to herein as the captured images);
identify, via the user E device, one or more objects (referred to herein as the identified objects) in the captured images;
receive, via the user E device, a selection mode (referred to herein as the selected mode);
if the selection mode is a manual processing format, then:
   receive, via the user E device, an item from the LDBs, the CDBs, or any combination thereof identical or similar to each of the identified objects (referred to herein as the selected items);
   receive, via the user E device, a manual selection type;
   if the selection type is a main manual processing format, then:
      receive, via the user E device, a size determination type;
      if the size determination type is an assign predetermined size, then:
         retrieve, via the user E device, a size for the selected items at known distances from the LDBs, the CDBs, or any combination thereof; and
         display, via the user E device on the display device, the selected items on the identified objects in the captured images;
      if the size determination type is not to assign predetermined sizing, then:
         display, via the user E device on the display device, the selected items on the identified objects in the captured images;
      adjust, via the user E device, a size of each of the selected items until the size of each of the selected items is the same as the size of the identified objects;
      determine, via the user E device, a distance to each of the identified objects based on the size of the corresponding selected item;
      display, via the user E device on the display device, the determined distance to each of the identified objects on the captured images;
      communicate, via the user E device, the distance to each of the identified objects to one or more E devices, one or more cell phones, or other mobile devices; and
      receive, via the user E device, a stop function;
   if the selection type is a first override selection processing format, then:
      select, via the user E device, an item similar to each of the identified objects from the LDBs, the CDBs, or any combination thereof (referred to herein as the similar items);
      display, via the user E device on the display device, the similar items on the identified objects in the captured images;
      adjust, via the user E device, a size of each of the similar items to a size of each of the identified objects in the captured images;
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phone, or other mobile devices; and
      receive, via the user E device, a stop function;
   if the selection type is a second override selection processing, then:
      receive, via the user E device, size values for calibrating a size of each of the identified objects (referred to herein as the input sizes);
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phone, or other mobile devices; and
      receive, via the user E device, a stop function;
if the selection mode is an automatic processing format, then:
   determine, via the user E device, whether each of the identified objects is found in the LDBs or the:
      if an identified object is not found in the LDBs, then:
         if the identified object is found in the CDBs, then add the identified object to the LDBs; otherwise, gather and/or generate information about the identified object from public websites, private websites, public databases, private databases, or any combination thereof, and add the identified object with the gathered and/or generated information to the LDBs;
   receive, via the user E device, an item from the LDBs for each of the identified objects (referred to as the selected items);
   display, via the user E device on the display device, each of the items on their corresponding identified objects in the captured images;
   adjust, via the user E device, a size of each of the found items until the sizes of each of the found items are the same as the sizes of each of the corresponding identified object;
   determine, via the user E device, a distance to each of the identified objects based on the sizes of each of the items;
   display, via the user E device on the display device, the determined distance to each of the identified objects on the captured images;
   communicate, via the user E device, the distance to each of the identified objects to one or more E devices, one or more cell phone, or other mobile devices; and
   receive, via the user E device, a stop function.

Embodiment 119. A method implemented on an apparatus or system, the apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines referred to herein as (the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the method comprising:
receiving, via the one of the E devices (referred to herein as the user E device), a start function;
capturing, via the IC devices, one or more images (referred to herein as the captured images);
identifying, via the user E device, one or more objects (referred to herein as the identified objects) in the captured images;
receiving, via the user E device, a selection mode (referred to herein as the selected mode);
if the selection mode is a manual processing format, then:
   receiving, via the user E device, an item from the LDBs, the CDBs, or any combination thereof identical or similar to each of the identified objects (referred to herein as the selected items);
   receiving, via the user E device, a manual selection type;
   if the selection type is a main manual processing format, then:
      receiving, via the user E device, a size determination type;
      if the size determination type is an assign predetermined size, then:
         retrieving, via the user E device, a size for the selected items at known distances from the LDBs, the CDBs, or any combination thereof; and
         displaying, via the user E device on the display device, the selected items on the identified objects in the captured images;
      if the size determination type is not to assign predetermined sizing, then:
         displaying, via the user E device on the display device, the selected items on the identified objects in the captured images;
      adjusting, via the user E device, a size of each of the selected items until the size of each of the selected items is the same as the size of the identified objects;
      determining, via the user E device, a distance to each of the identified objects based on the size of the corresponding selected item;
      displaying, via the user E device on the display device, the determined distance to each of the identified objects on the captured images;
      communicating, via the user E device, the distance to each of the identified objects to one or more E devices, one or more cell phones, or other mobile devices; and
      receiving, via the user E device, a stop function;
   if the selection type is a first override selection processing format, then:
      selecting, via the user E device, an item similar to each of the identified objects from the LDBs, the CDBs, or any combination thereof (referred to herein as the similar items);
      displaying, via the user E device on the display device, the similar items on the identified objects in the captured images;
      adjust, via the user E device, a size of each of the similar items to a size of each of the identified objects in the captured images;
      determining, via the user E device, a distance to each of the identified objects;
      displaying, via the user E device on the display device, the determined distance to each of the identified objects on the captured images;
      communicating, via the user E device, the distance to each of the identified objects to one or more E devices, one or more cell phone, or other mobile devices; and
      receive, via the user E device, a stop function;
   if the selection type is a second override selection processing, then:
      receiving, via the user E device, size values for calibrating a size of each of the identified objects (referred to herein as the input sizes);
      determining, via the user E device, a distance to each of the identified objects;
      displaying, via the user E device on the display device, the determined distance to each of the identified objects on the captured images;
      communicating, via the user E device, the distance to each of the identified objects to one or more E devices, one or more cell phone, or other mobile devices; and
      receiving, via the user E device, a stop function;
if the selection mode is an automatic processing format, then:
   determining, via the user E device, whether each of the identified objects is found in the LDBs or the:
      if an identified object is not found in the LDBs, then:
         if the identified object is found in the CDBs, then adding the identified object to the LDBs; otherwise, gathering and/or generating information about the identified object from public websites, private websites, public databases, private databases, or any combination thereof, and adding the identified object with the gathered and/or generated information to the LDBs;
   receive, via the user E device, an item from the LDBs for each of the identified objects (referred to as the selected items);
   displaying, via the user E device on the display device, each of the selected items on their corresponding identified objects in the captured images;
   adjusting, via the user E device, a size of each of the selected items until the sizes of each of the selected items are the same as the sizes of each of the corresponding identified object;
   determining, via the user E device, a distance to each of the identified objects based on the sizes of each of the selected items;
   displaying, via the user E device on the display device, the determined distance to each of the identified objects on the captured images;
   communicating, via the user E device, the distance to each of the identified objects to one or more E devices, one or more cell phone, or other mobile devices; and
   receiving, via the user E device, a stop function.

Embodiment 120. An apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the apparatus or system configured to:
receive, via the one of the E devices (referred to herein as the user E device), a start function;
capture, via the IC devices, one or more images or frames from a continuous sequence of images (referred to herein as the captured images);
identify, via the user E device, one or more objects (referred to herein as the identified objects) in the captured images;
receive, via the user E device, a selection mode (referred to herein as the selected mode);
if the selection mode is a manual processing format, then:
   receive, via the user E device, an item from the LDBs, the CDBs, or any combination thereof identical or similar to each of the identified objects (referred to herein as the selected items);
   receive, via the user E device, a manual selection type;
   if the selection type is a main manual processing format, then:
      receive, via the user E device, a size determination type;
      if the size determination type is an assign predetermined size, then:
         retrieve, via the user E device, a size for the selected items at known distances from the LDBs, the CDBs, or any combination thereof; and
         display, via the user E device on the display device, the selected items on the identified objects in the captured images;
      if the size determination type is not to assign predetermined sizing, then:
         display, via the user E device on the display device, the selected items on the identified objects in the captured images;
      adjust, via the user E device, a size of each of the selected items until the size of each of the selected items is the same as the size of the identified objects;
      determine, via the user E device, a distance to each of the identified objects based on the size of the corresponding selected item;
      display, via the user E device on the display device, the determined distance to each of the identified objects on the captured images;
      communicate, via the user E device, the distance to each of the identified objects to one or more E devices, one or more cell phone, other mobile devices, or any combination; and
      receive, via the user E device, a stop function;
   if the selection type is a first override selection processing format, then:
      select, via the user E device, an item similar to each of the identified objects from the LDBs, the CDBs, or any combination thereof (referred to herein as the similar items);
      display, via the user E device on the display device, the similar items on the identified objects in the captured images;
      adjust, via the user E device, a size of each of the similar items to a size of each of the identified objects in the captured images;
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phones, other mobile devices, or any combination; and
      receive, via the user E device, a stop function;
   if the selection type is a second override selection processing, then:
      receive, via the user E device, size values for calibrating a size of each of the identified objects (referred to herein as the input sizes);
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phones, other mobile devices, or any combination; and
      receive, via the user E device, a stop function;
if the selection mode is an automatic processing format, then:
   determine, via the user E device, whether each of the identified objects is found in the LDBs:
      if an identified object is not found in the LDBs, then:
         if the identified object is found in the CDBs, then add the identified object to the LDBs; otherwise, gather and/or generate information about the identified object from public websites, private websites, public databases, private databases, or any combination thereof, and add the identified object with the gathered and/or generated information to the LDBs;
   receive, via the user E device, an item from the LDBs for each of the identified objects (referred to as the selected items);
   display, via the user E device on the display device, each of the selected items on their corresponding identified objects in the captured images;
   adjust, via the user E device, a size of each of the selected items until the sizes of each of the selected items are the same as the sizes of each of the corresponding identified object;
   determine, via the user E device, a distance to each of the identified objects based on the sizes of each of the selected items;
   display, via the user E device on the display device, the determined distance to each of the identified objects on the captured images;
   communicate, via the user E device, the distance to each of the identified objects to one or more E devices, one or more cell phones, other mobile devices, or any combination; and
   receive, via the user E device, a stop function.

Embodiment 121. An interface implementing an apparatus or system, the apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the interface configured to:
receive, via the one of the E devices (referred to herein as the user E device), a start function;
capture, via the IC devices, one or more images or frames from a continuous sequence of images (referred to herein as the captured images);
identify, via the user E device, one or more objects (referred to herein as the identified objects) in the captured images;
receive, via the user E device, a selection mode (referred to herein as the selected mode);
if the selection mode is a manual processing format, then:
   receive, via the user E device, an item from the LDBs, the CDBs, or any combination thereof identical or similar to each of the identified objects (referred to herein as the selected items);
   receive, via the user E device, a manual selection type;
   if the selection type is a main manual processing format, then:
      receive, via the user E device, a size determination type;
      if the size determination type is an assign predetermined size, then:
         retrieve, via the user E device, a size for the selected items at known distances from the LDBs, the CDBs, or any combination thereof; and
         display, via the user E device on the display device, the selected items on the identified objects in the captured images;
      if the size determination type is not to assign predetermined sizing, then:
         display, via the user E device on the display device, the selected items on the identified objects in the captured images;
      adjust, via the user E device, a size of each of the selected items until the size of each of the selected items is the same as the size of the identified objects;
      determine, via the user E device, a distance to each of the identified objects based on the size of the corresponding selected item;
      display, via the user E device on the display device, the determined distance to each of the identified objects on the captured images;
      communicate, via the user E device, the distance to each of the identified objects to one or more E devices, one or more cell phones, other mobile devices, or any combination; and
      receive, via the user E device, a stop function;
   if the selection type is a first override selection processing format, then:
      select, via the user E device, an item similar to each of the identified objects from the LDBs, the CDBs, or any combination thereof (referred to herein as the similar items);
      display, via the user E device on the display device, the similar items on the identified objects in the captured images;
      adjust, via the user E device, a size of each of the similar items to a size of each of the identified objects in the captured images;
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phones, or other mobile devices; and
      receive, via the user E device, a stop function;
   if the selection type is a second override selection processing, then:
      receive, via the user E device, size values for calibrating a size of each of the identified objects (referred to herein as the input sizes);
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phone, other mobile devices, or any combination; and
      receive, via the user E device, a stop function;
if the selection mode is an automatic processing format, then:
   determine, via the user E device, whether each of the identified objects is found in the LDBs:
      if an identified object is not found in the LDBs, then:
         if the identified object is found in the CDBs, then add the identified object to the LDBs; otherwise, gather and/or generate information about the identified object from public websites, private websites, public databases, private databases, or any combination thereof, and add the identified object with the gathered and/or generated information to the LDBs;
   receive, via the user E device, an item from the LDBs for each of the identified objects (referred to as the selected items);
   display, via the user E device on the display device, each of the selected items on their corresponding identified objects in the captured images;
   adjust, via the user E device, a size of each of the selected items until the sizes of each of the selected items are the same as the sizes of each of the corresponding identified object;
   determine, via the user E device, a distance to each of the identified objects based on the sizes of each of the selected items;
   display, via the user E device on the display device, the determined distance to each of the identified objects on the captured images;
   communicate, via the user E device, the distance to each of the identified objects to one or more E devices, one or more cell phones, other mobile devices, or any combination; and
   receive, via the user E device, a stop function.

Embodiment 122. A method implemented on an apparatus or system, the apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the method comprising:
receiving, via the one of the E devices (referred to herein as the user E device), a start function;
capturing, via the IC devices, one or more images or frames from a continuous sequence of images (referred to herein as the captured images);
identifying, via the user E device, one or more objects (referred to herein as the identified objects) in the captured images;
receiving, via the user E device, a selection mode (referred to herein as the selected mode);
if the selection mode is a manual processing format, then:
   receiving, via the user E device, an item from the LDBs, the CDBs, or any combination thereof identical or similar to each of the identified objects (referred to herein as the selected items);
   receiving, via the user E device, a manual selection type;
   if the selection type is a main manual processing format, then:
      receiving, via the user E device, a size determination type;
      if the size determination type is an assign predetermined size, then:
         retrieving, via the user E device, a size for the selected items at known distances from the LDBs, the CDBs, or any combination thereof; and
         displaying, via the user E device on the display device, the selected items on the identified objects in the captured images;
      if the size determination type is not to assign predetermined sizing, then:
         displaying, via the user E device on the display device, the selected items on the identified objects in the captured images;
      adjusting, via the user E device, a size of each of the selected items until the size of each of the selected items is the same as the size of the identified objects;
      determining, via the user E device, a distance to each of the identified objects based on the size of the corresponding selected item;
      displaying, via the user E device on the display device, the determined distance to each of the identified objects on the captured images;
      communicating, via the user E device, the distance to each of the identified objects to one or more E devices, one or more cell phones, other mobile devices, or any combination; and
      receiving, via the user E device, a stop function;
   if the selection type is a first override selection processing format, then:
      selecting, via the user E device, an item similar to each of the identified objects from the LDBs, the CDBs, or any combination thereof (referred to herein as the similar items);
      displaying, via the user E device on the display device, the similar items on the identified objects in the captured images;
      adjusting, via the user E device, a size of each of the similar items to a size of each of the identified objects in the captured images;
      determining, via the user E device, a distance to each of the identified objects;
      displaying, via the user E device on the display device, the determined distance to each of the identified objects on the captured images;
      communicating, via the user E device, the distance to each of the identified objects to one or more E devices, one or more cell phones, other mobile devices, or any combination; and
      receiving, via the user E device, a stop function;
   if the selection type is a second override selection processing, then:
      receiving, via the user E device, size values for calibrating a size of each of the identified objects (referred to herein as the input sizes);
      determining, via the user E device, a distance to each of the identified objects;
      displaying, via the user E device on the display device, the determined distance to each of the identified objects on the captured images;
      communicating, via the user E device, the distance to each of the identified objects to one or more E devices, one or more cell phones, other mobile devices, or any combination; and
      receiving, via the user E device, a stop function;
if the selection mode is an automatic processing format, then:
   displaying, via the user E device on the display device, each of the items on their corresponding identified objects in the captured images;
   adjusting, via the user E device, a size of each of the found items until the sizes of each of the found items are the same as the sizes of each of the corresponding identified object;
   determining, via the user E device, a distance to each of the identified objects based on the sizes of each of the items;
   displaying, via the user E device on the display device, the determined distance to each of the identified objects on the captured images;
   communicating, via the user E device, the distance to each of the identified objects to one or more E devices, one or more cell phones, other mobile devices, or any combination; and
   receiving, via the user E device, a stop function.

Embodiment 123. An apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the apparatus or system configured to:
receive, via the one of the E devices (referred to herein as the user E device), a start function;
capture, via the IC devices, one or more still images (referred to herein as the captured images);
identify, via the user E device, one or more objects (referred to herein as the identified objects) in the captured images;
receive, via the user E device, a selection mode (referred to herein as the selected mode);
if the selection mode is a manual processing format, then:
   receive, via the user E device, an item from the LDBs, the CDBs, or any combination thereof identical or similar to each of the identified objects (referred to herein as the selected items);
   receive, via the user E device, a manual selection type;
   if the selection type is a main manual processing format, then:
      receive, via the user E device, a size determination type;
      if the size determination type is an assign predetermined size, then:
         retrieve, via the user E device, a size for the selected items at known distances from the LDBs, the CDBs, or any combination thereof; and
         display, via the user E device on the display device, the selected items on the identified objects in the captured images;
      if the size determination type is not to assign predetermined sizing, then:
         display, via the user E device on the display device, the selected items on the identified objects in the captured images;
      adjust, via the user E device, a size of each of the selected items until the size of each of the selected items is the same as the size of the identified objects;
      determine, via the user E device, a distance to each of the identified objects based on the size of the corresponding selected item;
      display, via the user E device on the display device, the determined distance to each of the identified objects on the captured images;
      communicate, via the user E device, the distance to each of the identified objects to one or more E devices, one or more cell phones, other mobile devices, or any combination thereof; and
      receive, via the user E device, a stop function;
   if the selection type is a first override selection processing format, then:
      receive, via the user E device, an item similar to each of the identified objects from the LDBs, the CDBs, or any combination thereof (referred to herein as the similar items);
      display, via the user E device on the display device, the similar items on the identified objects in the captured images;
      adjust, via the user E device, a size of each of the similar items to a size of each of the identified objects in the captured images;
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
   if the selection type is a second override selection processing, then:
      receive, via the user E device, size values for calibrating a size of each of the identified objects (referred to herein as the input sizes);
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
if the selection mode is an automatic processing format, then:
   determine, via the user E device, whether each of the identified objects is found in the LDBs:
      if an identified object is not found in the LDBs, then:
         if the identified object is found in the CDBs, then add the identified object to the LDBs; otherwise, gather and/or generate information about the identified object from public websites, private websites, public databases, private databases, or any combination thereof, and add the identified object with the gathered and/or generated information to the LDBs;
   receive, via the user E device, an item from the LDBs for each of the identified objects (referred to as the selected items);
   display, via the user E device on the display device, each of the selected items on their corresponding identified objects in the captured images;
   adjust, via the user E device, a size of each of the selected items until the sizes of each of the selected items are the same as the sizes of each of the corresponding identified object;
   determine, via the user E device, a distance to each of the identified objects based on the sizes of each of the selected items;
   display, via the user E device on the display device, the determined distance to each of the identified objects on the captured images;
   communicate, via the user E device, the distance to each of the identified objects to one or more E devices, one or more cell phone, other mobile devices, or any combination thereof; and
   receive, via the user E device, a stop function.

Embodiment 124. An interface implementing an apparatus or system, the apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the interface configured to:
receive, via the one of the E devices (referred to herein as the user E device), a start function;
capture, via the IC devices, one or more still images (referred to herein as the captured images);
identify, via the user E device, one or more objects (referred to herein as the identified objects) in the captured images;
receive, via the user E device, a selection mode (referred to herein as the selected mode);
if the selection mode is a manual processing format, then:
   receive, via the user E device, an item from the LDBs, the CDBs, or any combination thereof identical or similar to each of the identified objects (referred to herein as the selected items);
   receive, via the user E device, a manual selection type;
   if the selection type is a main manual processing format, then:
      receive, via the user E device, a size determination type;
      if the size determination type is an assign predetermined size, then:
         retrieve, via the user E device, a size for the selected items at known distances from the LDBs, the CDBs, or any combination thereof; and
         display, via the user E device on the display device, the selected items on the identified objects in the captured images;
      if the size determination type is not to assign predetermined sizing, then:
         display, via the user E device on the display device, the selected items on the identified objects in the captured images;
      adjust, via the user E device, a size of each of the selected items until the size of each of the selected items is the same as the size of the identified objects;
      determine, via the user E device, a distance to each of the identified objects based on the size of the corresponding selected item;
      display, via the user E device on the display device, the determined distance to each of the identified objects on the captured images;
      communicate, via the user E device, the distance to each of the identified objects to one or more E devices, one or more cell phones, other mobile devices, or any combination thereof; and
      receive, via the user E device, a stop function;
   if the selection type is a first override selection processing format, then:
      receive, via the user E device, an item similar to each of the identified objects from the LDBs, the CDBs, or any combination thereof (referred to herein as the similar items);
      display, via the user E device on the display device, the similar items on the identified objects in the captured images;
      adjust, via the user E device, a size of each of the similar items to a size of each of the identified objects in the captured images;
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
   if the selection type is a second override selection processing, then:
      receive, via the user E device, size values for calibrating a size of each of the identified objects (referred to herein as the input sizes);
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
if the selection mode is an automatic processing format, then:
   determine, via the user E device, whether each of the identified objects is found in the LDBs:
      if an identified object is not found in the LDBs, then:
         if the identified object is found in the CDBs, then add the identified object to the LDBs; otherwise, gather and/or generate information about the identified object from public websites, private websites, public databases, private databases, or any combination thereof, and add the identified object with the gathered and/or generated information to the LDBs;
   receive, via the user E device, an item from the LDBs for each of the identified objects (referred to as the selected items);
   display, via the user E device on the display device, each of the selected items on their corresponding identified objects in the captured images;
   adjust, via the user E device, a size of each of the selected items until the sizes of each of the selected items are the same as the sizes of each of the corresponding identified object;
   determine, via the user E device, a distance to each of the identified objects based on the sizes of each of the selected items;
   display, via the user E device on the display device, the determined distance to each of the identified objects on the captured images;
   communicate, via the user E device, the distance to each of the identified objects to one or more E devices, one or more cell phone, other mobile devices, or any combination thereof; and
   receive, via the user E device, a stop function.

Embodiment 125. A method implemented on an apparatus or system, the apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases referred to herein as (the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the method comprising:
receiving, via the one of the E devices (referred to herein as the user E device), a start function;
capturing, via the IC devices, one or more still images (referred to herein as the captured images);
identifying, via the user E device, one or more objects (referred to herein as the identified objects) in the captured images;
receiving, via the user E device, a selection mode (referred to herein as the selected mode);
if the selection mode is a manual processing format, then:
   receiving, via the user E device, an item from the LDBs, the CDBs, or any combination thereof identical or similar to each of the identified objects (referred to herein as the selected items);
   receiving, via the user E device, a manual selection type;
   if the selection type is a main manual processing format, then:
      receiving, via the user E device, a size determination type;
      if the size determination type is an assign predetermined size, then:
         retrieving, via the user E device, a size for the selected items at known distances from the LDBs, the CDBs, or any combination thereof; and
         displaying, via the user E device on the display device, the selected items on the identified objects in the captured images;
      if the size determination type is not to assign predetermined sizing, then:
         displaying, via the user E device on the display device, the selected items on the identified objects in the captured images;
      adjusting, via the user E device, a size of each of the selected items until the size of each of the selected items is the same as the size of the identified objects;
      determining, via the user E device, a distance to each of the identified objects based on the size of the corresponding selected item;
      displaying, via the user E device on the display device, the determined distance to each of the identified objects on the captured images;
      communicating, via the user E device, the distance to each of the identified objects to one or more E devices, one or more cell phones, other mobile devices, or any combination thereof; and
      receiving, via the user E device, a stop function;
   if the selection type is a first override selection processing format, then:
      receiving, via the user E device, an item similar to each of the identified objects from the LDBs, the CDBs, or any combination thereof (referred to herein as the similar items);
      displaying, via the user E device on the display device, the similar items on the identified objects in the captured images;
      adjust, via the user E device, a size of each of the similar items to a size of each of the identified objects in the captured images;
      determining, via the user E device, a distance to each of the identified objects;
      displaying, via the user E device on the display device, the determined distance to each of the identified objects on the captured images;
      communicating, via the user E device, the distance to each of the identified objects to one or more E devices, one or more cell phone, other mobile devices, or any combination thereof; and
      receive, via the user E device, a stop function;
   if the selection type is a second override selection processing, then:
      receiving, via the user E device, size values for calibrating a size of each of the identified objects (referred to herein as the input sizes);
      determining, via the user E device, a distance to each of the identified objects;
      displaying, via the user E device on the display device, the determined distance to each of the identified objects on the captured images;
      communicating, via the user E device, the distance to each of the identified objects to one or more E devices, one or more cell phone, other mobile devices, or any combination thereof; and
      receiving, via the user E device, a stop function;
if the selection mode is an automatic processing format, then:
   determining, via the user E device, whether each of the identified objects is found in the LDBs:
      if an identified object is not found in the LDBs, then:
         if the identified object is found in the CDBs, then adding the identified object to the LDBs; otherwise, gathering and/or generating information about the identified object from public websites, private websites, public databases, private databases, or any combination thereof, and adding the identified object with the gathered and/or generated information to the LDBs;
   receiving, via the user E device, an item from the LDBs for each of the identified objects (referred to as the selected items);
   displaying, via the user E device on the display device, each of the selected items on their corresponding identified objects in the captured images;
   adjusting, via the user E device, a size of each of the selected items until the sizes of each of the selected items are the same as the sizes of each of the corresponding identified object;
   determining, via the user E device, a distance to each of the identified objects based on the sizes of each of the selected items;
   displaying, via the user E device on the display device, the determined distance to each of the identified objects on the captured images;
   communicating, via the user E device, the distance to each of the identified objects to one or more E devices, one or more cell phone, other mobile devices, or any combination thereof; and
   receiving, via the user E device, a stop function.

Embodiment 126. An apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the apparatus or system configured to:
receive, via the one of the E devices (referred to herein as the user E device), a start function;
capture, via the IC devices, one or more images or frames from a continuous sequence of images, one or more still images, or any combination thereof (referred to herein as the captured images);
identify, via the user E device, one or more objects (referred to herein as the identified objects) in the captured images;
receive, via the user E device, a selection mode (referred to herein as the selected mode);
if the selection mode is a manual processing format, then:
   receive, via the user E device, an item from the LDBs, the CDBs, or any combination thereof identical or similar to each of the identified objects (referred to herein as the selected items);
   receive, via the user E device, a manual selection type;
   if the selection type is a main manual processing format, then:
      receive, via the user E device, a size determination type;
      if the size determination type is an assign predetermined size, then:
         retrieve, via the user E device, a size for the selected items at known distances from the LDBs, the CDBs, or any combination thereof; and
         display, via the user E device on the display device, the selected items on the identified objects in the captured images;
      if the size determination type is not to assign predetermined sizing, then:
         display, via the user E device on the display device, the selected items on the identified objects in the captured images;
      adjust, via the user E device, a size of each of the selected items until the size of each of the selected items is the same as the size of the identified objects;
      determine, via the user E device, a distance to each of the identified objects based on the size of the corresponding selected item;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
   if the selection type is a first override selection processing format, then:
      select, via the user E device, an item similar to each of the identified objects from the LDBs, the CDBs, or any combination thereof (referred to herein as the similar items);
      display, via the user E device on the display device, the similar items on the identified objects in the captured images;
      adjust, via the user E device, a size of each of the similar items to a size of each of the identified objects in the captured images;
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
   if the selection type is a second override selection processing, then:
      receive, via the user E device, size values for calibrating a size of each of the identified objects (referred to herein as the input sizes);
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
if the selection mode is an automatic processing format, then:
   determine, via the user E device, whether each of the identified objects is found in the LDBs:
      if an identified object is not found in the LDBs, then:
         if the identified object is found in the CDBs, then add the identified object to the LDBs; otherwise, gather and/or generate information about the identified object from public websites, private websites, public databases, private databases, or any combination thereof, and add the identified object with the gathered and/or generated information to the LDBs;
   receive, via the user E device, an item from the LDBs for each of the identified objects (referred to as the selected items);
   display, via the user E device on the display device, each of the selected items on their corresponding identified objects in the captured images;
   adjust, via the user E device, a size of each of the selected items until the sizes of each of the selected items are the same as the sizes of each of the corresponding identified object;
   determine, via the user E device, a distance to each of the identified objects based on the sizes of each of the selected items;
   display, via the user E device on the display device, the determined distance to each of the identified objects on the captured images;
   communicate, via the user E device, the distance to each of the identified objects to one or more E devices, one or more cell phone, other mobile devices, or any combination thereof; and
   receive, via the user E device, a stop function.

Embodiment 127. An interface implementing an apparatus or system, the apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the interface configured to:
receive, via the one of the E devices (referred to herein as the user E device), a start function;
capture, via the IC devices, one or more images or frames from a continuous sequence of images, one or more still images, or any combination thereof (referred to herein as the captured images);
identify, via the user E device, one or more objects (referred to herein as the identified objects) in the captured images;
receive, via the user E device, a selection mode (the selected mode);
if the selection mode is a manual processing format, then:
   receive, via the user E device, an item from the LDBs, the CDBs, or any combination thereof identical or similar to each of the identified objects (referred to herein as the selected items);
   receive, via the user E device, a manual selection type;
   if the selection type is a main manual processing format, then:
      receive, via the user E device, a size determination type;
      if the size determination type is an assign predetermined size, then:
         retrieve, via the user E device, a size for the selected items at known distances from the LDBs, the CDBs, or any combination thereof; and
         display, via the user E device on the display device, the selected items on the identified objects in the captured images;
      if the size determination type is not to assign predetermined sizing, then:
         display, via the user E device on the display device, the selected items on the identified objects in the captured images;
      adjust, via the user E device, a size of each of the selected items until the size of each of the selected items is the same as the size of the identified objects;
      determine, via the user E device, a distance to each of the identified objects based on the size of the corresponding selected item;
      display, via the user E device on the display device, the determined distance to each of the identified objects on the captured images;
      communicate, via the user E device, the distance to each of the identified objects to one or more E devices, one or more cell phones, other mobile devices, or any combination thereof; and
      receive, via the user E device, a stop function;
   if the selection type is a first override selection processing format, then:
      select, via the user E device, an item similar to each of the identified objects from the LDBs, the CDBs, or any combination thereof (referred to herein as the similar items);
      display, via the user E device on the display device, the similar items on the identified objects in the captured images;
      adjust, via the user E device, a size of each of the similar items to a size of each of the identified objects in the captured images;
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
   if the selection type is a second override selection processing, then:
      receive, via the user E device, size values for calibrating a size of each of the identified objects (referred to herein as the input sizes);
      determine, via the user E device, a distance to each of the identified objects;
      display, via the user E device on the display device, the determined distance to each of the identified objects on the captured images;
      communicate, via the user E device, the distance to each of the identified objects to one or more E devices, one or more cell phone, other mobile devices, or any combination thereof; and
      receive, via the user E device, a stop function;
if the selection mode is an automatic processing format, then:
   determine, via the user E device, whether each of the identified objects is found in the LDBs:
      if an identified object is not found in the LDBs, then:
         if the identified object is found in the CDBs, then add the identified object to the LDBs; otherwise, gather and/or generate information about the identified object from public websites, private websites, public databases, private databases, or any combination thereof, and add the identified object with the gathered and/or generated information to the LDBs;
   receive, via the user E device, an item from the LDBs for each of the identified objects (referred to as the selected items);
   display, via the user E device on the display device, each of the selected items on their corresponding identified objects in the captured images;
   adjust, via the user E device, a size of each of the selected items until the sizes of each of the selected items are the same as the sizes of each of the corresponding identified object;
   determine, via the user E device, a distance to each of the identified objects based on the sizes of each of the selected items;
   display, via the user E device on the display device, the determined distance to each of the identified objects on the captured images;
   communicate, via the user E device, the distance to each of the identified objects to one or more E devices, one or more cell phone, other mobile devices, or any combination thereof; and
   receive, via the user E device, a stop function.

Embodiment 128. A method implemented on an apparatus or system, the apparatus or system comprising:
one or more electronic devices (referred to herein as the E devices), each of the E devices includes one or more processing units, memory, one or more mass storage devices, an operating system or structure, one or more input devices including one or more display devices and one or more image capturing devices, one or more output devices, one or more local databases (referred to herein as the LDBs), one or more local artificial intelligence engines (referred to herein as the LAI engines), communication hardware and software, and routines for implementing the apparatus or system;
one or more cloud-based data depositories (referred to herein as the DRs) including one or more servers (referred to herein as the servers), the servers include one or more processing units, memory, one or more mass storage devices, an operating system or structure, one or more input devices including one or more display devices and one or more image capturing devices, one or more output devices, one or more data web-based or cloud-based data bases (referred to herein as the CDBs), one or more web-based or cloud-based artificial intelligence engines (referred to herein as the DRAI engines), communication hardware and software, and routines for implementing the apparatus or system;
one or more image capturing devices (referred to herein as the IC devices); and
communication pathways between the E devices, the DRs, and the IC devices,
   the method comprising:
receiving, via the one of the E devices (referred to herein as the user E device), a start function;
capturing, via the IC devices, one or more images or frames from a continuous sequence of images, one or more still images, or any combination thereof (referred to herein as the captured images);
identifying, via the user E device, one or more objects (referred to herein as the identified objects) in the captured images;
receiving, via the user E device, a selection mode (referred to herein as the selected mode);
if the selection mode is a manual processing format, then:
   receiving, via the user E device, an item from the LDBs, the CDBs, or any combination thereof identical or similar to each of the identified objects (referred to herein as the selected items);
   receiving, via the user E device, a manual selection type;
   if the selection type is a main manual processing format, then:
      receiving, via the user E device, a size determination type;
      if the size determination type is an assign predetermined size, then:
         retrieving, via the user E device, a size for the selected items at known distances from the LDBs, the CDBs, or any combination thereof; and
         displaying, via the user E device on the display device, the selected items on the identified objects in the captured images;
      if the size determination type is not to assign predetermined sizing, then:
         displaying, via the user E device on the display device, the selected items on the identified objects in the captured images;
      adjusting, via the user E device, a size of each of the selected items until the size of each of the selected items is the same as the size of the identified objects;
      determining, via the user E device, a distance to each of the identified objects based on the size of the corresponding selected item;
      displaying, via the user E device on the display device, the determined distance to each of the identified objects on the captured images;
      communicating, via the user E device, the distance to each of the identified objects to one or more E devices, one or more cell phones, other mobile devices, or any combination thereof; and
      receiving, via the user E device, a stop function;
   if the selection type is a first override selection processing format, then:
      receiving, via the user E device, an item similar to each of the identified objects from the LDBs, the CDBs, or any combination thereof (referred to herein as the similar items);
      displaying, via the user E device on the display device, the similar items on the identified objects in the captured images;
      adjust, via the user E device, a size of each of the similar items to a size of each of the identified objects in the captured images;
      determining, via the user E device, a distance to each of the identified objects;
      displaying, via the user E device on the display device, the determined distance to each of the identified objects on the captured images;
      communicating, via the user E device, the distance to each of the identified objects to one or more E devices, one or more cell phone, other mobile devices, or any combination thereof; and
      receiving, via the user E device, a stop function;
   if the selection type is a second override selection processing, then:
      receiving, via the user E device, size values for calibrating a size of each of the identified objects (referred to herein as the input sizes);
      determining, via the user E device, a distance to each of the identified objects;
      displaying, via the user E device on the display device, the determined distance to each of the identified objects on the captured images;
      communicating, via the user E device, the distance to each of the identified objects to one or more E devices, one or more cell phone, other mobile devices, or any combination thereof; and
      receiving, via the user E device, a stop function;
if the selection mode is an automatic processing format, then:
   determining, via the user E device, whether each of the identified objects is found in the LDBs:
      if an identified object is not found in the LDBs, then:
         if the identified object is found in the CDBs, then adding the identified object to the LDBs; otherwise, gathering and/or generating information about the identified object from public websites, private websites, public databases, private databases, or any combination thereof, and adding the identified object with the gathered and/or generated information to the LDBs;
   receiving, via the user E device, an item from the LDBs for each of the identified objects (referred to as the selected items);
   displaying, via the user E device on the display device, each of the selected items on their corresponding identified objects in the captured images;
   adjusting, via the user E device, a size of each of the selected items until the sizes of each of the selected items are the same as the sizes of each of the corresponding identified object;
   determining, via the user E device, a distance to each of the identified objects based on the sizes of each of the selected items;
   displaying, via the user E device on the display device, the determined distance to each of the identified objects on the captured images;
   communicating, via the user E device, the distance to each of the identified objects to one or more E devices, one or more cell phone, other mobile devices, or any combination thereof; and
   receiving, via the user E device, a stop function.

Embodiment 129. A law enforcement or military targeting system comprising:
one or more electronic devices, referred to as the E Devices, each of the E Devices includes one or more processing units, memory, one or more mass storage devices, an operating system or structure, one or more input devices including one or more display devices and one or more image capturing devices, one or more output devices, communication hardware and software, and routines for implementing the system;
one or more cloud servers, referred to as the CSs, including one or more user databases, referred to as the UDBs, including user identification data and one or more E device databases, referred to as the EDDBs, including E Device identification data;
one or more cloud-based data depositories, referred herein as the DRs, including one or more servers, referred herein as the servers, the servers include one or more processing units, memory, one or more mass storage devices, an operating system or structure, one or more input devices including one or more display devices and one or more image capturing devices, one or more output devices, one or more data web-based or cloud-based data bases, referred as the DRDBs, or data storage structures, referred herein as the DRDSSs, collectively referred to as the DRDBDSSs, one or more web-based or cloud-based artificial intelligence engines, referred as the DRAI engines, communication hardware and software, and routines for implementing the system;
one or more image capturing devices, referred herein as the IC Devices; and
communication pathways between the E Devices, the CSs, the DRs, and the IC Devices,
   the system configured to:
capture, via the IC Devices associated with an E Device of a user referred to as the User E Device, image data, referred to as the Captured Image Data;
select, via the user or the DRAI engines, one or more targets or target types in the Captured Image Data, referred to as the Targets;
identify, via the DRAI engines, all recognizable objects in the Captured Image Data, referred to as the Identified Objects, and one or more of the Identified Objects associated with or located on, at, or near each of the Targets, referred to as the Target Relevant Objects;
select, via the DRAI engines from the DRDBDSSs, an item that is identical or similar to each of the Target Relevant Objects, referred to as the Target Selected Items;
adjust, via the DRAI engines, a size and a spatial orientation of each of the Target Selected Items until the size and the spatial orientation of each of the Target Selected Items corresponds to its Target Relevant Object, referred to as the Size and Orientation Data;
determine, via the DRAI engines, distance data for each of the Target Relevant Objects based on the Size and Orientation Data, referred to as the Target Relevant Object Distance Data;
calculate, via the DRAI engines, a distance to each of the Targets based on the Target Relevant Object Distance Data, referred to as the Target Distance Data; and
engage, via a user, one, some, or all of the Targets.

Embodiment 130. The system of Embodiment 129, further comprising:

prior to the Captured Image Data capture, determine, via the CSs, the User E Device, or any combination thereof, Location Data including the user location and the User E Device location.

Embodiment 131. The system of Embodiment 129, further comprising:
after or simultaneous with the image data capture, monitor, via the DRAI engines, the image data.

Embodiment 132. The system of Embodiment 129, further comprising:
prior to the Target Distance Data calculation, calculate, via the DRAI engines, a confidence value for each of the Target Relevant Object Distance Data, referred to as the CVs; and
calculate, via the DRAI engines, the Target Distance Data based on the CVs.

Embodiment 133. The system of Embodiment 129, further comprising:
prior to the Target Distance Data calculation, calculate, via the DRAI engines, a confidence value for each of the Target Relevant Object Distance Data, referred to as the CVs;
select, via the user or the DRAI engines, a percentile or percentile range ranking protocol for each of the Targets, referred to as the Ranking Protocols;
calculate, via the DRAI engines, ranking confidence values for each of the Target Relevant Objects based on the Ranking Protocols, referred to as the Ranked CVs; and
calculate, via the DRAI engines, the Target Distance Data based on the CVs, the Ranked CVs, or any combination thereof.

Embodiment 134. The system of Embodiment 129, further comprising:
prior to the Target Distance Data calculation, calculate, via the DRAI engines, a confidence value for each of the Target Relevant Object Distance Data, referred to as the CVs;
select, via the user or the DRAI engines, a percentile or percentile range ranking protocol for each of the Targets, referred to as the Ranking Protocols;
calculate, via the DRAI engines, ranking confidence values for each of the Target Relevant Objects based on the Ranking Protocols, referred to as the Ranked CVs;
select, via the DRAI engines, a Target Engagement Protocol for each of the Targets based the CVs, the Ranked CVs, or any combination thereof, referred to as the Target Engagement Protocols; and
calculate, via the DRAI engines, the Target Distance Data based on the CVs, the Ranked CVs, Target Engagement Protocols, or any combination thereof.

Embodiment 135. The system of Embodiment 129, further comprising:
prior to the image data capture, receive, via the CSs from the User E Device, a user access request comprising user identification data;
determine, via the CSs,
   if the user is included in the UBDs, then:
      add other devices under control of the user to the EDDBs; or
      if the potential user is not included in the UBDs, then:
         exit the system.

Embodiment 136. The system of Embodiment 129, further comprising:
prior to the image data capture, receive, via the User E Device, a start function; or
after the Target engagement, receive, via the User E Device, exit the system; or
prior to the image data capture, receive, via one of the User E Device, a start function, and
after the Target engagement, receive, via the User E Device, exit the system.

Embodiment 137. The system of Embodiment 129, further comprising:
prior to the Target Selected Items identification, determine, via the DRAI engines, if any of the Identified Objects are not found in the DRDBDSSs, referred to as the Unknown Objects;
for each of the Unknown Objects:
   generate/gather, via the CSs, information and data about the Unknown Object, referred to as the Unknown Object Data, and
   add, via the CSs, the Unknown Object Data to the DRDBDSSs.

Embodiment 138. The system of Embodiment 129, further comprising:
prior to the image data capture, receive, via one of the User E Device from an authorizing authority, an Engagement Protocol comprising engagement data, operation data, or any combination thereof;
after the Target Distance Data calculation, communicate, via the User E Device, the Target Distance Data to one or more additional E Devices, one or more authorized persons, or any combination thereof;
prior to the Targets engagement, receive, via the User E device from the authorizing authority, a Target Engagement Protocol comprising instructions concerning target engagement for each of the Targets;
after the Targets engagement:
   confirm, via the DRAI engines, a successful engagement or an unsuccessful engagement of each of the Targets, referred to as the Target Confirmation Data; and
   communicate, via the User E Device, the Target Confirmation Data to one or more of the E Devices of the one or more additional E Devices, the one or more authorized persons, or any combination thereof.

Embodiment 139. The system of Embodiments 129-138, further comprising:
store, via the CSs, the Captured Image Data, the Engagement Protocol, the user, the Location Data, the User E Device, the Targets, the Identified Objects, the Target Relevant Objects, the Target Selected Items, the Size and Orientation Data, the Target Relevant Object Distance Data, the CVs, the Ranked CVs, the Target Distance Data, the Target Engagement Authorization, the Target Engagement Data, and the Target Confirmation Data, referred to as the Current Operation Data, in all of the DRDBDSSs on all of the DRs;
calculate, via the DRAI engines,
   current user AI rules, user AI models, user AI methods, or any combination thereof based on the Current Operation Data, referred to as the Current User AI Data, and
current operation AI rules, operation AI models, operation AI methods, or any combination thereof based on the Current Operation Data, referred to as the Current Operation AI Data;
store, via the DRAI engines, the Current User AI Rules and the Current Operation AI Data on the DRDBDSSs;
update, via the CSs:
   User AI Data stored in the DRDBDSSs based on the Current User AI Rules, and
   Operation AI Data stored in the DRDBDSSs based on the Current Operation AI Data; and
store, via the CSs, the updated User AI Data and the updated Operation AI Data in DRDBDSSs.

Embodiment 140. The system of Embodiment 129, wherein:
the user identification data comprise a user name, a user ID, referred to as UID, a Universal Unique Identifier, referred to as UUID, or combination thereof, a user password, one or more phone numbers, one or more email addresses, other user identification information, or any combination thereof;
the user name comprises a full name of a person, initials of a person, a combination of letters, a combination of numbers, or any combination thereof;
each of the E device identification data comprise a unique identifier assigned to each E device;
the E device identification comprise E device manufacturer data, E device serial number data, E device operating system data, Identifier for Advertisers, referred to as IDFA, for iOS® devices, Android Advertising ID, referred to as AAID, for Android® devices, Google Advertising ID, referred to as GAID, for the Google® ecosystem, proprietary Secure ID, Media Access Control address, referred to as MAC address, International Mobile Equipment Identity, referred to as IMEI, for mobile devices, Universally Unique Identifier, referred to as UUID, Item Unique Identification, referred to as IUID, Unique Device Identification, referred to as UDI, Unique Device Identifier, referred to as UDID, or any combination thereof;
each of the DRDBDSSs includes data corresponding to items, item types, item classes, item categories, users, user types, user classes, and user categories;
the items comprise members of the animal kingdom including human beings or people, members of the plant kingdom, apparatuses, apparatus types, apparatus classes, apparatus categories, devices, devices types, devices classes, devices categories, equipment, equipment types, equipment classes, equipment categories, operations, operation types, operation classes, and operation categories, referred to as the DRDBDSS Data; and
the DRAI engines comprise routines for recognizing objects in the Captured Image Data.

Embodiment 141. A law enforcement or military targeting system comprising:
one or more electronic devices, referred to as the E devices, each of the E devices includes one or more processing units, memory, one or more mass storage devices, an operating system or structure, one or more input devices including one or more display devices and one or more image capturing devices, one or more output devices, one or more local databases, referred to as the LDBs, one or more local artificial intelligence engines, referred to as the LAI engines, communication hardware and software, and routines for implementing the system;
one or more cloud servers, referred to as the CSs, including one or more user databases, referred to as the UDBs, including user identification data and one or more E device databases, referred to as the EDDBs, including E device identification data;
one or more cloud-based data depositories, referred to as the DRs, including one or more servers, referred herein as the servers, the servers include one or more processing units, memory, one or more mass storage devices, an operating system or structure, one or more input devices including one or more display devices and one or more image capturing devices, one or more output devices, one or more data web-based or cloud-based data bases, referred as the DRDBs, or data storage structures, referred to as the DRDSSs, collectively referred to as the DRDBDSSs, one or more web-based or cloud-based artificial intelligence engines, referred to as the DRAI engines, communication hardware and software, and routines for implementing the system;
one or more image capturing devices, referred to as the IC Devices; and
communication pathways between the E Devices, the CSs, the DRs, and the IC Devices,
   the system configured to:
download, via the CSs to an E Device of a user, referred to as the User E Device, relevant data in a continuous or periodic manner from the DRDBDSSs to the LDBs and the LAI engines based on a capacity of the User E Device, a location of the user, and a location of the User E Device, referred to as the Relevant Data;
capture, via the IC Devices associated with the User E Device, image data, referred to as the Captured Image Data;
select, via a user or the LAI engines, one or more targets or target types in the Captured Image Data, referred to as the Targets;
identify, via the LAI engines, all recognizable objects in the Captured Image Data, referred to as the Identified Objects, and one or more of the Identified Objects associated with or located on, at, or near each of the Targets, referred to as the Target Relevant Objects;
select, via the LAI engines, an item from the LDBs that is identical or similar to each of the Target Relevant Objects, referred to as the Target Selected Items;
adjust, via the LAI engines, a size and a spatial orientation of each of the Target Selected Items until the size and the spatial orientation of each of the Target Selected Items corresponds to each of the Target Relevant Objects, referred to as the Size and Orientation Data;
determine, via the LAI engines, distance data for each of the Target Relevant Objects based on the Sizes and Orientations of the Target Selected Items, referred to as the Target Relevant Object Distance Data;
calculate, via the LAI engines, a distance to each of the Targets based on the Target Relevant Object Distance Data, referred to as the Target Distance Data; and
engage, via a user, some, or all of the Targets.

Embodiment 142. The system of Embodiment 141, further comprising:
prior to the Captured Image Data capture, determine, via the User E Device, Relevant Data including the user location and the User E Device location.

Embodiment 143. The system of Embodiment 141, further comprising:
after or simultaneous with the image data capture, monitor, via the LAI engines, the Captured Image Data.

Embodiment 144. The system of Embodiment 141, further comprising:
prior to the Target Distance Data calculation, calculate, via the LAI engines, a confidence value for each of the Target Relevant Object Distance Data, referred to as the CVs; and
calculate, via the LAI engines, the Target Distance Data based on the CVs.

Embodiment 145. The system of Embodiment 141, further comprising:
prior to the Target Distance Data calculation, calculate, via the LAI engines, a confidence value for each of the Target Relevant Object Distance Data, referred to as the CVs;
select, via the user or the LAI engines, a percentile or percentile range ranking protocol for each of the Targets, referred to as the Ranking Protocols;
calculate, via the LAI engines, ranking confidence values for each of the Target Relevant Objects based on the Ranking Protocols, referred to as the Ranked CVs; and
calculate, via the LAI engines, the Target Distance Data based on the CVs, the Ranked CVs, or any combination thereof.

Embodiment 146. The system of Embodiment 141, further comprising:
prior to the Target Distance Data calculation, calculate, via the LAI engines, a confidence value for each of the Target Relevant Object Distance Data, referred to as the CVs;
select, via the user or the LAI engines, a percentile or percentile range ranking protocol for each of the Targets, referred to as the Ranking Protocols;
calculate, via the LAI engines, ranking confidence values for each of the Target Relevant Objects based on the Ranking Protocols, referred to as the Ranked CVs;
select, via the LAI engines, a Target Engagement Protocol for each of the Targets based the CVs, the Ranked CVs, or any combination thereof, referred to as the Target Engagement Protocols; and
calculate, via the LAI engines, the Target Distance Data based on the CVs, the Ranked CVs, Target Engagement Protocols, or any combination thereof.

Embodiment 147. The system of Embodiment 141, further comprising:
prior to the image data capture, receive, via the CSs from the User E Device, a user access request comprising user identification data;
determine, via the CSs,
   if the user is included in the UBDs, then:
   add other devices under control of the user to the EDDBs; or
   if the potential user is not included in the UBDs, then:
      exit the system.

Embodiment 148. The system of Embodiment 141, further comprising:
prior to the prior to the image data capture, receive, via the User E Device, a start function; or
after the Target engagement, receive, via the User E Device, exit the system; or
prior to the prior to the image data capture, receive, via one of the User E Device, a start function, and
after the Target engagement, receive, via the User E Device, exit the system.

Embodiment 149. The system of Embodiment 141, further comprising:
prior to the Target Selected Items identification, determine, via the LAI engines, if any of the Identified Objects are not found in the LDBs, referred to as the Unknown Objects;
for each of the Unknown Objects:
   generate/gather, via the LAI engines, information and data about the Unknown Object, referred to as the Unknown Object Data, and
   add via the LAI engines, the Unknown Object Data to the LDBs.

Embodiment 150. The system of Embodiment 141, further comprising:
prior to the prior to the image data capture, receive, via one of the User E Device from an authorizing authority, an Engagement Protocol comprising engagement data, operation data, or any combination thereof;
after the Target Distance Data calculation, communicate, via the User E Device, the Target Distance Data to one or more additional E Devices, one or more authorized persons, or any combination thereof;
prior to the Targets engagement, receive, via the User E device from the authorizing authority, a Target Engagement Protocol comprising instructions concerning target engagement for each of the Targets;
after the Targets engagement:
   confirm, via the LAI engines, a successful engagement or an unsuccessful engagement of each of the Targets, referred to as the Target Confirmation Data; and
   communicate, via the User E Device, the Target Confirmation Data to one or more of the E Devices of the one or more additional E Devices, the one or more authorized persons, or any combination thereof.

Embodiment 151. The system of Embodiments 141-150, further comprising:
store, via the CSs, the Captured Image Data, the Engagement Protocol, the user, the Relevant Data, the User E Device, the Targets, the Identified Objects, the Target Relevant Objects, the Target Selected Items, the Size and Orientation Data, the Target Relevant Object Distance Data, the CVs, the Ranked CVs, the Target Distance Data, the Target Engagement Authorization, the Target Engagement Data, and the Target Confirmation Data, referred to as the Current Operation Data, in the LDBs and all of the DRDBDSSs on all of the DRs;
calculate, via the LAI engines,
   current user AI rules, user AI models, user AI methods, or any combination thereof based on the Current Operation Data, referred to as the Current User AI Data, and
   current operation AI rules, operation AI models, operation AI methods, or any combination thereof based on the Current Operation Data, referred to as the Current Operation AI Data;
store, via the LAI engines, the Current User AI Rules and the Current Operation AI Data on the LDBs and the DRDBDSSs;
update, via the LAI engines:
   User AI Data stored in the LDBs and the DRDBDSSs based on the Current User AI Rules, and
   Operation AI Data stored in the LDBs and the DRDBDSSs based on the Current Operation AI Data; and
store, via the LAI engines, the updated User AI Data and the updated Operation AI Data in the LDBs and the DRDBDSSs.

Embodiment 152. The system of Embodiment 141, further comprising:
the user identification data comprise a user name, a user ID, referred to as UID, a Universal Unique Identifier, referred to as UUID, or combination thereof, a user password, one or more phone numbers, one or more email addresses, other user identification information, or any combination thereof;
the user name comprises a full name of a person, initials of a person, a combination of letters, a combination of numbers, or any combination thereof;
each of the E device identification data comprise a unique identifier assigned to each E device;
the E device identification comprise E device manufacturer data, E device serial number data, E device operating system data, Identifier for Advertisers, referred to as IDFA, for iOS® devices, Android Advertising ID, referred to as AAID, for Android® devices, Google Advertising ID, referred to as GAID, for the Google® ecosystem, proprietary Secure ID, Media Access Control address, referred to as MAC address, International Mobile Equipment Identity, referred to as IMEI, for mobile devices, Universally Unique Identifier, referred to as UUID, Item Unique Identification, referred to as IUID, Unique Device Identification, referred to as UDI, Unique Device Identifier, referred to as UDID, or any combination thereof;
the LDBs and the DRDBDSSs includes data corresponding to items, item types, item classes, item categories, users, user types, user classes, and user categories;
the items comprise members of the animal kingdom including human beings or people, members of the plant kingdom, apparatuses, apparatus types, apparatus classes, apparatus categories, devices, devices types, devices classes, devices categories, equipment, equipment types, equipment classes, equipment categories, operations, operation types, operation classes, and operation categories, referred to as the DRDBDSS Data; and
the LAI engines comprise routines for recognizing objects in the Captured Image Data.

Embodiment 153. A law enforcement or military targeting system comprising:
one or more electronic devices, referred to as the E Devices, each of the E Devices includes one or more processing units, memory, one or more mass storage devices, an operating system or structure, one or more input devices including one or more display devices and one or more image capturing devices, one or more output devices, communication hardware and software, and routines for implementing the system;
one or more cloud servers, referred to as the CSs, including one or more user databases, referred to as the UDBs, including user identification data and one or more E device databases, referred to as the EDDBs, including E Device identification data;
one or more cloud-based data depositories, referred herein as the DRs, including one or more servers, referred herein as the servers, the servers include one or more processing units, memory, one or more mass storage devices, an operating system or structure, one or more input devices including one or more display devices and one or more image capturing devices, one or more output devices, one or more data web-based or cloud-based data bases, referred as the DRDBs, or data storage structures, referred herein as the DRDSSs, collectively referred to as the DRDBDSSs, one or more web-based or cloud-based artificial intelligence engines, referred as the DRAI engines, communication hardware and software, and routines for implementing the system;
one or more image capturing devices, referred herein as the IC Devices; and
communication pathways between the E Devices, the CSs, the DRs, and the IC Devices,
   the system configured to:
download, via the CSs to an E Device of a user, referred to as the User E Device, relevant data in a continuous or periodic manner from the DRDBDSSs of the DRs to the LDBs and the LAI engines based on a capacity of the User E Device, a location of the user, and a location of the User E Device, referred to as the Relevant Data;
capture, via the IC Devices, Captured Image Data associated with an E Device of the user referred to as the User E Device;
select, via the user, the LAI engines, the DRAI engines, or any combination thereof, one or more targets or target types in the Captured Image Data, referred to as the Targets;
identify, via the LAI engines, the DRAI engines, or any combination thereof, all recognizable objects in the Captured Image Data, referred to as the Identified Objects, and one or more of the Identified Objects associated with or located on, at, or near each of the Targets, referred to as the Target Relevant Objects;
select, via the LAI engines, the DRAI engines, or any combination thereof from the LDBs, the DRDBDSSs, an item that is identical or similar to each of the Target Relevant Objects, referred to as the Target Selected Items;
adjust, via the LAI engines, the DRAI engines, or any combination thereof, a size and a spatial orientation of each of the Target Selected Items until the size and the spatial orientation of each of the Target Selected Items corresponds to its Target Relevant Object, referred to as the Size and Orientation Data;
determine, via the LAI engines, the DRAI engines, or any combination thereof, distance data for each of the Target Relevant Objects based on the Size and Orientation Data, referred to as the Target Relevant Object Distance Data;
calculate, via the LAI engines, the DRAI engines, or any combination thereof, a distance to each of the Targets based on the Target Relevant Object Distance Data, referred to as the Target Distance Data; and engage, via a user, one, some, or all of the Targets.

Embodiment 154. The system of Embodiment 153, further comprising:
after or simultaneous with the image data capture, monitor, via the LAI engines, the DRAI engines, or any combination thereof, the Captured Image Data.

Embodiment 155. The system of Embodiment 153, further comprising:
prior to the Target Distance Data calculation, calculate, via the LAI engines, the DRAI engines, or any combination thereof, a confidence value for each of the Target Relevant Object Distance Data, referred to as the CVs; and
calculate, via the LAI engines, the DRAI engines, or any combination thereof, the Target Distance Data based on the CVs.

Embodiment 156. The system of Embodiment 153, further comprising:
prior to the Target Distance Data calculation, calculate, via the LAI engines, the DRAI engines, or any combination thereof, a confidence value for each of the Target Relevant Object Distance Data, referred to as the CVs;
select, via the user, the LAI engines, the DRAI engines, or any combination thereof, a percentile or percentile range ranking protocol for each of the Targets, referred to as the Ranking Protocols;
calculate, via the LAI engines, the DRAI engines, or any combination thereof, ranking confidence values for each of the Target Relevant Objects based on the Ranking Protocols, referred to as the Ranked CVs; and
calculate, via the LAI engines, the DRAI engines, or any combination thereof, the Target Distance Data based on the CVs, the Ranked CVs, or any combination thereof.

Embodiment 157. The system of Embodiment 153, further comprising:
prior to the Target Distance Data calculation, calculate, via the LAI engines, the DRAI engines, or any combination thereof, a confidence value for each of the Target Relevant Object Distance Data, referred to as the CVs;
select, via the user, the LAI engines, the DRAI engines, or any combination thereof, a percentile or percentile range ranking protocol for each of the Targets, referred to as the Ranking Protocols;
calculate, via the LAI engines, the DRAI engines, or any combination thereof, ranking confidence values for each of the Target Relevant Objects based on the Ranking Protocols, referred to as the Ranked CVs;
select, via the LAI engines, the DRAI engines, or any combination thereof, a Target Engagement Protocol for each of the Targets based the CVs, the Ranked CVs, or any combination thereof, referred to as the Target Engagement Protocols; and
calculate, via the LAI engines, the DRAI engines, or any combination thereof, the Target Distance Data based on the CVs, the Ranked CVs, Target Engagement Protocols, or any combination thereof.

Embodiment 158. The system of Embodiment 153, further comprising:
prior to the image data capture, receive, via the CSs from the User E Device, a user access request comprising user identification data;
determine, via the CSs,
   if the user is included in the UBDs, then:
      add other devices under control of the user to the EDDBs; or
      if the potential user is not included in the UBDs, then:
         exit the system.

Embodiment 159. The system of Embodiment 153, further comprising:
prior to the image data capture, receive, via the User E Device, a start function; or
after the Target engagement, receive, via the User E Device, exit the system; or
prior to the image data capture, receive, via one of the User E Device, a start function, and
after the Target engagement, receive, via the User E Device, exit the system.

Embodiment 160. The system of Embodiment 153, further comprising:
prior to the Target Selected Items identification, determine, via the LAI engines, the DRAI engines, or any combination thereof, if any of the Identified Objects are not found in the LDBs and/or DRDBDSSs, referred to as the Unknown Objects;
for each of the Unknown Objects:
   generate/gather, via the CSs, information and data about the Unknown Object, referred to as the Unknown Object Data, and
   add via the LAI engines, the Unknown Object Data to the LDBs and
   add via the DRAI engines, the Unknown Object Data to the DRDBDSSs.

Embodiment 161. The system of Embodiment 153, further comprising:
prior to the image data capture, receive, via one of the User E Device from an authorizing authority, an Engagement Protocol comprising engagement data, operation data, or any combination thereof;
after the Target Distance Data calculation, communicate, via the User E Device, the Target Distance Data to one or more additional E Devices, one or more authorized persons, or any combination thereof;
prior to the Targets engagement, receive, via the User E device from the authorizing authority, a Target Engagement Protocol comprising instructions concerning target engagement for each of the Targets;
after the Targets engagement:
   confirm, via the LAI engines, the DRAI engines, or any combination thereof, a successful engagement or an unsuccessful engagement of each of the Targets, referred to as the Target Confirmation Data; and
   communicate, via the User E Device, the Target Confirmation Data to one or more of the E Devices of the one or more additional E Devices, the one or more authorized persons, or any combination thereof.

Embodiment 162. The system of Embodiments 153-161, further comprising:
store, via the CSs, the Captured Image Data, the Engagement Protocol, the user, the Relevant Data, the User E Device, the Targets, the Identified Objects, the Target Relevant Objects, the Target Selected Items, the Size and Orientation Data, the Target Relevant Object Distance Data, the CVs, the Ranked CVs, the Target Distance Data, the Target Engagement Authorization, the Target Engagement Data, and the Target Confirmation Data, referred to as the Current Operation Data, in the LDBs and the DRDBDSSs;
calculate, via the LAI engines, the DRAI engines, or any combination thereof,
   current user AI rules, user AI models, user AI methods, or any combination thereof based on the Current Operation Data, referred to as the Current User AI Data, and current operation AI rules, operation AI models, operation AI methods, or any combination thereof based on the Current Operation Data, referred to as the Current Operation AI Data;
store, via the LAI engines, the DRAI engines, or any combination thereof, the Current User AI Rules and the Current Operation AI Data on the LDBs and the DRDBDSSs;
update, via the LAI engines, the DRAI engines, or any combination thereof:
   User AI Data stored in the LDBs and the DRDBDSSs based on the Current User AI Rules, and
   Operation AI Data stored in the LDBs and the DRDBDSSs based on the Current Operation AI Data; and
store, via the LAI engines, the DRAI engines, or any combination thereof, the updated User AI Data and the updated Operation AI Data in DRDBDSSs.

Embodiment 163. The system of Embodiment 153, further comprising:
the user identification data comprise a user name, a user ID, referred to as UID, a Universal Unique Identifier, referred to as UUID, or combination thereof, a user password, one or more phone numbers, one or more email addresses, other user identification information, or any combination thereof;
the user name comprises a full name of a person, initials of a person, a combination of letters, a combination of numbers, or any combination thereof;
each of the E device identification data comprise a unique identifier assigned to each E device;
the E device identification comprise E device manufacturer data, E device serial number data, E device operating system data, Identifier for Advertisers, referred to as IDFA, for iOS® devices, Android Advertising ID, referred to as AAID, for Android® devices, Google Advertising ID, referred to as GAID, for the Google® ecosystem, proprietary Secure ID, Media Access Control address, referred to as MAC address, International Mobile Equipment Identity, referred to as IMEI, for mobile devices, Universally Unique Identifier, referred to as UUID, Item Unique Identification, referred to as IUID, Unique Device Identification, referred to as UDI, Unique Device Identifier, referred to as UDID, or any combination thereof;
the LDBs and the DRDBDSSs includes data corresponding to items, item types, item classes, item categories, users, user types, user classes, and user categories;
the items comprise members of the animal kingdom including human beings or people, members of the plant kingdom, apparatuses, apparatus types, apparatus classes, apparatus categories, devices, devices types, devices classes, devices categories, equipment, equipment types, equipment classes, equipment categories, operations, operation types, operation classes, and operation categories, referred to as the DRDBDSS Data; and
the LAI engines, the DRAI engines, or any combination thereof comprise routines for recognizing objects in the Captured Image Data.

Embodiment 164. A system, comprising:
one or more electronic devices, referred to as the E Devices, each of the E Devices includes one or more processing units, memory, one or more mass storage devices, an operating system or structure, one or more input devices including one or more display devices and one or more image capturing devices, one or more output devices, communication hardware and software, and routines for implementing the system;
one or more cloud servers, referred to as the CSs, including one or more user databases, referred to as the UDBs, including user identification data and one or more E device databases, referred to as the EDDBs, including E Device identification data;
one or more cloud-based data depositories, referred herein as the DRs, including one or more servers, referred herein as the servers, the servers include one or more processing units, memory, one or more mass storage devices, an operating system or structure, one or more input devices including one or more display devices and one or more image capturing devices, one or more output devices, one or more data web-based or cloud-based data bases, referred as the DRDBs, or data storage structures, referred herein as the DRDSSs, collectively referred to as the DRDBDSSs, one or more web-based or cloud-based artificial intelligence engines, referred as the DRAI engines, communication hardware and software, and routines for implementing the system;
one or more image capturing devices, referred herein as the IC Devices; and
communication pathways between the E Devices, the CSs, the DRs, and the IC Devices,
   the system configured to:
download, via the CSs to an E Device of a user, referred to as the User E Device, relevant data, referred to as the Relevant Data, in a continuous or periodic manner from the DRDBDSSs of the DRs to the LDBs and the LAI engines based on a Capacity of the User E Device, and Location Data comprising a location of the user and a location of the User E Device;
capture, via the IC Devices, image data associated with the User E Device, referred to as the Captured Image Data;
select, via the user, the LAI engines, the DRAI engines, or any combination thereof, one or more targets or target types in the Captured Image Data, referred to as the Targets;
identify, via the LAI engines, the DRAI engines, or any combination thereof, all recognizable objects in the Captured Image Data, referred to as the Identified Objects, and one or more of the Identified Objects associated with or located on, at, or near each of the Targets, referred to as the Target Relevant Objects;
select, via the LAI engines, the DRAI engines, or any combination thereof from the LDBs, the DRDBDSSs, or any combination, an item that is identical or similar to each of the Target Relevant Objects, referred to as the Target Selected Items;
adjust, via the LAI engines, the DRAI engines, or any combination thereof, a size and a spatial orientation of each of the Target Selected Items until the size and the spatial orientation of each of the Target Selected Items corresponds to its Target Relevant Object, referred to as the Size and Orientation Data;
determine, via the LAI engines, the DRAI engines, or any combination thereof, distance data for each of the Target Relevant Objects based on the Size and Orientation Data, referred to as the Target Relevant Object Distance Data;
calculate, via the LAI engines, the DRAI engines, or any combination thereof, a distance to each of the Targets based on the Target Relevant Object Distance Data, referred to as the Target Distance Data; and engage, via a user, one, some, or all of the Targets.

Embodiment 165. The system of Embodiment 164, further comprising:
after or simultaneous with the image data capture, monitor, via the LAI engines, the DRAI engines, or any combination thereof, the image data;
prior to the Target Distance Data calculation, calculate, via the LAI engines, the DRAI engines, or any combination thereof, a confidence value for each of the Target Relevant Object Distance Data, referred to as the CVs; and
calculate, via the LAI engines, the DRAI engines, or any combination thereof, the Target Distance Data based on the CVs.

Embodiment 166. The system of Embodiment 165, further comprising:
select, via the user, the LAI engines, the DRAI engines, or any combination thereof, a percentile or percentile range ranking protocol for each of the Targets, referred to as the Ranking Protocols;
calculate, via the LAI engines, the DRAI engines, or any combination thereof, ranking confidence values for each of the Target Relevant Objects based on the Ranking Protocols, referred to as the Ranked CVs; and
calculate, via the LAI engines, the DRAI engines, or any combination thereof, the Target Distance Data based on the CVs, the Ranked CVs, or any combination thereof.

Embodiment 167. The system of Embodiment 166, further comprising:
select, via the LAI engines, the DRAI engines, or any combination thereof, a Target engagement protocol for each of the Targets based on the CVs, the Ranked CVs, or any combination thereof, referred to as the Target Engagement Protocols; and
calculate, via the LAI engines, the DRAI engines, or any combination thereof, the Target Distance Data based on the CVs, the Ranked CVs, Target Engagement Protocols, or any combination thereof.

Embodiment 168. The system of Embodiment 167, further comprising:
prior to the image data capture, receive, via the CSs from the User E Device, a user access request comprising user identification data;
determine, via the CSs,
   if the user is included in the UBDs, then:
      add other devices under control of the user to the EDDBs; or
      if the potential user is not included in the UBDs, then:
      exit the system.

Embodiment 169. The system of Embodiment 168, further comprising:
prior to the image data capture, receive, via the User E Device, a start function; or
after the Target engagement, receive, via the User E Device, exit the system; or
prior to the image data capture, receive, via one of the User E Device, a start function, and
after the Target engagement, receive, via the User E Device, exit the system.

Embodiment 170. The system of Embodiment 169, further comprising:
prior to the Target Selected Items identification, determine, via the LAI engines, the DRAI engines, or any combination thereof, if any of the Identified Objects is not found in the LDBs, DRDBDSSs, or any combination, thereof, referred to as the Unknown Objects;
for each of the Unknown Objects:
   generate/gather, via the CSs, information and data about the Unknown Object, referred to as the Unknown Object Data, and
   add via the LAI engines, the Unknown Object Data to the LDBs and add via the DRAI engines, the Unknown Object Data to the DRDBDSSs.

Embodiment 171. The system of Embodiment 170, further comprising:
prior to the image data capture, receive, via the User E Device from an authorizing authority, an Engagement Protocol comprising engagement data, operation data, or any combination thereof;
after the Target Distance Data calculation, communicate, via the User E Device, the Target Distance Data to one or more additional E Devices, one or more authorized persons, or any combination thereof;
prior to the Targets engagement, receive, via the User E device from the authorizing authority, a Target Engagement Protocol for each of the Targets, each of the Target Engagement Protocols comprises instructions concerning target engagement; after the Targets engagement:
   confirm, via the LAI engines, the DRAI engines, or any combination thereof, a successful engagement or an unsuccessful engagement of each of the Targets, referred to as the Target Confirmation Data; and
   communicate, via the User E Device, the Target Confirmation Data to one or more of the E Devices of the one or more additional E Devices, the one or more authorized persons, or any combination thereof.

Embodiment 172. The system of Embodiment 171, further comprising:
store, via the CSs and the User E Device, the Captured Image Data, the Engagement Protocol, the user, the Location Data, the User E Device, the Targets, the Identified Objects, the Relevant Objects, the Selected Items, the Size and Orientation Data, the Relevant Object Distance Data, the CVs, the Ranked CVs, the Target Distance Data, the Target Engagement Authorization, the Target Engagement Data, and the Target Confirmation Data, referred to as the Current Operation Data, in the LDBs and the DRDBDSSs;
calculate, via the LAI engines, the DRAI engines, or any combination thereof, current user AI rules, user AI models, user AI methods, or any combination thereof based on the Current Operation Data, referred to as the Current User AI Data, and current operation AI rules, operation AI models, operation AI methods, or any combination thereof based on the Current Operation Data, referred to as the Current Operation AI Data;
store, via the LAI engines, the DRAI engines, or any combination thereof, the Current User AI Rules and the Current Operation AI Data on the LDBs and the DRDBDSSs;
update, via the LAI engines, the DRAI engines, or any combination thereof:
   User AI Data stored in the LDBs and the DRDBDSSs based on the Current User AI Rules, and
   Operation AI Data stored in the LDBs and the DRDBDSSs based on the Current Operation AI Data; and
store, via the LAI engines, the DRAI engines, or any combination thereof, the updated User AI Data and the updated Operation AI Data in DRDBDSSs.

Embodiment 173. The system of Embodiment 164, further comprising:
the user identification data comprise a user name, a user ID, referred to as UID, a Universal Unique Identifier, referred to as UUID, or combination thereof, a user password, one or more phone numbers, one or more email addresses, other user identification information, or any combination thereof;
the user name comprises a full name of a person, initials of a person, a combination of letters, a combination of numbers, or any combination thereof;
each of the E device identification data comprise a unique identifier assigned to each E device;
the E device identification comprise E device manufacturer data, E device serial number data, E device operating system data, Identifier for Advertisers, referred to as IDFA, for iOS® devices, Android Advertising ID, referred to as AAID, for Android® devices, Google Advertising ID, referred to as GAID, for the Google® ecosystem, proprietary Secure ID, Media Access Control address, referred to as MAC address, International Mobile Equipment Identity, referred to as IMEI, for mobile devices, Universally Unique Identifier, referred to as UUID, Item Unique Identification, referred to as IUID, Unique Device Identification, referred to as UDI, Unique Device Identifier, referred to as UDID, or any combination thereof;
the LDBs and the DRDBDSSs includes data corresponding to items, item types, item classes, item categories, users, user types, user classes, and user categories;
the items comprise members of the animal kingdom including human beings or people, members of the plant kingdom, apparatuses, apparatus types, apparatus classes, apparatus categories, devices, devices types, devices classes, devices categories, equipment, equipment types, equipment classes, equipment categories, operations, operation types, operation classes, and operation categories, referred to as the DRDBDSS Data; and
the LAI engines, the DRAI engines, or any combination thereof comprise routines for recognizing objects in the Captured Image Data.

Embodiment 174. A system, comprising:
one or more electronic devices, referred to as the E Devices, each of the E Devices includes one or more processing units, memory, one or more mass storage devices, an operating system or structure, one or more input devices including one or more display devices and one or more image capturing devices, one or more output devices, communication hardware and software, and routines for implementing the system;
one or more cloud servers, referred to as the CSs, including one or more user databases, referred to as the UDBs, including user identification data and one or more E device databases, referred to as the EDDBs, including E Device identification data;
one or more cloud-based data depositories, referred herein as the DRs, including one or more servers, referred herein as the servers, the servers include one or more processing units, memory, one or more mass storage devices, an operating system or structure, one or more input devices including one or more display devices and one or more image capturing devices, one or more output devices, one or more data web-based or cloud-based data bases, referred as the DRDBs, or data storage structures, referred herein as the DRDSSs, collectively referred to as the DRDBDSSs, one or more web-based or cloud-based artificial intelligence engines, referred as the DRAI engines, communication hardware and software, and routines for implementing the system;
one or more image capturing devices, referred herein as the IC Devices; and
communication pathways between the E Devices, the CSs, the DRs, and the IC Devices,
   the system configured to:
receive, via an E Device of a user, referred to as the User E Device, from an authorizing authority, an Engagement Protocol comprising engagement data, operation data, or any combination thereof;
download, via the CSs to the User E Device, relevant data, referred to as the Relevant Data, in a continuous or periodic manner from the DRDBDSSs of the DRs to the LDBs and the LAI engines based on a Capacity of the User E Device, and Location Data comprising a location of the user and a location of the User E Device;
capture, via the IC Devices, image data associated with the User E Device, referred to as the Captured Image Data;
select, via the user, the LAI engines, the DRAI engines, or any combination thereof, one or more targets or target types in the Captured Image Data, referred to as the Targets;
identify, via the LAI engines, the DRAI engines, or any combination thereof, all recognizable objects in the Captured Image Data, referred to as the Identified Objects, and one or more of the Identified Objects associated with or located on, at, or near each of the Targets, referred to as the Target Relevant Objects;
select, via the LAI engines, the DRAI engines, or any combination thereof from the LDBs, the DRDBDSSs, or any combination, an item that is identical or similar to each of the Target Relevant Objects, referred to as the Target Selected Items;
adjust, via the LAI engines, the DRAI engines, or any combination thereof, a size and a spatial orientation of each of the Target Selected Items until the size and the spatial orientation of each of the Target Selected Items corresponds to its Target Relevant Object, referred to as the Size and Orientation Data;
determine, via the LAI engines, the DRAI engines, or any combination thereof, distance data for each of the Target Relevant Objects based on the Size and Orientation Data, referred to as the Target Relevant Object Distance Data;
calculate, via the LAI engines, the DRAI engines, or any combination thereof, a confidence value for each of the Target Relevant Object Distance Data, referred to as the CVs;
select, via the user, the LAI engines, the DRAI engines, or any combination thereof, a percentile or percentile range ranking protocol for each of the Targets, referred to as the Ranking Protocols;
calculate, via the LAI engines, the DRAI engines, or any combination thereof, ranking confidence values for each of the Target Relevant Objects based on the Ranking Protocols, referred to as the Ranked CVs;
select, via the LAI engines, the DRAI engines, or any combination thereof, a Target engagement protocol for each of the Targets based the CVs, the Ranked CVs, or any combination thereof, referred to as the Target Engagement Protocols; and
calculate, via the LAI engines, the DRAI engines, or any combination thereof, the Target Distance Data based on the CVs, the Ranked CVs, Target Engagement Protocols, or any combination thereof;
calculate, via the LAI engines, the DRAI engines, or any combination thereof, a distance to each of the Targets based on the Target Relevant Object Distance Data, referred to as the Target Distance Data;
communicate, via the User E Device, the Target Distance Data to one or more additional E Devices, one or more authorized persons, or any combination thereof;
receive, via the User E device from the authorizing authority, a Target Engagement Protocol for each of the Targets, each of the Target Engagement Protocols comprises instructions concerning target engagement;
engage, via a user, one, some, or all of the Targets;
confirm, via the LAI engines, the DRAI engines, or any combination thereof, a successful engagement or an unsuccessful engagement of each of the Targets, referred to as the Target Confirmation Data; and
communicate, via the User E Device, the Target Confirmation Data to one or more of the E Devices of the one or more additional E Devices, the one or more authorized persons, or any combination thereof.

Embodiment 175. The system of Embodiment 174, further comprising:
prior to the image data capture, receive, via the CSs from the User E Device, a user access request comprising user identification data;
determine, via the CSS,
   if the user is included in the UBDs, then:
      add other devices under control of the user to the EDDBs; or
      if the potential user is not included in the UBDs, then:
      exit the system.

Embodiment 176. The system of Embodiment 175, further comprising:
prior to the image data capture, receive, via the User E Device, a start function; or
after the Target engagement, receive, via the User E Device, exit the system; or
prior to the image data capture, receive, via one of the User E Device, a start function, and
after the Target engagement, receive, via the User E Device, exit the system.

Embodiment 177. The system of Embodiment 176, further comprising:
prior to the Target Selected Items identification, determine, via the LAI engines, the DRAI engines, or any combination thereof, if any of the Identified Objects is not found in the LDBs, DRDBDSSs, or any combination, thereof, referred to as the Unknown Objects;
for each of the Unknown Objects:
   generate/gather, via the CSs, information and data about the Unknown Object, referred to as the Unknown Object Data, and
   add via the LAI engines, the Unknown Object Data to the LDBs and
   add via the DRAI engines, the Unknown Object Data to the DRDBDSSs.

Embodiment 178. The system of Embodiment 177, further comprising:
store, via the CSs and the User E Device, the Captured Image Data, the Engagement Protocol, the user, the Location Data, the User E Device, the Targets, the Identified Objects, the Relevant Objects, the Selected Items, the Size and Orientation Data, the Relevant Object Distance Data, the CVs, the Ranked CVs, the Target Distance Data, the Target Engagement Authorization, the Target Engagement Data, and the Target Confirmation Data, referred to as the Current Operation Data, in the LDBs and the DRDBDSSs;
calculate, via the LAI engines, the DRAI engines, or any combination thereof, current user AI rules, user AI models, user AI methods, or any combination thereof based on the Current Operation Data, referred to as the Current User AI Data, and current operation AI rules, operation AI models, operation AI methods, or any combination thereof based on the Current Operation Data, referred to as the Current Operation AI Data;
store, via the LAI engines, the DRAI engines, or any combination thereof, the Current User AI Rules and the Current Operation AI Data on the LDBs and the DRDBDSSs;
update, via the LAI engines, the DRAI engines, or any combination thereof:
   User AI Data stored in the LDBs and the DRDBDSSs based on the Current User AI Rules, and
   Operation AI Data stored in the LDBs and the DRDBDSSs based on the Current Operation AI Data; and
store, via the LAI engines, the DRAI engines, or any combination thereof, the updated User AI Data and the updated Operation AI Data in DRDBDSSs.

Embodiment 179. The system of Embodiment 174, further comprising:
the user identification data comprises a user name, a user ID, referred to as UID, a Universal Unique Identifier, referred to as UUID, or combination thereof, a user password, one or more phone numbers, one or more email addresses, other user identification information, or any combination thereof;
the user name comprises a full name of a person, initials of a person, a combination of letters, a combination of numbers, or any combination thereof;
each of the E device identification data comprise a unique identifier assigned to each E device;
the E device identification comprise E device manufacturer data, E device serial number data, E device operating system data, Identifier for Advertisers, referred to as IDFA, for iOS® devices, Android Advertising ID, referred to as AAID, for Android® devices, Google Advertising ID, referred to as GAID, for the Google® ecosystem, proprietary Secure ID, Media Access Control address, referred to as MAC address, International Mobile Equipment Identity, referred to as IMEI, for mobile devices, Universally Unique Identifier, referred to as UUID, Item Unique Identification, referred to as IUID, Unique Device Identification, referred to as UDI, Unique Device Identifier, referred to as UDID, or any combination thereof;
the LDBs and the DRDBDSSs includes data corresponding to items, item types, item classes, item categories, users, user types, user classes, and user categories;
the items comprise members of the animal kingdom including human beings or people, members of the plant kingdom, apparatuses, apparatus types, apparatus classes, apparatus categories, devices, devices types, devices classes, devices categories, equipment, equipment types, equipment classes, equipment categories, operations, operation types, operation classes, and operation categories, referred to as the DRDBDSS Data; and
the LAI engines, the DRAI engines, or any combination thereof comprise routines for recognizing objects in the Captured Image Data.

Embodiment 180. The system of Embodiment 174, wherein for people, the DRDBDSSs include social media data, relationship data, biometric data such as fingerprints, hand size and shape, finger sizes and shapes, iris features, iris data stored in iris recognition databases, facial features, facial data stored in facial recognition databases, height, weight, skin color, ethnicity, any other biometric data associated with an individual, and any other data specific to the individual.

Embodiment 181. The system of Embodiment 174, further comprising:
prior to the Target Distance Data communicating, determine size information for one or more of the Targets.

Embodiment 182. A method implemented on a system, the system comprising:
one or more electronic devices, referred to as the E Devices, each of the E Devices includes one or more processing units, memory, one or more mass storage devices, an operating system or structure, one or more input devices including one or more display devices and one or more image capturing devices, one or more output devices, communication hardware and software, and routines for implementing the system;
one or more cloud servers, referred to as the CSs, including one or more user databases, referred to as the UDBs, including user identification data and one or more E device databases, referred to as the EDDBs, including E Device identification data;
one or more cloud-based data depositories, referred herein as the DRs, including one or more servers, referred herein as the servers, the servers include one or more processing units, memory, one or more mass storage devices, an operating system or structure, one or more input devices including one or more display devices and one or more image capturing devices, one or more output devices, one or more data web-based or cloud-based data bases, referred as the DRDBs, or data storage structures, referred herein as the DRDSSs, collectively referred to as the DRDBDSSs, one or more web-based or cloud-based artificial intelligence engines, referred as the DRAI engines, communication hardware and software, and routines for implementing the system;
one or more image capturing devices, referred herein as the IC Devices; and
communication pathways between the E Devices, the CSs, the DRs, and the IC Devices,
   the method comprising:
receiving, via an E Device of a user, referred to as the User E Device, from an authorizing authority, an Engagement Protocol comprising engagement data, operation data, or any combination thereof;
downloading, via the CSs to the User E Device, relevant data, referred to as the Relevant Data, in a continuous or periodic manner from the DRDBDSSs of the DRs to the LDBs and the LAI engines based on a Capacity of the User E Device, and Location Data comprising a location of the user and a location of the User E Device;
capturing, via the IC Devices, image data associated with the User E Device, referred to as the Captured Image Data;
selecting, via the user, the LAI engines, the DRAI engines, or any combination thereof, one or more targets or target types in the Captured Image Data, referred to as the Targets;
identifying, via the LAI engines, the DRAI engines, or any combination thereof, all recognizable objects in the Captured Image Data, referred to as the Identified Objects, and one or more of the Identified Objects associated with or located on, at, or near each of the Targets, referred to as the Target Relevant Objects;
selecting, via the LAI engines, the DRAI engines, or any combination thereof from the LDBs, the DRDBDSSs, or any combination, an item that is identical or similar to each of the Target Relevant Objects, referred to as the Target Selected Items;
adjusting, via the LAI engines, the DRAI engines, or any combination thereof, a size and a spatial orientation of each of the Target Selected Items until the size and the spatial orientation of each of the Target Selected Items corresponds to its Target Relevant Object, referred to as the Size and Orientation Data;
determining, via the LAI engines, the DRAI engines, or any combination thereof, distance data for each of the Target Relevant Objects based on the Size and Orientation Data, referred to as the Target Relevant Object Distance Data;
calculating, via the LAI engines, the DRAI engines, or any combination thereof, a confidence value for each of the Target Relevant Object Distance Data, referred to as the CVs;
selecting, via the user, the LAI engines, the DRAI engines, or any combination thereof, a percentile or percentile range ranking protocol for each of the Targets, referred to as the Ranking Protocols;
calculating, via the LAI engines, the DRAI engines, or any combination thereof, ranking confidence values for each of the Target Relevant Objects based on the Ranking Protocols, referred to as the Ranked CVs;
selecting, via the LAI engines, the DRAI engines, or any combination thereof, a Target engagement protocol for each of the Targets based the CVs, the Ranked CVs, or any combination thereof, referred to as the Target Engagement Protocols; and
calculating, via the LAI engines, the DRAI engines, or any combination thereof, the Target Distance Data based on the CVs, the Ranked CVs, Target Engagement Protocols, or any combination thereof;
calculating, via the LAI engines, the DRAI engines, or any combination thereof, a distance to each of the Targets based on the Target Relevant Object Distance Data, referred to as the Target Distance Data;
communicating, via the User E Device, the Target Distance Data to one or more additional E Devices, one or more authorized persons, or any combination thereof;
receiving, via the User E device from the authorizing authority, a Target Engagement Protocol for each of the Targets, each of the Target Engagement Protocols comprises instructions concerning target engagement;
engaging, via a user, one, some, or all of the Targets;
confirm, via the LAI engines, the DRAI engines, or any combination thereof, a successful engagement or an unsuccessful engagement of each of the Targets, referred to as the Target Confirmation Data; and
communicating, via the User E Device, the Target Confirmation Data to one or more of the E Devices of the one or more additional E Devices, the one or more authorized persons, or any combination thereof.

Although the present disclosure is described above in terms of various exemplary embodiments and implementations, it should be understood that the various features and functionality described in one or more of the individual embodiments are not limited in their applicability to the particular embodiment with which they are described, but instead might be applied, alone or in various combinations, to one or more other embodiments whether or not such embodiments are described and whether or not such features are presented as being a part of a described embodiment. Thus, the breadth and scope of the claimed invention should not be limited by any of the above-described embodiments.

Persons of ordinary skill in the art will recognize that many modifications may be made to the present disclosure without departing from the spirit and scope of the disclosure. The embodiment(s) described herein are meant to be illustrative only and should not be taken as limiting the invention, which is defined in the claims.

We claim:

1. A system, comprising:
one or more electronic devices, referred to as the E Devices, each of the E Devices includes one or more processing units, memory, one or more mass storage devices, an operating system or structure, one or more input devices including one or more display devices and one or more image capturing devices, one or more output devices, communication hardware and software, and routines for implementing the system;
one or more cloud servers, referred to as the CSs, including one or more user databases, referred to as the UDBs, including user identification data and one or more E device databases, referred to as the EDDBs, including E Device identification data;
one or more cloud-based data depositories, referred herein as the DRs, including one or more servers, referred herein as the servers, the servers include one or more processing units, memory, one or more mass storage devices, an operating system or structure, one or more input devices including one or more display devices and one or more image capturing devices, one or more output devices, one or more data web-based or cloud-based data bases, referred as the DRDBs, or data storage structures, referred herein as the DRDSSs, collectively referred to as the DRDBDSSs, one or more web-based or cloud-based artificial intelligence engines, referred as the DRAI engines, communication hardware and software, and routines for implementing the system;
one or more image capturing devices, referred herein as the IC Devices; and
communication pathways between the E Devices, the CSs, the DRs, and the IC Devices,
the system configured to:
download, via the CSs to an E Device of a user, referred to as the User E Device, relevant data, referred to as the Relevant Data, in a continuous or periodic manner from the DRDBDSSs of the DRs to the LDBs and the LAI engines based on a Capacity of the User E Device, and Location Data comprising a location of the user and a location of the User E Device;
capture, via the IC Devices, image data associated with the User E Device, referred to as the Captured Image Data;
select, via the user, the LAI engines, the DRAI engines, or any combination thereof, one or more targets or target types in the Captured Image Data, referred to as the Targets;
identify, via the LAI engines, the DRAI engines, or any combination thereof, all recognizable objects in the Captured Image Data, referred to as the Identified Objects, and one or more of the Identified Objects associated with or located on, at, or near each of the Targets, referred to as the Target Relevant Objects;
select, via the LAI engines, the DRAI engines, or any combination thereof from the LDBs, the DRDBDSSs, or any combination, an item that is identical or similar to each of the Target Relevant Objects, referred to as the Target Selected Items;
adjust, via the LAI engines, the DRAI engines, or any combination thereof, a size and a spatial orientation of each of the Target Selected Items until the size and the spatial orientation of each of the Target Selected Items corresponds to its Target Relevant Object, referred to as the Size and Orientation Data;
determine, via the LAI engines, the DRAI engines, or any combination thereof, distance data for each of the Target Relevant Objects based on the Size and Orientation Data, referred to as the Target Relevant Object Distance Data;
calculate, via the LAI engines, the DRAI engines, or any combination thereof, a distance to each of the Targets based on the Target Relevant Object Distance Data, referred to as the Target Distance Data; and
engage, via a user, one, some, or all of the Targets.

2. The system of claim 1, further comprising:
after or simultaneous with the image data capture, monitor, via the LAI engines, the DRAI engines, or any combination thereof, the image data;
prior to the Target Distance Data calculation, calculate, via the LAI engines, the DRAI engines, or any combination thereof, a confidence value for each of the Target Relevant Object Distance Data, referred to as the CVs; and
calculate, via the LAI engines, the DRAI engines, or any combination thereof, the Target Distance Data based on the CVs.

3. The system of claim 2, further comprising:
select, via the user, the LAI engines, the DRAI engines, or any combination thereof, a percentile or percentile range ranking protocol for each of the Targets, referred to as the Ranking Protocols;
calculate, via the LAI engines, the DRAI engines, or any combination thereof, ranking confidence values for each of the Target Relevant Objects based on the Ranking Protocols, referred to as the Ranked CVs; and
calculate, via the LAI engines, the DRAI engines, or any combination thereof, the Target Distance Data based on the CVs, the Ranked CVs, or any combination thereof.

4. The system of claim 3, further comprising:
select, via the LAI engines, the DRAI engines, or any combination thereof, a Target engagement protocol for each of the Targets based on the CVs, the Ranked CVs, or any combination thereof, referred to as the Target Engagement Protocols; and
calculate, via the LAI engines, the DRAI engines, or any combination thereof, the Target Distance Data based on the CVs, the Ranked CVs, Target Engagement Protocols, or any combination thereof.

5. The system of claim 4, further comprising:
prior to the image data capture, receive, via the CSs from the User E Device, a user access request comprising user identification data;
determine, via the CSS,
if the user is included in the UBDs, then:
add other devices under control of the user to the EDDBs; or
if the potential user is not included in the UBDs, then:
exit the system.

6. The system of claim 5, further comprising:
prior to the image data capture, receive, via the User E Device, a start function; or
after the Target engagement, receive, via the User E Device, exit the system; or
prior to the image data capture, receive, via one of the User E Device, a start function, and
after the Target engagement, receive, via the User E Device, exit the system.

7. The system of claim 6, further comprising:
prior to the Target Selected Items identification, determine, via the LAI engines, the DRAI engines, or any combination thereof, if any of the Identified Objects is not found in the LDBs, DRDBDSSs, or any combination, thereof, referred to as the Unknown Objects;
for each of the Unknown Objects:
generate/gather, via the CSs, information and data about the Unknown Object, referred to as the Unknown Object Data, and
add via the LAI engines, the Unknown Object Data to the LDBs and
add via the DRAI engines, the Unknown Object Data to the DRDBDSSs.

8. The system of claim 7, further comprising:
prior to the image data capture, receive, via the User E Device from an authorizing authority, an Engagement Protocol comprising engagement data, operation data, or any combination thereof;
after the Target Distance Data calculation, communicate, via the User E Device, the Target Distance Data to one or more additional E Devices, one or more authorized persons, or any combination thereof;
prior to the Targets engagement, receive, via the User E device from the authorizing authority, a Target Engagement Protocol for each of the Targets, each of the Target Engagement Protocols comprises instructions concerning target engagement;
after the Targets engagement:
confirm, via the LAI engines, the DRAI engines, or any combination thereof, a successful engagement or an unsuccessful engagement of each of the Targets, referred to as the Target Confirmation Data; and
communicate, via the User E Device, the Target Confirmation Data to one or more of the E Devices of the one or more additional E Devices, the one or more authorized persons, or any combination thereof.

9. The system of claim 8, further comprising:
store, via the CSs and the User E Device, the Captured Image Data, the Engagement Protocol, the user, the Location Data, the User E Device, the Targets, the Identified Objects, the Relevant Objects, the Selected Items, the Size and Orientation Data, the Relevant Object Distance Data, the CVs, the Ranked CVs, the Target Distance Data, the Target Engagement Authorization, the Target Engagement Data, and the Target Confirmation Data, referred to as the Current Operation Data, in the LDBs and the DRDBDSSs;
calculate, via the LAI engines, the DRAI engines, or any combination thereof, current user AI rules, user AI models, user AI methods, or any combination thereof based on the Current Operation Data, referred to as the Current User AI Data, and current operation AI rules, operation AI models, operation AI methods, or any combination thereof based on the Current Operation Data, referred to as the Current Operation AI Data;
store, via the LAI engines, the DRAI engines, or any combination thereof, the Current User AI Rules and the Current Operation AI Data on the LDBs and the DRDBDSSs;
update, via the LAI engines, the DRAI engines, or any combination thereof:
User AI Data stored in the LDBs and the DRDBDSSs based on the Current User AI Rules, and
Operation AI Data stored in the LDBs and the DRDBDSSs based on the Current Operation AI Data; and
store, via the LAI engines, the DRAI engines, or any combination thereof, the updated User AI Data and the updated Operation AI Data in DRDBDSSs.

10. The system of claim 1, further comprising:
the user identification data comprise a user name, a user ID, referred to as UID, a Universal Unique Identifier, referred to as UUID, or combination thereof, a user password, one or more phone numbers, one or more email addresses, other user identification information, or any combination thereof;
the user name comprises a full name of a person, initials of a person, a combination of letters, a combination of numbers, or any combination thereof;
each of the E device identification data comprise a unique identifier assigned to each E device;
the E device identification comprise E device manufacturer data, E device serial number data, E device operating system data, Identifier for Advertisers, referred to as IDFA, for iOS® devices, Android Advertising ID, referred to as AAID, for Android® devices, Google Advertising ID, referred to as GAID, for the Google® ecosystem, proprietary Secure ID, Media Access Control address, referred to as MAC address, International Mobile Equipment Identity, referred to as IMEI, for mobile devices, Universally Unique Identifier, referred to as UUID, Item Unique Identification, referred to as IUID, Unique Device Identification, referred to as UDI, Unique Device Identifier, referred to as UDID, or any combination thereof;
the LDBs and the DRDBDSSs includes data corresponding to items, item types, item classes, item categories, users, user types, user classes, and user categories;
the items comprise members of the animal kingdom including human beings or people, members of the plant kingdom, apparatuses, apparatus types, apparatus classes, apparatus categories, devices, devices types, devices classes, devices categories, equipment, equipment types, equipment classes, equipment categories, operations, operation types, operation classes, and operation categories, referred to as the DRDBDSS Data; and
the LAI engines, the DRAI engines, or any combination thereof comprise routines for recognizing objects in the Captured Image Data.

11. A system, comprising:
one or more electronic devices, referred to as the E Devices, each of the E Devices includes one or more processing units, memory, one or more mass storage devices, an operating system or structure, one or more input devices including one or more display devices and one or more image capturing devices, one or more output devices, communication hardware and software, and routines for implementing the system;
one or more cloud servers, referred to as the CSs, including one or more user databases, referred to as the UDBs, including user identification data and one or more E device databases, referred to as the EDDBs, including E Device identification data;
one or more cloud-based data depositories, referred herein as the DRs, including one or more servers, referred herein as the servers, the servers include one or more processing units, memory, one or more mass storage devices, an operating system or structure, one or more input devices including one or more display devices and one or more image capturing devices, one or more output devices, one or more data web-based or cloud-based data bases, referred as the DRDBs, or data storage structures, referred herein as the DRDSSs, collectively referred to as the DRDBDSSs, one or more web-based or cloud-based artificial intelligence engines, referred as the DRAI engines, communication hardware and software, and routines for implementing the system;
one or more image capturing devices, referred herein as the IC Devices; and
communication pathways between the E Devices, the CSs, the DRs, and the IC Devices,
the system configured to:
receive, via an E Device of a user, referred to as the User E Device, from an authorizing authority, an Engagement Protocol comprising engagement data, operation data, or any combination thereof;
download, via the CSs to the User E Device, relevant data, referred to as the Relevant Data, in a continuous or periodic manner from the DRDBDSSs of the DRs to the LDBs and the LAI engines based on a Capacity of the User E Device, and Location Data comprising a location of the user and a location of the User E Device;
capture, via the IC Devices, image data associated with the User E Device, referred to as the Captured Image Data;
select, via the user, the LAI engines, the DRAI engines, or any combination thereof, one or more targets or target types in the Captured Image Data, referred to as the Targets;
identify, via the LAI engines, the DRAI engines, or any combination thereof, all recognizable objects in the Captured Image Data, referred to as the Identified Objects, and one or more of the Identified Objects associated with or located on, at, or near each of the Targets, referred to as the Target Relevant Objects;
select, via the LAI engines, the DRAI engines, or any combination thereof from the LDBs, the DRDBDSSs, or any combination, an item that is identical or similar to each of the Target Relevant Objects, referred to as the Target Selected Items;
adjust, via the LAI engines, the DRAI engines, or any combination thereof, a size and a spatial orientation of each of the Target Selected Items until the size and the spatial orientation of each of the Target Selected Items corresponds to its Target Relevant Object, referred to as the Size and Orientation Data;
determine, via the LAI engines, the DRAI engines, or any combination thereof, distance data for each of the Target Relevant Objects based on the Size and Orientation Data, referred to as the Target Relevant Object Distance Data;
calculate, via the LAI engines, the DRAI engines, or any combination thereof, a confidence value for each of the Target Relevant Object Distance Data, referred to as the CVs;
select, via the user, the LAI engines, the DRAI engines, or any combination thereof, a percentile or percentile range ranking protocol for each of the Targets, referred to as the Ranking Protocols;
calculate, via the LAI engines, the DRAI engines, or any combination thereof, ranking confidence values for each of the Target Relevant Objects based on the Ranking Protocols, referred to as the Ranked CVs;
select, via the LAI engines, the DRAI engines, or any combination thereof, a Target engagement protocol for each of the Targets based the CVs, the Ranked CVs, or any combination thereof, referred to as the Target Engagement Protocols; and
calculate, via the LAI engines, the DRAI engines, or any combination thereof, the Target Distance Data based on the CVs, the Ranked CVs, Target Engagement Protocols, or any combination thereof;
calculate, via the LAI engines, the DRAI engines, or any combination thereof, a distance to each of the Targets based on the Target Relevant Object Distance Data, referred to as the Target Distance Data;
communicate, via the User E Device, the Target Distance Data to one or more additional E Devices, one or more authorized persons, or any combination thereof;
receive, via the User E device from the authorizing authority, a Target Engagement Protocol for each of the Targets, each of the Target Engagement Protocols comprises instructions concerning target engagement;
engage, via a user, one, some, or all of the Targets;
confirm, via the LAI engines, the DRAI engines, or any combination thereof, a successful engagement or an unsuccessful engagement of each of the Targets, referred to as the Target Confirmation Data; and
communicate, via the User E Device, the Target Confirmation Data to one or more of the E Devices of the one or more additional E Devices, the one or more authorized persons, or any combination thereof.

12. The system of claim 11, further comprising:
prior to the image data capture, receive, via the CSs from the User E Device, a user access request comprising user identification data;
determine, via the CSs,
if the user is included in the UBDs, then:
add other devices under control of the user to the EDDBs; or
if the potential user is not included in the UBDs, then:
exit the system.

13. The system of claim 12, further comprising:
prior to the image data capture, receive, via the User E Device, a start function; or
after the Target engagement, receive, via the User E Device, exit the system; or
prior to the image data capture, receive, via one of the User E Device, a start function, and
after the Target engagement, receive, via the User E Device, exit the system.

14. The system of claim 13, further comprising:
prior to the Target Selected Items identification, determine, via the LAI engines, the DRAI engines, or any combination thereof, if any of the Identified Objects is not found in the LDBs, DRDBDSSs, or any combination, thereof, referred to as the Unknown Objects;
for each of the Unknown Objects:
generate/gather, via the CSs, information and data about the Unknown Object, referred to as the Unknown Object Data, and
add via the LAI engines, the Unknown Object Data to the LDBs and
add via the DRAI engines, the Unknown Object Data to the DRDBDSSs.

15. The system of claim 14, further comprising:
store, via the CSs and the User E Device, the Captured Image Data, the Engagement Protocol, the user, the Location Data, the User E Device, the Targets, the Identified Objects, the Relevant Objects, the Selected Items, the Size and Orientation Data, the Relevant Object Distance Data, the CVs, the Ranked CVs, the Target Distance Data, the Target Engagement Authorization, the Target Engagement Data, and the Target Confirmation Data, referred to as the Current Operation Data, in the LDBs and the DRDBDSSs;
calculate, via the LAI engines, the DRAI engines, or any combination thereof, current user AI rules, user AI models, user AI methods, or any combination thereof based on the Current Operation Data, referred to as the Current User AI Data, and current operation AI rules, operation AI models, operation AI methods, or any combination thereof based on the Current Operation Data, referred to as the Current Operation AI Data;
store, via the LAI engines, the DRAI engines, or any combination thereof, the Current User AI Rules and the Current Operation AI Data on the LDBs and the DRDBDSSs;
update, via the LAI engines, the DRAI engines, or any combination thereof:
User AI Data stored in the LDBs and the DRDBDSSs based on the Current User AI Rules, and
Operation AI Data stored in the LDBs and the DRDBDSSs based on the Current Operation AI Data; and
store, via the LAI engines, the DRAI engines, or any combination thereof, the updated User AI Data and the updated Operation AI Data in DRDBDSSs.

16. The system of claim 11, further comprising:
the user identification data comprises a user name, a user ID, referred to as UID, a Universal Unique Identifier, referred to as UUID, or combination thereof, a user password, one or more phone numbers, one or more email addresses, other user identification information, or any combination thereof;
the user name comprises a full name of a person, initials of a person, a combination of letters, a combination of numbers, or any combination thereof;
each of the E device identification data comprise a unique identifier assigned to each E device;
the E device identification comprise E device manufacturer data, E device serial number data, E device operating system data, Identifier for Advertisers, referred to as IDFA, for iOS® devices, Android Advertising ID, referred to as AAID, for Android® devices, Google Advertising ID, referred to as GAID, for the Google® ecosystem, proprietary Secure ID, Media Access Control address, referred to as MAC address, International Mobile Equipment Identity, referred to as IMEI, for mobile devices, Universally Unique Identifier, referred to as UUID, Item Unique Identification, referred to as IUID, Unique Device Identification, referred to as UDI, Unique Device Identifier, referred to as UDID, or any combination thereof;
the LDBs and the DRDBDSSs includes data corresponding to items, item types, item classes, item categories, users, user types, user classes, and user categories;
the items comprise members of the animal kingdom including human beings or people, members of the plant kingdom, apparatuses, apparatus types, apparatus classes, apparatus categories, devices, devices types, devices classes, devices categories, equipment, equipment types, equipment classes, equipment categories, operations, operation types, operation classes, and operation categories, referred to as the DRDBDSS Data; and
the LAI engines, the DRAI engines, or any combination thereof comprise routines for recognizing objects in the Captured Image Data.

17. The system of claim 11, wherein for people, the DRDBDSSs include social media data, relationship data, biometric data such as fingerprints, hand size and shape, finger sizes and shapes, iris features, iris data stored in iris recognition databases, facial features, facial data stored in facial recognition databases, height, weight, skin color, ethnicity, any other biometric data associated with an individual, and any other data specific to the individual.

18. The system of claim 11, further comprising:
prior to the Target Distance Data communicating, determine size information for one or more of the Targets.

19. A method implemented on a system, the system comprising:
one or more electronic devices, referred to as the E Devices, each of the E Devices includes one or more processing units, memory, one or more mass storage devices, an operating system or structure, one or more input devices including one or more display devices and one or more image capturing devices, one or more output devices, communication hardware and software, and routines for implementing the system;
one or more cloud servers, referred to as the CSs, including one or more user databases, referred to as the UDBs, including user identification data and one or more E device databases, referred to as the EDDBs, including E Device identification data;
one or more cloud-based data depositories, referred herein as the DRs, including one or more servers, referred herein as the servers, the servers include one or more processing units, memory, one or more mass storage devices, an operating system or structure, one or more input devices including one or more display devices and one or more image capturing devices, one or more output devices, one or more data web-based or cloud-based data bases, referred as the DRDBs, or data storage structures, referred herein as the DRDSSs, collectively referred to as the DRDBDSSs, one or more web-based or cloud-based artificial intelligence engines, referred as the DRAI engines, communication hardware and software, and routines for implementing the system;
one or more image capturing devices, referred herein as the IC Devices; and
communication pathways between the E Devices, the CSs, the DRs, and the IC Devices,
the method comprising:
receiving, via an E Device of a user, referred to as the User E Device, from an authorizing authority, an Engagement Protocol comprising engagement data, operation data, or any combination thereof;
downloading, via the CSs to the User E Device, relevant data, referred to as the Relevant Data, in a continuous or periodic manner from the DRDBDSSs of the DRs to the LDBs and the LAI engines based on a Capacity of the User E Device, and Location Data comprising a location of the user and a location of the User E Device;
capturing, via the IC Devices, image data associated with the User E Device, referred to as the Captured Image Data;
selecting, via the user, the LAI engines, the DRAI engines, or any combination thereof, one or more targets or target types in the Captured Image Data, referred to as the Targets;
identifying, via the LAI engines, the DRAI engines, or any combination thereof, all recognizable objects in the Captured Image Data, referred to as the Identified Objects, and one or more of the Identified Objects associated with or located on, at, or near each of the Targets, referred to as the Target Relevant Objects;
selecting, via the LAI engines, the DRAI engines, or any combination thereof from the LDBs, the DRDBDSSs, or any combination, an item that is identical or similar to each of the Target Relevant Objects, referred to as the Target Selected Items;
adjusting, via the LAI engines, the DRAI engines, or any combination thereof, a size and a spatial orientation of each of the Target Selected Items until the size and the spatial orientation of each of the Target Selected Items corresponds to its Target Relevant Object, referred to as the Size and Orientation Data;
determining, via the LAI engines, the DRAI engines, or any combination thereof, distance data for each of the Target Relevant Objects based on the Size and Orientation Data, referred to as the Target Relevant Object Distance Data;
calculating, via the LAI engines, the DRAI engines, or any combination thereof, a confidence value for each of the Target Relevant Object Distance Data, referred to as the CVs;
selecting, via the user, the LAI engines, the DRAI engines, or any combination thereof, a percentile or percentile range ranking protocol for each of the Targets, referred to as the Ranking Protocols;
calculating, via the LAI engines, the DRAI engines, or any combination thereof, ranking confidence values for each of the Target Relevant Objects based on the Ranking Protocols, referred to as the Ranked CVs;
selecting, via the LAI engines, the DRAI engines, or any combination thereof, a Target engagement protocol for each of the Targets based the CVs, the Ranked CVs, or any combination thereof, referred to as the Target Engagement Protocols; and
calculating, via the LAI engines, the DRAI engines, or any combination thereof, the Target Distance Data based on the CVs, the Ranked CVs, Target Engagement Protocols, or any combination thereof;
calculating, via the LAI engines, the DRAI engines, or any combination thereof, a distance to each of the Targets based on the Target Relevant Object Distance Data, referred to as the Target Distance Data;
communicating, via the User E Device, the Target Distance Data to one or more additional E Devices, one or more authorized persons, or any combination thereof;
receiving, via the User E device from the authorizing authority, a Target Engagement Protocol for each of the Targets, each of the Target Engagement Protocols comprises instructions concerning target engagement;
engaging, via a user, one, some, or all of the Targets;
confirm, via the LAI engines, the DRAI engines, or any combination thereof, a successful engagement or an unsuccessful engagement of each of the Targets, referred to as the Target Confirmation Data; and
communicating, via the User E Device, the Target Confirmation Data to one or more of the E Devices of the one or more additional E Devices, the one or more authorized persons, or any combination thereof.
